(19) United States
(12) Patent Application Publication
(10) Pub. No.: US 2012/0031303 A1
(43) Pub. Date: Feb. 9, 2012

(54) CALCIUM CARBONATE COMPOSITIONS AND METHODS THEREOF

(76) Inventors: BRENT R. CONSTANTZ, Portola Valley, CA (US); Miguel Fernandez, San Jose, CA (US); Andrew Youngs, Antelope, CA (US); Michael Joseph Weiss, Los Gatos, CA (US)

(21) Appl. No.: 13/156,698

(22) Filed: Jun. 9, 2011

Related U.S. Application Data
(60) Provisional application No. 61/371,620, filed on Aug. 6, 2010.
(60) Provisional application No. 61/408,325, filed on Oct. 29, 2010.

(51) Int. Cl. C04B 14/48; B01J 19/00

(52) U.S. Cl. 106/640; 422/129

(57) ABSTRACT

Provided herein are cementitious compositions including hydraulic cement, supplementary cementitious material, and/or self-cementing material. Such compositions may be made from carbonate brines. Methods and systems for making the compositions and using the compositions are also provided.

### CROSS-REFERENCE TO RELATED APPLICATIONS

This application claims priority to U.S. Provisional Application No. 61/371,620, filed Aug. 6, 2010, and U.S. Provisional Application No. 61/408,325, filed Oct. 29, 2010, which are both incorporated herein by reference in their entirety.

### GOVERNMENT SUPPORT

Work described herein was made in whole or in part with Government support under Award Number: DE-FE0002472 awarded by the Department of Energy. The Government has certain rights in this invention.

### BACKGROUND

Calcium carbonates are used in numerous industries from papermaking, to adhesives production, to construction. As the production of conventional cements is one of the greatest contributors to the emission of carbon dioxide into the atmosphere through the calcination of conventional cements as well as the energy needed to heat the kilns, reductions in the amount of conventional cements used can help to reduce the amount of carbon dioxide in the earth's atmosphere.

### SUMMARY

In one aspect, there is provided a cementitious composition, comprising: a carbonate, bicarbonate, or mixture thereof and one or more elements selected from the group consisting of barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa. In one aspect, there is provided a cementitious composition, comprising: a carbonate, bicarbonate, or mixture thereof and one or more elements selected from the group consisting of barium, cobalt, copper, lanthanum, mercury, arsenic, cadmium, lead, nickel, scandium, titanium, zinc, zirconium, molybdenum, and selenium, wherein the composition has a carbon isotopic fractionation value (δ¹³C) of greater than −5‰. In one aspect, there is provided a cementitious composition, comprising: at least 47% w/w vaterite and one or more elements selected from the group consisting of barium, cobalt, copper, lanthanum, mercury, arsenic, cadmium, lead, nickel, scandium, titanium, zinc, zirconium, molybdenum, and selenium. In one aspect, there is provided a cementitious composition, comprising: comprising at least 10% w/w vaterite, at least 1% w/w amorphous calcium carbonate (ACC), and one or more elements selected from the group consisting of barium, cobalt, copper, lanthanum, mercury, arsenic, cadmium, lead, nickel, scandium, titanium, zinc, zirconium, molybdenum, and selenium.

In some embodiments, the one or more elements are selected from the group consisting of lanthanum, mercury, arsenic, lead, and selenium. In some embodiments, each of the one or more elements are present in the composition in an amount of between 0.1-1000 ppm. In some embodiments, the one or more elements are arsenic, mercury, or selenium. In some embodiments, each of the one or more elements are present in the composition in an amount of between 0.5-100 ppm. In some embodiments, the composition after setting and hardening has a compressive strength in a range of 14-80 MPa. In some embodiments, after setting and hardening the composition has a compressive strength in a range of 14-35 MPa. In some embodiments, the composition is a particulate composition with an average particle size of 0.1-100 microns. In some embodiments, the composition is a particulate composition with an average particle size of 1-10 microns. In some embodiments, the composition has a δ¹³C of greater than −5‰. In some embodiments, the composition has the δ¹³C of between −5‰ to 25‰. In some embodiments, the composition has the δ¹³C of between 0.1‰ to 20‰. In some embodiments, the composition comprises at least 47% w/w vaterite or at least 10% w/w vaterite and at least 1% w/w amorphous calcium carbonate (ACC). In some embodiments, the composition comprises between 47% w/w to 99% w/w vaterite. In some embodiments, the composition comprises between 47% w/w to 99% w/w vaterite and between 1% w/w to 50% w/w amorphous calcium carbonate (ACC). In some embodiments, the composition further comprises a polymorph selected from the group consisting of amorphous calcium carbonate, aragonite, calcite, ikaite, a precursor phase of vaterite, a precursor phase of aragonite, an intermediary phase that is less stable than calcite, polymorphic forms in between these polymorphs, and combination thereof. In some embodiments, the vaterite and the polymorph are in a vaterite:polymorph ratio of 1:1 to 20:1. In some embodiments, the composition further comprises one or more of polymorph selected from the group consisting of aragonite, calcite, and ikaite, wherein the aragonite, calcite and/or ikaite are present in at least 1% w/w. In some embodiments, the composition has a bulk density of between 75 lb/ft³-170 lb/ft³.

In some embodiments, the composition has an average surface area of from 0.5 m²/gm-50 m²/gm. In some embodiments, the composition further comprises Portland cement clinker, aggregate, supplementary cementitious material (SCM), or combination thereof. In some embodiments, the composition is a hydraulic cement. In some embodiments, the composition is a supplementary cementitious material. In some embodiments, the composition is a self-cementing material. In some embodiments, the composition is in a dry powdered form. In some embodiments, the composition has a zeta potential of greater than −25 mV. In some embodiments, the composition has a zeta potential of between −25 mV to 45 mV. In some embodiments, the composition comprises calcium carbonate, calcium bicarbonate, or mixture thereof.

In one aspect, there is provided a formed building material, comprising: the composition of any of the foregoing aspects and foregoing embodiments or the set and hardened form thereof.

In one aspect, there is provided an aggregate, comprising: the composition of any of the foregoing aspects and foregoing embodiments or the set and hardened form thereof.

In one aspect, there is provided a package, comprising: the composition of any of the foregoing aspects and foregoing embodiments and a packaging material adapted to contain the composition.

In one aspect, there is provided a method comprising: contacting a source of cation with a carbonate brine to give a reaction product comprising carbonic acid, bicarbonate, carbonate, or mixture thereof. In some embodiments, the method further comprises using a portion of the reaction product to produce a solid material. In some embodiments, the source of cation is an aqueous solution containing an alkaline earth metal ion. In some embodiments, the alkaline earth metal ion is calcium ion or magnesium ion. In some embodiments, the source of cation has between 1% to 90% by wt of alkaline earth metal ions. In some embodiments, the carbonate brine comprises 5% to 95% carbonate by wt. In some embodiments, the method further comprises a proton removing agent. In some embodiments, the proton removing agent is sodium hydroxide. In some embodiments, the method comprises one or more conditions selected from the group consisting of temperature, pH, precipitation, residence time of the precipitate, dewatering of the precipitate, washing the precipitate with water, drying, milling, and storage.

In another aspect, there is provided a cementitious composition made from the method of any one of the foregoing method aspects and/or embodiments.

In another aspect, there is provided a system, comprising: (a) an input for a source of cation, (b) an input for a source of carbonate brine, and c) a reactor connected to the inputs of step (a) and step (b) that is configured to give a reaction product comprising carbonic acid, bicarbonate, carbonate, or mixture thereof.

In another aspect, there is provided a method for making a cement product from the composition of any one of the foregoing composition aspect and/or embodiments, comprising: (a) combining the composition of any one of the foregoing composition aspect and/or embodiments with an aqueous medium under one or more suitable conditions; and (b) allowing the composition to set and harden into a cement product. In some embodiments, the aqueous medium comprises fresh water. In some embodiments, the one or more suitable conditions are selected from the group consisting of temperature, pressure, time period for setting, a ratio of the aqueous medium to the composition, and combination thereof. In some embodiments, the method further comprises combining the composition before step (a) with a Portland cement clinker, aggregate, SCM, or a combination thereof, before combining with the aqueous medium. In some embodiments, the cement product is a building material selected from the group consisting of building, driveway, foundation, kitchen slab, furniture, pavement, road, bridges, motorway, overpass, parking structure, brick, block, wall, footing for a gate, fence, or pole, and combination thereof. In some embodiments, the cement product is a formed building material.

In one aspect, there is provided a system for making a cement product from the composition of any one of the foregoing composition aspects and/or embodiments, comprising: (a) an input for the composition of any one of the foregoing composition aspects and/or embodiments; (b) an input for an aqueous medium; and (c) a reactor connected to the inputs of step (a) and step (b) configured to mix the composition of any one of the foregoing composition aspects and/or embodiments with the aqueous medium under one or more suitable conditions to make a cement product. In some embodiments, the one or more suitable conditions are selected from the group consisting of temperature, pressure, time period for setting, a ratio of the aqueous medium to the composition, and combination thereof. In some embodiments, the system further comprises a filtration element to filter the composition after the mixing step (c). In some embodiments, the system further comprises a drying step to dry the filtered composition to make the cement product.

In one aspect, there is provided a composition, comprising a hydraulic cement, the hydraulic cement comprising a carbonate, bicarbonate, or mixture thereof and one or more elements selected from the group consisting of barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa. In one aspect, there is provided a composition, comprising a hydraulic cement, the hydraulic cement comprising: a carbonate, bicarbonate, or mixture thereof and one or more elements selected from the group consisting of barium, cobalt, copper, lanthanum, mercury, arsenic, cadmium, lead, nickel, scandium, titanium, zinc, zirconium, molybdenum, and selenium, wherein the composition has a carbon isotopic fractionation value (δ¹³C) of greater than −5‰. In one aspect, there is provided a composition, comprising a hydraulic cement, the hydraulic cement comprising: at least 47% w/w vaterite and one or more elements selected from the group consisting of barium, cobalt, copper, lanthanum, mercury, arsenic, cadmium, lead, nickel, scandium, titanium, zinc, zirconium, molybdenum, and selenium. In one aspect, there is provided a composition, comprising a hydraulic cement, the hydraulic cement comprising: comprising at least 10% w/w vaterite, at least 1% w/w amorphous calcium carbonate (ACC), and one or more elements selected from the group consisting of barium, cobalt, copper, lanthanum, mercury, arsenic, cadmium, lead, nickel, scandium, titanium, zinc, zirconium, molybdenum, and selenium. In some embodiments, the one or more elements are selected from the group consisting of lanthanum, mercury, arsenic, lead, and selenium. In some embodiments, each of the one or more elements are present in the composition in an amount of between 0.1-1000 ppm. In some embodiments, the one or more elements are arsenic, mercury, or selenium. In some embodiments, each of the one or more elements are present in the composition in an amount of between 0.5-100 ppm. In some embodiments, the composition after setting and hardening has a compressive strength in a range of 14-80 MPa. In some embodiments, after setting and hardening the composition has a compressive strength in a range of 14-35 MPa. In some embodiments, the composition is a particulate composition with an average particle size of 0.1-100 microns. In some embodiments, the composition is a particulate composition with an average particle size of 1-10 microns. In some embodiments, the composition has a δ¹³C of greater than −5‰. In some embodiments, the composition has the δ¹³C of between −5‰ to 25‰. In some embodiments, the composition has the δ¹³C of between 0.1‰ to 20‰. In some embodiments, the composition comprises at least 47% w/w vaterite or at least 10% w/w vaterite and at least 1% w/w amorphous calcium carbonate (ACC). In some embodiments, the composition comprises between 47% w/w to 99% w/w vaterite. In some embodiments, the composition comprises between 47% w/w to 99% w/w vaterite and between 1% w/w to 50% w/w amorphous calcium carbonate (ACC). In some embodiments, the composition further comprises a polymorph selected from the group consisting of amorphous calcium carbonate, aragonite, calcite, ikaite, a precursor phase of vaterite, a precursor phase of aragonite, an intermediary phase that is less stable than calcite, polymorphic forms in between these polymorphs, and combination thereof. In some embodiments, the vaterite and the polymorph are in a vaterite:polymorph ratio of 1:1 to 20:1. In some embodiments, the composition further comprises one or more of polymorph selected from the group consisting of aragonite, calcite, and ikaite, wherein aragonite, calcite and/or ikaite are present in at least 1% w/w. In some embodiments, the composition has a bulk density of between 75 lb/ft³-170 lb/ft³. In some embodiments, the composition has an average surface area of from 0.5 m²/gm-50 m²/gm. In some embodiments, the composition further comprises Portland cement clinker, aggregate, supplementary cementitious material (SCM), or combination thereof. In some embodiments, the SCM comprises slag, fly ash, silica fume, calcined clay, or combination thereof. In some embodiments, the aggregate comprises sand, gravel, crushed stone, slag, recycled concrete, or combination thereof. In some embodiments, the composition is a synthetic composition. In some embodiments, the composition is in a dry powdered form. In some embodiments, the composition has a zeta potential of greater than −25 mV. In some embodiments, the composition has a zeta potential of between −25 mV to 45 mV. In some embodiments, the composition comprises calcium carbonate, calcium bicarbonate, or mixture thereof.

In one aspect, there is provided a formed building material, comprising: the composition of any one of the foregoing aspects and/or the foregoing embodiments or the set and hardened form thereof.

In one aspect, there is provided an aggregate, comprising: the composition of any one of the foregoing aspects and/or the foregoing embodiments or the set and hardened form thereof.

In one aspect, there is provided a package, comprising: the composition of any one of the foregoing aspects and/or the foregoing embodiments and a packaging material adapted to contain the composition.

In one aspect, there is provided a method for making the composition of any one of the foregoing composition aspects and/or the foregoing embodiments comprising: contacting a source of cation with a carbonate brine to give the composition of any one of the foregoing aspects and/or the foregoing embodiments. In some embodiments, the composition upon combination with water; setting; and hardening has a compressive strength of between 14-35 MPa. In some embodiments, the source of cation is an aqueous solution containing an alkaline earth metal ion. In some embodiments, the alkaline earth metal ion is calcium ion or magnesium ion. In some embodiments, the source of cation has between 1% to 90% by wt of an alkaline earth metal ion. In some embodiments, the carbonate brine comprises 5% to 95% carbonate by wt. In some embodiments, the method further comprises a proton removing agent. In some embodiments, the proton removing agent is sodium hydroxide. In some embodiments, the method comprises one or more of conditions selected from the group consisting of temperature, pH, precipitation, residence time of the precipitate, dewatering of the precipitate, washing the precipitate with water, drying, milling, and storage.

In one aspect, there is provided a composition made from the method of any one of the foregoing method aspects and/or embodiments.

In one aspect, there is provided a system for making the composition of any one of the foregoing composition aspects and/or embodiments, comprising: (a) an input for a source of cation, (b) an input for a source of carbonate brine, and (c) a reactor connected to the inputs of step (a) and step (b) that is configured to give a composition of any one of the foregoing composition aspects and/or embodiments.

In one aspect, there is provided a method for making a cement product from the composition of any one of the foregoing composition aspects and/or embodiments, comprising: (a) combining the composition of any one of the foregoing composition aspects and/or embodiments with an aqueous medium under one or more suitable conditions; and (b) allowing the composition to set and harden into a cement product. In some embodiments, the aqueous medium comprises fresh water or brine. In some embodiments, the one or more suitable conditions are selected from the group consisting of temperature, pressure, time period for setting, a ratio of the aqueous medium to the composition, and combination thereof. In some embodiments, the method further comprises combining the composition before step (a) with a Portland cement clinker, aggregate, SCM, or a combination thereof, before combining with the aqueous medium.

In some embodiments, the cement product is a building material selected from the group consisting of building, driveway, foundation, kitchen slab, furniture, pavement, road, bridges, motorway, overpass, parking structure, brick, block, wall, footing for a gate, fence, or pole, and combination thereof.

In some embodiments, the cement product is a formed building material.

In one aspect, there is provided a system for making a cement product from the composition of any one of the foregoing composition aspects and/or embodiments, comprising: (a) an input for the composition of any one of claims 1-30; (b) an input for an aqueous medium; and (c) a reactor connected to the inputs of step (a) and step (b) configured to mix the composition of any one of the foregoing composition aspects and/or embodiments with the aqueous medium under one or more suitable conditions to make a cement product. In some embodiments, the one or more suitable conditions are selected from the group consisting of temperature, pressure, time period for setting, a ratio of the aqueous medium to the composition, and combination thereof. In some embodiments, the system further comprises a filtration element to filter the composition after the mixing step (c). In some embodiments, the system further comprises a drying step to dry the filtered composition to make the cement product.

In one aspect, there is provided a composition, comprising a supplementary cementitious material (SCM), the SCM comprising a carbonate, bicarbonate, or mixture thereof and one or more elements selected from the group consisting of barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa. In one aspect, there is provided a composition, comprising a SCM, the SCM comprising: a carbonate, bicarbonate, or mixture thereof and one or more elements selected from the group consisting of barium, cobalt, copper, lanthanum, mercury, arsenic, cadmium, lead, nickel, scandium, titanium, zinc, zirconium, molybdenum, and selenium, wherein the composition has a carbon isotopic fractionation value (δ¹³C) of greater than −5‰. In one aspect, there is provided a composition, comprising a SCM, the SCM comprising: at least 47% w/w vaterite and one or more elements selected from the group consisting of barium, cobalt, copper, lanthanum, mercury, arsenic, cadmium, lead, nickel, scandium, titanium, zinc, zirconium, molybdenum, and selenium. In one aspect, there is provided a composition, comprising a SCM, the SCM comprising: comprising at least 10% w/w vaterite, at least 1% w/w amorphous calcium carbonate (ACC), and one or more elements selected from the group consisting of barium, cobalt, copper, lanthanum, mercury, arsenic, cadmium, lead, nickel, scandium, titanium, zinc, zirconium, molybdenum, and selenium.

In some embodiments, the one or more elements are selected from the group consisting of lanthanum, mercury, arsenic, lead, and selenium. In some embodiments, each of the one or more elements is present in the composition in an amount of between 0.1-1000 ppm.

In some embodiments, the one or more elements are arsenic, mercury, or selenium. In some embodiments, each of the one or more elements are present in the composition in an amount of between 0.5-100 ppm.

In some embodiments, the composition after setting and hardening has a compressive strength in a range of 14-80 MPa. In some embodiments, after setting and hardening the composition has a compressive strength in a range of 14-35 MPa.

In some embodiments, the composition is a particulate composition with an average particle size of 0.1-100 microns. In some embodiments, the composition is a particulate composition with an average particle size of 1-10 microns.

In some embodiments, the composition has a δ¹³C of greater than −5‰. In some embodiments, the composition has the δ¹³C of between −5‰ to 25‰. In some embodiments, the composition has the δ¹³C of between 0.1‰ to 20‰.

In some embodiments, the composition comprises at least 47% w/w vaterite or at least 10% w/w vaterite and at least 1% w/w amorphous calcium carbonate (ACC). In some embodiments, the composition comprises between 47% w/w to 99% w/w vaterite. In some embodiments, the composition comprises between 47% w/w to 99% w/w vaterite and between 1% w/w to 50% w/w amorphous calcium carbonate (ACC).

In some embodiments, the composition further comprises a polymorph selected from the group consisting of amorphous calcium carbonate, aragonite, calcite, ikaite, a precursor phase of vaterite, a precursor phase of aragonite, an intermediary phase that is less stable than calcite, polymorphic forms in between these polymorphs, and combination thereof. In some embodiments, the vaterite and the polymorph are in a vaterite:polymorph ratio of 1:1 to 20:1.

In some embodiments, the composition further comprises one or more of polymorph selected from the group consisting of aragonite, calcite, and ikaite, wherein aragonite, calcite and/or ikaite are present in at least 1% w/w.

In some embodiments, the composition has a bulk density of between 75 lb/ft³-170 lb/ft³.

In some embodiments, the composition has an average surface area of from 0.5 m²/gm-50 m²/gm.

In some embodiments, the composition further comprises Portland cement clinker, aggregate, other supplementary cementitious material (SCM), or combination thereof.

In some embodiments, the other SCM comprises slag, fly ash, silica fume, calcined clay, or combination thereof.

In some embodiments, the aggregate comprises sand, gravel, crushed stone, slag, recycled concrete, or combination thereof.

In some embodiments, the composition is a synthetic composition. In some embodiments, the composition is in a dry powdered form.

In some embodiments, the composition has a zeta potential of greater than −25 mV. In some embodiments, the composition has a zeta potential of between −25 mV to 45 mV.

In some embodiments, the composition comprises calcium carbonate, calcium bicarbonate, or mixture thereof.

In one aspect, there is provided a formed building material, comprising: the composition of any one of the foregoing aspects and/or foregoing embodiments or the set and hardened form thereof.

In one aspect, there is provided an aggregate, comprising: the composition of any one of the foregoing aspects and/or foregoing embodiments or the set and hardened form thereof.

In one aspect, there is provided a package, comprising: the composition of any one of the foregoing aspects and/or foregoing embodiments and a packaging material adapted to contain the composition.

In one aspect, there is provided a method for making the composition of any one of the foregoing aspects and/or foregoing embodiments comprising: contacting a source of cation with a carbonate brine to give a composition of any one of the foregoing composition aspects and/or foregoing embodiments.

In some embodiments, the composition upon combination with water; setting; and hardening has a compressive strength of 14-35 MPa.

In some embodiments, the source of cation is an aqueous solution containing an alkaline earth metal ion. In some embodiments, the alkaline earth metal ion is calcium ion or magnesium ion.

In some embodiments, the source of cation has between 1% to 90% by wt of an alkaline earth metal ion.

In some embodiments, the carbonate brine comprises 5% to 95% carbonate by wt.

In some embodiments, the method further comprises a proton removing agent. In some embodiments, the proton removing agent is sodium hydroxide.

In some embodiments, the method comprises one or more of conditions selected from the group consisting of temperature, pH, precipitation, residence time of the precipitate, dewatering of the precipitate, washing the precipitate with water, drying, milling, and storage.

In one aspect, there is provided a cementitious composition made from the method of any one of the foregoing method aspects and/or foregoing embodiments.

In one aspect, there is provided a system for making the composition of any one of the foregoing composition aspects and/or foregoing embodiments, comprising: (a) an input for a source of cation, (b) an input for a source of carbonate brine, and (c) a reactor connected to the inputs of step (a) and step (b) that is configured to give a composition of any one of the foregoing composition aspects and/or foregoing embodiments.

In one aspect, there is provided a method for making a cement product from the composition of any one of the foregoing composition aspects and/or foregoing embodiments, comprising: (a) combining the composition of any one of the foregoing composition aspects and/or foregoing embodiments with an aqueous medium under one or more suitable conditions; and (b) allowing the composition to set and harden into a cement product.

In some embodiments, the aqueous medium comprises fresh water.

In some embodiments, the one or more suitable conditions are selected from the group consisting of temperature, pressure, time period for setting, a ratio of the aqueous medium to the composition, and combination thereof.

In some embodiments, the method further comprises combining the composition before step (a) with a Portland cement clinker, aggregate, SCM, or a combination thereof, before combining with the aqueous medium.

In some embodiments, the cement product is a building material selected from the group consisting of building, driveway, foundation, kitchen slab, furniture, pavement, road, bridges, motorway, overpass, parking structure, brick, block, wall, footing for a gate, fence, or pole, and combination thereof.

In some embodiments, the cement product is a formed building material.

In one aspect, there is provided a system for making a cement product from the composition of any one of the foregoing composition aspects and/or foregoing embodiments, comprising: (a) an input for the composition of any one of the foregoing composition aspects and/or foregoing embodiments; (b) an input for an aqueous medium; and (c) a reactor connected to the inputs of step (a) and step (b) configured to mix the composition of any one of the foregoing composition aspects and/or foregoing embodiments with the aqueous medium under one or more suitable conditions to make a cement product. In some embodiments, the one or more suitable conditions are selected from the group consisting of temperature, pressure, time period for setting, a ratio of the aqueous medium to the composition, and combination thereof. In some embodiments, the system further comprises a filtration element to filter the composition after the mixing step (c).

In some embodiments, the system further comprises a drying step to dry the filtered composition to make the cement product.

In one aspect, there is provided a self-cementing composition, comprising a carbonate, bicarbonate, or mixture thereof and one or more elements selected from the group consisting of barium, cobalt, copper, lanthanum, mercury, arsenic, cadmium, lead, nickel, scandium, titanium, zinc, zirconium, molybdenum, and selenium, wherein the self-cementing composition is in saltwater which composition upon rinsing with water; setting; and hardening has a compressive strength of at least 14 MPa.

In some embodiments, the composition is oven dried at 40° C.-60° C. while setting.

In some embodiments, the composition is cured at 60° C.-80° C. in humid atmosphere after drying.

In some embodiments, the composition is dewatered before rinsing with water.

In some embodiments, the composition has a compressive strength in a range of 14-35 MPa.

In some embodiments, the composition has a δ¹³C of between −5‰ to 25‰.

In some embodiments, the composition comprises vaterite in a range of 1% w/w to 99% w/w. In some embodiments, the vaterite is in a range of 40% w/w to 85% w/w.

In some embodiments, the composition further comprises a polymorph selected from the group consisting of amorphous calcium carbonate, aragonite, calcite, ikaite, a precursor phase of vaterite, a precursor phase of aragonite, an intermediary phase that is less stable than calcite, polymorphic forms in between these polymorphs, and combination thereof. In some embodiments, the vaterite and the polymorph are in a vaterite:polymorph ratio of 1:1 to 20:1.

In some embodiments, the composition further comprises one or more of polymorph selected from the group consisting of aragonite, calcite, and ikaite, wherein aragonite, calcite and/or ikaite are present in at least 1% w/w.

In some embodiments, the one or more elements are selected from the group consisting of lanthanum, mercury, arsenic, lead, and selenium. In some embodiments, each of the one or more elements is present in the composition in an amount of between 0.1-1000 ppm.

In some embodiments, the one or more elements are arsenic, mercury, or selenium. In some embodiments, each of the one or more elements are present in the composition in an amount of between 0.5-100 ppm.

In some embodiments, the composition is a particulate composition with an average particle size of 0.1-100 microns. In some embodiments, the composition is a particulate composition with an average particle size of 1-50 microns.

In some embodiments, the composition has a bulk density of between 75 lb/ft³-170 lb/ft³.

In some embodiments, the composition has an average surface area of from 0.5 m²/gm-50 m²/gm.

In some embodiments, the saltwater is sea water.

In some embodiments, the composition is synthetic. In some embodiments, the composition is non-naturally occurring.

In one aspect, there is provided a formed building material, comprising: the composition of any one of the foregoing aspects and/or embodiments or the set and hardened form thereof.

In one aspect, there is provided an aggregate, comprising: the composition of any one of the foregoing composition aspects and/or embodiments or the set and hardened form thereof.

In one aspect, there is provided a package, comprising: the composition of any one of the foregoing composition aspects and/or embodiments and a packaging material adapted to contain the composition.

In one aspect, there is provided a method for making the composition of any one of the foregoing composition aspects and/or embodiments, comprising: (a) contacting a source of cations with a carbonate brine to give a reaction product comprising carbonic acid, bicarbonate, carbonate, or mixture thereof; and (b) subjecting the reaction product of step (a) to a condition to make the composition of any one of the foregoing composition aspects and/or embodiments.

In some embodiments, the condition comprises filtering the reaction product to give a precipitate and washing the precipitate with fresh water. In some embodiments, the source of cations is sea water, brine, or combination thereof. In some embodiments, the condition comprises one or more of precipitation and dewatering of a precipitate to make the composition. In some embodiments, the condition comprises contacting the source of cations with a proton removing agent. In some embodiments, the proton removing is selected from the group consisting of oxide, hydroxide, carbonate, coal ash, and naturally occurring mineral. In some embodiments, the condition comprises subjecting the source of cations to electrochemical condition.

In one aspect, there is provided a composition made by the method of any one of the foregoing method aspects and/or embodiments.

In one aspect, there is provided a system for making the composition of any one of the foregoing composition aspects and/or embodiments, comprising: (a) an input for a source of cations; (b) an input for a carbonate brine; and (c) a reactor connected to the inputs of step (a) and step (b) that is configured to make the composition of any one of the foregoing composition aspects and/or embodiments.

In one aspect, there is provided a method for making a cement product from the composition of any one of the foregoing composition aspects and/or embodiments, comprising: (a) combining the composition of any one of the foregoing composition aspects and/or embodiments with an water under one or more suitable conditions; and (b) allowing the composition to set and harden into a cement product.

In some embodiments, the one or more suitable conditions are selected from the group consisting of dewatering, rinsing with water, setting, drying, curing, and combination thereof.

In some embodiments, the method further comprises transporting the product to a subterranean location.

In one aspect, there is provided a system for making a cement product from the composition of any one of the foregoing composition aspects and/or embodiments, comprising: (a) an input for the composition of any one of the foregoing composition aspects and/or embodiments; (b) an input for water; and (c) a reactor connected to the inputs of step (a) and step (b) configured to mix the composition of any one of the foregoing composition aspects and/or embodiments with the water under one or more suitable conditions to make a cement product.

In one aspect, there is provided a method of assessing a region for a subterranean carbonate brine comprising: creating a representation of the region comprising a combination of a physical data wherein the physical data comprises data indicative of a subterranean carbonate brine and data indicative of sources of cations, and determining a proximity of the subterranean carbonate brine to the source of cations, thereby assessing the region for the subterranean carbonate brine.

In some embodiments, the physical data comprises geographical, lithographical, hydrological, seismic data or a combination thereof. In some embodiments, the representation comprises a map. In some embodiments, the source of cations is a hard brine. In some embodiments, the representation of the region further comprises data indicative of the legal status of water rights, mineral rights or a combination thereof of the region. In some embodiments, the physical data about the region comprises lithographic data indicating the presence and/or abundance of carbonate. In some embodiments, the physical data about the region comprises seismic data indicating the presence and/or abundance of a permeable rock. In some embodiments, the physical data about the region comprises hydrological data indicating the presence of a subterranean brine. In some embodiments, the representation of the region comprises data indicating the proximity of the subterranean brine to the source of cations. In some embodiments, the proximity of the source of cations to the subterranean brine is less than 5 surface miles.

In some embodiments, the method further comprises generating other physical data about the region. In some embodiments, generating the other physical data comprises drilling a well. In some embodiments, the other data may be acquired by seismic, infrared, geophysical tomographic, magnetic, robotic, aerial, ground mapping methods or any combination thereof.

In one aspect, there is provide a method for evaluating that a subterranean carbonate brine in a region is suitable for reaction with a source of cations, the method comprising: determining a one or more properties of the subterranean carbonate brine, and evaluating that the subterranean carbonate brine in the region is suitable for reaction with the source of cations based on the determination. In some embodiments, the method further comprises pursuing beneficial use rights to the subterranean carbonate brine in the region. In some embodiments, the reaction results in a reaction product comprising carbonic acid, bicarbonate, carbonate, or mixture thereof. In some embodiments, the evaluating comprises evaluating a probability by programming a computer. In some embodiments, the determining step comprises determining a proximity of the subterranean carbonate brine to the source of cations. In some embodiments, the one or more properties are determined remotely. In some embodiments, the determining the properties comprises determining a concentration of divalent cations in the subterranean carbonate brine. In some embodiments, the determining the properties comprises determining an alkalinity of the subterranean carbonate brine. In some embodiments, the determining the properties comprises determining a temperature of the subterranean carbonate brine.

In some embodiments, the determining the properties comprises determining a source of alkalinity of the subterranean carbonate brine. In some embodiments, the determining of the source of the alkalinity of the brine further comprises quantifying borate, carbonate and/or hydroxyl components of the brine. In some embodiments, the determining the properties comprises determining an ionic strength of the subterranean carbonate brine.

In some embodiments, the method further comprises modifying a composition of the subterranean carbonate brine based on the concentration of divalent cations, alkalinity, temperature, and/or ionic strength.

In some embodiments, modifying the subterranean carbonate brine composition occurs above the ground. In some embodiments, modifying the subterranean carbonate brine composition occurs below the ground. In some embodiments, modifying the subterranean carbonate brine composition comprises raising the pH of the brine. In some embodiments, modifying the subterranean carbonate brine composition comprises diluting the brine with water. In some embodiments, modifying the subterranean carbonate brine composition comprises concentrating the brine.

In another aspect, there is provided a system comprising: (a) an input for a source of one or more carbonate brines; (b) an input for a source of cations; (c) a detector configured for determining a composition of the one or more carbonate brines; and (d) a reactor connected to the inputs of step (a) and step (b) configured to give a reaction product comprising carbonic acid, bicarbonate, carbonate, or mixture thereof, wherein the detector is operably connected to the input and/or the reactor. In some embodiments, the reactor is configured to dilute the one or more carbonate brines with water. In some embodiments, the reactor is configured to concentrate the one or more carbonate brines by removing water.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a flow diagram of a precipitation process according to an embodiment of the invention.

FIG. 2 illustrates a schematic of a system according to some embodiments of the invention.

FIG. 3 illustrates a Gibbs free energy diagram of the transition from vaterite to aragonite and aragonite to calcite. Values reported from (Wolf et al. Journal of Thermal Analysis and Calorimetry (2000) 60, 463-472).

FIG. 4 illustrates a schematic of a system according to some embodiments of the invention.

FIG. 5 illustrates the calorimetry data of the precipitate obtained from the carbonate brine.

FIG. 6 illustrates a drop in the calcium concentration 18 min. after the precipitate was formed from the carbonate brine.

FIGS. 7A, 7B, 7C, and 7D illustrate the stability of vaterite composition when made from tap water+CaCl₂ dihydrate+0.25 M Na₂CO₃ (Ca:base stoichiometric ratio of 1:1).

FIG. 8 illustrates a flow diagram of the sesquicarbonate process and the monohydrate process.

FIG. 9 illustrates a particle size of the precipitate obtained from Trona brine mixed with calcium chloride.

FIG. 10 illustrates a cumulative heat of the precipitate obtained from Trona brine mixed with calcium chloride.

FIG. 11 illustrates a heat evolution graph of the precipitate obtained from Trona brine mixed with calcium chloride.

FIGS. 12A and 12B illustrate SEM images of the precipitate obtained from Trona brine mixed with calcium chloride.

FIG. 13 illustrates a particle size comparison of the samples obtained from Trona brine mixed with calcium chloride.

FIG. 14 illustrates a comparison of the heat of evolution of the 20% samples mixed with 80% OPC.

### DETAILED DESCRIPTION

This invention provides compositions, methods, and systems of compositions including a carbonate, bicarbonate, or mixture thereof; methods and systems for making and using the compositions; and the materials formed from such compositions, such as aggregates and pre-formed building materials.

The compositions and the methods of the invention include the use of synthetic brines containing the carbonates or subterranean carbonate brines to make the compositions of the invention. The carbonate brines upon combination with cations, such as, calcium and/or magnesium, result in the compositions of the invention including carbonate, bicarbonate, or mixture thereof. In some embodiments, the compositions include a reaction product including carbonate, bicarbonate, or mixture thereof and one or more elements including, but not limited to, barium, cobalt, copper, lanthanum, mercury, arsenic, cadmium, lead, nickel, scandium, titanium, zinc, zirconium, molybdenum, and selenium. The carbonates may be calcium carbonates present in various polymorphic forms of calcium carbonate, such as, but are not limited to, vaterite (CaCO₃) alone or vaterite in combination with amorphous calcium carbonate (CaCO₃.nH₂O), aragonite (CaCO₃), calcite (CaCO₃), ikaite (CaCO₃.6H₂O), a precursor phase of vaterite, a precursor phase of aragonite, an intermediary phase that is less stable than calcite, polymorphic forms in between these polymorphs, or combination thereof.

In some embodiments, the compositions are cementitious compositions that may be hydraulic cement, supplementary cementitious material, or self-cementing compositions. In some embodiments, the compositions may be used for non-cementitious applications such as filler for paper, paint, lubricants, food products, medicines and other ingestibles, cleaning applications (personal, house hold, or industrial), paint removal, etc.

Also provided herein are the formed building materials and aggregates that are made from these compositions. Further provided herein are methods of making and using the compositions of the invention which may be hydraulic cements, supplementary cementitious material, or self-cementing compositions. Further provided herein are methods of making cement products, such as, aggregates and pre-formed building materials from the compositions. The compositions find use in a variety of applications, including use in a variety of building materials and building applications.

Typically, Ordinary Portland Cement (OPC) is made primarily from limestone, certain clay minerals, and gypsum, in a high temperature process that drives off carbon dioxide and chemically combines the primary ingredients into new compounds. The energy required to fire the mixture consumes about 4 GJ per ton of cement produced. Because the carbon dioxide is generated by both the cement production process itself, as well as by energy plants that generate power to run the production process, cement production may be a leading source of current carbon dioxide atmospheric emissions. In addition to the pollution problems associated with Portland cement production, the structures produced with Portland cements may have a repair and maintenance expense because of the instability of the cured product produced from Portland cement.

The cementitious compositions, provided herein, may reduce the carbon foot print by using the synthetic brines containing the carbonates or subterranean carbonate brines to make the compositions of the invention. In some embodiments, the production of such compositions may not require an energy intensive process and thereby reduce the carbon dioxide atmospheric emissions. In some embodiments, the production of cement products from the compositions of the invention may not emit as much carbon dioxide as is emitted by Portland cement and thereby reduce the overall carbon dioxide atmospheric emissions. In still further embodiments, the cement compositions of the invention may partially or completely replace the carbon emitting cements, such as OPC thereby reducing the carbon dioxide atmospheric emissions and the carbon foot print. The compositions of the invention may be mixed with OPC to give the cement material with equal or higher strength, thereby reducing the amount of OPC to make cement.

The cementitious compositions provided herein also show surprising and unexpected properties as the products obtained from the compositions (either alone or in combination with OPC) have high compressive strength resulting in products with high durability and less maintenance costs. The cementitious compositions of the invention may also be optimized to result in materials with desired compressive strengths and thereby, further increasing the efficiency of the process and reducing the cost of production. For example, the compressive strength required for a roof-tile may not be as high as the compressive strength required for pillars. The cementitious compositions of the invention and the process to make the cement products from the compositions of the invention may be optimized to result in cement products with desired compressive strength.

Additionally, the methods of the invention may be optimized to give compositions that differ in their reactivity with water or with other cement. For example, the compositions of the invention may either be formed as hydraulic cement compositions or as a supplementary cementitious material or as a self-cementing material depending on their reactivity with water. In some embodiments, the SCM compositions of the invention may be mixed with Portland cement to result in the cement with an equal or higher compressive strength than the Portland cement itself or the Portland cement in combination with other SCM known in the art.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a,” “an,” and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### I. Compositions

Aspects of the invention include cementitious compositions including hydraulic cement or a supplementary cemetitious material (SCM) or a self-cementing material where the reaction product and/or the composition includes a carbonate, bicarbonate, or mixture thereof and one or more elements including, but not limited to, barium, cobalt, copper, lanthanum, mercury, arsenic, cadmium, lead, nickel, scandium, titanium, zinc, zirconium, molybdenum, and selenium. As used herein, “cementitious” includes a conventional meaning of cement known in the art. For example, the cementitious composition is a composition that sets and hardens independently or can be used as a supplementary cementitious material (SCM) that can bind with other cement materials, such as, Portland cement, aggregates, other supplementary cementitious materials, or combination thereof.

The carbonate, bicarbonate, or a mixture thereof, present in the composition of the invention, may be one or more of calcium carbonate, calcium bicarbonate, magnesium carbonate, magnesium bicarbonate, calcium magnesium carbonate, or mixture thereof. In some embodiments, carbonate, bicarbonate, or a mixture thereof present in the composition of the invention is a calcium carbonate, calcium bicarbonate, or mixture thereof. In some embodiments, the carbonate, bicarbonate, or mixture thereof includes one or more polymorphs including, but are not limited to, amorphous calcium carbonate (ACC), vaterite, aragonite, calcite, ikaite, a precursor phase of vaterite, a precursor phase of aragonite, an intermediary phase that is less stable than calcite, polymorphic forms in between these polymorphs, and combination thereof. The ACC, precursor of vaterite, vaterite, precursor of aragonite, and aragonite can be utilized as a reactive metastable calcium carbonate forms for reaction purposes and stabilization reactions, such as cementing. The metastable forms such as vaterite and precursor to vaterite and stable carbonate forms, such as, calcite, may have varying degrees of solubility so that they may dissolve when hydrated in aqueous solutions and reprecipitate stable carbonate minerals, such as calcite and/or aragonite.

The compositions of the invention including metastable forms, such as vaterite, surprisingly and unexpectedly are stable compositions in a dry powdered form or in a slurry containing saltwater. The metastable forms in the compositions of the invention may not completely convert to the stable forms for cementation until contacted with fresh water.

Vaterite may be present in monodisperse or agglomerated form, and may be in spherical, ellipsoidal, plate like shape, scalenohedral, clusters, pillow shaped, rhombohedral, star shaped, or hexagonal system. Vaterite typically has a hexagonal crystal structure and forms polycrystalline spherical particles upon growth. The precursor form of vaterite comprises nanoclusters of vaterite and the precursor form of aragonite comprises sub-micron to nanoclusters of aragonite needles. Aragonite, if present in the composition, may be needle shaped, columnar, or crystals of the rhombic system. Calcite, if present, may be cubic, spindle, or crystals of hexagonal system. An intermediary phase that is less stable than calcite may be a phase that is between vaterite and calcite, a phase between precursor of vaterite and calcite, a phase between aragonite and calcite, and/or a phase between precursor of aragonite and calcite.

In some embodiments, the compositions of the invention are synthetic compositions and are not naturally occurring. In some embodiments, the composition of the invention is in a powder form. In some embodiments, the composition of the invention is in a dry powder form. In some embodiments, the composition of the invention is disordered or is not in an ordered array or is in the powdered form. In still some embodiments, the composition of the invention is in a partially or wholly hydrated form. In still some embodiments, the composition of the invention is in saltwater or fresh water. In still some embodiments, the composition of the invention is in water containing sodium chloride. In still some embodiments, the composition of the invention is in water containing alkaline earth metal ions, such as, but are not limited to, calcium, magnesium, etc.

The compositions provided herein show unexpected properties, such as, high compressive strength, high durability, and/or less maintenance costs. In some embodiments, the compositions reduce carbon footprint and provide cleaner environment. In some embodiments, the compositions upon combination with water, setting, and hardening, have a compressive strength of at least 14 MPa (megapascal) or in some embodiments, between 14-80 MPa or 14-35 MPa. In some embodiments, the compositions provided herein are formed from carbonate brines, such as, subterranean carbonate brines. In some embodiments, the compositions provided herein have a carbon isotopic fractionation value (δ¹³C) of greater than −5‰. In some embodiments, the compositions of the invention are non-medical or are not used for medical procedures. In some embodiments, the compositions of the invention are synthetic compositions and are not naturally occurring.

In a first aspect, there is provided a cementitious composition including a carbonate, bicarbonate, or mixture thereof and one or more elements including, but not limited to, barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa. In a second aspect, there is provided a cementitious composition including a carbonate, bicarbonate, or mixture thereof and one or more elements including, but not limited to, barium, cobalt, copper, lanthanum, mercury, arsenic, cadmium, lead, nickel, scandium, titanium, zinc, zirconium, molybdenum, and selenium, wherein the composition has a carbon isotopic fractionation value (δ¹³C) of greater than −5‰. In a third aspect, there is provided a cementitious composition including at least 47% w/w vaterite and one or more elements including, but not limited to, barium, cobalt, copper, lanthanum, mercury, arsenic, cadmium, lead, nickel, scandium, titanium, zinc, zirconium, molybdenum, and selenium. In a fourth aspect, there is provided a cementitious composition including at least 10% w/w vaterite, at least 1% w/w amorphous calcium carbonate (ACC), and one or more elements including, but not limited to, barium, cobalt, copper, lanthanum, mercury, arsenic, cadmium, lead, nickel, scandium, titanium, zinc, zirconium, molybdenum, and selenium.

In some embodiments, the carbonate brines used to make the reaction product or the composition of the invention include one or more elements, including, but not limited to, barium (Ba), cobalt (Co), copper (Cu), lanthanum (La), mercury (Hg), arsenic (As), cadmium (Cd), lead (Pb), nickel (Ni), scandium (Sc), titanium (Ti), zinc (Zn), zirconium (Zr), molybdenum (Mo), and selenium (Se). In some embodiments, the one or more elements are present in the carbonate brines and are carried over from the carbonate brines to the compositions of the invention. In some embodiments, the one or more elements provided herein serve as a marker to identify or differentiate the compositions of the invention derived from carbonate brines. In some embodiments, the composition of any of the above recited four aspects includes one or more elements including, but not limited to, lanthanum, mercury, arsenic, lead, and selenium. In some embodiments, the composition of any of the above recited four aspects includes one or more elements including, but not limited to, arsenic, mercury, or selenium. In some embodiments, the composition of any of the above recited four aspects includes any one or more combinations of the elements provided in Table I below.

TABLE I

| composition | Hg | As | Pb | La | Ba | Co | Cd | Cu | Ni | Sc | Ti | Zn | Zr | Mo | Se |
|---|---|---|---|---|---|---|---|---|---|---|---|---|---|---|---|
| 1 | X | | | | | | | | | | | | | | |
| 2 | X | X | | | | | | | | | | | | | |
| 3 | X | X | X | | | | | | | | | | | | |
| 4 | X | X | X | X | | | | | | | | | | | |
| 5 | X | X | X | X | X | | | | | | | | | | |
| 6 | X | X | X | X | X | X | | | | | | | | | |
| 7 | X | X | X | X | X | X | X | | | | | | | | |
| 8 | X | X | X | X | X | X | X | X | | | | | | | |
| 9 | X | X | X | X | X | X | X | X | X | | | | | | |
| 10 | X | X | X | X | X | X | X | X | X | | | | | | |
| 11 | X | X | X | X | X | X | X | X | X | X | | | | | |
| 12 | X | X | X | X | X | X | X | X | X | X | X | | | | |
| 13 | X | X | X | X | X | X | X | X | X | X | X | X | | | |
| 14 | X | X | X | X | X | X | X | X | X | X | X | X | X | | |
| 15 | X | X | X | X | X | X | X | X | X | X | X | X | X | X | |
| 16 | X | X | X | X | X | X | X | X | X | X | X | X | X | X | X |
| 17 | | X | | | | | | | | | | | | | |
| 18 | | X | X | | | | | | | | | | | | |
| 19 | | X | X | X | | | | | | | | | | | |
| 20 | | X | X | X | X | | | | | | | | | | |
| 21 | | X | X | X | X | X | | | | | | | | | |
| 22 | | X | X | X | X | X | X | | | | | | | | |
| 23 | | X | X | X | X | X | X | X | | | | | | | |
| 24 | | X | X | X | X | X | X | X | X | | | | | | |
| 25 | | X | X | X | X | X | X | X | X | | | | | | |
| 26 | | X | X | X | X | X | X | X | X | X | | | | | |
| 27 | | X | X | X | X | X | X | X | X | X | X | | | | |
| 28 | | X | X | X | X | X | X | X | X | X | X | X | | | |
| 29 | | X | X | X | X | X | X | X | X | X | X | X | X | | |
| 30 | | X | X | X | X | X | X | X | X | X | X | X | X | X | |
| 31 | | X | X | X | X | X | X | X | X | X | X | X | X | X | X |
| 32 | | | X | | | | | | | | | | | | |
| 33 | X | | X | | | | | | | | | | | | |
| 34 | X | | X | X | | | | | | | | | | | |
| 35 | X | | X | X | X | | | | | | | | | | |
| 36 | X | | X | X | X | X | | | | | | | | | |
| 37 | X | | X | X | X | X | X | | | | | | | | |
| 38 | X | | X | X | X | X | X | X | | | | | | | |
| 39 | X | | X | X | X | X | X | X | X | | | | | | |
| 40 | X | | X | X | X | X | X | X | X | | | | | | |
| 41 | X | | X | X | X | X | X | X | X | X | | | | | |
| 42 | X | | X | X | X | X | X | X | X | X | X | | | | |
| 43 | X | | X | X | X | X | X | X | X | X | X | X | | | |
| 44 | X | | X | X | X | X | X | X | X | X | X | X | X | | |
| 45 | X | | X | X | X | X | X | X | X | X | X | X | X | X | |
| 46 | X | | X | X | X | X | X | X | X | X | X | X | X | X | X |
| 47 | | | | X | | | | | | | | | | | |
| 48 | X | | | X | | | | | | | | | | | |
| 49 | X | X | | X | | | | | | | | | | | |
| 50 | X | | X | X | | | | | | | | | | | |
| 51 | X | X | | X | X | | | | | | | | | | |
| 52 | X | X | | X | X | X | | | | | | | | | |
| 53 | X | X | | X | X | X | X | | | | | | | | |
| 54 | X | X | | X | X | X | X | X | | | | | | | |
| 55 | X | X | | X | X | X | X | X | X | | | | | | |
| 56 | X | X | | X | X | X | X | X | X | | | | | | |
| 57 | X | X | | X | X | X | X | X | X | X | | | | | |
| 58 | X | X | | X | X | X | X | X | X | X | X | | | | |
| 59 | X | X | | X | X | X | X | X | X | X | X | X | | | |
| 60 | X | X | | X | X | X | X | X | X | X | X | X | X | | |
| 61 | X | X | | X | X | X | X | X | X | X | X | X | X | X | |
| 62 | | | | | X | | | | | | | | | | |
| 63 | X | | | | X | | | | | | | | | | |
| 64 | X | X | | | X | | | | | | | | | | |
| 65 | X | X | X | | X | | | | | | | | | | |
| 66 | X | | X | | X | | | | | | | | | | |
| 67 | X | X | | X | X | | | | | | | | | | |
| 68 | X | X | | X | X | | | | | | | | | | |
| 69 | X | X | X | | X | | | | | | | | | | |
| 70 | X | X | X | | X | | | | | | | | | | |
| 71 | X | X | X | | X | X | | | | | | | | | |
| 72 | X | X | X | | X | X | X | | | | | | | | |
| 73 | X | X | X | | X | X | X | X | | | | | | | |
| 74 | X | X | X | | X | X | X | X | X | | | | | | |
| 75 | X | X | X | | X | X | X | X | X | | | | | | |
| 76 | X | X | X | | X | X | X | X | X | X | | | | | |
| 77 | X | X | X | | X | X | X | X | X | X | X | | | | |
| 78 | X | X | X | | X | X | X | X | X | X | X | X | | | |
| 79 | X | X | X | | X | X | X | X | X | X | X | X | X | | |
| 80 | X | X | X | | X | X | X | X | X | X | X | X | X | X | |
| 81 | X | X | X | | X | X | X | X | X | X | X | X | X | X | X |
| 82 | | | | | | X | | | | | | | | | |
| 83 | X | | | | | X | | | | | | | | | |
| 84 | X | X | | | | X | | | | | | | | | |
| 85 | X | X | X | | | X | | | | | | | | | |
| 86 | X | X | X | X | | X | | | | | | | | | |
| 87 | X | | X | | | X | | | | | | | | | |
| 88 | X | X | | X | | X | | | | | | | | | |
| 89 | X | X | | X | X | X | | | | | | | | | |
| 90 | X | X | X | X | | X | X | | | | | | | | |
| 91 | X | X | X | X | | X | X | X | | | | | | | |
| 92 | X | X | X | X | | X | X | X | X | | | | | | |
| 93 | X | X | X | X | | X | X | X | X | | | | | | |
| 94 | X | X | X | X | | X | X | X | X | X | | | | | |
| 95 | X | X | X | X | | X | X | X | X | X | X | | | | |
| 96 | X | X | X | X | | X | X | X | X | X | X | X | | | |
| 97 | X | X | X | X | | X | X | X | X | X | X | X | X | | |
| 98 | X | X | X | X | | X | X | X | X | X | X | X | X | X | |
| 99 | X | X | X | X | | X | X | X | X | X | X | X | X | X | X |
| 100 | | | | | | | X | | | | | | | | |
| 101 | X | | | | | | X | | | | | | | | |
| 102 | X | X | | | | | X | | | | | | | | |
| 103 | X | X | X | | | | X | | | | | | | | |
| 104 | X | X | X | X | | | X | | | | | | | | |
| 105 | X | X | X | X | X | | X | | | | | | | | |
| 106 | X | X | X | | X | | X | | | | | | | | |
| 107 | X | X | | X | | | X | | | | | | | | |
| 108 | X | | X | | X | | X | | | | | | | | |
| 109 | X | X | X | | X | | X | | | | | | | | |
| 110 | X | X | X | | X | X | X | | | | | | | | |
| 111 | X | X | X | X | X | | X | X | | | | | | | |
| 112 | X | X | X | X | X | | X | X | X | | | | | | |
| 113 | X | X | X | X | X | | X | X | X | | | | | | |
| 114 | X | X | X | X | X | | X | X | X | X | | | | | |
| 115 | X | X | X | X | X | | X | X | X | X | X | | | | |
| 116 | X | X | X | X | X | | X | X | X | X | X | X | | | |
| 117 | X | X | X | X | X | | X | X | X | X | X | X | X | | |
| 118 | X | X | X | X | X | | X | X | X | X | X | X | X | X | |
| 119 | X | X | X | X | X | | X | X | X | X | X | X | X | X | X |
| 120 | | | | | | | | X | | | | | | | |
| 121 | X | | | | | | | X | | | | | | | |
| 122 | X | X | | | | | | X | | | | | | | |
| 123 | X | X | X | | | | | X | | | | | | | |
| 124 | X | X | X | X | | | | X | | | | | | | |
| 125 | X | X | X | X | X | | | X | | | | | | | |
| 126 | X | X | X | X | X | X | | X | | | | | | | |
| 127 | X | | X | | X | | | X | | | | | | | |
| 128 | X | X | X | | X | X | X | X | | | | | | | |
| 129 | X | | X | | X | | X | X | | | | | | | |
| 130 | X | X | X | X | X | X | | X | X | | | | | | |
| 131 | X | X | X | X | X | X | X | X | X | | | | | | |
| 132 | X | X | X | X | X | X | X | X | X | X | | | | | |
| 133 | X | X | X | X | X | X | X | X | X | X | X | | | | |
| 134 | X | X | X | X | X | X | X | X | X | X | X | X | | | |
| 135 | X | X | X | X | X | X | X | X | X | X | X | X | X | | |
| 136 | X | X | X | X | X | X | X | X | X | X | X | X | X | X | |
| 137 | X | X | X | X | X | X | X | X | X | X | X | X | X | X | X |
| 138 | | X | | X | | X | | X | | X | | X | | X | |
| 139 | | | | | | | | | X | | | | | | |
| 140 | X | | | | | | | | X | | | | | | |
| 141 | X | X | | | | | | | X | | | | | | |
| 142 | X | X | X | | | | | | X | | | | | | |
| 143 | X | X | X | X | | | | | X | | | | | | |
| 144 | X | X | X | X | X | | | | X | | | | | | |
| 145 | X | X | X | X | X | X | | | X | | | | | | |
| 146 | X | X | X | X | X | X | X | | X | | | | | | |
| 147 | X | X | X | X | X | X | X | | X | | | | | | |
| 148 | X | X | X | X | X | X | X | | X | X | | | | | |
| 149 | X | X | X | X | X | X | X | | X | X | X | | | | |
| 150 | X | X | X | X | X | X | X | | X | X | X | X | | | |
| 151 | X | X | X | X | X | X | X | | X | X | X | X | X | | |
| 152 | X | X | X | X | X | X | X | | X | X | X | X | X | X | |
| 153 | X | X | X | X | X | X | X | | X | X | X | X | X | X | X |
| 154 | | | | | | | | | | | | | | | |
| 155 | X | | | | | | | | | | | | | | |
| 156 | X | X | | | | | | | | | | | | | |
| 157 | X | X | X | | | | | | | | | | | | |
| 158 | X | X | X | X | | | | | | | | | | | |
| 159 | X | X | X | X | X | | | | | | | | | | |
| 160 | X | X | X | X | X | X | | | | | | | | | |
| 161 | X | X | X | X | X | X | X | | | | | | | | |
| 162 | X | X | X | X | X | X | X | X | | | | | | | |
| 163 | X | X | X | X | X | X | X | X | | X | | | | | |
| 164 | X | X | X | X | X | X | X | X | | X | X | | | | |
| 165 | X | X | X | X | X | X | X | X | | X | X | X | | | |
| 166 | X | X | X | X | X | X | X | X | | X | X | X | X | | |
| 167 | X | X | X | X | X | X | X | X | | X | X | X | X | X | |
| 168 | X | X | X | X | X | X | X | X | | X | X | X | X | X | X |
| 169 | | | | | | | | | | X | | | | | |
| 170 | X | | | | | | | | | X | | | | | |
| 171 | X | X | | | | | | | | X | | | | | |
| 172 | X | X | X | | | | | | | X | | | | | |
| 173 | X | X | X | X | | | | | | X | | | | | |
| 174 | X | X | X | X | X | | | | | X | | | | | |
| 175 | X | X | X | X | X | X | | | | X | | | | | |
| 176 | X | X | X | X | X | X | X | | | X | | | | | |
| 177 | X | X | X | X | X | X | X | X | | X | | | | | |
| 178 | X | X | X | X | X | X | X | X | X | X | | | | | |
| 179 | X | X | X | X | X | X | X | X | X | X | X | | | | |
| 180 | X | X | X | X | X | X | X | X | X | X | X | X | | | |
| 181 | X | X | X | X | X | X | X | X | X | X | X | X | X | | |
| 182 | X | X | X | X | X | X | X | X | X | X | X | X | X | X | |
| 183 | X | X | X | X | X | X | X | X | X | X | X | X | X | X | X |
| 184 | | | | | | | | | | | X | | | | |
| 185 | X | | | | | | | | | | X | | | | |
| 186 | X | X | | | | | | | | | X | | | | |
| 187 | X | X | X | | | | | | | | X | | | | |
| 188 | X | X | X | X | | | | | | | X | | | | |
| 189 | X | X | X | X | X | | | | | | X | | | | |
| 190 | X | X | X | X | X | X | | | | | X | | | | |
| 191 | X | X | X | X | X | X | X | | | | X | | | | |
| 192 | X | X | X | X | X | X | X | X | | | X | | | | |
| 193 | X | X | X | X | X | X | X | X | X | | X | | | | |
| 194 | X | X | X | X | X | X | X | X | X | | X | | | | |
| 195 | X | X | X | X | X | X | X | X | X | | X | X | | | |
| 196 | X | X | X | X | X | X | X | X | X | | X | X | X | | |
| 197 | X | X | X | X | X | X | X | X | X | | X | X | X | X | |
| 198 | X | X | X | X | X | X | X | X | X | | X | X | X | X | X |
| 199 | | | | | | | | | | | | X | | | |
| 200 | X | | | | | | | | | | | X | | | |
| 201 | X | X | | | | | | | | | | X | | | |
| 202 | X | X | X | | | | | | | | | X | | | |
| 203 | X | X | X | X | | | | | | | | X | | | |
| 204 | X | X | X | X | X | | | | | | | X | | | |
| 205 | X | X | X | X | X | X | | | | | | X | | | |
| 206 | X | X | X | X | X | X | X | | | | | X | | | |
| 207 | X | X | X | X | X | X | X | X | | | | X | | | |
| 208 | X | X | X | X | X | X | X | X | X | | | X | | | |
| 209 | X | X | X | X | X | X | X | X | X | | | X | | | |
| 210 | X | X | X | X | X | X | X | X | X | X | | X | | | |
| 211 | X | X | X | X | X | X | X | X | X | X | | X | X | | |
| 212 | X | X | X | X | X | X | X | X | X | X | | X | X | X | |
| 213 | X | X | X | X | X | X | X | X | X | X | | X | X | X | X |
| 214 | | | | | | | | | | | | | X | | |
| 215 | X | | | | | | | | | | | | X | | |
| 216 | X | X | | | | | | | | | | | X | | |
| 217 | X | X | X | | | | | | | | | | X | | |
| 218 | X | X | X | X | | | | | | | | | X | | |
| 219 | X | X | X | X | X | | | | | | | | X | | |
| 220 | X | X | X | X | X | X | | | | | | | X | | |
| 221 | X | X | X | X | X | X | X | | | | | | X | | |
| 222 | X | X | X | X | X | X | X | X | | | | | X | | |
| 223 | X | X | X | X | X | X | X | X | X | | | | X | | |
| 224 | X | X | X | X | X | X | X | X | X | | | | X | | |
| 225 | X | X | X | X | X | X | X | X | X | X | | | X | | |
| 226 | X | X | X | X | X | X | X | X | X | X | X | | X | | |
| 227 | X | X | X | X | X | X | X | X | X | X | X | | X | X | |
| 228 | X | X | X | X | X | X | X | X | X | X | X | | X | X | X |
| 229 | | | | | | | | | | | | | | X | |
| 230 | X | | | | | | | | | | | | | X | |
| 231 | X | X | | | | | | | | | | | | X | |
| 232 | X | X | X | | | | | | | | | | | X | |
| 233 | X | X | X | X | | | | | | | | | | X | |
| 234 | X | X | X | X | X | | | | | | | | | X | |
| 235 | X | X | X | X | X | X | | | | | | | | X | |
| 236 | X | X | X | X | X | X | X | | | | | | | X | |
| 237 | X | X | X | X | X | X | X | X | | | | | | X | |
| 238 | X | X | X | X | X | X | X | X | X | | | | | X | |
| 239 | X | X | X | X | X | X | X | X | X | | | | | X | |
| 240 | X | X | X | X | X | X | X | X | X | X | | | | X | |
| 241 | X | X | X | X | X | X | X | X | X | X | X | | | X | |
| 242 | X | X | X | X | X | X | X | X | X | X | X | X | | X | |
| 243 | X | X | X | X | X | X | X | X | X | X | X | X | | X | X |
| 244 | | | | | | | | | | | | | | | X |
| 245 | X | | | | | | | | | | | | | | X |
| 246 | X | X | | | | | | | | | | | | | X |
| 247 | X | X | X | | | | | | | | | | | | X |
| 248 | X | X | X | X | | | | | | | | | | | X |
| 249 | X | X | X | X | X | | | | | | | | | | X |
| 250 | X | X | X | X | X | X | | | | | | | | | X |
| 251 | X | X | X | X | X | X | X | | | | | | | | X |
| 252 | X | X | X | X | X | X | X | X | | | | | | | X |
| 253 | X | X | X | X | X | X | X | X | X | | | | | | X |
| 254 | X | X | X | X | X | X | X | X | X | | | | | | X |
| 255 | X | X | X | X | X | X | X | X | X | X | | | | | X |
| 256 | X | X | X | X | X | X | X | X | X | X | X | | | | X |
| 257 | X | X | X | X | X | X | X | X | X | X | X | X | | | X |
| 258 | X | X | X | X | X | X | X | X | X | X | X | X | X | | X |
| 259 | X | | X | | X | | X | X | | | X | | | X | X |
| 260 | X | | X | | X | | X | | X | X | | X | | X | X |

It is to be understood that Table I provides illustrative examples of the combination of the elements present in the invention and that other combinations of the elements are well within the scope of the invention. The elements, such as, but not limited to, bromide, boron, tungsten, potassium, sodium, strontium, aluminium, phosphorus, sulfur, lithium, etc. may also be present in the composition of the invention. In some embodiments, the elements such as, strontium, aluminium, sulfur, lithium, antimony, barium, beryllium, boron, chromium, selenium, silver, thallium, tungsten, vanadium, zinc, phosphorus, sulfide, bromide, chloride, and nitrogen as nitrate, or nitrite are present in less than 0.001 ppm, or less than 0.1 ppm, or less than 1 ppm; or less than 5 ppm; or less than 50 ppm; or less than 100 ppm; or less than 500 ppm; or less than 1000 ppm; or between 1 to 1000 ppm; or between 1 to 500 ppm; or between 1 to 200 ppm; or between 1 to 100 ppm; or between 1 to 150 ppm; or between 100 to 200 ppm; or between 1 to 50 ppm; or between 1 to 10 ppm; or between 1 to 5 ppm. In some embodiments, potassium and sodium may be present in less than 100,000 ppm; or less than 90,000 ppm; or less than 50,000 ppm; or less than 10,000 ppm; or less than 5,000 ppm; or less than 2000 ppm; or less than 1000 ppm; or less than 500 ppm; or between 1 to 1000 ppm. In some embodiments, strontium, silica, aluminum, iron, and lithium are not present in the composition of the invention.

The elements in the compositions of the invention can be determined qualitatively by the use of techniques, such as, but not limited to, a cathodoluminescence microscope, or quantitatively by a microprobe.

Each of these one or more elements including, but not limited to, barium, cobalt, copper, lanthanum, mercury, arsenic, cadmium, lead, nickel, scandium, titanium, zinc, zirconium, molybdenum, and selenium are present in the carbonate brine and/or in the composition of the invention in less than 10,000 ppm; or less than 9,000 ppm; or less than 8,000 ppm; or less than 7,000 ppm; or less than 6,000 ppm; or less than 5,000 ppm; or less than 4,000 ppm; or less than 3,000 ppm; or less than 2,000 ppm; or less than 1,000 ppm; or less than 900 ppm; or less than 800 ppm; or less than 700 ppm; or less than 600 ppm; or less than 500 ppm; or less than 400 ppm; or less than 300 ppm; or less than 200 ppm; or less than 100 ppm; or less than 90 ppm; or less than 80 ppm; or less than 70 ppm; or less than 60 ppm; or less than 50 ppm; or less than 40 ppm; or less than 30 ppm; or less than 20 ppm; or less than 10 ppm; or less than 1 ppm; or between 0.1-10,000 ppm; or between 0.1-9,000 ppm; or between 0.1-5,000 ppm; or between 0.1-1000 ppm; or between 0.1-900 ppm; or between 0.1-500 ppm; or between 0.1-400 ppm; or between 0.1-100 ppm; or between 0.1-90 ppm; or between 0.1-50 ppm; or between 0.1-10 ppm; or between 0.1-5 ppm; or between 0.5-10,000 ppm; or between 0.5-9,000 ppm; or between 0.5-5,000 ppm; or between 0.5-1000 ppm; or between 0.5-900 ppm; or between 0.5-500 ppm; or between 0.5-400 ppm; or between 0.5-100 ppm; or between 0.5-90 ppm; or between 0.5-50 ppm; or between 0.5-10 ppm; or between 0.5-5 ppm; or between 5-1000 ppm; or between 5-500 ppm; or between 5-100 ppm; or between 5-200 ppm; or between 5-50 ppm; or between 5-10 ppm; or between 50-1000 ppm; or between 50-500 ppm; or between 100-500 ppm; or between 500-900 ppm; or between 500-1000 ppm. For example, arsenic present in the carbonate brine and/or in the composition of the invention is less than 200 ppm; or less than 150 ppm; or less than 100 ppm; or between 1 to 100 ppm; or between 1 to 200 ppm; or between 1 to 150 ppm.

In some embodiments, the cementitious composition of the invention is a hydraulic cement composition. As used herein, “hydraulic cement” includes a composition which sets and hardens after combining with water or a solution where the solvent is water, e.g., an admixture solution. After hardening, the compositions retain strength and stability even under water. As a result of the immediately starting reactions, stiffening can be observed which may increase with time. After reaching a certain level, this point in time may be referred to as the start of setting. The consecutive further consolidation may be called setting, after which the phase of hardening begins. The compressive strength of the material may then grow steadily, over a period which ranges from a few days in the case of “ultra-rapid-hardening” cements, to several months or years in the case of other cements. Setting and hardening of the product produced by combination of the composition of the invention with an aqueous liquid may or may not result from the production of hydrates that may be formed from the composition upon reaction with water, where the hydrates are essentially insoluble in water. Cements may be employed by themselves or in combination with aggregates, both coarse and fine, in which case the compositions may be referred to as concretes or mortars. Cements may also be cut and chopped to form aggregates.

In some embodiments, the cementitious composition of the invention is a supplementary cementitious material. As used herein, “supplementary cementitious material” (SCM) includes SCM as is well known in the art. For example, when SCM of the invention is mixed with Portland cement, one or more properties of that Portland cement after interaction with SCM substantially remain unchanged or are enhanced as compared to the Portland cement itself without SCM or the Portland cement mixed with conventional SCM (such as fly ash). The properties include, but are not limited to, fineness, soundness, consistency, setting time of cement, hardening time of cement, rheological behavior, hydration reaction, specific gravity, loss of ignition, and/or hardness, such as compressive strength of the cement. For example, when 20% of SCM of the invention is added to 80% of OPC (ordinary Portland cement), the one or more properties, such as, e.g., compressive strength, of OPC either remain unchanged, decrease by no more than 10%, or are enhanced. The properties of Portland cement may vary depending on the type of Portland cement. The substitution of Portland cement with the SCM of the invention reduces the CO₂ emissions without compromising the performance of the cement or the concrete as compared to regular Portland cement.

In some embodiments, maximum replacement volume of Portland cement with the SCM of the invention can be determined by carrying out various performance tests on cement and/or concrete, after mixing the SCM with OPC (for cement) and aggregate and/or sand (for concrete). Such tests can be used as parameters for testing the amount of the SCM of the invention that can be used to replace the OPC. The property, such as, fineness of the cement, for example, may affect the rate of hydration. Greater fineness may increase the surface available for hydration, causing greater early strength and more rapid generation of heat. The Wagner Turbidimeter and the Blaine air permeability test for measuring cement fineness are both required by the American Society for Testing Materials (ASTM) and the American Association for State Highway Transportation Officials (AASHTO). Soundness, which is the ability of hardened cement paste to retain its volume after setting, can be characterized by measuring the expansion of mortar bars in an autoclave. For example, the compressive strength of 2-inch (50-mm) mortar cubes after 7 days may not be less than 2,800 psi (19.3 MPa) for Type I cement.

Examples of such tests for concrete include, but are not limited to, concrete compressive strength, concrete flexural strength, concrete splitting tensile strength, concrete modulus of elasticity, concrete shrinkage, concrete resistance to alkali-silica reactivity, concrete resistance to sulfate attack, concrete resistance to freezing and thawing, concrete resistance to scaling, and concrete resistance to passage of chloride ions.

ASTM is an international standard organization that developes and publishes voluntary consensus technical standards for cementitious materials, amongst others. AASHTO is a standards setting body which publishes specifications, test protocols, and guidelines which are used in highway design and construction throughout the United States. The membership of AASHTO consists of every US State DOT (Department of Transportation), and the Federal DOT. Most Canadian Provinces as well as a few foreign nations are affiliate members of AASHTO. Some of the tests for testing the durability and sustainability of concrete and the tests specified in ASTM and AASHTO standards, are as illustrated in Table II. The tests for testing the durability and sustainability of concrete, may be accepted by individual state DOTs, such as, but not limited to, NewYork department of transportation (NYDOT), Minnesota department of transportation (MNDOT), Texas department of transportation (TxDOT), Nevada department of transportation (NDOT), Arizona department of transportation (ADOT), Florida department of transportation (FDOT), and Louisiana department of transportation (DOTD LA). In some embodiments, the cementitious compositions of the invention meet one or more test standards developed by ASTM, AASHTO, and/or DOT.

TABLE II

| | ASTM | | | | | |
|---|---|---|---|---|---|---|
| | | | | ASTM | | |
| | | | | C688 - 00 | | |
| | | | | Standard | Designation: | |
| | | | ASTM C595 - | Specifications | C 1157 - 03 | |
| | | ASTM C150 - | 08 | for | Standard | |
| | | 07 | Standard | functional | Performance | |
| | | Standard | Specification | Additions | Specification | |
| | | Specification | for Blended | for Use in | for | AASHTO |
| | | for Portland | Hydraulic | Hydraulic | Hydraulic | AASHTO |
| Tests | | Cement | Cements | Cements | Cement | Equivalent |
| Consistency | C143/ | | | X | | T119-05 |
| | C143M | | | | | |
| Time of | C403/ | | | X | | |
| Setting | C403M. | | | | | |
| Compressive | C39/ | | | X | | T22-05 |
| Strength | C39M | | | | | |
| Flexural | C78. | | | X | | T97(96) |
| Strength | | | | | | |
| Resistance to | C666 | | | X | | T161-05 |
| Freezing and | | | | | | |
| Thawing | | | | | | |
| (Durability | | | | | | |
| Factor) | | | | | | |
| Bleeding | C232 | | | X | | |
| Unit Weight | C138 | | | | | T121-05 |
| Air Content | C173 | | | | | T196-5 |
| by | | | | | | |
| Volumetric | | | | | | |
| Making and | C192 | | | | | T23 |
| Curing | | | | | | |
| Concrete | | | | | | |
| Air Content | C231 | | | | | T152-05 |
| by Pressure | | | | | | |
| Tensile | C496 | | | | | T198-02 |
| Strength | | | | | | |
| Bond | C882 | | | | | |
| Strength | | | | | | |
| using Slant | | | | | | |
| Shear | | | | | | |
| Sampling | C172 | | | | | T141 |
| Flexural | C293 | | | | | T177 |
| Strength of | | | | | | |
| Concrete | | | | | | |
| (Using | | | | | | |
| Simple Beam | | | | | | |
| With Center- | | | | | | |
| Point | | | | | | |
| Loading) | | | | | | |
| Scaling | C131 | | | | | T96 |
| Resistance of | | | | | | |
| Concrete | | | | | | |
| Surfaces | | | | | | |
| Exposed to | | | | | | |
| Deicing | | | | | | |
| Chemicals | | | | | | |
| Cement | C1084 | | | | | T178 |
| Content of | | | | | | |
| Hardenened | | | | | | |
| Portland | | | | | | |
| Cement | | | | | | |
| Concrerete | | | | | | |
| Capping | C617 | | | | | T231 |
| Cylindrical | | | | | | |
| Concrete | | | | | | |
| Specimens | | | | | | |
| Air Content | | | | | | T199 |
| of Freshly | | | | | | |
| Mixed | | | | | | |
| Concrete by | | | | | | |
| the Chase | | | | | | |
| Indicator | | | | | | |
| Compressive | C116 | | | | | T140 |
| Strength of | | | | | | |
| Concrete | | | | | | |
| using | | | | | | |
| Portions of | | | | | | |
| Beams | | | | | | |
| Broken in | | | | | | |
| Flexure | | | | | | |
| Chemical | C114. | X | X | | X | T105 |
| Analysis | | | | | | |
| Fineness by | C204. | X | X | | X | T153 |
| Air | | | | | | |
| Permeability | | | | | | |
| Fineness by | C115. | X | | | | T98 |
| Turbidimeter | | | | | | |
| Autoclave | C151. | X | X | X | X | T107-03 |
| Expansion | | | | | | |
| Fineness by | C430. | | X | | X | T192 |
| Sieving | | | | | | |
| Density of | C188 | | | | | |
| hydraulic | | | | | | |
| cement | | | | | | |
| Determining the | | | | | | |
| coefficient of | | | | | | |
| thermal | | | | | | |
| expansion of | | | | | | |
| concrete | | | | | | |
| Wick- | C940 | | | | | |
| induced | | | | | | |
| Bleed Test of | | | | | | |
| Freshly | | | | | | |
| Mixed | | | | | | |
| Grouts | | | | | | |
| Air Content | C185. | X | X | | X | T137 |
| of Mortar | | | | | | |
| Strength | C109/ | X | X | X | X | T106 |
| | C109M. | | | | | |
| Sulfate | C452 | X | | | | |
| Resistance | (sulfateexpansion). | | | | | |
| Drying | C596 | | | X | | |
| Shrinkage of | | | | | | |
| Mortar | | | | | | |
| Determine | C1012 | | | | X | T277-00 |
| sulfate | | | | | | |
| resistance | | | | | | |
| using | | | | | | |
| Determine | C1038 | | | | X | |
| mortar bar | | | | | | |
| expansion | | | | | | |
| using | | | | | | |
| Tensile | C190 | | | | | |
| Strength of | (discintinued) | | | | | |
| Hydraulic | | | | | | |
| Cement | | | | | | |
| Mortars | | | | | | |
| VolumeChange | C157/ | | | X | | T160-01 |
| | C157M | | | | | |
| False Set | C451. | X | | X | X | T186 |
| Time of | C266. | X | | X | | T154-02 |
| Setting by | | | | | | |
| Gillmore | | | | | | |
| Needles | | | | | | |
| Time of | C191. | X | X | | X | T131 |
| Setting by | | | | | | |
| Vicat | | | | | | |
| Needles | | | | | | |
| Early | C451 | | | | | T186 |
| Stiffening of | | | | | | |
| Portland | | | | | | |
| Cement | | | | | | |
| (Paste) | | | | | | |
| Normal | C187 | | | | | |
| Consistancy | | | | | | |
| of Hydraulic | | | | | | |
| Cement | | | | | | |
| Heat of | C186. | X | X | | X | |
| Hydration | | | | | | |
| Bond to Steel | C234. | | | X | | |
| Fineness of | C184 | | | | | T128 |
| Hydraulic | | | | | | |
| Cement by | | | | | | |
| the 150-mm | | | | | | |
| (No. 100) | | | | | | |
| and 75-mm | | | | | | |
| (No. 200) | | | | | | |
| Sieves | | | | | | |

In some embodiments, Portland clinker may be inter-ground with the SCM of the invention to give Portland cement blend. The amount of SCM added to the Portland clinker may be optimized based on the size and the distribution of the particles in the blend. In some embodiments, on an average, the finely ground SCM of the invention is half the size of the particle of the clinker which in turn is smaller than the clinker particle size in regular Portland cement. This may provide the blend with a particle packing effect, which may increase the strength of the concrete. In some embodiments, the aluminates from the clinker fraction may combine with the carbonate of the SCM to form carboaluminates which may reduce the porosity of the concrete and increase its strength.

In some embodiments, the vaterite in the SCM composition of the invention may react with the Portland cement or Portland clinker. In some embodiments, the SCM composition of the invention may act as a filler. In some embodiments, the size of the particles and/or the surface area of the particles may affect the interaction of the SCM composition of the invention with the Portland cement or Portland clinker. In some embodiments, the SCM composition of the invention may provide nucleation sites for the Portland cement or the Portland clinker. In some embodiments, the SCM composition of the invention may possess a combination of the foregoing embodiments.

In some embodiments, the SCM composition of the invention may differ from the hydraulic cement composition of the invention in reactivity. In some embodiments, the SCM composition of the invention may not be an effective hydraulic cement composition and vice versa. For example, in some embodiments, the SCM composition of the invention alone upon combination with water, setting and hardening may not result in the same compressive strength as the hydraulic cement composition of the invention upon combination with water, setting and hardening. However, such SCM composition upon mixing with other cement, such as, Portland cement gives surprisingly and unexpectedly high compressive strengths, as described below.

In some embodiments of the above recited four aspects, there is provided a SCM composition, wherein at least 16% by wt of SCM mixed with OPC results in no more than 10% reduction in compressive strength of OPC at 28 days as compared to OPC alone. In some embodiments of the above recited four aspects, there is provided a SCM composition, wherein at least 16% by wt of SCM mixed with OPC results in more than 5% increase in compressive strength of OPC at 28 days as compared to OPC alone.

In some embodiments, there is provided a SCM composition, the SCM comprising a carbonate, bicarbonate, or mixture thereof and one or more elements selected from the group consisting of barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa, wherein at least 16% by wt of SCM mixed with OPC results in no more than 10% reduction in compressive strength of OPC at 28 days as compared to OPC alone. In some embodiments, there is provided a SCM composition, the SCM comprising a carbonate, bicarbonate, or mixture thereof and one or more elements selected from the group consisting of barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa, wherein at least 16% by wt of SCM mixed with OPC results in more than 5% increase in compressive strength of OPC at 28 days as compared to OPC alone.

In some embodiments, the SCM composition of the invention includes at least 50% w/w calcite, wherein the composition upon combination with water and cement; setting; and hardening, has a compressive strength of at least 14 MPa or has a carbon isotopic fractionation value (δ¹³C) of less than −15‰. In some embodiments, the calcite in the SCM composition is between 50-100% w/w; or between 50-99% w/w; or between 50-95% w/w; or between 50-90% w/w; or between 50-85% w/w; or between 50-80% w/w; or between 50-70% w/w; or between 50-60% w/w; or between 50-55% w/w. In some embodiments, the foregoing SCM composition containing at least 50% w/w calcite, further comprises vaterite, aragonite, or ACC in at least 1% w/w, or 10% w/w, or 50% w/w, or between 1-50% w/w.

In some embodiments, at least 17% by wt of SCM; or at least 18% by wt of SCM; or at least 19% by wt of SCM; or at least 20% by wt of SCM; or at least 21% by wt of SCM; or at least 22% by wt of SCM; or at least 23% by wt of SCM; or at least 24% by wt of SCM; or at least 25% by wt of SCM; or at least 30% by wt of SCM; or at least 40% by wt of SCM; or at least 50% by wt of SCM; or between 16-50% by wt of SCM; or between 16-40% by wt of SCM; or between 16-30% by wt of SCM; or between 16-25% by wt of SCM; or between 16-22% by wt of SCM; or between 16-20% by wt of SCM; or between 16-18% by wt of SCM; or between 18-50% by wt of SCM; or between 18-40% by wt of SCM; or between 18-30% by wt of SCM; or between 18-20% by wt of SCM; or between 20-50% by wt of SCM; or between 20-40% by wt of SCM; or between 20-30% by wt of SCM; or between 35-50% by wt of SCM; or between 35-40% by wt of SCM; or between 40-50% by wt of SCM; or 16% by wt of SCM; or 17% by wt of SCM; or 18% by wt of SCM; or 19% by wt of SCM; or 20% by wt of SCM; or 22% by wt of SCM; or 25% by wt of SCM; or 30% by wt of SCM; or 35% by wt of SCM; mixed with OPC results in no more than 10% reduction in the compressive strength of OPC at 28 days, as compared to OPC alone or results in more than 5% increase in compressive strength of OPC at 28 days as compared to OPC alone. For example, at least 17-20% by wt of SCM or 20% by wt of SCM mixed with OPC results in no more than 10% reduction in the compressive strength of OPC at 28 days, as compared to OPC alone or results in more than 5% increase in compressive strength of OPC at 28 days as compared to OPC alone.

In some embodiments, the compressive strength of Portland cement is in a range of 17-45 MPa. Accordingly, in some embodiments of the above recited four aspects, there is provided a composition including a SCM, wherein at least 16% by wt of SCM mixed with OPC results in no more than 10% reduction in compressive strength of OPC at 28 days wherein the compressive strength of OPC is in a range of 17-45 MPa. In some embodiments of the above recited four aspects, there is provided a composition including a SCM, wherein at least 16% by wt of SCM mixed with OPC results in more than 5% increase in compressive strength of OPC at 28 days wherein the compressive strength of OPC is in a range of 17-45 MPa. In some embodiments, the compressive strength of Portland cement is in a range of 17-40 MPa; or in a range of 17-35 MPa; or in a range of 17-30 MPa; or in a range of 17-25 MPa; or in a range of 17-23 MPa; or in a range of 17-22 MPa; or in a range of 17-21 MPa; or in a range of 17-20 MPa; or in a range of 17-19 MPa; or in a range of 17-18 MPa; or in a range of 18-35 MPa; or in a range of 18-25 MPa; or in a range of 18-20 MPa; or in a range of 20-40 MPa; or in a range of 20-35 MPa; or in a range of 20-25 MPa; or in a range of 30-45 MPa; or in a range of 30-40 MPa; or in a range of 30-35 MPa; or in a range of 40-45 MPa. For example, in some embodiments, the compressive strength of Portland cement is in a range of 17-35 MPa.

The compressive strength of OPC may vary depending on the type of OPC. The types of OPC include, Type I, Type II, Type III, Type IV, Type V, Type IA, Type IIA, and Type IIIA. Table III illustrates the compressive strength (in MPa) of various types of Portland cement at 1 day, 3 days, 7 days, and 28 days of curing time.

TABLE III

| | Portland cement type | | | | | | | |
|---|---|---|---|---|---|---|---|---|
| Curing time | I | IA | II | IIA | III | IIIA | IV | V |
| 1 day | — | — | — | — | 12.4 | 10.0 | — | — |
| 3 days | 12.4 | 10.0 | 10.3 | 8.3 | 24.1 | 19.3 | — | 8.3 |
| 7 days | 19.3 | 15.5 | 17.2 | 13.8 | — | — | 6.9 | 15.2 |
| 28 days | — | — | — | — | — | — | 17.2 | 20.7 |

In some embodiments of the above recited four aspects and the above recited embodiments, at least 16% by wt of SCM mixed with OPC results in no more than 10%; or no more than 9%; or no more than 8%; or no more than 7%; or no more than 6%; or no more than 5%; or no more than 4%; or no more than 3%; or no more than 2%; or no more than 1%; or no more than 1-5%; or no more than 5-10%; or no more than 6-10%; or no more than 8-10%; reduction in compressive strength of OPC at 28 days as compared to OPC alone or as compared to the compressive strength of Portland cement in a range of 17-45 MPa. In some embodiments, at least 16% by wt of SCM mixed with OPC results in no more than 5 MPa; or no more than 4 MPa; or no more than 3 MPa; or no more than 2 MPa; or no more than 1 MPa; or no more than 0.5 MPa; or no more than 0.5-1 MPa; or no more than 0.5-2 MPa; or no more than 0.5-3 MPa; or no more than 0.5-5 MPa, reduction in compressive strength of OPC at 28 days as compared to OPC alone or as compared to the compressive strength of Portland cement in a range of 17-45 MPa.

In some embodiments, there is provided a composition including a SCM, wherein at least 16% by wt of SCM mixed with OPC results in more than 5%; or more than 8%; or more than 10%; or more than 15%; or more than 20%; or more than 25%; or more than 30%; or more than 5-10%; or more than 5-15%; or more than 5-8%; or more than 5-20%; or more than 5-30%, increase in compressive strength of OPC at 28 days as compared to OPC alone or as compared to the compressive strength of Portland cement in a range of 17-45 MPa. In some embodiments, there is provided a composition including a SCM, wherein the at least 16% by wt of SCM mixed with OPC results in between 1-20 MPa; or between 1-15 MPa; or between 1-12 MPa; or between 1-10 MPa; or between 1-8 MPa; or between 1-5 MPa; or between 1-4 MPa; or between 1-3 MPa; or between 1-2 MPa; or 1 or 2 or 3 MPa; or more than 1 MPa, increase in compressive strength of OPC at 28 days when compared to OPC alone or as compared to the compressive strength of Portland cement in a range of 17-45 MPa.

In some embodiments, the cementitious composition of the invention is a self-cementing composition. The self-cementing composition of the invention is in any aqueous medium including saltwater. As used herein, the “saltwater” is employed in its conventional sense to refer to a number of different types of aqueous medium other than fresh water, including, but not limited to brackish water, sea water, brine (including man-made brines, e.g., geothermal plant wastewaters, desalination waste waters, etc), as well as other salines having a salinity that is greater than that of freshwater. Brine is water saturated or nearly saturated with salt and has a salinity that is 50 ppt (parts per thousand) or greater. Brackish water is water that is saltier than fresh water, but not as salty as seawater, having a salinity ranging from 0.5 to 35 ppt. Seawater is water from a sea or ocean and has a salinity ranging from 35 to 50 ppt. The saltwater source from which the composition of the invention is derived may be a naturally occurring source, such as a sea, ocean, lake, swamp, estuary, lagoon, etc., or a man-made source. In some embodiments, the saltwater includes water containing more than 1% chloride content, such as, NaCl; or more than 10% NaCl; or more than 20% NaCl; or more than 30% NaCl; or more than 40% NaCl; or more than 50% NaCl; or more than 60% NaCl; or more than 70% NaCl; or more than 80% NaCl; or more than 90% NaCl; or between 1-95% NaCl; or between 10-95% NaCl; or between 20-95% NaCl; or between 30-95% NaCl; or between 40-95% NaCl; or between 50-95% NaCl; or between 60-95% NaCl; or between 70-95% NaCl; or between 80-95% NaCl; or between 90-95% NaCl.

In some embodiments, the self-cementing composition that is in saltwater comprises less than 90% by wt solid material; or less than 80% by wt solid material; or less than 70% by wt solid material; or less than 60% by wt solid material; or less than 50% by wt solid material; or less than 40% by wt solid material; or less than 30% by wt solid material; or less than 20% by wt solid material; or less than 10% by wt solid material; or between 10-90% by wt solid material; or between 10-80% by wt solid material; or between 10-70% by wt solid material; or between 10-50% by wt solid material; or between 10-30% by wt solid material; or between 40-90% by wt solid material; or between 50-90% by wt solid material.

The self-cementing composition need not be dewatered and dried to make the hydraulic cement. Such composition can be simply dewatered, washed with water to remove chloride, such as, sodium chloride, optionally dewatered again, and poured into molds where it sets and hardens to form a rock, pre-cast or pre-formed building materials. The rock can be further processed to make aggregates. Such absence of the step of drying saves energy, reduces the carbon foot print, and provides a cleaner environment. This composition may or may not include a binder. In some embodiments, the self-cementing composition does not include a binder. In some embodiments, the invention provides a self-cementing composition that does not contain binders and leads to a self-cementing synthetic rock.

The methods of the invention allow for production of a hard, durable rock through processes that involve physical reactions without the need for extrinsic or intrinsic binders. Thus, in some embodiments the invention provides self-cementing composition that contains less than 10, 5, 2, 1, 0.5, 0.2, 0.1, 0.05, 0.02, 0.01, 0.005, 0.001, 0.0005, 0.0001% w/w of binder, where “binder,” includes compounds or substances that are added to a self-cementing composition in order to cause or promote chemical reactions that cause components of the self-cementing composition to bind together during a synthetic process. Examples of binders include, but are not limited to, acrylic polymer liquid, lime, volcanic ash, etc. In some embodiments, the self-cementing composition of the invention includes substantially no binder.

Such self-cementing composition can be artificially lithified in processes that mimic geologic processes in which physical, rather than chemical processes are the processes by which rocks are formed, e.g., dissolution and reprecipitation of compounds in new forms that serve to bind the composition together.

In some embodiments, the self-cementing composition when rinsed with water may lead to a synthetic rock in a process in which polymorphs recited herein, such as, vaterite, is converted to more stable components, such as aragonite, calcite, or combination thereof. For example, in some embodiments, the synthetic rock is produced from the self-cementing composition in a process where aragonite is converted to calcite, and/or vaterite is converted to aragaonite and/or calcite.

In some embodiments, there is provided a composition including a hydraulic cement where the hydraulic cement includes at least 47% w/w vaterite and one or more elements including, but not limited to, barium, cobalt, copper, lanthanum, mercury, arsenic, cadmium, lead, nickel, scandium, titanium, zinc, zirconium, molybdenum, and selenium. In some embodiments, there is provided a composition including a SCM where the SCM includes at least 47% w/w vaterite and one or more elements including, but not limited to, barium, cobalt, copper, lanthanum, mercury, arsenic, cadmium, lead, nickel, scandium, titanium, zinc, zirconium, molybdenum, and selenium.

In some embodiments of the foregoing aspects and the foregoing embodiments, the composition includes at least 47% w/w vaterite; or at least 50% w/w vaterite; or at least 60% w/w vaterite; or at least 70% w/w vaterite; or at least 75% w/w vaterite; or at least 80% w/w vaterite; or at least 85% w/w vaterite; or at least 90% w/w vaterite; or at least 95% w/w vaterite; or from 47% w/w to 100% w/w vaterite; or from 47% w/w to 99% w/w vaterite; or from 47% w/w to 95% w/w vaterite; or from 47% w/w to 90% w/w vaterite; or from 47% w/w to 85% w/w vaterite; or from 47% w/w to 80% w/w vaterite; or from 47% w/w to 75% w/w vaterite; or from 47% w/w to 70% w/w vaterite; or from 47% w/w to 65% w/w vaterite; or from 47% w/w to 60% w/w vaterite; or from 47% w/w to 55% w/w vaterite; or from 47% w/w to 50% w/w vaterite; or from 50% w/w to 100% w/w vaterite; or from 50% w/w to 90% w/w vaterite; or from 50% w/w to 80% w/w vaterite; or from 50% w/w to 75% w/w vaterite; or from 50% w/w to 70% w/w vaterite; or from 50% w/w to 60% w/w vaterite; or from 60% w/w to 100% w/w vaterite; or from 60% w/w to 90% w/w vaterite; or from 60% w/w to 80% w/w vaterite; or from 60% w/w to 70% w/w vaterite; or from 70% w/w to 100% w/w vaterite; or from 70% w/w to 95% w/w vaterite; or from 70% w/w to 90% w/w vaterite; or from 70% w/w to 85% w/w vaterite; or from 70% w/w to 80% w/w vaterite; or from 70% w/w to 75% w/w vaterite; or from 80% w/w to 100% w/w vaterite; or from 80% w/w to 95% w/w vaterite; or from 80% w/w to 90% w/w vaterite; or from 80% w/w to 85% w/w vaterite; or from 90% w/w to 100% w/w vaterite; or from 90% w/w to 99% w/w vaterite; or from 90% w/w to 98% w/w vaterite; or from 90% w/w to 95% w/w vaterite; or from 90% w/w to 92% w/w vaterite; or 47% w/w vaterite; or 50% w/w vaterite; or 55% w/w vaterite; or 60% w/w vaterite; or 65% w/w vaterite; or 70% w/w vaterite; or 75% w/w vaterite; or 80% w/w vaterite; or 85% w/w vaterite; or 90% w/w vaterite; or 92% w/w vaterite; or 95% w/w vaterite; or 98% w/w vaterite; or 99% w/w vaterite. For example, in some embodiments of the foregoing aspects and the foregoing embodiments, the composition includes at least 70% w/w vaterite to 99% w/w vaterite; or 70% w/w vaterite to 95% w/w vaterite; or 70% w/w vaterite to 90% w/w vaterite; 70% w/w vaterite to 85% w/w vaterite; 70% w/w vaterite to 80% w/w vaterite; 70% w/w vaterite to 75% w/w vaterite.

In some embodiments of the foregoing aspects and the foregoing embodiment, the composition further includes ACC. In such compositions, the amount of ACC is at least 1% w/w; or at least 2% w/w ACC; or at least 5% w/w ACC; or at least 10% w/w ACC; or at least 20% w/w ACC; or at least 30% w/w ACC; or at least 40% w/w ACC; or at least 50% w/w ACC; or at least 53% w/w ACC; or from 1% w/w to 53% w/w ACC; or from 1% w/w to 50% w/w ACC; or from 1% w/w to 40% w/w ACC; or from 1% w/w to 30% w/w ACC; or from 1% w/w to 20% w/w ACC; or from 1% w/w to 10% w/w ACC; or from 5% w/w to 53% w/w ACC; or from 5% w/w to 50% w/w ACC; or from 5% w/w to 40% w/w ACC; or from 5% w/w to 30% w/w ACC; or from 5% w/w to 20% w/w ACC; or from 5% w/w to 10% w/w ACC; or from 10% w/w to 53% w/w ACC; or from 10% w/w to 50% w/w ACC; or from 10% w/w to 40% w/w ACC; or from 10% w/w to 30% w/w ACC; or from 10% w/w to 20% w/w ACC; or from 20% w/w to 53% w/w ACC; or from 20% w/w to 50% w/w ACC; or from 20% w/w to 40% w/w ACC; or from 20% w/w to 30% w/w ACC; or from 30% w/w to 53% w/w ACC; or from 30% w/w to 50% w/w ACC; or from 30% w/w to 40% w/w ACC; or from 40% w/w to 53% w/w ACC; or from 40% w/w to 50% w/w ACC; or from 50% w/w to 53% w/w ACC.

In some embodiments, there is provided a composition including a hydraulic cement where the hydraulic cement includes at least 10% w/w vaterite, at least 1% w/w amorphous calcium carbonate (ACC), and one or more elements including, but not limited to, barium, cobalt, copper, lanthanum, mercury, arsenic, cadmium, lead, nickel, scandium, titanium, zinc, zirconium, molybdenum, and selenium. In some embodiments, there is provided a composition including a SCM where the SCM includes at least 10% w/w vaterite, at least 1% w/w ACC, and one or more elements including, but not limited to, barium, cobalt, copper, lanthanum, mercury, arsenic, cadmium, lead, nickel, scandium, titanium, zinc, zirconium, molybdenum, and selenium.

In some embodiments of the foregoing aspects and the foregoing embodiments, the composition includes at least 10% w/w vaterite; or at least 20% w/w vaterite; or at least 30% w/w vaterite; or at least 40% w/w vaterite; or at least 50% w/w vaterite; or at least 60% w/w vaterite; or at least 70% w/w vaterite; or at least 80% w/w vaterite; or at least 90% w/w vaterite; or at least 95% w/w vaterite; or at least 99% w/w vaterite; or from 10% w/w to 99% w/w vaterite; or from 10% w/w to 95% w/w vaterite; or from 10% w/w to 90% w/w vaterite; or from 10% w/w to 80% w/w vaterite; or from 10% w/w to 70% w/w vaterite; or from 10% w/w to 60% w/w vaterite; or from 10% w/w to 50% w/w vaterite; or from 10% w/w to 40% w/w vaterite; or from 10% w/w to 30% w/w vaterite; or from 10% w/w to 20% w/w vaterite; or from 20% w/w to 99% w/w vaterite; or from 20% w/w to 95% w/w vaterite; or from 20% w/w to 90% w/w vaterite; or from 20% w/w to 80% w/w vaterite; or from 20% w/w to 70% w/w vaterite; or from 20% w/w to 60% w/w vaterite; or from 20% w/w to 50% w/w vaterite; or from 20% w/w to 40% w/w vaterite; or from 20% w/w to 30% w/w vaterite; or from 20% w/w to 25% w/w vaterite; or from 30% w/w to 99% w/w vaterite; or from 30% w/w to 95% w/w vaterite; or from 30% w/w to 90% w/w vaterite; or from 30% w/w to 80% w/w vaterite; or from 30% w/w to 70% w/w vaterite; or from 30% w/w to 60% w/w vaterite; or from 30% w/w to 50% w/w vaterite; or from 30% w/w to 40% w/w vaterite; or from 40% w/w to 99% w/w vaterite; or from 40% w/w to 95% w/w vaterite; or from 40% w/w to 90% w/w vaterite; or from 40% w/w to 80% w/w vaterite; or from 40% w/w to 70% w/w vaterite; or from 40% w/w to 60% w/w vaterite; or from 40% w/w to 50% w/w vaterite; or from 50% w/w to 99% w/w vaterite; or from 50% w/w to 95% w/w vaterite; or from 50% w/w to 90% w/w vaterite; or from 50% w/w to 80% w/w vaterite; or from 50% w/w to 70% w/w vaterite; or from 50% w/w to 60% w/w vaterite; or from 60% w/w to 99% w/w vaterite; or from 60% w/w to 95% w/w vaterite; or from 60% w/w to 90% w/w vaterite; or from 60% w/w to 80% w/w vaterite; or from 60% w/w to 70% w/w vaterite; or from 70% w/w to 99% w/w vaterite; or from 70% w/w to 95% w/w vaterite; or from 70% w/w to 90% w/w vaterite; or from 70% w/w to 80% w/w vaterite; or from 80% w/w to 99% w/w vaterite; or from 80% w/w to 95% w/w vaterite; or from 80% w/w to 90% w/w vaterite; or from 90% w/w to 99% w/w vaterite; or from 90% w/w to 95% w/w vaterite; or 10% w/w vaterite; or 20% w/w vaterite; or 30% w/w vaterite; or 40% w/w vaterite; or 50% w/w vaterite; or 60% w/w vaterite; or 70% w/w vaterite; or 75% w/w vaterite; or 80% w/w vaterite; or 85% w/w vaterite; or 90% w/w vaterite; or 95% w/w vaterite; or 99% w/w vaterite; at least 1% w/w ACC, and one or more elements including, but not limited to, barium, cobalt, copper, lanthanum, mercury, arsenic, cadmium, lead, nickel, scandium, titanium, zinc, zirconium, molybdenum, and selenium.

In some embodiments of the foregoing four aspects and the foregoing embodiments, the composition includes at least 1% w/w amorphous calcium carbonate (ACC); or at least 2% w/w ACC; or at least 5% w/w ACC; or at least 10% w/w ACC; or at least 20% w/w ACC; or at least 30% w/w ACC; or at least 40% w/w ACC; or at least 50% w/w ACC; or at least 60% w/w ACC; or at least 70% w/w ACC; or at least 80% w/w ACC; or at least 90% w/w ACC; or from 1% w/w to 90% w/w ACC; or from 1% w/w to 80% w/w ACC; or from 1% w/w to 70% w/w ACC; or from 1% w/w to 60% w/w ACC; or from 1% w/w to 50% w/w ACC; or from 1% w/w to 40% w/w ACC; or from 1% w/w to 30% w/w ACC; or from 1% w/w to 20% w/w ACC; or from 1% w/w to 10% w/w ACC; or from 5% w/w to 90% w/w ACC; or from 5% w/w to 80% w/w ACC; or from 5% w/w to 70% w/w ACC; or from 5% w/w to 60% w/w ACC; or from 5% w/w to 50% w/w ACC; or from 5% w/w to 40% w/w ACC; or from 5% w/w to 30% w/w ACC; or from 5% w/w to 20% w/w ACC; or from 5% w/w to 10% w/w ACC; or from 10% w/w to 90% w/w ACC; or from 10% w/w to 80% w/w ACC; or from 10% w/w to 70% w/w ACC; or from 10% w/w to 60% w/w ACC; or from 10% w/w to 50% w/w ACC; or from 10% w/w to 40% w/w ACC; or from 10% w/w to 30% w/w ACC; or from 10% w/w to 20% w/w ACC; or from 20% w/w to 90% w/w ACC; or from 20% w/w to 80% w/w ACC; or from 20% w/w to 70% w/w ACC; or from 20% w/w to 60% w/w ACC; or from 20% w/w to 50% w/w ACC; or from 20% w/w to 40% w/w ACC; or from 20% w/w to 30% w/w ACC; or from 30% w/w to 90% w/w ACC; or from 30% w/w to 80% w/w ACC; or from 30% w/w to 70% w/w ACC; or from 30% w/w to 60% w/w ACC; or from 30% w/w to 50% w/w ACC; or from 30% w/w to 40% w/w ACC; or from 40% w/w to 90% w/w ACC; or from 40% w/w to 80% w/w ACC; or from 40% w/w to 70% w/w ACC; or from 40% w/w to 60% w/w ACC; or from 40% w/w to 50% w/w ACC; or from 50% w/w to 90% w/w ACC; or from 50% w/w to 80% w/w ACC; or from 50% w/w to 70% w/w ACC; or from 50% w/w to 60% w/w ACC; or from 60% w/w to 90% w/w ACC; or from 60% w/w to 80% w/w ACC; or from 60% w/w to 70% w/w ACC; or from 60% w/w to 65% w/w ACC; or from 70% w/w to 90% w/w ACC; or from 70% w/w to 80% w/w ACC; or from 70% w/w to 75% w/w ACC; or from 80% w/w to 90% w/w ACC; or from 80% w/w to 85% w/w ACC; or from 85% w/w to 90% w/w ACC; or 1% w/w ACC; or 2% w/w ACC; or 5% w/w ACC; or 10% w/w ACC; or 20% w/w ACC; or 30% w/w ACC; or 40% w/w ACC; or 50% w/w ACC; or 60% w/w ACC; or 70% w/w ACC; or 80% w/w ACC; or 90% w/w ACC.

In some embodiments of the foregoing aspects and the foregoing embodiments, the composition comprises the vaterite in a range of 10% w/w to 99% w/w and the ACC in a range of 1% w/w to 90% w/w; or the vaterite is in a range of 10% w/w to 90% w/w and the ACC is in a range of 10% w/w to 90% w/w; or the vaterite is in a range of 10% w/w to 80% w/w and the ACC is in a range of 20% w/w to 90% w/w; or the vaterite is in a range of 10% w/w to 70% w/w and the ACC is in a range of 30% w/w to 90% w/w; or the vaterite is in a range of 10% w/w to 60% w/w and the ACC is in a range of 40% w/w to 90% w/w; or the vaterite is in a range of 10% w/w to 50% w/w and the ACC is in a range of 50% w/w to 90% w/w; or the vaterite is in a range of 10% w/w to 40% w/w and the ACC is in a range of 60% w/w to 90% w/w; or the vaterite is in a range of 10% w/w to 30% w/w and the ACC is in a range of 70% w/w to 90% w/w; or the vaterite is in a range of 10% w/w to 20% w/w and the ACC is in a range of 80% w/w to 90% w/w.

In some embodiments, there is provided a composition including a hydraulic cement where the hydraulic cement includes a carbonate, bicarbonate, or mixture thereof and one or more elements including, but not limited to, barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa. In some embodiments, there is provided a composition including a SCM where the SCM includes a carbonate, bicarbonate, or mixture thereof and one or more elements including, but not limited to, barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa. In some embodiments, there is provided a self-cementing composition including a carbonate, bicarbonate, or mixture thereof and one or more elements including, but not limited to, barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa.

In some embodiments of the foregoing aspects and the foregoing embodiments, the composition after setting, and hardening has a compressive strength of at least 14 MPa; or at least 16 MPa; or at least 18 MPa; or at least 20 MPa; or at least 25 MPa; or at least 30 MPa; or at least 35 MPa; or at least 40 MPa; or at least 45 MPa; or at least 50 MPa; or at least 55 MPa; or at least 60 MPa; or at least 65 MPa; or at least 70 MPa; or at least 75 MPa; or at least 80 MPa; or at least 85 MPa; or at least 90 MPa; or at least 95 MPa; or at least 100 MPa; or from 14-100 MPa; or from 14-80 MPa; or from 14-75 MPa; or from 14-70 MPa; or from 14-65 MPa; or from 14-60 MPa; or from 14-55 MPa; or from 14-50 MPa; or from 14-45 MPa; or from 14-40 MPa; or from 14-35 MPa; or from 14-30 MPa; or from 14-25 MPa; or from 14-20 MPa; or from 14-18 MPa; or from 14-16 MPa; or from 17-35 MPa; or from 17-30 MPa; or from 17-25 MPa; or from 17-20 MPa; or from 17-18 MPa; or from 20-100 MPa; or from 20-90 MPa; or from 20-80 MPa; or from 20-75 MPa; or from 20-70 MPa; or from 20-65 MPa; or from 20-60 MPa; or from 20-55 MPa; or from 20-50 MPa; or from 20-45 MPa; or from 20-40 MPa; or from 20-35 MPa; or from 20-30 MPa; or from 20-25 MPa; or from 30-100 MPa; or from 30-90 MPa; or from 30-80 MPa; or from 30-75 MPa; or from 30-70 MPa; or from 30-65 MPa; or from 30-60 MPa; or from 30-55 MPa; or from 30-50 MPa; or from 30-45 MPa; or from 30-40 MPa; or from 30-35 MPa; or from 40-100 MPa; or from 40-90 MPa; or from 40-80 MPa; or from 40-75 MPa; or from 40-70 MPa; or from 40-65 MPa; or from 40-60 MPa; or from 40-55 MPa; or from 40-50 MPa; or from 40-45 MPa; or from 50-100 MPa; or from 50-90 MPa; or from 50-80 MPa; or from 50-75 MPa; or from 50-70 MPa; or from 50-65 MPa; or from 50-60 MPa; or from 50-55 MPa; or from 60-100 MPa; or from 60-90 MPa; or from 60-80 MPa; or from 60-75 MPa; or from 60-70 MPa; or from 60-65 MPa; or from 70-100 MPa; or from 70-90 MPa; or from 70-80 MPa; or from 70-75 MPa; or from 80-100 MPa; or from 80-90 MPa; or from 80-85 MPa; or from 90-100 MPa; or from 90-95 MPa; or 14 MPa; or 16 MPa; or 18 MPa; or 20 MPa; or 25 MPa; or 30 MPa; or 35 MPa; or 40 MPa; or 45 MPa. For example, in some embodiments of the foregoing aspects and the foregoing embodiments, the composition after setting, and hardening has a compressive strength of 14 MPa to 40 MPa; or 17 MPa to 40 MPa; or 20 MPa to 40 MPa; or 30 MPa to 40 MPa; or 35 MPa to 40 MPa. In some embodiments, the compressive strengths described herein are the compressive strengths after 1 day, or 3 days, or 7 days, or 28 days.

The calcium carbonate in the compositions of the invention may contain carbonate from the synthetic carbonate brine where carbonate may originate from sodium carbonate or such or may be a dissolved carbon dioxide. In some embodiments, the carbonate in the carbonate containing composition of the invention may originate from subterranean carbonate brines. In some embodiments, the carbonate in the carbonate compositions of the invention, originates from the subterranean carbonate brine, and thus some (e.g., at least 10, 50, 60, 70, 80, 90, 95%) or substantially all (e.g., at least 99, 99.5, or 99.9%) of the carbon in the carbonates is of subterranean carbonate brine origin.

Typically, carbon of plant origin has a different ratio of stable isotopes (¹³C and ¹²C) than carbon of inorganic origin. The plants from which fossil fuels are derived preferentially utilize ¹²C over ¹³C, thus fractionating the carbon isotopes so that the value of their ratio differs from that in the atmosphere in general. This value, when compared to a standard value (PeeDee Belemnite, or PDB, standard), is termed the carbon isotopic fractionation (δ¹³C) value. Typically, δ¹³C values for coal are in the range −30 to −20‰; δ¹³C values for methane may be as low as −20‰ to −40‰ or even −40‰ to −80‰; δ¹³C values for atmospheric CO₂ are −10‰ to −7‰; for limestone+3‰ to −3‰; and for marine bicarbonate, 0‰.

In some embodiments, the carbon in the carbonate containing composition of the invention, has a δ¹³C of greater than −5‰, −1‰, or greater than 1‰, or between −5‰ to 25‰, or between 0.1‰ to 20%, as described in further detail herein. In some embodiments, the composition of the invention include carbonates, such as, vaterite, bicarbonates, or a combination thereof, in which the carbonates, bicarbonates, or a combination thereof have a carbon isotopic fractionation (δ¹³C) value less than −5.00‰.

The relative carbon isotope composition (δ¹³C) value with units of ‰ (per mille) is a measure of the ratio of the concentration of two stable isotopes of carbon, namely ¹²C and ¹³C, relative to a standard of fossilized belemnite (the PDB standard).

δ¹³C‰=[(¹³C/¹²Cₛₐₘₚₗₑ−¹³C/¹²C_{PDB standard})/(¹³C/¹²C_{PDB standard})]×1000

¹²C is preferentially taken up by plants during photosynthesis and in other biological processes that use inorganic carbon because of its lower mass. The lower mass of ¹²C allows for kinetically limited reactions to proceed more efficiently than with ¹³C. Thus, materials that are derived from plant material, e.g., fossil fuels, have relative carbon isotope composition values that are less than those derived from inorganic sources. The carbon dioxide in flue gas produced from burning fossil fuels reflects the relative carbon isotope composition values of the organic material that was fossilized.

Material incorporating carbon from fossil fuels reflects δ¹³C values that are like those of plant derived material, i.e. less than that which incorporates carbon from atmospheric or non-plant marine sources. The δ¹³C value of the material produced by the carbon dioxide from the burning fossil fuels can be verified by measuring the δ¹³C value of the material and confirming that it is not similar to the values for atmospheric carbon dioxide or marine sources of carbon. Table IV below lists relative carbon isotope composition (δ¹³C) value ranges for various carbon sources for comparison.

TABLE IV

| Carbon Source | δ¹³C Range [‰] | δ¹³C Average value [‰] |
|---|---|---|
| C3 Plants (most higher | −23 to −33 | −27 |
| plants) | | |
| C4 Plants (most tropical | −9 to −16 | −13 |
| and marsh plants) | | |
| Atmosphere | −6 to −7 | −6 |
| Marine Carbonate (CO₃) | −2 to +2 | 0 |
| Marine Bicarbonate | −3 to +1 | −1 |
| (HCO₃) | | |
| Coal from Yallourn | −27.1 to −23.2 | −25.5 |
| Seam in Australia¹ | | |
| Coal from Dean Coal | −24.47 to −25.14 | −24.805 |
| Bed in Kentucky, USA² | | |

¹Holdgate, G. R. et al, Global and Planetary Change, 65 (2009) pp. 89-103.
²Elswick, E. R. et al., Applied Geochemistry, 22 (2007) pp. 2065-2077.

In some embodiments, the invention provides a method of characterizing the composition of the invention by measuring its δ¹³C value. Any suitable method may be used for measuring the δ¹³C value, such as mass spectrometry or off-axis integrated-cavity output spectroscopy (off-axis ICOS). Any mass-discerning technique, sensitive enough to measure the amounts of carbon, can be used to find ratios of the ¹³C to ¹²C isotope concentrations. The δ¹³C values can be measured by the differences in the energies in the carbon-oxygen double bonds made by the ¹²C and ¹³C isotopes in carbon dioxide.

The δ¹³C value of the carbonate in the composition of the invention may serve as a fingerprint for the carbonate source, as the value can vary from source to source. Within one source of the carbonate or the carbonate brine, for example, Owens Lake in California, the δ¹³C value of the carbonate may vary depending on the location of the carbonate within that source. For example, the δ¹³C value of the carbonate may vary if the carbonate is from the surface water, bedrock, soil, floodplain, dust, or playa. Similarly, δ¹⁸O value of the carbonate may also be characterized and may depend on the source of the carbonate. In some embodiments, the δ¹⁸O value of the carbonate is in a range of between −11 to 2‰; or between −11 to −2‰; or between −5 to 0.1‰; or between −5 to 2‰; or between −5 to 1‰; or between −5 to −1‰; or between −5 to −2‰; or between −5 to −3‰; or between −5 to −4‰. The δ¹³C value of the carbonate and/or the δ¹⁸O value of the carbonate may also be dependent on the seasonal fluctuations of mineral formation, such as, temperature, humidity, and/or available CO₂. In some embodiments, the δ¹³C value of the carbonate and/or δ¹⁸O value of the carbonate in the compositions of the invention is an average isotopic value of the carbonate, i.e., an average δ¹³C value of the carbonate or an average δ¹⁸O value of the carbonate.

In some embodiments, the amount of carbon in the vaterite and/or polymorphs in the compositions of the invention, may be determined any suitable technique known in the art. Such techniques include, but are not limited to, coulometry.

In some embodiments of the foregoing aspects and the foregoing embodiments, the composition has a δ¹³C of greater than −5‰; or greater than −1‰; or greater than 0‰; or greater than 1‰; or greater than 2‰; or greater than 5‰; or greater than 10‰; or greater than 20‰; or greater than 25‰; or greater than 30‰; or greater than 35‰; or greater than 40‰; or −5‰ to 40‰; or −5‰ to 35‰; or −5‰ to 30‰; -5‰ to 25‰; or −5‰ to 20‰; or −5‰ to 10‰; or −5‰ to 5‰; -5‰ to −1‰; or −1‰ to 40‰; or −1‰ to 35‰; or −1‰ to 30‰; or −1‰ to 25‰; or −1‰ to 20‰; or −1‰ to 10‰; or −1‰ to 5‰; or −1‰ to 1‰; or −0.1‰ to 40‰; or −0.1‰ to 35‰; or −0.1‰ to 30‰; 0.1‰ to 25‰; or 0.1‰ to 20‰; or 0.1‰ to 10‰; or 0.1‰ to 5‰; or 0.1‰ to 4‰; or 0.1‰ to 3‰; or 0.1‰ to 2‰; or 0.1‰ to 1‰; or 1‰ to 40‰; or 1‰ to 35‰; or 1‰ to 30‰; or 1‰ to 25‰; or 1‰ to 20‰; or 1‰ to 10‰; or 1‰ to 5‰; or 1‰ to 4‰; or 1‰ to 3‰; or 1‰ to 2‰; or 2‰ to 40‰; or 2‰ to 35‰; or 2‰ to 30‰; or 2‰ to 25‰; or 2‰ to 20‰; or 2‰ to 10‰; or 2‰ to 5‰; or 2‰ to 4‰; or 2‰ to 3‰; or 3‰ to 40‰; or 3‰ to 35‰; or 3‰ to 30‰; or 3‰ to 25‰; or 3‰ to 20‰; or 3‰ to 10‰; or 3‰ to 5‰; or 3‰ to 4‰; or 4‰ to 40‰; or 4‰ to 35‰; or 4‰ to 30‰; or 4‰ to 25‰; or 4‰ to 20‰; or 4‰ to 10‰; or 4‰ to 5‰; or 5‰ to 40‰; or 5‰ to 35‰; or 5‰ to 30‰; or 5‰ to 25‰; or 5‰ to 20‰; or 5‰ to 15‰; or 5‰ to 10‰; or 10‰ to 40‰; or 10‰ to 35‰; or 10‰ to 30‰; or 10‰ to 15‰; or 10‰ to 20‰; or 10‰ to 25‰; or 20‰ to 45‰; or 20‰ to 40‰ or 20‰ to 30‰; or 20‰ to 25‰. For example, in some embodiments, the composition has a δ¹³C of 0.1‰ to 5‰; or 0.1‰ to 4‰; or 0.1‰ to 3‰; or 0.1‰ to 2‰; or 0.1‰ to 1‰.

In some embodiments, the compositions of the invention may also be characterized based on other isotopes in the compositions of the invention. Hydrogen has two stable isotopes: ¹H and ²H. When water evaporates, the lighter isotope, ¹H, is preferentially removed, leaving the residual water relatively enriched in the heavier isotope. Hydrogen isotope ratios can be used to measure the origin of the compositions of the invention. Strontium ratios (⁸⁷Sr/⁸⁶Sr) can also be used to trace source of the compositions of the invention. Carbonate minerals may incorporate strontium in trace amounts. Higher ratios may indicate that formation waters were in contact with clays or other minerals containing radioactive rubidium, which decays to produce stable ⁸⁷Sr. Carbonates forming from deep groundwaters in sedimentary basins may have high ⁸⁷Sr/⁸⁶Sr ratios. Sulphur has two isotopes in sedimentary geochemistry, ³⁴S and ³²S. In small percentages, metal sulphide minerals may be found in both carbonate and clastic rocks. They may form when sediment pore waters become depleted in oxygen, which is used up as bacteria break down organic matter. Some bacteria may use sulphate as a substitute for oxygen, and this process may cause the sulphate to be transformed to sulphide. If metal ions are presented in solution, the sulphide ions may readily precipitate out, forming minerals such as pyrite within the pore spaces of sedimentary rocks.

In some embodiments of foregoing aspects and the foregoing embodiments, the composition further includes a polymorph including, but are not limited to, amorphous calcium carbonate, aragonite, calcite, ikaite, a precursor phase of vaterite, a precursor phase of aragonite, an intermediary phase that is less stable than calcite, polymorphic forms in between these polymorphs, and combination thereof. It is to be understood that the composition may also include any other polymorphic form of calcium carbonate and such polymorphic forms are well within the scope of the invention. Some embodiments of the composition provided herein including one or more polymorphs, are as shown below in Table V.

TABLE V

| Composition | Vaterite | ACC | Aragonite | Calcite | Ikaite |
|---|---|---|---|---|---|
| 1 | x | | | | |
| 2 | x | x | | | |
| 3 | x | x | x | | |
| 4 | x | x | x | x | |
| 5 | x | x | x | x | x |
| 6 | x | | x | | |
| 7 | x | | x | x | |
| 8 | x | | x | x | x |
| 9 | x | | x | | x |
| 10 | x | | | x | |
| 11 | x | x | | x | |
| 12 | x | | x | x | |
| 13 | x | | | x | x |
| 14 | x | x | | x | x |
| 15 | x | | x | x | x |
| 16 | x | | | | x |
| 17 | x | x | | | x |
| 18 | x | | x | | x |
| 19 | x | | | x | x |
| 20 | x | | x | x | x |
| 21 | x | x | | x | x |
| 22 | x | x | x | | x |
| 23 | | x | | | |
| 24 | | | x | | |
| 25 | | x | x | | |

In some embodiments, the vaterite and the one or more polymorphs, in the compositions provided herein, are in a vaterite:one or more polymorph ratio of greater than 1:1; or a ratio of greater than 2:1; or a ratio of greater than 3:1; or a ratio of greater than 4:1; or a ratio of greater than 5:1; or a ratio of greater than 6:1; or a ratio of greater than 7:1; or a ratio of greater than 8:1; or a ratio of greater than 9:1; or a ratio of greater than 10:1; or a ratio of greater than 11:1; or a ratio of greater than 12:1; or a ratio of greater than 13:1; or a ratio of greater than 14:1; or a ratio of greater than 15:1; or a ratio of greater than 16:1; or a ratio of greater than 17:1; or a ratio of greater than 18:1; or a ratio of greater than 19:1; or a ratio of greater than 20:1; or a ratio of 1:1 to 20:1; or a ratio of 1:1 to 18:1; or a ratio of 1:1 to 15:1; or a ratio of 1:1 to 10:1; or a ratio of 1:1 to 9:1; or a ratio of 1:1 to 8:1; or a ratio of 1:1 to 7:1; or a ratio of 1:1 to 6:1; or a ratio of 1:1 to 5:1; or a ratio of 1:1 to 4:1; or a ratio of 1:1 to 3:1; or a ratio of 1:1 to 2:1; or a ratio of 2:1 to 20:1; or a ratio of 2:1 to 15:1; or a ratio of 2:1 to 10:1; or a ratio of 2:1 to 9:1; or a ratio of 2:1 to 8:1; or a ratio of 2:1 to 7:1; or a ratio of 2:1 to 6:1; or a ratio of 2:1 to 5:1; or a ratio of 2:1 to 4:1; or a ratio of 2:1 to 3:1; or a ratio of 5:1 to 20:1; or a ratio of 5:1 to 15:1; or a ratio of 5:1 to 10:1; or a ratio of 5:1 to 8:1; or a ratio of 7:1 to 20:1; or a ratio of 7:1 to 15:1; or a ratio of 7:1 to 10:1; or a ratio of 7:1 to 9:1; or a ratio of 10:1 to 20:1; or a ratio of 10:1 to 15:1; or a ratio of 10:1 to 12:1; or a ratio of 15:1 to 20:1; or a ratio of 15:1 to 18:1; or a ratio of 1:1; or a ratio of 2:1; or a ratio of 3:1; or a ratio of 4:1; or a ratio of 5:1; or a ratio of 6:1; or a ratio of 7:1; or a ratio of 8:1; or a ratio of 9:1; or a ratio of 10:1; or a ratio of 11:1; or a ratio of 12:1; or a ratio of 13:1; or a ratio of 14:1; or a ratio of 15:1; or a ratio of 16:1; or a ratio of 17:1; or a ratio of 18:1; or a ratio of 19:1; or a ratio of 20:1.

In some embodiments, the vaterite and the polymorph in the compositions provided herein are in a vaterite:one or more polymorph ratio of less than 1:1; or 0.1:1; or 0.2:1; or 0.3:1; or 0.4:1; or 0.5:1; or 0.6:1; or 0.7:1; or 0.8:1; or 0.9:1; or 0.1:1-10:1; or 0.2:1-10:1; or 0.3:1-10:1; or 0.4:1-10:1; or 0.5:1-10:1; or 0.6:1-10:1; or 0.7:1-10:1; or 0.8:1-10:1; or 0.9:1-10:1.

In some embodiments of all of the aspects and embodiments recited herein, the composition includes 1% w/w to 85% w/w aragonite, 1% w/w to 85% w/w calcite, 1% w/w to 85% w/w ikaite, or combination thereof.

In some embodiments, the compositions in the aspects and embodiments recited herein, include at least 1% w/w ACC and at least 1% w/w aragonite; at least 1% w/w ACC and at least 1% w/w calcite; at least 1% w/w ACC and at least 1% w/w ikaite; at least 1% w/w aragonite and at least 1% w/w calcite; at least 1% w/w aragonite and at least 1% w/w ikaite; at least 1% w/w calcite and at least 1% w/w ikaite; at least 1% w/w ACC, at least 1% w/w aragonite, and at least 1% w/w calcite; at least 1% w/w ACC, at least 1% w/w aragonite, and at least 1% w/w ikaite; at least 1% w/w ACC, at least 1% w/w ikaite, and at least 1% w/w calcite; at least 1% w/w aragonite, at least 1% w/w calcite, and at least 1% w/w ikaite; at least 1% w/w ACC, at least 1% w/w aragonite, at least 1% w/w calcite, and at least 1% w/w ikaite.

In some embodiments, the compositions in the aspects and embodiments recited herein, includes at least 1% w/w to 90% w/w ACC and at least 1% w/w to 85% w/w aragonite; at least 1% w/w to 90% w/w ACC and at least 1% w/w to 85% w/w calcite; at least 1% w/w to 90% w/w ACC and at least 1% w/w to 85% w/w ikaite; at least 1% w/w to 85% w/w aragonite and at least 1% w/w to 85% w/w calcite; at least 1% w/w to 85% w/w aragonite and at least 1% w/w to 85% w/w ikaite; at least 1% w/w to 85% w/w calcite and at least 1% w/w to 85% w/w ikaite; at least 1% w/w to 90% w/w ACC, at least 1% w/w to 85% w/w aragonite, and at least 1% w/w to 85% w/w calcite; at least 1% w/w to 90% w/w ACC, at least 1% w/w to 85% w/w aragonite, and at least 1% w/w to 85% w/w ikaite; at least 1% w/w to 90% w/w ACC, at least 1% w/w to 85% w/w ikaite, and at least 1% w/w to 85% w/w calcite; at least 1% w/w to 85% w/w aragonite, at least 1% w/w to 85% w/w calcite, and at least 1% w/w to 85% w/w ikaite; at least 1% w/w to 90% w/w ACC, at least 1% w/w to 85% w/w aragonite, at least 1% w/w to 85% w/w calcite, and at least 1% w/w to 85% w/w ikaite.

In some embodiments of all of the aspects and embodiments recited herein, the compositions includes at least 1% w/w aragonite; or at least 2% w/w aragonite; or at least 5% w/w aragonite; or at least 10% w/w aragonite; or at least 20% w/w aragonite; or at least 30% w/w aragonite; or at least 40% w/w aragonite; or at least 50% w/w aragonite; or at least 60% w/w aragonite; or at least 70% w/w aragonite; or at least 80% w/w aragonite; or at least 85% w/w aragonite; or from 1% w/w to 85% w/w aragonite; or from 1% w/w to 80% w/w aragonite; or from 1% w/w to 70% w/w aragonite; or from 1% w/w to 60% w/w aragonite; or from 1% w/w to 50% w/w aragonite; or from 1% w/w to 40% w/w aragonite; or from 1% w/w to 30% w/w aragonite; or from 1% w/w to 20% w/w aragonite; or from 1% w/w to 10% w/w aragonite; or from 5% w/w to 85% w/w aragonite; or from 5% w/w to 80% w/w aragonite; or from 5% w/w to 70% w/w aragonite; or from 5% w/w to 60% w/w aragonite; or from 5% w/w to 50% w/w aragonite; or from 5% w/w to 40% w/w aragonite; or from 5% w/w to 30% w/w aragonite; or from 5% w/w to 20% w/w aragonite; or from 5% w/w to 10% w/w aragonite; or from 10% w/w to 85% w/w aragonite; or from 10% w/w to 80% w/w aragonite; or from 10% w/w to 70% w/w aragonite; or from 10% w/w to 60% w/w aragonite; or from 10% w/w to 50% w/w aragonite; or from 10% w/w to 40% w/w aragonite; or from 10% w/w to 30% w/w aragonite; or from 10% w/w to 20% w/w aragonite; or from 20% w/w to 85% w/w aragonite; or from 20% w/w to 80% w/w aragonite; or from 20% w/w to 70% w/w aragonite; or from 20% w/w to 60% w/w aragonite; or from 20% w/w to 50% w/w aragonite; or from 20% w/w to 40% w/w aragonite; or from 20% w/w to 30% w/w aragonite; or from 30% w/w to 85% w/w aragonite; or from 30% w/w to 80% w/w aragonite; or from 30% w/w to 70% w/w aragonite; or from 30% w/w to 60% w/w aragonite; or from 30% w/w to 50% w/w aragonite; or from 30% w/w to 40% w/w aragonite; or from 40% w/w to 85% w/w aragonite; or from 40% w/w to 80% w/w aragonite; or from 40% w/w to 70% w/w aragonite; or from 40% w/w to 60% w/w aragonite; or from 40% w/w to 50% w/w aragonite; or from 50% w/w to 85% w/w aragonite; or from 50% w/w to 80% w/w aragonite; or from 50% w/w to 70% w/w aragonite; or from 50% w/w to 60% w/w aragonite; or from 60% w/w to 85% w/w aragonite; or from 60% w/w to 80% w/w aragonite; or from 60% w/w to 70% w/w aragonite; or from 60% w/w to 65% w/w aragonite; or from 70% w/w to 85% w/w aragonite; or from 70% w/w to 80% w/w aragonite; or from 70% w/w to 75% w/w aragonite; or from 80% w/w to 85% w/w aragonite; or 1% w/w aragonite; or 2% w/w aragonite; or 5% w/w aragonite; or 10% w/w aragonite; or 20% w/w aragonite; or 30% w/w aragonite; or 40% w/w aragonite; or 50% w/w aragonite; or 60% w/w aragonite; or 70% w/w aragonite; or 80% w/w aragonite; or 85% w/w aragonite.

In some embodiments of all of the aspects and embodiments recited herein, the compositions includes at least 1% w/w calcite; or at least 2% w/w calcite; or at least 5% w/w calcite; or at least 10% w/w calcite; or at least 20% w/w calcite; or at least 30% w/w calcite; or at least 40% w/w calcite; or at least 50% w/w calcite; or at least 60% w/w calcite; or at least 70% w/w calcite; or at least 80% w/w calcite; or at least 85% w/w calcite; or from 1% w/w to 85% w/w calcite; or from 1% w/w to 80% w/w calcite; or from 1% w/w to 75% w/w calcite; or from 1% w/w to 70% w/w calcite; or from 1% w/w to 65% w/w calcite; or from 1% w/w to 60% w/w calcite; or from 1% w/w to 55% w/w calcite; or from 1% w/w to 50% w/w calcite; or from 1% w/w to 45% w/w calcite; or from 1% w/w to 40% w/w calcite; or from 1% w/w to 35% w/w calcite; or from 1% w/w to 30% w/w calcite; or from 1% w/w to 25% w/w calcite; or from 1% w/w to 20% w/w calcite; or from 1% w/w to 15% w/w calcite; or from 1% w/w to 10% w/w calcite; or from 5% w/w to 85% w/w calcite; or from 5% w/w to 80% w/w calcite; or from 5% w/w to 70% w/w calcite; or from 5% w/w to 60% w/w calcite; or from 5% w/w to 50% w/w calcite; or from 5% w/w to 40% w/w calcite; or from 5% w/w to 30% w/w calcite; or from 5% w/w to 20% w/w calcite; or from 5% w/w to 10% w/w calcite; or from 10% w/w to 85% w/w calcite; or from 10% w/w to 80% w/w calcite; or from 10% w/w to 70% w/w calcite; or from 10% w/w to 60% w/w calcite; or from 10% w/w to 50% w/w calcite; or from 10% w/w to 40% w/w calcite; or from 10% w/w to 30% w/w calcite; or from 10% w/w to 20% w/w calcite; or from 20% w/w to 85% w/w calcite; or from 20% w/w to 80% w/w calcite; or from 20% w/w to 70% w/w calcite; or from 20% w/w to 60% w/w calcite; or from 20% w/w to 50% w/w calcite; or from 20% w/w to 40% w/w calcite; or from 20% w/w to 30% w/w calcite; or from 30% w/w to 85% w/w calcite; or from 30% w/w to 80% w/w calcite; or from 30% w/w to 70% w/w calcite; or from 30% w/w to 60% w/w calcite; or from 30% w/w to 50% w/w calcite; or from 30% w/w to 40% w/w calcite; or from 40% w/w to 85% w/w calcite; or from 40% w/w to 80% w/w calcite; or from 40% w/w to 70% w/w calcite; or from 40% w/w to 60% w/w calcite; or from 40% w/w to 50% w/w calcite; or from 50% w/w to 85% w/w calcite; or from 50% w/w to 80% w/w calcite; or from 50% w/w to 70% w/w calcite; or from 50% w/w to 60% w/w calcite; or from 60% w/w to 85% w/w calcite; or from 60% w/w to 80% w/w calcite; or from 60% w/w to 70% w/w calcite; or from 60% w/w to 65% w/w calcite; or from 70% w/w to 85% w/w calcite; or from 70% w/w to 80% w/w calcite; or from 70% w/w to 75% w/w calcite; or from 80% w/w to 85% w/w calcite; or 1% w/w calcite; or 2% w/w calcite; or 5% w/w calcite; or 10% w/w calcite; or 20% w/w calcite; or 30% w/w calcite; or 40% w/w calcite; or 50% w/w calcite; or 60% w/w calcite; or 70% w/w calcite; or 80% w/w calcite; or 85% w/w calcite.

In some embodiments of all of the aspects and embodiments recited herein, the compositions includes at least 1% w/w ikaite; or at least 2% w/w ikaite; or at least 5% w/w ikaite; or at least 10% w/w ikaite; or at least 20% w/w ikaite; or at least 30% w/w ikaite; or at least 40% w/w ikaite; or at least 50% w/w ikaite; or at least 60% w/w ikaite; or at least 70% w/w ikaite; or at least 80% w/w ikaite; or at least 85% w/w ikaite; or from 1% w/w to 85% w/w ikaite; or from 1% w/w to 80% w/w ikaite; or from 1% w/w to 70% w/w ikaite; or from 1% w/w to 60% w/w ikaite; or from 1% w/w to 50% w/w ikaite; or from 1% w/w to 40% w/w ikaite; or from 1% w/w to 30% w/w ikaite; or from 1% w/w to 20% w/w ikaite; or from 1% w/w to 10% w/w ikaite; or from 5% w/w to 85% w/w ikaite; or from 5% w/w to 80% w/w ikaite; or from 5% w/w to 70% w/w ikaite; or from 5% w/w to 60% w/w ikaite; or from 5% w/w to 50% w/w ikaite; or from 5% w/w to 40% w/w ikaite; or from 5% w/w to 30% w/w ikaite; or from 5% w/w to 20% w/w ikaite; or from 5% w/w to 10% w/w ikaite; or from 10% w/w to 85% w/w ikaite; or from 10% w/w to 80% w/w ikaite; or from 10% w/w to 70% w/w ikaite; or from 10% w/w to 60% w/w ikaite; or from 10% w/w to 50% w/w ikaite; or from 10% w/w to 40% w/w ikaite; or from 10% w/w to 30% w/w ikaite; or from 10% w/w to 20% w/w ikaite; or from 20% w/w to 85% w/w ikaite; or from 20% w/w to 80% w/w ikaite; or from 20% w/w to 70% w/w ikaite; or from 20% w/w to 60% w/w ikaite; or from 20% w/w to 50% w/w ikaite; or from 20% w/w to 40% w/w ikaite; or from 20% w/w to 30% w/w ikaite; or from 30% w/w to 85% w/w ikaite; or from 30% w/w to 80% w/w ikaite; or from 30% w/w to 70% w/w ikaite; or from 30% w/w to 60% w/w ikaite; or from 30% w/w to 50% w/w ikaite; or from 30% w/w to 40% w/w ikaite; or from 40% w/w to 85% w/w ikaite; or from 40% w/w to 80% w/w ikaite; or from 40% w/w to 70% w/w ikaite; or from 40% w/w to 60% w/w ikaite; or from 40% w/w to 50% w/w ikaite; or from 50% w/w to 85% w/w ikaite; or from 50% w/w to 80% w/w ikaite; or from 50% w/w to 70% w/w ikaite; or from 50% w/w to 60% w/w ikaite; or from 60% w/w to 85% w/w ikaite; or from 60% w/w to 80% w/w ikaite; or from 60% w/w to 70% w/w ikaite; or from 60% w/w to 65% w/w ikaite; or from 70% w/w to 85% w/w ikaite; or from 70% w/w to 80% w/w ikaite; or from 70% w/w to 75% w/w ikaite; or from 80% w/w to 85% w/w ikaite; or 1% w/w ikaite; or 2% w/w ikaite; or 5% w/w ikaite; or 10% w/w ikaite; or 20% w/w ikaite; or 30% w/w ikaite; or 40% w/w ikaite; or 50% w/w ikaite; or 60% w/w ikaite; or 70% w/w ikaite; or 80% w/w ikaite; or 85% w/w ikaite.

It is to be understood that the total amount of the polymorphs in the compositions described herein, is between 10-100% w/w.

The compositions of the invention including a carbonate, bicarbonate, or mixture thereof, where carbonate minerals include, but are not limited to: calcium carbonate minerals, magnesium carbonate minerals and calcium magnesium carbonate minerals. Calcium carbonate minerals in the composition of the invention include, but are not limited to: vaterite alone or in combination with calcite, aragonite, ikaite, amorphous calcium carbonate, a precursor phase of vaterite, a precursor phase of aragonite, an intermediary phase that is less stable than calcite, polymorphic forms in between these polymorphs, or combination thereof. These carbonate minerals may also be present in combination with magnesium carbonate minerals. Magnesium carbonate minerals include, but are not limited to, magnesite (MgCO₃), barringtonite (MgCO₃.2H₂O), nesquehonite (MgCO₃.3H₂O), lanfordite (MgCO₃.5H₂O) and amorphous magnesium calcium carbonate (MgCO₃.nH₂O). The carbonate minerals in the composition of the invention may also be present in combination with calcium magnesium carbonate minerals which include, but are not limited to, dolomite (CaMgCO₃), huntitte (CaMg(CO₃)₄) and sergeevite (Ca₂Mg₁₁(CO₃)₁₃.H₂O). Other calcium mineral that may be present in the composition of the invention, is portlandite (Ca(OH)₂), and amorphous hydrated analogs thereof. Other magnesium mineral that may be present in the composition of the invention, is brucite (Mg(OH)₂), and amorphous hydrated analogs thereof.

In some embodiments, the above recited one or more elements are present in a crystal lattice of the vaterite. In some embodiments, the above recited one or more elements are present in a crystal lattice of the aragonite. In some embodiments, the above recited one or more elements are present in a crystal lattice of the calcite. In some embodiments, the above recited one or more elements are present in a crystal lattice of the ikaite. In some embodiments, the above recited one or more elements are present in a crystal lattice of one or more of vaterite, aragonite, calcite, and ikaite.

The composition has, in certain embodiments, a calcium/magnesium ratio that is influenced by, and therefore reflects, the water source from which it has been precipitated, e.g., seawater, which contains more magnesium than calcium, or, e.g., certain brines, which may contain one-hundred-fold the calcium content as seawater. The calcium/magnesium ratio also reflects factors such as the addition of calcium and/or magnesium-containing substances during the production process, e.g., the use of flyash, red mud, slag, or other calcium and/or magnesium-containing industrial wastes, or the presence of calcium and/or magnesium-containing minerals in the carbonate brines, such as mafic and ultramafic minerals, such as serpentine, olivine, and the like. Because of the large variation in raw materials as well as materials added during production, the calcium/magnesium molar ratio may vary widely in various embodiments of the compositions and methods of the invention, and indeed in certain embodiment the ratio may be adjusted according to the intended use of the composition.

In some embodiments of all of the above recited aspects and embodiments, the composition further includes magnesium (Mg). In some embodiments, Mg is present as magnesium carbonate. In some embodiments, a ratio of calcium and magnesium (Ca:Mg) is greater than 1:1; or a ratio of greater than 2:1; or a ratio of greater than 3:1; or a ratio of greater than 4:1; or a ratio of greater than 5:1; or a ratio of greater than 6:1; or a ratio of greater than 7:1; or a ratio of greater than 8:1; or a ratio of greater than 9:1; or a ratio of greater than 10:1; or a ratio of greater than 15:1; or a ratio of greater than 20:1; or a ratio of greater than 30:1; or a ratio of greater than 40:1; or a ratio of greater than 50:1; or a ratio of greater than 60:1; or a ratio of greater than 70:1; or a ratio of greater than 80:1; or a ratio of greater than 90:1; or a ratio of greater than 100:1; or a ratio of greater than 150:1; or a ratio of greater than 200:1; or a ratio of greater than 250:1; or a ratio of greater than 300:1; or a ratio of greater than 350:1; or a ratio of greater than 400:1; or a ratio of greater than 450:1; or a ratio of greater than 500:1; or a ratio of 1:1 to 500:1; or a ratio of 1:1 to 450:1; or a ratio of 1:1 to 400:1; or a ratio of 1:1 to 350:1; or a ratio of 1:1 to 300:1; or a ratio of 1:1 to 250:1; or a ratio of 1:1 to 200:1; or a ratio of 1:1 to 150:1; or a ratio of 1:1 to 100:1; or a ratio of 1:1 to 50:1; or a ratio of 1:1 to 25:1; or a ratio of 1:1 to 10:1; or a ratio of 5:1 to 500:1; or a ratio of 5:1 to 450:1; or a ratio of 5:1 to 400:1; or a ratio of 5:1 to 350:1; or a ratio of 5:1 to 300:1; or a ratio of 5:1 to 250:1; or a ratio of 5:1 to 200:1; or a ratio of 5:1 to 150:1; or a ratio of 5:1 to 100:1; or a ratio of 5:1 to 50:1; or a ratio of 5:1 to 25:1; or a ratio of 5:1 to 10:1; or a ratio of 10:1 to 500:1; or a ratio of 10:1 to 450:1; or a ratio of 10:1 to 400:1; or a ratio of 10:1 to 350:1; or a ratio of 10:1 to 300:1; or a ratio of 10:1 to 250:1; or a ratio of 10:1 to 200:1; or a ratio of 10:1 to 150:1; or a ratio of 10:1 to 100:1; or a ratio of 10:1 to 50:1; or a ratio of 10:1 to 25:1; or a ratio of 20:1 to 500:1; or a ratio of 20:1 to 450:1; or a ratio of 20:1 to 400:1; or a ratio of 20:1 to 350:1; or a ratio of 20:1 to 300:1; or a ratio of 20:1 to 250:1; or a ratio of 20:1 to 200:1; or a ratio of 20:1 to 150:1; or a ratio of 20:1 to 100:1; or a ratio of 20:1 to 50:1; or a ratio of 20:1 to 25:1; or a ratio of 50:1 to 500:1; or a ratio of 50:1 to 450:1; or a ratio of 50:1 to 400:1; or a ratio of 50:1 to 350:1; or a ratio of 50:1 to 300:1; or a ratio of 50:1 to 250:1; or a ratio of 50:1 to 200:1; or a ratio of 50:1 to 150:1; or a ratio of 50:1 to 100:1; or a ratio of 100:1 to 500:1; or a ratio of 100:1 to 450:1; or a ratio of 100:1 to 400:1; or a ratio of 100:1 to 350:1; or a ratio of 100:1 to 300:1; or a ratio of 100:1 to 250:1; or a ratio of 100:1 to 200:1; or a ratio of 100:1 to 150:1; or a ratio of 200:1 to 500:1; or a ratio of 200:1 to 450:1; or a ratio of 200:1 to 400:1; or a ratio of 200:1 to 350:1; or a ratio of 200:1 to 300:1; or a ratio of 200:1 to 250:1; or a ratio of 300:1 to 500:1; or a ratio of 300:1 to 450:1; or a ratio of 300:1 to 400:1; or a ratio of 300:1 to 350:1; or a ratio of 400:1 to 500:1; or a ratio of 400:1 to 450:1; or a ratio of 1:1; or a ratio of 2:1; or a ratio of 3:1; or a ratio of 4:1; or a ratio of 5:1; or a ratio of 6:1; or a ratio of 7:1; or a ratio of 8:1; or a ratio of 9:1; or a ratio of 10:1; or a ratio of 11:1; or a ratio of 15:1; or a ratio of 20:1; or a ratio of 30:1; or a ratio of 40:1; or a ratio of 50:1; or a ratio of 60:1; or a ratio of 70:1; or a ratio of 80:1; or a ratio of 90:1; or a ratio of 100:1; or a ratio of 150:1; or a ratio of 200:1; or a ratio of 250:1; or a ratio of 300:1; or a ratio of 350:1; or a ratio of 400:1; or a ratio of 450:1; or a ratio of 500:1. In some embodiments, the ratio of calcium and magnesium (Ca:Mg) is between 2:1 to 5:1, or greater than 4:1, or 4:1. In some embodiments, the ratios herein are molar ratios or weight (such as, grams, mg or ppm) ratios.

In some embodiments, the amount of Mg present in the compositions provided herein is less than 2% w/w; or less than 1.5% w/w; or less than 1% w/w; or less than 0.5% w/w; or less than 0.1% w/w; or between 0.1% w/w Mg to 5% w/w Mg; or between 0.1% w/w Mg to 2% w/w Mg; or between 0.1% w/w Mg to 1.5% w/w Mg; or between 0.1% w/w Mg to 1% w/w Mg; or between 0.1% w/w Mg to 0.5% w/w Mg. In some embodiments, no Mg is present in the composition of the invention.

Alternatively, in some embodiments, the ratio of calcium to magnesium (Ca:Mg) is 0.1; or 0.2; or 0.3; or 0.4; or 0.5.

In some embodiments, the compositions provided herein further include sodium. In such compositions, the sodium is present in an amount less than 100,000 ppm; or less than 80,000 ppm; or less than 50,000 ppm; or less than 20,000 ppm; or less than 15,000 ppm; or less than 10,000 ppm; or less than 5,000 ppm; or less than 1,000 ppm; or less than 500 ppm; or less than 400 ppm; or less than 300 ppm; or less than 200 ppm; or less than 100 ppm; or between 100 ppm to 100,000 ppm; or between 100 ppm to 50,000 ppm; or between 100 ppm to 30,000 ppm; or between 100 ppm to 20,000 ppm; or between 100 ppm to 15,000 ppm; or between 100 ppm to 10,000 ppm; or between 100 ppm to 5,000 ppm; or between 100 ppm to 1,000 ppm; or between 100 ppm to 500 ppm; or between 100 ppm to 400 ppm; or between 100 ppm to 300 ppm; or between 100 ppm to 200 ppm; or between 500 ppm to 100,000 ppm; or between 500 ppm to 50,000 ppm; or between 500 ppm to 30,000 ppm; or between 500 ppm to 20,000 ppm; or between 500 ppm to 15,000 ppm; or between 500 ppm to 10,000 ppm; or between 500 ppm to 5,000 ppm; or between 500 ppm to 1,000 ppm; or between 1000 ppm to 100,000 ppm; or between 1000 ppm to 50,000 ppm; or between 1000 ppm to 30,000 ppm; or between 1000 ppm to 20,000 ppm; or between 1000 ppm to 15,000 ppm; or between 1000 ppm to 10,000 ppm; or between 1000 ppm to 5,000 ppm; or between 5000 ppm to 100,000 ppm; or between 5000 ppm to 50,000 ppm; or between 10,000 ppm to 100,000 ppm; or between 10,000 ppm to 50,000 ppm; or between 50,000 ppm to 100,000 ppm; or between 1 ppm to 100 ppm; or 20,000 ppm; or 15,000 ppm; or 10,000 ppm; or 5,000 ppm; or 1,000 ppm; or 500 ppm; or 400 ppm; or 300 ppm; or 200 ppm; or 100 ppm.

In some embodiments, the compositions of the invention do not include calcium phosphate. In some embodiments, the compositions of the invention include calcium phosphate. In such compositions, the calcium phosphate is in an amount of less than 1,000 ppm; or less than 500 ppm; or less than 400 ppm; or less than 300 ppm; or less than 200 ppm; or less than 100 ppm; or between 100 ppm to 1,000 ppm; or between 100 ppm to 500 ppm; or between 100 ppm to 400 ppm; or between 100 ppm to 300 ppm; or between 100 ppm to 200 ppm; or between 1 ppm to 100 ppm; or 1,000 ppm; or 500 ppm; or 400 ppm; or 300 ppm; or 200 ppm; or 100 ppm.

In some embodiments, the composition provided herein is a particulate composition with an average particle size of 0.1-100 microns. The average particle size may be determined using any conventional particle size determination method, such as, but is not limited to, multi-detector laser scattering or sieving (i.e. <38 microns). In certain embodiments, unimodel or multimodal, e.g., bimodal or other, distributions are present. Bimodal distributions allow the surface area to be minimized, thus allowing a lower liquids/solids mass ratio for the cement yet providing smaller reactive particles for early reaction. In such instances, the average particle size of the larger size class can be upwards of 1000 microns (1 mm). In some embodiments, the composition provided herein is a particulate composition with an average particle size of 0.1-1000 microns; or 0.1-900 microns; or 0.1-800 microns; or 0.1-700 microns; or 0.1-600 microns; or 0.1-500 microns; or 0.1-400 microns; or 0.1-300 microns; or 0.1-200 microns; or 0.1-100 microns; or 0.1-90 microns; or 0.1-80 microns; or 0.1-70 microns; or 0.1-60 microns; or 0.1-50 microns; or 0.1-40 microns; or 0.1-30 microns; or 0.1-20 microns; or 0.1-10 microns; or 0.1-8 microns; or 0.1-5 microns; or 0.5-100 microns; or 0.5-90 microns; or 0.5-80 microns; or 0.5-70 microns; or 0.5-60 microns; or 0.5-50 microns; or 0.5-40 microns; or 0.5-30 microns; or 0.5-20 microns; or 0.5-10 microns; or 0.5-5 microns; or 1-100 microns; or 1-90 microns; or 1-80 microns; or 1-70 microns; or 1-60 microns; or 1-50 microns; or 1-40 microns; or 1-30 microns; or 1-20 microns; or 1-10 microns; or 1-5 microns; or 3-100 microns; or 3-90 microns; or 3-80 microns; or 3-70 microns; or 3-60 microns; or 3-50 microns; or 3-40 microns; or 3-30 microns; or 3-20 microns; or 3-10 microns; or 3-8 microns; or 3-6 microns; or 5-100 microns; or 5-90 microns; or 5-80 microns; or 5-70 microns; or 5-60 microns; or 5-50 microns; or 5-40 microns; or 5-30 microns; or 5-20 microns; or 5-10 microns; or 5-8 microns; or 8-100 microns; or 8-90 microns; or 8-80 microns; or 8-70 microns; or 8-60 microns; or 8-50 microns; or 8-40 microns; or 8-30 microns; or 8-20 microns; or 8-10 microns; or 10-100 microns; or 10-90 microns; or 10-80 microns; or 10-70 microns; or 10-60 microns; or 10-50 microns; or 10-40 microns; or 10-30 microns; or 10-20 microns; or 10-15 microns; or 15-100 microns; or 15-90 microns; or 15-80 microns; or 15-70 microns; or 15-60 microns; or 15-50 microns; or 15-40 microns; or 15-30 microns; or 15-20 microns; or 20-100 microns; or 20-90 microns; or 20-80 microns; or 20-70 microns; or 20-60 microns; or 20-50 microns; or 20-40 microns; or 20-30 microns; or 30-100 microns; or 30-90 microns; or 30-80 microns; or 30-70 microns; or 30-60 microns; or 30-50 microns; or 30-40 microns; or 40-100 microns; or 40-90 microns; or 40-80 microns; or 40-70 microns; or 40-60 microns; or 40-50 microns; or 50-100 microns; or 50-90 microns; or 50-80 microns; or 50-70 microns; or 50-60 microns; or 60-100 microns; or 60-90 microns; or 60-80 microns; or 60-70 microns; or 70-100 microns; or 70-90 microns; or 70-80 microns; or 80-100 microns; or 80-90 microns; or 0.1 microns; or 0.5 microns; or 1 microns; or 2 microns; or 3 microns; or 4 microns; or 5 microns; or 8 microns; or 10 microns; or 15 microns; or 20 microns; or 30 microns; or 40 microns; or 50 microns; or 60 microns; or 70 microns; or 80 microns; or 100 microns. For example, in some embodiments, the composition provided herein is a particulate composition with an average particle size of 0.1-20 micron; or 0.1-15 micron; or 0.1-10 micron; or 0.1-8 micron; or 0.1-5 micron; or 1-5 micron; or 5-10 micron.

In some embodiments, the composition includes one or more different sizes of the particles in the composition. In some embodiments, the composition includes two or more, or three or more, or four or more, or five or more, or ten or more, or 20 or more, or 3-20, or 4-10 different sizes of the particles in the composition. For example, the composition may include two or more, or three or more, or between 3-20 particles ranging from 0.1-10 micron, 10-50 micron, 50-100 micron, 100-200 micron, 200-500 micron, 500-1000 micron, and/or sub-micron sizes of the particles.

In some embodiments, the composition of the invention may include different morphologies of the particles, such as, but not limited to, fine or disperse and large or agglomerated.

The bulk density of the composition in the powder form or after the setting and/or hardening of the cement may vary. In some embodiments, the composition provided herein has a bulk density of between 75 lb/ft³-170 lb/ft³; or between 75 lb/ft³-160 lb/ft³; or between 75 lb/ft³-150 lb/ft³; or between 75 lb/ft³-140 lb/ft³; or between 75 lb/ft³-130 lb/ft³; or between 75 lb/ft³-125 lb/ft³; or between 75 lb/ft³-120 lb/ft³; or between 75 lb/ft³-110 lb/ft³; or between 75 lb/ft³-100 lb/ft³; or between 75 lb/ft³-90 lb/ft³; or between 75 lb/ft³-80 lb/ft³; or between 80 lb/ft³-170 lb/ft³; or between 80 lb/ft³-160 lb/ft³; or between 80 lb/ft³-150 lb/ft³; or between 80 lb/ft³-140 lb/ft³; or between 80 lb/ft³-130 lb/ft³; or between 80 lb/ft³-125 lb/ft³; or between 80 lb/ft³-120 lb/ft³; or between 80 lb/ft³-110 lb/ft³; or between 80 lb/ft³-100 lb/ft³; or between 80 lb/ft³-90 lb/ft³; or between 90 lb/ft³-170 lb/ft³; or between 90 lb/ft³-160 lb/ft³; or between 90 lb/ft³-150 lb/ft³; or between 90 lb/ft³-140 lb/ft³; or between 90 lb/ft³-130 lb/ft³; or between 90 lb/ft³-125 lb/ft³; or between 90 lb/ft³-120 lb/ft³; or between 90 lb/ft³-110 lb/ft³; or between 90 lb/ft³-100 lb/ft³; or between 90 lb/ft³-90 lb/ft³; or between 100 lb/ft³-170 lb/ft³; or between 100 lb/ft³-160 lb/ft³; or between 100 lb/ft³-150 lb/ft³; or between 100 lb/ft³-140 lb/ft³; or between 100 lb/ft³-130 lb/ft³; or between 100 lb/ft³-125 lb/ft³; or between 100 lb/ft³-120 lb/ft³; or between 100 lb/ft³-110 lb/ft³; or between 110 lb/ft³-170 lb/ft³; or between 110 lb/ft³-160 lb/ft³; or between 110 lb/ft³-150 lb/ft³; or between 110 lb/ft³-140 lb/ft³; or between 110 lb/ft³-130 lb/ft³; or between 110 lb/ft³-125 lb/ft³; or between 110 lb/ft³-120 lb/ft³; or between 120 lb/ft³-170 lb/ft³; or between 120 lb/ft³-160 lb/ft³; or between 120 lb/ft³-150 lb/ft³; or between 120 lb/ft³-140 lb/ft³; or between 120 lb/ft³-130 lb/ft³; or between 120 lb/ft³-125 lb/ft³; or between 130 lb/ft³-170 lb/ft³; or between 130 lb/ft³-160 lb/ft³; or between 130 lb/ft³-150 lb/ft³; or between 130 lb/ft³-140 lb/ft³; or between 140 lb/ft³-170 lb/ft³; or between 140 lb/ft³-160 lb/ft³; or between 140 lb/ft³-150 lb/ft³; or between 150 lb/ft³-170 lb/ft³; or between 150 lb/ft³-160 lb/ft³; or between 160 lb/ft³-170 lb/ft³; or 75 lb/ft³; or 80 lb/ft³; or 85 lb/ft³; or 90 lb/ft³; or 95 lb/ft³; or 100 lb/ft³; or 110 lb/ft³; or 120 lb/ft³; or 130 lb/ft³; or 140 lb/ft³; or 150 lb/ft³; or 160 lb/ft³; or 170 lb/ft³.

The surface area of the components making up the cement may vary. In some embodiments, the compositions of the invention have an average surface area sufficient to provide for a liquid to solids ratio (as described herein) upon combination with a liquid to produce a settable composition. In some embodiments, an average surface area ranges from 0.5 m²/gm-50 m²/gm. The surface area may be determined using the surface area determination protocol described in Breunner, Emmit and Teller (BET) surface area analysis. In some embodiments, the composition provided herein has an average surface area of from 0.5 m²/gm-50 m²/gm; or from 0.5 m²/gm-45 m²/gm; or from 0.5 m²/gm-40 m²/gm; or from 0.5 m²/gm-35 m²/gm; or from 0.5 m²/gm-30 m²/gm; or from 0.5 m²/gm-25 m²/gm; or from 0.5 m²/gm-20 m²/gm; or from 0.5 m²/gm-15 m²/gm; or from 0.5 m²/gm-10 m²/gm; or from 0.5 m²/gm-5 m²/gm; or from 0.5 m²/gm-4 m²/gm; or from 0.5 m²/gm-2 m²/gm; or from 0.5 m²/gm-1 m²/gm; or from 1 m²/gm-50 m²/gm; or from 1 m²/gm-45 m²/gm; or from 1 m²/gm-40 m²/gm; or from 1 m²/gm-35 m²/gm; or from 1 m²/gm-30 m²/gm; or from 1 m²/gm-25 m²/gm; or from 1 m²/gm-20 m²/gm; or from 1 m²/gm-15 m²/gm; or from 1 m²/gm-10 m²/gm; or from 1 m²/gm-5 m²/gm; or from 1 m²/gm-4 m²/gm; or from 1 m²/gm-2 m²/gm; or from 2 m²/gm-50 m²/gm; or from 2 m²/gm-45 m²/gm; or from 2 m²/gm-40 m²/gm; or from 2 m²/gm-35 m²/gm; or from 2 m²/gm-30 m²/gm; or from 2 m²/gm-25 m²/gm; or from 2 m²/gm-20 m²/gm; or from 2 m²/gm-15 m²/gm; or from 2 m²/gm-10 m²/gm; or from 2 m²/gm-5 m²/gm; or from 2 m²/gm-4 m²/gm; or from 5 m²/gm-50 m²/gm; or from 5 m²/gm-45 m²/gm; or from 5 m²/gm-40 m²/gm; or from 5 m²/gm-35 m²/gm; or from 5 m²/gm-30 m²/gm; or from 5 m²/gm-25 m²/gm; or from 5 m²/gm-20 m²/gm; or from 5 m²/gm-15 m²/gm; or from 5 m²/gm-10 m²/gm; or from 8 m²/gm-50 m²/gm; or from 8 m²/gm-45 m²/gm; or from 8 m²/gm-40 m²/gm; or from 8 m²/gm-35 m²/gm; or from 8 m²/gm-30 m²/gm; or from 8 m²/gm-25 m²/gm; or from 8 m²/gm-20 m²/gm; or from 8 m²/gm-15 m²/gm; or from 8 m²/gm-10 m²/gm; or from 10 m²/gm-50 m²/gm; or from 10 m²/gm-45 m²/gm; or from 10 m²/gm-40 m²/gm; or from 10 m²/gm-35 m²/gm; or from 10 m²/gm-30 m²/gm; or from 10 m²/gm-25 m²/gm; or from 10 m²/gm-20 m²/gm; or from 10 m²/gm-15 m²/gm; or from 15 m²/gm-50 m²/gm; or from 15 m²/gm-45 m²/gm; or from 15 m²/gm-40 m²/gm; or from 15 m²/gm-35 m²/gm; or from 15 m²/gm-30 m²/gm; or from 15 m²/gm-25 m²/gm; or from 15 m²/gm-20 m²/gm; or from 20 m²/gm-50 m²/gm; or from 20 m²/gm-45 m²/gm; or from 20 m²/gm-40 m²/gm; or from 20 m²/gm-35 m²/gm; or from 20 m²/gm-30 m²/gm; or from 20 m²/gm-25 m²/gm; or from 30 m²/gm-50 m²/gm; or from 30 m²/gm-45 m²/gm; or from 30 m²/gm-40 m²/gm; or from 30 m²/gm-35 m²/gm; or from 40 m²/gm-50 m²/gm; or from 40 m²/gm-45 m²/gm; or 0.5 m²/gm; or 1 m²/gm; or 2 m²/gm; or 5 m²/gm; or 10 m²/gm; or 15 m²/gm; or 20 m²/gm; or 30 m²/gm; or 40 m²/gm; or 50 m²/gm.

In some embodiments, in the foregoing aspects and the foregoing embodiments, the composition comprises a zeta potential of greater than −25 millivolts (mV) or between −25 to 45 mV. Zeta potential is the potential difference between the dispersion medium and the stationary layer of fluid attached to the dispersed particle. The zeta potential indicates a degree of repulsion between adjacent similar particles in the dispersion. When the zeta potential is high, the particles may repel and resist aggregation resulting in high dispersion of the particles in the medium. When the zeta potential is low, the attraction may exceed repulsion causing the dispersion to break and particles to flocculate. Without being bound by any theory, it is proposed that the high dispersion of the particles in the compositions of the invention may facilitate the SCM properties of the composition where the SCM composition does not flocculate readily and can be added to Portland cement as SCM. The low dispersion of the particles in the composition may cause setting and hardening of the composition making the cement suitable as the hydraulic cement. The low dispersion of the particles in the composition may also cause setting and hardening of the composition making the cement suitable as the self-cementing material. The experimental techniques to determine the zeta potential are well known in the art and include, but are not limited to, electrophoresis such as microelectrophoresis and electrophoretic light scattering.

In some embodiments, in the foregoing aspects and the foregoing embodiments, the composition has a zeta potential of greater than −20 mV; or greater than −15 mV; or greater than −10 mV; or greater than −5 mV; or greater than −1 mV; or greater than 1 mV; or greater than 2 mV; or greater than 3 mV; or greater than 5 mV; or greater than 10 mV; or greater than 15 mV; or greater than 20 mV; or greater than 25 mV; or greater than 30 mV; or greater than 35 mV; or greater than 40 mV; or greater than 45 mV; or greater than 50 mV; or less than 45 mV; or less than 40 mV; or less than 35 mV; or less than 30 mV; or less than 25 mV; or less than 20 mV; or less than 15 mV; or less than 10 mV; or less than 5 mV; or less than 1 mV; or less than −1 mV; or less than −5 mV; or less than −10 mV; or less than −20 mV; or less than −25 mV; or between +50 mV to −25 mV; or between +45 mV to −25 mV; or between +40 mV to −25 mV; or between +35 mV to −25 mV; or between +30 mV to −25 mV; or between +25 mV to −25 mV; or between +20 mV to −25 mV; or between +15 mV to −25 mV; or between +10 mV to −25 mV; or between +5 mV to −25 mV; or between +1 mV to −25 mV; or between −1 mV to −25 mV; or between −5 mV to −25 mV; or between −10 mV to −25 mV; or between −15 mV to −25 mV; or between −20 mV to −25 mV; or between +20 mV to −20 mV; or between +15 mV to −20 mV; or between +10 mV to −20 mV; or between +5 mV to −20 mV; or between +1 mV to −20 mV; or between −1 mV to −20 mV; or between −5 mV to −20 mV; or between −10 mV to −20 mV; or between −15 mV to −20 mV; or between +25 mV to −10 mV; or between +20 mV to −10 mV; or between +15 mV to −10 mV; or between +10 mV to −10 mV; or between +5 mV to −10 mV; or between +1 mV to −10 mV; or between −1 mV to −10 mV; or between −5 mV to −10 mV; or between −15 mV to −10 mV; or between −25 mV to −10 mV; or between +25 mV to −5 mV; or between +20 mV to −5 mV; or between +15 mV to −5 mV; or between +10 mV to −5 mV; or between +5 mV to −5 mV; or between +1 mV to −5 mV; or between −1 mV to −5 mV; or between −10 mV to −5 mV; or between −15 mV to −5 mV; or between −20 mV to −5 mV; or between −25 mV to −5 mV; or between +25 mV to −1 mV; or between +20 mV to −1 mV; or between +15 mV to −1 mV; or between +10 mV to −1 mV; or between +5 mV to −1 mV; or between +1 mV to −1 mV; or between −5 mV to −1 mV; or between −10 mV to −1 mV; or between −15 mV to −1 mV; or between −20 mV to −1 mV; or between −25 mV to −1 mV; or between 25 mV to 5 mV; or between 20 mV to 5 mV; or between 15 mV to 5 mV; or between 10 mV to 5 mV; or between 1 mV to 5 mV; or between −1 mV to +5 mV; or between −5 mV to +5 mV; or between −10 mV to +5 mV; or between −15 mV to +5 mV; or between −20 mV to +5 mV; or between −25 mV to +5 mV; or between 25 mV to 10 mV; or between 20 mV to 10 mV; or between 15 mV to 10 mV; or between 5 mV to 10 mV; or between 1 mV to 10 mV; or between −1 mV to +10 mV; or between −5 mV to +10 mV; or between −10 mV to +10 mV; or between −15 mV to +10 mV; or between −20 mV to +10 mV; or between −25 mV to +10 mV; or between 25 mV to 20 mV; or between 15 mV to 20 mV; or between 10 mV to 20 mV; or between 5 mV to 20 mV; or between 1 mV to 20 mV; or between −1 mV to +20 mV; or between −5 mV to +20 mV; or between −10 mV to +20 mV; or between −15 mV to +20 mV; or between −20 mV to +20 mV; or between −25 mV to +20 mV; or between 20 mV to 25 mV; or between 15 mV to 25 mV; or between 10 mV to 25 mV; or between 5 mV to 25 mV; or between 1 mV to 25 mV; or between −1 mV to +25 mV; or between −5 mV to +25 mV; or between −10 mV to +25 mV; or between −15 mV to +25 mV; or between −20 mV to +25 mV. For example, the foregoing aspects and the foregoing embodiments, the composition includes a zeta potential of between 10 mV to 45 mV; or between 15 mV to 45 mV; or between 20 mV to 45 mV; or between 25 mV to 45 mV; or between 30 mV to 45 mV; or between 35 mV to 45 mV; or between 40 mV to 45 mV. In some embodiments, the composition of the invention includes a mix of particles with different zeta potential. For example, two or more, or three or more particles, or 3-20 particles in the composition may have different zeta potentials. In some embodiments, the zeta potential herein is an average zeta potential of the composition.

In some embodiments, a ratio of calcium to carbonate in the composition may affect the zeta potential of the composition. Without being limited by any theory, it is proposed that the higher ratio of calcium to the carbonate may result in a higher zeta potential or a positive zeta potential, and the lower ratio of the calcium to the carbonate may result in a lower zeta potential or a negative zeta potential. In some embodiments, the ratio of calcium or calcium ion with the carbonate or the carbonate ion in the composition (calcium:carbonate) is greater than 1:1; or greater than 1.5:1; or greater than 2:1; or greater than 2.5:1; or greater than 3:1; or greater than 3.5:1; or greater than 4:1; or greater than 4.5:1; or greater than 5:1; or is in a range of 1:1 to 5:1; or is in a range of 1.5:1 to 5:1; or is in a range of 2:1 to 5:1; or is in a range of 3:1 to 5:1; or is in a range of 4:1 to 5:1; or is in a range of 1:1 to 4:1; or is in a range of 1.5:1 to 4:1; or is in a range of 2:1 to 4:1; or is in a range of 3:1 to 4:1; or is in a range of 1:1 to 3:1; or is in a range of 1.5:1 to 3:1; or is in a range of 2:1 to 3:1; or is in a range of 1:1 to 2:1; or is in a range of 1.5:1 to 2:1; or is in a range of 1.5:1 to 1:1; or is 1:1; or is 1.5:1; or is 2:1; or is 2.5:1; or is 3:1; or is 3.5:1; or is 4:1; or is 4.5:1; or is 5:1. In some embodiments, the ratio of calcium to carbonate (calcium:carbonate) in the composition is 1.5:1, or 1:1, or 2:1.

In some embodiments, the ratio of carbonate or the carbonate ion with the calcium or calcium ion (carbonate:calcium) in the composition is greater than 1:1; or greater than 1.5:1; or greater than 2:1; or greater than 2.5:1; or greater than 3:1; or greater than 3.5:1; or greater than 4:1; or greater than 4.5:1; or greater than 5:1; or is in a range of 1:1 to 5:1; or is in a range of 1.5:1 to 5:1; or is in a range of 2:1 to 5:1; or is in a range of 3:1 to 5:1; or is in a range of 4:1 to 5:1; or is in a range of 1:1 to 4:1; or is in a range of 1.5:1 to 4:1; or is in a range of 2:1 to 4:1; or is in a range of 3:1 to 4:1; or is in a range of 1:1 to 3:1; or is in a range of 1.5:1 to 3:1; or is in a range of 2:1 to 3:1; or is in a range of 1:1 to 2:1; or is in a range of 1.5:1 to 2:1; or is in a range of 1.5:1 to 1:1; or is 1:1; or is 1.5:1; or is 2:1; or is 2.5:1; or is 3:1; or is 3.5:1; or is 4:1; or is 4.5:1; or is 5:1. In some embodiments, the ratio of carbonate to calcium (carbonate:calcium) in the composition is 1.5:1, or 1:1, or 2:1.

In some embodiments, the composition of the invention comprises a ratio of the carbonate to the hydroxide (carbonate:hydroxide) in a range of 100:1; or 10:1 or 1:1.

In some embodiments, the compositions contain polymorphs of carbonates in combination with bicarbonates, e.g., of divalent cations such as calcium or magnesium; in some cases the composition contains substantially all polymorphs of carbonates, or substantially all bicarbonates, or some ratio of polymorphs of carbonate to bicarbonate. The molar ratio of carbonates:bicarbonates may be any suitable ratio, such as 500/1 to 100/1; 100/1 to 1/100, or 50/1 to 1/50, or 25/1 to 1/25, or 10/1 to 1/10, or 2/1 to 1/2, or about 1/1, or substantially all carbonate or substantially all bicarbonate.

In some embodiments, when the compositions of the invention are derived from a saltwater source, they may include one or more components that are present in the saltwater source which may help in identifying the compositions that come from the saltwater source. These identifying components and the amounts thereof are collectively referred to herein as a saltwater source identifier or “markers”. For example, if the saltwater source is sea water, identifying component that may be present in the composition include, but are not limited to: chloride, sodium, sulfur, potassium, bromide, silicon, strontium and the like. Any such source-identifying or marker elements are generally present in small amounts, e.g., in amounts of 20,000 ppm or less, such as amounts of 2000 ppm or less. In certain embodiments, the marker compounds are strontium or magnesium. The saltwater source identifier of the compositions may vary depending on the particular saltwater source employed to produce the saltwater-derived composition. In some embodiments, the composition is characterized by having a water source identifying carbonate to hydroxide compound ratio, where in certain embodiments the carbonate:hydroxide ratio ranges from 100 to 1, such as 10 to 1 and including 1 to 1.

In some embodiments, the compositions provided herein further include one or more additional components including, but are not limited to, blast furnace slag, fly ash, diatomaceous earth, and other natural or artificial pozzolans, silica fumes, limestone, gypsum, hydrated lime, air entrainers, retarders, waterproofers and coloring agents. These components may be added to modify the properties of the cement, e.g., to provide desired strength attainment, to provide desired setting times, etc. The amount of such components present in a given composition of the invention may vary, and in certain embodiments, the amounts of these components range from 1 to 50% w/w, or 10% w/w to 50% w/w, such as 2 to 10% w/w.

In some embodiments, silica minerals may co-occur with the vaterite compositions of the invention. These compounds may be amorphous in nature or crystalline. In certain embodiments, the silica may be in the form of opal-A, amorphous silica, typically found in chert rocks. Calcium magnesium carbonate silicate amorphous compounds may form, within crystalline regions of the polymorphs listed above. Non-carbonate, silicate minerals may also form. Sepiolite is a clay mineral, a complex magnesium silicate, a typical formula for which is Mg₄Si₆O₁₅(OH)₂.6H₂O. It can be present in fibrous, fine-particulate, and solid forms. Silcate carbonate minerals may also form. Carletonite, KNa₄Ca₄CO₃)₄Si₈O₁₈ (F, OH).H₂O, Hydrated potassium sodium calcium carbonate silicate, can form under these conditions. Like any member of the phyllosilicates subclass, carletonite's structure is layered with alternating silicate sheets and the potassium, sodium and calcium layers. Unlike other phyllosilicates, carletonite's silicate sheets are composed of interconnected four and eight-member rings. The sheets can be thought of as being like chicken wire with alternating octagon and square shaped holes. Both octagons and squares have a four fold symmetry and this is what gives carletonite its tetragonal symmetry; 4/m 2/m 2/m. Only carletonite and other members of the apophyllite group have this unique interconnected four and eight-member ring structure.

In some embodiments, the compositions provided herein further include geopolymers. “Geopolymers” are chains or networks of mineral molecules that comprise alumina silica chains, such as, but are not limited to, —Si—O—Si—O— siloxo, poly(siloxo); —Si—O—Al—O— sialate, poly(sialate); —Si—O—Al—O—Si—O— sialate-siloxo, poly(sialate-siloxo); —Si—O—Al—O—Si—O—Si-β-sialate-disiloxo, poly(sialate-disiloxo); —P—O—P—O— phosphate, poly(phosphate); —P—O—Si—O—P—O-phospho-siloxo, poly(phospho-siloxo); —P—O—Si—O—Al—O—P—O— phospho-sialate, poly(phospho-sialate); and —(R)—Si—O—Si—O—(R) organo-siloxo, poly-silicone. Geopolymers include, but are not limited to, water-glass based geopolymer, kaolinite/hydrosodalite-based geopolymer, metakaolin MK-750-based geopolymer, calcium based geopolymer, rock-based geopolymer, silica-based geopolymer, fly-ash based geopolymer, phosphate based geopolymer, and organic mineral geopolymer. In some embodiments, the amount of geopolymer added to the composition of the invention is 1-50% by wt or 1-25% by wt or 1-10% by wt. The geopolymer can be blended into the composition of the invention which can then be used as a hydraulic cement or SCM. The addition of geopolymer to the composition of the invention may decrease the setting time and/or increase the compressive strength of cement when the composition in combination with water sets and hardens into the cement.

In some embodiments, the compositions provided herein further include Ordinary Portland cement, Portland cement clinker, aggregate, SCM, or combination thereof. In some embodiments, the SCM compositions provided herein further include Ordinary Portland cement, Portland cement clinker, aggregate, other supplementary cementitious material (SCM), or combination thereof. In some embodiments, the other SCM is slag, fly ash, silica fume, or calcined clay.

As is known in the art, Portland cements are powder compositions produced by grinding Portland cement clinker (more than 90%), a limited amount of calcium sulfate which controls the set time, and up to 5% minor constituents (as allowed by various standards). As defined by the European Standard EN197.1, “Portland cement clinker is a hydraulic material which shall consist of at least two-thirds by mass of calcium silicates (3CaO.SiO₂ and 2CaO.SiO₂), the remainder consisting of aluminium- and iron-containing clinker phases and other compounds. The ratio of CaO to SiO₂ shall not be less than 2.0. The magnesium content (MgO) shall not exceed 5.0% by mass.” In certain embodiments, the Portland cement constituent of the present invention is any Portland cement that satisfies the ASTM Standards and Specifications of C150 (Types 1-VIII) of the American Society for Testing of Materials (ASTM C50-Standard Specification for Portland Cement). ASTM C150 covers eight types of Portland cement, each possessing different properties, and used specifically for those properties.

In some embodiments, the composition of the invention may further include Ordinary Portland Cement (OPC) or Portland cement clinker. The amount of Portland cement component may vary and range from 10 to 95% w/w; or 10 to 90% w/w; or 10 to 80% w/w; or 10 to 70% w/w; or 10 to 60% w/w; or 10 to 50% w/w; or 10 to 40% w/w; or 10 to 30% w/w; or 10 to 20% w/w; or 20 to 90% w/w; or 20 to 80% w/w; or 20 to 70% w/w; or 20 to 60% w/w; or 20 to 50% w/w; or 20 to 40% w/w; or 20 to 30% w/w; or 30 to 90% w/w; or 30 to 80% w/w; or 30 to 70% w/w; or 30 to 60% w/w; or 30 to 50% w/w; or 30 to 40% w/w; or 40 to 90% w/w; or 40 to 80% w/w; or 40 to 70% w/w; or 40 to 60% w/w; or 40 to 50% w/w; or 50 to 90% w/w; or 50 to 80% w/w; or 50 to 70% w/w; or 50 to 60% w/w; or 60 to 90% w/w; or 60 to 80% w/w; or 60 to 70% w/w; or 70 to 90% w/w; or 70 to 80% w/w. For example, the composition may comprise a blend of 80% OPC and 20% composition of the invention. In some embodiments, such composition of the invention is an SCM.

In certain embodiments, the composition may further include an aggregate. Aggregate may be included in the composition to provide for mortars which include fine aggregate and concretes which also include coarse aggregate. The fine aggregates are materials that almost entirely pass through a Number 4 sieve (ASTM C 125 and ASTM C 33), such as silica sand. The coarse aggregate are materials that are predominantly retained on a Number 4 sieve (ASTM C 125 and ASTM C 33), such as silica, quartz, crushed round marble, glass spheres, granite, limestone, calcite, feldspar, alluvial sands, sands or any other durable aggregate, and mixtures thereof. As such, the term “aggregate” is used broadly to refer to a number of different types of both coarse and fine particulate material, including, but not limited to, sand, gravel, crushed stone, slag, and recycled concrete. The amount and nature of the aggregate may vary widely. In some embodiments, the amount of aggregate may range from 25 to 80%, such as 40 to 70% and including 50 to 70% w/w of the total composition made up of both the composition and the aggregate.

In some embodiments, the compositions further include a pH regulating agent which may influence the pH of the fluid component of the settable composition produced from the composition or composition mixed with aggregates (to form concrete), upon combination of the composition with water. Such pH regulating agents may provide for an alkaline environment upon combination with water, e.g., where the pH of the hydrated cement is 12 or higher, such as 13 or higher, and including 13.5 or higher. In certain embodiments, the pH regulating (i.e., modulating) agent is an oxide or hydroxide, e.g., calcium oxide, calcium hydroxide, magnesium oxide or magnesium hydroxide. When present, such agents may be present in amounts ranging from 1 to 10% w/w, such as 2 to 5% w/w.

In some embodiments, there is provided a settable composition prepared from the above recited compositions of the invention. Such settable compositions include, but are not limited to, cement, concrete, and mortar. Settable compositions may be produced by combining the composition of the invention with water or by combining the composition of the invention with an aggregate and water. The aggregate can be a fine aggregate to prepare mortar, such as sand, or a combination of fine and coarse aggregate or coarse aggregate alone for concrete. The composition, the aggregate, and the water may all be mixed at the same time or the composition may be pre-combined with the aggregate and the pre-combined mixture is then mixed with water. The coarse aggregate material for concrete mixes, using the compositions of the invention, may have a minimum size of about ⅜ inch and can vary in size from that minimum to up to one inch or larger, including gradations between these limits. Crushed limestone and other rocks, gravel, and the like are some examples of the coarse aggregates. Finely divided aggregate is smaller than ⅜ inch in size and may be graduated in much finer sizes down to 200-sieve size or so. Ground limestone and other rocks, sand, and the like are some examples of the fine aggregates. Fine aggregates may be present in both mortars and concretes of the invention. The weight ratio of the composition to the aggregate may vary, and in certain embodiments ranges from 1:10 to 4:10, such as 2:10 to 5:10 and including from 55:1000 to 70:100. Such settable compositions are described in detail below.

The aqueous medium, such as, water, with which the composition of the invention is combined to produce the settable composition, may vary from pure water to water that includes one or more solutes, additives, co-solvents, etc., as desired. In some embodiments, the ratio of the aqueous medium:dry components or aqueous medium:composition of the invention is 0.1-10; or 0.1-8; or 0.1-6; or 0.1-4; or 0.1-2; or 0.1-1; or 0.2-10; or 0.2-8; or 0.2-6; or 0.2-4; or 0.2-2; or 0.2-1; or 0.3-10; or 0.3-8; or 0.3-6; or 0.3-4; or 0.3-2; or 0.3-1; or 0.4-10; or 0.4-8; or 0.4-6; or 0.4-4; or 0.4-2; or 0.4-1; or 0.5-10; or 0.5-8; or 0.5-6; or 0.5-4; or 0.5-2; or 0.5-1; or 0.6-10; or 0.6-8; or 0.6-6; or 0.6-4; or 0.6-2; or 0.6-1; or 0.8-10; or 0.8-8; or 0.8-6; or 0.8-4; or 0.8-2; or 0.8-1; or 1-10; or 1-8; or 1-6; or 1-4; or 1-2; or 0.1; or 0.5; or 1; or 2. In some embodiments, the ratio is a weight ratio.

### Admixtures

In certain embodiments, the compositions of the invention further include one or more admixtures. Admixtures may be added to concrete to provide it with desirable characteristics or to modify properties of the concrete to make it more readily useable or more suitable for a particular purpose or for cost reduction. As is known in the art, an admixture is any material or composition, other than the composition of the invention, aggregate and water; that is used as a component of the concrete or mortar to enhance some characteristic or lower the cost, thereof. The amount of admixture that is employed may vary depending on the nature of the admixture. In certain embodiments the amounts of these components range from 1 to 50% w/w, such as 2 to 10% w/w.

The admixtures may provide one or more advantages, such as, (1) achieve certain structural improvements in the resulting cured concrete; (2) improve the quality of concrete through the successive stages of mixing, transporting, placing, and curing during adverse weather or traffic conditions; (3) overcome certain emergencies during concreting operations; and (4) reduce the cost of concrete construction.

Admixtures of interest include finely divided mineral admixtures, such as SCM. Finely divided mineral admixtures are materials in powder or pulverized form added to concrete before or during the mixing process to improve or change some of the plastic or hardened properties of concrete. The SCM can be classified according to their chemical or physical properties as: cementitious materials; pozzolans; pozzolanic and cementitious materials; and nominally inert materials. A pozzolan is a siliceous or aluminosiliceous material that possesses little or no cementitious value but, in the presence of water and in finely divided form, may chemically react with the calcium hydroxide released by the hydration of the cement to form materials with cementitious properties. Pozzolans can also be used to reduce the rate at which water under pressure is transferred through concrete. Diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Nominally inert materials can also include finely divided raw quartz, dolomites, limestone, marble, granite, and others. Fly ash is defined in ASTM C618.

Plasticizer is another example of the admixture. Plasticizers can be added to the concrete to provide it with improved workability; ease of placement; reduced consolidating effort; and provide uniform flow in reinforced concretes without leaving void space under reinforcing bars. Other examples of admixtures include, but are not limited to, accelerators, retarders, air-entrainers, foaming agents, water reducers, corrosion inhibitors, and pigments. Accelerators may be used to increase the cure rate (hydration) of the concrete formulation and may be used in applications where it is desirable for the concrete to harden quickly and in low temperature applications. Retarders act to slow the rate of hydration and increase the time available to pour the concrete and to form it into a desired shape. Retarders may be of advantage in applications where the concrete is being used in hot climates. Air-entrainers are used to distribute tiny air bubbles throughout the concrete. Air-entrainers may be of advantage for utilization in regions that experience cold weather because the tiny entrained air bubbles may help to allow for some contraction and expansion to protect the concrete from freeze-thaw damage. Pigments can also be added to concrete to provide it with desired color characteristics for aesthetic purposes.

As such, admixtures of interest include, but are not limited to: set accelerators, set retarders, air-entraining agents, defoamers, alkali-reactivity reducers, bonding admixtures, dispersants, coloring admixtures, corrosion inhibitors, damp-proofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, aggregates, wetting agents, strength enhancing agents, water repellents, and any other concrete or mortar admixture or additive. When using an admixture, the fresh composition, to which the admixture raw materials are introduced, is mixed for sufficient time to cause the admixture raw materials to be dispersed relatively uniformly throughout the fresh concrete.

Set accelerators may be used to accelerate the setting and early strength development of concrete. The set accelerator that can be used with the admixture system can be, but is not limited to, a nitrate salt of an alkali metal, alkaline earth metal, or aluminum; a nitrite salt of an alkali metal, alkaline earth metal, or aluminum; a thiocyanate of an alkali metal, alkaline earth metal or aluminum; an alkanolamine; a thiosulfate of an alkali metal, alkaline earth metal, or aluminum; a hydroxide of an alkali metal, alkaline earth metal, or aluminum; a carboxylic acid salt of an alkali metal, alkaline earth metal, or aluminum (preferably calcium formate); a polyhydroxylalkylamine; a halide salt of an alkali metal or alkaline earth metal (e.g., chloride). Examples of set accelerators that may be used in the present dispensing method include, but are not limited to, POZZOLITH® NC534, nonchloride type set accelerator and/or RHEOCRETE® CNI calcium nitrite-based corrosion inhibitor, both sold under the above trademarks by BASF Admixtures Inc. of Cleveland, Ohio.

Also of interest are set retarding admixtures. Set retarding, also known as delayed-setting or hydration control, admixtures are used to retard, delay, or slow the rate of setting of concrete. They can be added to the concrete mix upon initial batching or sometime after the hydration process has begun. Set retarders may be used to offset the accelerating effect of hot weather on the setting of concrete, or delay the initial set of concrete or grout when difficult conditions of placement occur, or problems of delivery to the job site, or to allow time for special finishing processes. Most set retarders may also act as low level water reducers and can also be used to entrain some air into concrete. Retarders that can be used include, but are not limited to, an oxy-boron compound, corn syrup, lignin, a polyphosphonic acid, a carboxylic acid, a hydroxycarboxylic acid, polycarboxylic acid, hydroxylated carboxylic acid, such as fumaric, itaconic, malonic, borax, gluconic, and tartaric acid, lignosulfonates, ascorbic acid, isoascorbic acid, sulphonic acid-acrylic acid copolymer, and their corresponding salts, polyhydroxysilane, polyacrylamide, carbohydrates and mixtures thereof. Illustrative examples of retarders are set forth in U.S. Pat. Nos. 5,427,617 and 5,203,919, which are incorporated herein by reference. A further example of a retarder suitable for use in the admixture system is a hydration control admixture sold under the trademark DELVO® by BASF Admixtures Inc. of Cleveland, Ohio.

Also of interest as admixtures are air entrainers. The air entrainer includes any substance that will entrain air in cementitious compositions. Some air entrainers can also reduce the surface tension of a composition at low concentration. Air-entraining admixtures are used to purposely entrain microscopic air bubbles into concrete. Air-entrainment may improve the durability of concrete exposed to moisture during cycles of freezing and thawing. In addition, entrained air may improve concrete's resistance to surface scaling caused by chemical deicers. Air entrainment may also increase the workability of fresh concrete while eliminating or reducing segregation and bleeding. Materials used to achieve these desired effects can be selected from wood resin, natural resin, synthetic resin, sulfonated lignin, petroleum acids, proteinaceous material, fatty acids, resinous acids, alkylbenzene sulfonates, sulfonated hydrocarbons, vinsol resin, anionic surfactants, cationic surfactants, nonionic surfactants, natural rosin, synthetic rosin, an inorganic air entrainer, synthetic detergents, and their corresponding salts, and mixtures thereof. Air entrainers are added in an amount to yield a desired level of air in a cementitious composition. Examples of air entrainers that can be utilized in the admixture system include, but are not limited to MB AE 90, MB VR and MICRO AIR®, all available from BASF Admixtures Inc. of Cleveland, Ohio.

Also of interest as admixtures are defoamers. Defoamers are used to decrease the air content in the cementitious composition. Examples of defoamers that can be utilized in the composition include, but are not limited to, mineral oils, vegetable oils, fatty acids, fatty acid esters, hydroxyl functional compounds, amides, phosphoric esters, metal soaps, silicones, polymers containing propylene oxide moieties, hydrocarbons, alkoxylated hydrocarbons, alkoxylated polyalkylene oxides, tributyl phosphates, dibutyl phthalates, octyl alcohols, water-insoluble esters of carbonic and boric acid, acetylenic diols, ethylene oxide-propylene oxide block copolymers and silicones.

Also of interest as admixtures are dispersants. The dispersant includes, but is not limited to, polycarboxylate dispersants, with or without polyether units. The term dispersant is also meant to include those chemicals that also function as a plasticizer, water reducer such as a high range water reducer, fluidizer, antiflocculating agent, or superplasticizer for cementitious compositions, such as lignosulfonates, salts of sulfonated naphthalene sulfonate condensates, salts of sulfonated melamine sulfonate condensates, beta naphthalene sulfonates, sulfonated melamine formaldehyde condensates, naphthalene sulfonate formaldehyde condensate resins for example LOMAR D® dispersant (Cognis Inc., Cincinnati, Ohio), polyaspartates, or oligomeric dispersants. Polycarboxylate dispersants can be used, by which is meant a dispersant having a carbon backbone with pendant side chains, wherein at least a portion of the side chains are attached to the backbone through a carboxyl group or an ether group.

Examples of polycarboxylate dispersants can be found in U.S. Pub. No. 2002/0019459, U.S. Pat. No. 6,267,814, U.S. Pat. No. 6,290,770, U.S. Pat. No. 6,310,143, U.S. Pat. No. 6,187,841, U.S. Pat. No. 5,158,996, U.S. Pat. No. 6,008,275, U.S. Pat. No. 6,136,950, U.S. Pat. No. 6,284,867, U.S. Pat. No. 5,609,681, U.S. Pat. No. 5,494,516; U.S. Pat. No. 5,674,929, U.S. Pat. No. 5,660,626, U.S. Pat. No. 5,668,195, U.S. Pat. No. 5,661,206, U.S. Pat. No. 5,358,566, U.S. Pat. No. 5,162,402, U.S. Pat. No. 5,798,425, U.S. Pat. No. 5,612,396, U.S. Pat. No. 6,063,184, U.S. Pat. No. 5,912,284, U.S. Pat. No. 5,840,114, U.S. Pat. No. 5,753,744, U.S. Pat. No. 5,728,207, U.S. Pat. No. 5,725,657, U.S. Pat. No. 5,703,174, U.S. Pat. No. 5,665,158, U.S. Pat. No. 5,643,978, U.S. Pat. No. 5,633,298, U.S. Pat. No. 5,583,183, and U.S. Pat. No. 5,393,343, which are all incorporated herein by reference as if fully written out below. The polycarboxylate dispersants of interest include, but are not limited to, dispersants or water reducers sold under the trademarks GLENIUM® 3030NS, GLENIUM® 3200 HES, GLENIUM 3000NS® (BASF Admixtures Inc., Cleveland, Ohio), ADVA® (W. R. Grace Inc., Cambridge, Mass.), VISCOCRETE® (Sika, Zurich, Switzerland), and SUPERFLUX® (Axim Concrete Technologies Inc., Middlebranch, Ohio).

Also of interest as admixtures are alkali reactivity reducers. Alkali reactivity reducers can reduce the alkali-aggregate reaction and limit the disruptive expansion forces that this reaction can produce in hardened concrete. The alkali-reactivity reducers include pozzolans (fly ash, silica fume), blast-furnace slag, salts of lithium and barium, and other air-entraining agents. Natural and synthetic admixtures are used to color concrete for aesthetic and safety reasons. These coloring admixtures are usually composed of pigments and include carbon black, iron oxide, phthalocyanine, umber, chromium oxide, titanium oxide, cobalt blue, and organic coloring agents.

Also of interest as admixtures are corrosion inhibitors. Corrosion inhibitors in concrete may serve to protect embedded reinforcing steel from corrosion due to its highly alkaline nature. The high alkaline nature of the concrete may cause a passive and non-corroding protective oxide film to form on steel. However, carbonation or the presence of chloride ions from deicers or seawater can destroy or penetrate the film and may result in corrosion. Corrosion-inhibiting admixtures may chemically arrest this corrosion reaction. The materials commonly used to inhibit corrosion are calcium nitrite, sodium nitrite, sodium benzoate, certain phosphates or fluorosilicates, fluoroaluminites, amines and related chemicals.

Also of interest are damp-proofing admixtures. Dampproofing admixtures reduce the permeability of concrete that have low cement contents, high water-cement ratios, or a deficiency of fines in the aggregate. These admixtures retard moisture penetration into dry concrete and include certain soaps, stearates, and petroleum products. Also of interest are gas former admixtures. Gas formers, or gas-forming agents, are sometimes added to concrete and grout in very small quantities to cause a slight expansion prior to hardening. The amount of expansion is dependent upon the amount of gas-forming material used and the temperature of the fresh mixture. Aluminum powder, resin soap and vegetable or animal glue, saponin or hydrolyzed protein can be used as gas formers.

Also of interest are permeability reducers. Permeability reducers may be used to reduce the rate at which water under pressure is transmitted through concrete. Silica fume, fly ash, ground slag, natural pozzolans, water reducers, and latex may be employed to decrease the permeability of the concrete.

Also of interest are rheology modifying agent admixtures. Rheology modifying agents may be used to increase the viscosity of cementitious compositions. Suitable examples of rheology modifier include firmed silica, colloidal silica, hydroxyethyl cellulose, hydroxypropyl cellulose, fly ash (as defined in ASTM C618), mineral oils (such as light naphthenic), hectorite clay, polyoxyalkylenes, polysaccharides, natural gums, or mixtures thereof.

Also of interest are shrinkage compensation admixtures. The shrinkage compensation agent which can be used in the cementitious composition can include, but is not limited to, RO(AO)₁₋₁₀H, wherein R is a C₁₋₅ alkyl or C₅₋₆ cycloalkyl radical and A is a C₂₋₃ alkylene radical, alkali metal sulfate, alkaline earth metal sulfates, alkaline earth oxides, preferably sodium sulfate and calcium oxide. TETRAGUARD® is an example of a shrinkage reducing agent and is available from BASF Admixtures Inc. of Cleveland, Ohio.

Bacterial and fungal growth on or in hardened concrete may be partially controlled through the use of fungicidal and germicidal admixtures. The materials for these purposes include, but are not limited to, polyhalogenated phenols, dialdrin emulsions, and copper compounds.

Also of interest in some embodiments is workability improving admixtures. Entrained air, which acts like a lubricant, can be used as a workability improving agent. Other workability agents are water reducers and certain finely divided admixtures.

In some embodiments, the compositions of the invention are employed with fibers, e.g., where fiber-reinforced concrete is desirable. Fibers can be made of zirconia containing materials, steel, carbon, fiberglass, or synthetic materials, e.g., polypropylene, nylon, polyethylene, polyester, rayon, high-strength aramid, (i.e. Kevlar®), or mixtures thereof.

The components of the compositions of the invention can be combined using any suitable protocol. Each material may be mixed at the time of work, or part of or all of the materials may be mixed in advance. Alternatively, some of the materials are mixed with water with or without admixtures, such as high-range water-reducing admixtures, and then the remaining materials may be mixed therewith. As a mixing apparatus, any conventional apparatus can be used. For example, Hobart mixer, slant cylinder mixer, Omni Mixer, Henschel mixer, V-type mixer, and Nauta mixer can be employed.

Following the combination of the components to produce a settable composition (e.g., concrete), the settable composition will set after a given period of time. The setting time may vary, and in certain embodiments ranges from 30 minutes to 48 hours, such as 30 minutes to 24 hours and including from 1 hour to 4 hours. In certain embodiments, the cement products produced from compositions of the invention are extremely durable, e.g., as determined using the test method described at ASTM C1157.

### Building Material

In one aspect, there is provided a structure or a building material comprising the composition of the invention or or the set and hardened form thereof. In some embodiments, the building material is formed from the compositions of the invention. Examples of such structures or the building materials include, but are not limited to, building, driveway, foundation, kitchen slab, furniture, pavement, road, bridges, motorway, overpass, parking structure, brick, block, wall, footing for a gate, fence, or pole, and combination thereof.

In one aspect, there is provided a formed building material comprising the composition of the invention or or the set and hardened form thereof. In some embodiments, the formed building material is formed from the compositions of the invention. The formed building materials and the methods of making and using the formed building materials are described in U.S. application Ser. No. 12/571,398, filed Sep. 30, 2009, which is incorporated herein by reference in its entirety. The formed building materials of the invention may vary greatly and include materials shaped (e.g., molded, cast, cut, or otherwise produced) into man-made structures with defined physical shape, i.e., configuration. Formed building materials are distinct from amorphous building materials (e.g., powder, paste, slurry, etc.) that do not have a defined and stable shape, but instead conform to the container in which they are held, e.g., a bag or other container. Formed building materials of the invention are also distinct from irregularly or imprecisely formed materials (e.g., aggregate, bulk forms for disposal, etc.) in that formed building materials are produced according to specifications that allow for use of formed building materials in, for example, buildings. Formed building materials formed from the compositions of the invention may be prepared in accordance with traditional manufacturing protocols for such structures, with the exception that the composition of the invention is employed in making such materials. In some embodiments, the formed building materials made from the composition of the invention have a compressive strength of at least 14 MPa; or between about 14-100 MPa; or between about 14-45 MPa; or the compressive strength of the composition of the invention after setting, and hardening, as described herein. In some embodiments, the formed building materials made from the composition of the invention have a δ¹³C of greater than −5‰; or from −5‰ to 25‰; or the δ¹³C of the composition of the invention, as described herein.

Since these structures or building materials are produced from the compositions of the invention, they may include markers or one or more elements that identify them as being obtained from carbonate brines and/or being obtained from water having trace amounts of various elements present in the initial salt water source, as described herein. For example, where the mineral component of the cement component of the concrete is one that has been produced from sea water, the set product will contain a seawater marker profile of different elements in identifying amounts, such as magnesium, potassium, sulfur, boron, sodium, and chloride, etc. In some embodiments, where the mineral component of the cement component of the concrete is one that has been produced from subterranean carbonate brine, the set product will contain the subterranean carbonate brine marker profile of different elements in identifying amounts, such as, but are not limited to, one or more of barium, cobalt, copper, lanthanum, mercury, arsenic, cadmium, lead, nickel, scandium, titanium, zinc, zirconium, molybdenum, and selenium.

One example of the formed building materials is masonry units. Masonry units are formed building materials used in the construction of load-bearing and non-load-bearing structures that are generally assembled using mortar, grout, and the like. Exemplary masonry units of the invention include bricks, blocks, and tiles. Bricks and blocks of the invention are polygonal structures possessing linear dimensions. Bricks of the invention are masonry units with dimensions (mm) not exceeding 337.5×225×112.5 (length×width×height). Any unit with dimensions (mm) between 337.5×225×112.5 to 2000×1000×500 (length×width×depth) is termed a “block.” Structural units with dimensions (mm) exceeding 2000×1000×500 (length×width×depth) are termed “slabs.” Tiles refer to masonry units that possess the same dimensions as bricks or blocks, but may vary considerably in shape, i.e., may not be polygonal (e.g., hacienda-style roof tiles).

One type of masonry unit provided by the invention is a brick, which refers to a structural unit of material used in masonry construction, generally laid using mortar. Bricks of the invention are masonry units with dimensions (mm) not exceeding 337.5×225×112.5 (length×width×height). In some embodiments, the bricks may have lengths ranging from 175 to 300 mm, such as 200 to 250 mm, including 200 to 230 mm; widths ranging from 75 to 150 mm, such as 100 to 120 mm, including 100 to 110 mm; and heights ranging from 50 to 90 mm, such as 50 to 80 mm, including 55 to 75 mm. Bricks of the invention may vary in grade, class, color, texture, size, weight and can be solid, cellular, perforated, frogged, or hollow. Bricks of the invention may include, but are not limited to, building brick, facing brick, load bearing brick, engineering brick, thin veneer brick, paving brick, glazed brick, firebox brick, chemical resistant brick, sewer and manhole brick, industrial floor brick, etc. The bricks may also vary in frost resistance (i.e., frost resistant, moderately frost resistant or non frost resistant), which relates to the durability of bricks in conditions where exposure to water may result in different levels of freezing and thawing. Frost resistant bricks are durable in conditions of constant exposure to water and freezing and thawing. Moderately frost resistant bricks are durable in conditions of sporadic exposure to water and freezing and thawing. Non-frost resistant bricks are not durable in conditions of exposure to water and freezing and thawing. These bricks are suitable only for internal use and are liable to damage by freezing and thawing except when protected by an impermeable cladding during construction. Bricks of the invention may also vary in soluble salt content (i.e., low or normal). Percentage by mass of soluble ions in bricks with a low soluble salt content does not exceed 0.03% magnesium, 0.03% potassium, 0.03% sodium, and 0.5% sulfate. Percentage by mass of soluble ions in bricks with a normal salt content does not exceed 0.25% of magnesium, potassium, and sodium in total and sulfate content does not exceed 1.6%. The bricks of the invention may vary considerably in physical and mechanical properties. The compressive strength of bricks of the invention may range, in certain instances, from 5 to 100 MPa; or 20-100 MPa; or 50-100 MPa; or 80-100 MPa; or 20-80 MPa; or 20-40 MPa; or 60-80 MPa.

The flexural strength of bricks of the invention may vary, ranging from 0.5 to 10 MPa, including 2 to 7 MPa, such as 2 to 5 MPa. The maximum water absorption of bricks of the invention may vary, ranging from 5 to 25%, including 10 to 15%. Bricks of the invention may also undergo moisture movement (expansion or contraction) due to the absorption or loss of water to its environment. The dimensional stability (i.e., linear shrinkage or expansion) due to moisture movement may vary, in certain instances ranging from 0.001 to 0.2%, including 0.05 to 0.1%. In some embodiments, the bricks of the invention may be used for paving a road. Bricks used to pave areas exposed to heavy traffic (e.g., pedestrian, vehicular, etc.) may have an abrasion resistance index ranging from 0.1 to 0.5, including 0.2 to 0.4, such as 0.3. In addition, bricks of the invention may have a volume abrasion loss ranging from 1.0 to 4.0 cm³/cm², including 1.5 to 2.5 cm³/cm², or 2.0 cm³/cm². The composition of the invention may be molded, extruded, or sculpted into the desired shape and size to form a brick. The shaped composition is then dried and further hardened by hydraulic pressure, autoclave or fired in a kiln at temperatures ranging between 900° to 1200° C., such as 900° to 1100° C. and including 1000° C.

Another type of masonry unit provided by the invention is blocks, (e.g., concrete, cement, foundation, etc.). Blocks are distinct from bricks based on their structural dimensions. Specifically, blocks exceed the dimensions (mm) of 337.5×225×112.5 (length×width×height). Blocks of the invention may vary in color, texture, size, and weight and can be solid, cellular, and hollow or employ insulation (e.g., expanded polystyrene foam) in the block void volume. Blocks of the invention may be load-bearing, non-load-bearing or veneer (i.e., decorative) blocks. In some embodiments, the blocks may have lengths ranging from 300 to 500 mm, such as 350 to 450 mm, widths ranging from 150 to 250 mm, such as 180 to 215 mm and heights ranging from 100 to 250 mm, such as 150 to 200 mm. The blocks of the invention may also vary in faceshell thickness. In some instances, the blocks may have faceshell thicknesses ranging from 15 to 40 mm, including 20 to 30 mm, such as 25 mm. The blocks may also vary in web thickness. In some embodiments, the blocks may have web thicknesses ranging from 15 to 30 mm, including 15 to 25 mm, such as 20 mm. The blocks of the invention may vary considerably in physical and mechanical properties. The compressive strength of blocks of the invention may vary, in certain instances ranging from 5 to 100 MPa, including 15 to 75 MPa, such as 20 to 40 MPa. The flexural strength of blocks of the invention may also vary, ranging from 0.5 to 15 MPa, including 2 to 10 MPa, such as 4 to 6 MPa. The maximum water absorption of the blocks of the invention may vary, ranging from 7 to 20% by weight including 8 to 15%, such as 9 to 11%. Blocks of the invention may also undergo moisture movement (expansion or contraction) due to the absorption or loss of water to its environment. Blocks of the invention may be Type I moisture-controlled units or Type II non-moisture-controlled units. The dimensional stability (i.e., linear shrinkage) of the blocks of the invention may vary depending on their intended use and/or geographical location of use, in certain instances ranging from 0.02 to 0.15%, such as 0.03 to 0.05%. The composition of the invention may be molded, extruded, or sculpted into the desired shape and size to form a block. The shaped composition may be further compacted by roller compaction, hydraulic pressure, vibrational compaction, or resonant shock compaction. In some instances, the resultant composition may also be foamed using mechanically or chemically introduced gases prior to being shaped or while the composition is setting in order to form a lightweight concrete block. The composition is further cured in an environment with a controlled temperature and humidity.

Another type of building material provided by the invention is a tile. Tiles of the invention refer to non-load-bearing building materials that are commonly employed on roofs and to pave exterior and interior floors of commercial and residential structures. Some examples where tiles of the invention may be employed include, but are not limited to, the roofs of commercial and residential buildings, decorative patios, bathrooms, saunas, kitchens, building foyer, driveways, pool decks, porches, walkways, sidewalks, and the like. Tiles may take on many forms depending on their intended use and/or intended geographical location of use, varying in shape, size, weight, and may be solid, webbed, cellular or hollow. Tiles of the invention may vary in dimension, e.g., lengths ranging from 100 to 1000 mm, including 250 to 500 mm, such as 250 to 300 mm; widths ranging from 50 to 1000 mm, including 100 to 250 mm, such as 125 to 175 mm; and thickness ranging from 10 to 30 mm, including 15 to 25 mm, such as 15 to 20 mm. The compressive strengths of tiles of the invention may also vary, in certain instances ranging from 5 to 75 MPa, including 15 to 40 MPa, such as 25 MPa. The flexural strength of tiles of the invention may vary, ranging from 0.5 to 7.5 MPa, including 2 to 5 MPa, such as 2.5 MPa. The maximum water absorption of tiles of the invention may also vary, in certain instances ranging from 5 to 15%, including 7 to 12%. Tiles of the invention may also undergo moisture movement (expansion or contraction) due to the absorption or loss of water to its environment. The dimensional stability (i.e., linear shrinkage or expansion) due to moisture movement may vary, in certain instances ranging from 0.001 to 0.25%, including 0.025 to 0.075%, such as 0.05%. Tiles used to pave areas exposed to heavy traffic (e.g., pedestrian, vehicular, etc.) may have an abrasion resistance index that may vary considerably, ranging from 0.1 to 0.5, including 0.25. In addition, tiles may have a volume abrasion loss ranging from 1.0 to 4.0 cm³/cm², including 1.5 to 3.0 cm³/cm², such as, 2.7 cm³/cm². Tiles may be polygonal, circular or take on any other desired shape.

As such, the composition of the invention may be molded or cast into the desired tile shape and size. The shaped composition may be further compacted by roller compaction, hydraulic pressure, vibrational compaction, or resonant shock compaction. The resultant composition may also be poured out into sheets or a roller may be used to form sheets of a desired thickness. The sheets are then cut to the desired dimensions of the tiles. In some instances, the resultant composition may also be foamed using mechanically or chemically introduced gases prior to being shaped or while the composition is setting in order to form a lightweight tile. The shaped composition is then allowed to set and further cured in an environment with a controlled temperature and humidity. Tiles may be further polished, colored, textured, shot blasted, inlaid with decorative components and the like.

Construction panels are formed building materials employed in a broad sense to refer to any non-load-bearing structural element that are characterized such that their length and width are substantially greater than their thickness. Exemplary construction panels formed from the compositions of the invention, include cement boards, fiber-cement sidings, and drywall. Construction panels are polygonal structures with dimensions that vary greatly depending on their intended use. The dimensions of construction panels may range from 50 to 500 cm in length, including 100 to 300 cm, such as 250 cm; width ranging from 25 to 200 cm, including 75 to 150 cm, such as 100 cm; thickness ranging from 5 to 25 mm, including 7 to 20 mm, including 10 to 15 mm. Cement boards comprise construction panels conventionally prepared as a combination of cement and fiberglass and possess additional fiberglass reinforcement at both faces of the board. Fiber-cement sidings comprise construction panels conventionally prepared as a combination of cement, aggregate, interwoven cellulose, and/or polymeric fibers and possess a texture and flexibility that resembles wood. Drywall comprises construction panels conventionally prepared from gypsum plaster (i.e., semi-hydrous form of calcium sulfate), fibers (glass or paper) and is sandwiched between two sheets of outer material, e.g., paper or fiberglass mats.

One type of construction panel provided by the invention is cement board. They are formed building materials where in some embodiments, are used as backer boards for ceramics that may be employed behind bathroom tiles, kitchen counters, backsplashes, etc. and may have lengths ranging from 100 to 200 cm, such as 125 to 175 cm, e.g., 150 to 160 cm; a breadth ranging from 75 to 100 cm, such as 80 to 100 cm, e.g., 90 to 95 cm, and a thickness ranging from 5 to 25 mm, e.g., 5 to 15 mm, including 5 to 10 mm. Cement boards of the invention may vary in physical and mechanical properties. In some embodiments, the flexural strength may vary, ranging between 1 to 7.5 MPa, including 2 to 6 MPa, such as 5 MPa. The compressive strengths may also vary, ranging from 5 to 50 MPa, including 10 to 30 MPa, such as 15 to 20 MPa.

In some embodiments of the invention, cement boards may be employed in environments having extensive exposure to moisture (e.g., commercial saunas). The maximum water absorption of the cement boards formed from the compositions of the invention may vary, ranging from 5 to 15% by weight, including 8 to 10%, such as 9%. Cement boards may also undergo moisture movement (expansion or contraction) due to the absorption or loss of water to its environment. The dimensional stability (i.e., linear shrinkage or expansion) due to moisture movement may vary, in certain instances ranging from 0.035 to 0.1%, including 0.04 to 0.08%, such as 0.05 to 0.06%. The composition of the invention may be used to produce the desired shape and size to form a cement board. In addition, a variety of further components may be added to the cement boards which include, but are not limited to, plasticizers, foaming agents, accelerators, retarders and air entrainment additives. The composition is then poured out into sheet molds or a roller may be used to form sheets of a desired thickness. The shaped composition may be further compacted by roller compaction, hydraulic pressure, vibrational compaction, or resonant shock compaction. The sheets are then cut to the desired dimensions of the cement boards. In some instances, the resultant composition may also be foamed using mechanically or chemically introduced gases prior to being shaped or while the composition is setting in order to form a lightweight cement board. The shaped composition is then allowed to set and further cured in an environment with a controlled temperature and humidity. The cement boards then may be covered in a fiberglass mat on both faces of the board. Where desired, the cement boards may also be prepared using chemical admixtures such that they possess increased fire, water, and frost resistance as well as resistance to damage by bio-degradation and corrosion. The cement board may also be combined with components such as dispersed glass fibers, which may impart improved durability, increased flexural strength, and a smoother surface.

Another type of construction panel provided by the invention is fiber-cement siding. Fiber-cement sidings formed from the compositions of the invention are formed building materials used to cover the exterior or roofs of buildings and include, but are not limited to, building sheets, roof panels, ceiling panels, eternits, and the like. They may also find use as a substitute for timber fascias and barge boards in high fire areas. Fiber-cement sidings may have dimensions that vary, ranging from 200 to 400 cm in length, e.g., 250 cm and 50 to 150 cm in width, e.g., 100 cm and a thickness ranging from 4 to 20 mm, e.g., 5 to 15 mm, including 10 mm. Fiber-cement sidings of the invention may possess physical and mechanical properties that vary. In some embodiments, the flexural strength may range between 0.5 to 5 MPa, including 1 to 3 MPa, such as 2 MPa. The compressive strengths may also vary, in some instances ranging from 2 to 25 MPa, including 10 to 15 MPa, such as 10 to 12 MPa. In some embodiments of the invention, fiber-cement sidings may be employed on buildings that are subject to varying weather conditions, in some embodiments ranging from extremely arid to wet (i.e., low to high levels of humidity). Accordingly, the maximum water absorption of the fiber-cement sidings of the invention may vary, ranging from 10 to 25% by mass, including 10 to 20%, such as 12 to 15%. The dimensional stability (i.e., linear shrinkage or expansion) due to moisture movement may vary, in certain instances ranging from 0.05 to 0.1%, including 0.07 to 0.09%. The composition of the invention may be used to produce the desired shape and size to form a fiber-cement siding. In addition, a variety of further components may be added to the fiber-cement sidings which include, but are not limited to, cellulose fibers, plasticizers, foaming agents, accelerators, retarders and air entrainment additives. The composition is then poured into sheet molds or a roller is used to form sheets of a desired thickness. The shaped composition may be further compacted by roller compaction, hydraulic pressure, vibrational compaction, or resonant shock compaction. The sheets are then cut to the desired dimensions of the fiber-cement sidings. In some instances, the resultant composition may also be foamed using mechanically or chemically introduced gases prior to being shaped or while the composition is setting in order to form a lightweight fiber-cement siding. The shaped composition is then allowed to set and further cured in an environment with a controlled temperature and humidity. The fiber-cement sidings may then be covered with a polymeric film, enamel or paint. Where desired, the fiber-cement sidings may also be prepared using chemical admixtures such that they possess increased fire, water, and frost resistance as well as resistance to damage by bio-degradation and corrosion.

Another type of construction panel provided by the invention is drywall. The term drywall refers to the commonly manufactured building material that is used to finish construction of interior walls and ceilings. In certain instances, drywall building materials are panels that are made of a paper liner wrapped around an inner core. The inner core of drywall of the invention will include at least some amount of the composition of the invention. The dimensions of the drywall building materials of the invention may vary, in certain instances ranging from 100 to 200 cm, such as 125 to 175 cm, e.g., 150 to 160 cm in length; ranging from 75 to 100 cm, such as 80 to 100 cm, e.g., 90 to 95 cm in breadth, and ranging from 5 to 50 mm, e.g., 5 to 30 mm, including 10 to 25 mm in thickness. Drywall provided by the invention may possess physical and mechanical properties that vary considerably, and may depend upon the amount of the conventional constituents of drywall preparation that are replaced with the composition of the invention. The flexural and compressive strengths of drywall provided by the invention are generally larger than conventional drywall prepared with gypsum plaster, which is known to be a soft construction material. In some embodiments, the flexural strength may range between 0.1 to 3 MPa, including 0.5 to 2 MPa, such as 1.5 MPa. The compressive strengths may also vary, in some instances ranging from 1 to 20 MPa, including 5 to 15 MPa, such as 8 to 10 MPa. The maximum water absorption of drywall of the invention may vary, ranging from 2 to 10% by mass, including 4 to 8%, such as 5%. In certain embodiments, the inner core will be analogous to a conventional drywall core which is made primarily from gypsum plaster (the semi-hydrous form of calcium sulfate (CaSO₄.½H₂O), with at least a portion of the gypsum component replaced with the composition of the invention. In addition, the core may include a variety of further components, such as, but not limited to, fibers (e.g., paper and/or fiberglass), plasticizers, foaming agents, accelerators, e.g., potash, retarders, e.g., EDTA or other chelators, various additives that increase mildew and fire resistance (e.g., fiberglass or vermiculite), and water. The portion of components replaced with the composition of the invention may vary, and in certain instances is 5% by weight or more, including 10% by weight or more, 25% by weight or more, 50% by weight or more, 75% by weight or more, 90% by weight or more, or even 100% by weight. In producing the drywall, the core components may be combined and the resultant composition sandwiched between two sheets of outer material, e.g., heavy paper or fiberglass mats. When the core sets and is dried in a large drying chamber, the sandwich becomes rigid and strong enough for use as a building material.

Another building material formed from the compositions of the invention, is a conduit. Conduits are tubes or analogous structures configured to convey a gas or liquid, from one location to another. Conduits can include any of a number of different structures used in the conveyance of a liquid or gas that include, but are not limited to, pipes, culverts, box culverts, drainage channels and portals, inlet structures, intake towers, gate wells, outlet structures, and the like. Conduits may vary considerably in shape, which is generally determined by hydraulic design and installation conditions. Shapes of conduits may include, but are not limited to circular, rectangular, oblong, horseshoe, square, etc. Multiple cell configurations of conduits are also possible. Conduit design may vary depending on its intended use. As such, conduits may have dimensions that vary considerably. Conduits may have outer diameters which range in length from 5 to 500 cm or longer, such as 10 to 300 cm, e.g., 25 to 250 cm. The wall thicknesses may vary considerably, ranging in certain instances from 0.5 to 25 cm or thicker, such as 1 to 15 cm, e.g., 1 to 10 cm. In certain embodiments, conduits formed from the compositions of the invention may be designed in order to support high internal pressure from water flow within the conduit. In yet other embodiments, conduits may be designed to support high external loadings (e.g., earth loads, surface surcharge loads, vehicle loads, external hydrostatic pressures, etc.). Accordingly, the compressive strength of the walls of conduits may also vary, depending on the size and intended use of the conduit, in some instances ranging, from 5 to 75 MPa, such as 10 to 50 MPa, e.g., 15 to 40 MPa. Where desired, the conduits may be employed with various coatings or liners (e.g., polymeric), and may be configured for easy joining with each other to produce long conveyance structures made up of multiple conduits formed from the compositions of the invention. In producing conduits, the composition of the invention after combining with water is poured into a mold in order to form the desired conduit shape and size. The shaped composition may be further compacted by roller compaction, hydraulic pressure, vibrational compaction, or resonant shock compaction. In some instances, the resultant composition may also be foamed using mechanically or chemically introduced gases prior to being shaped or while the composition is setting in order to form a lightweight conduit structure. The shaped composition is further allowed to set and is cured in an environment with a controlled temperature and humidity. In addition, the conduits may include a variety of further components, such as, but not limited to, plasticizers, foaming agents, accelerators, retarders and air entrainment additives. Where desired, the further components may include chemical admixtures such that the conduits possess increased resistance to damage by bio-degradation, frost, water, fire and corrosion. In some embodiments, the conduits formed from the compositions of the invention may employ structural support components such as, but not limited to, cables, wires and mesh composed of steel, polymeric materials, ductile iron, aluminum or plastic.

Another building material provided by the invention is basins. The term basin may include any configured container used to hold a liquid, such as water. As such, a basin may include, but is not limited to structures such as wells, collection boxes, sanitary manholes, septic tanks, catch basins, grease traps/separators, storm drain collection reservoirs, etc. Basins may vary in shape, size, and volume capacity. Basins may be rectangular, circular, spherical, or any other shape depending on its intended use. In some embodiments, basins may possess a greater width than depth, becoming smaller toward the bottom. The dimensions of the basin may vary depending on the intended use of the structure (e.g., from holding a few gallons of liquid to several hundred or several thousand or more gallons of liquid). The wall thicknesses may vary considerably, ranging in certain instances from 0.5 to 25 cm or thicker, such as 1 to 15 cm, e.g., 1 to 10 cm. Accordingly, the compressive strength may also vary considerably, depending on the size and intended use of the basin, in some instances ranging, from 5 to 60 MPa, such as 10 to 50 MPa, e.g., 15 to 40 MPa. In some embodiments, the basin may be designed to support high external loadings (e.g., earth loads, surface surcharge loads, vehicle loads, etc.). In certain other embodiments, the basins may be employed with various coatings or liners (e.g., polymeric), and may be configured so that they may be combined with conveyance elements (e.g., drainage pipe). In other embodiments, basins formed from the compositions of the invention may be configured so that they may be connected to other basins so that they may form a connected series of basins. In producing basins from the compositions of the invention, the composition after combining with water may be poured into a mold to form the desired basin shape and size. The shaped composition may be further compacted by roller compaction, hydraulic pressure, vibrational compaction, or resonant shock compaction. The basins may also be prepared by pouring the composition into sheet molds and the basins further assembled by combining the sheets together to form basins with varying dimensions (e.g., polygonal basins, rhomboidal basins, etc.). In some instances, the resultant composition may also be foamed using mechanically or chemically introduced gases prior to being shaped or while the composition is setting in order to form a lightweight basin structure. The shaped composition is further allowed to set and is cured in an environment with a controlled temperature and humidity. In addition, the basins may include a variety of further components, such as, but not limited to, plasticizers, foaming agents, accelerators, retarders and air entrainment additives. Where desired, the further components may include chemical admixtures such that the basins possess increased resistance to damage by bio-degradation, frost, water, fire and corrosion. In some embodiments, the basins formed from the compositions of the invention may employ structural support components such as, but not limited to, cables, wires and mesh composed of steel, polymeric materials, ductile iron, aluminum or plastic.

Another building material formed from the compositions of the invention is a beam, which, in a broad sense, refers to a horizontal load-bearing structure possessing large flexural and compressive strengths. Beams may be rectangular cross-shaped, C-channel, L-section edge beams, I-beams, spandrel beams, H-beams, possess an inverted T-design, etc. Beams formed from the compositions of the invention may also be horizontal load-bearing units, which include, but are not limited to joists, lintels, archways and cantilevers. Beams generally have a much longer length than their longest cross-sectional dimension, where the length of the beam may be 5-fold or more, 10-fold or more, 25-fold or more, longer than the longest cross-sectional dimension. Beams formed from the compositions of the invention may vary in their mechanical and physical properties. For example, unreinforced concrete beams may possess flexural capacities that vary, ranging from 2 to 25 MPa, including 5 to 15 MPa, such as 7 to 12 MPa and compressive strengths that range from 10 to 75 MPa, including 20 to 60 MPa, such as 40 MPa. Structurally reinforced concrete beams may possess considerably larger flexural capacities, ranging from 15 to 75 MPa, including as 25 to 50 MPa, such as 30 to 40 MPa and compressive strengths that range from 35 to 150 MPa, including 50 to 125 MPa, such as 75 to 100 MPa. The beams formed from the compositions of the invention may be internal or external, and may be symmetrically loaded or asymmetrically loaded. In some embodiments, beams may be composite, wherein it acts compositely with other structural units by the introduction of appropriate interface shear mechanisms. In other embodiments, beams may be non-composite, wherein it utilizes the properties of the basic beam alone. In producing beams, the composition of the invention after mixing with water may be poured into a beam mold or cast around a correlated steel reinforcing beam structure (e.g., steel rebar). In some embodiments, the steel reinforcement is pretensioned prior to casting the composition around the steel framework. In other embodiments, beams may be cast with a steel reinforcing cage that is mechanically anchored to the concrete beam. The beams formed from the compositions of the invention may also employ additional structural support components such as, but not limited to cables, wires and mesh composed of steel, ductile iron, polymeric fibers, aluminum or plastic. The structural support components may be employed parallel, perpendicular, or at some other angle to the carried load. The molded or casted composition may be further compacted by roller compaction, hydraulic pressure, vibrational compaction, or resonant shock compaction. The composition is further allowed to set and is cured in an environment with a controlled temperature and humidity. In addition, the beams may include a variety of further components, such as but not limited to, plasticizers, foaming agents, accelerators, retarders and air entrainment additives. Where desired, the further components may include chemical admixtures such that the beams possess increased resistance to damage by bio-degradation, frost, water, fire and corrosion.

Another building material formed from the compositions of the invention is a column, which, in a broad sense, refers to a vertical load-bearing structure that carries loads chiefly through axial compression and includes structural elements such as compression members. Other vertical compression members formed from the compositions of the invention may include, but are not limited to pillars, piers, pedestals, or posts. Columns may be rigid, upright supports, composed of relatively few pieces. Columns may also be decorative pillars having a cylindrical or polygonal, smooth or fluted, tapered or straight shaft with a capital and usually a base, among other configurations. The capital and base of the column may have a similar shape as the column or may be different. Any combination of shapes for the capital and base on a column are possible. Polygonal columns possess a width that is not more than four times its thickness. Columns formed from the compositions of the invention may be constructed such that they are solid, hollow (e.g., decorative columns), reinforcement filled, or any combination thereof. Columns formed from the compositions of the invention can be short columns (i.e., columns where strength is governed by construction components and the geometry of its cross section) or slender columns (i.e., cross-sectional dimensions that are less than 5 times its length). The dimensions of the column may vary greatly depending on the intended use of the structure, e.g., from being less than a single story high, to several stories high or more, and having a corresponding width. Columns may vary in their mechanical and physical properties.

Properties such as compressive and flexural strengths may vary depending on the design and intended use of the column. For example, unreinforced concrete columns may possess flexural strengths that range from 2 to 20 MPa, including 5 to 15 MPa, such as 7 to 12 MPa and compressive strengths that range from 10 to 100 MPa, including 25 to 75 MPa, such as 50 MPa. Structurally reinforced concrete columns formed from the compositions of the invention may possess considerably larger flexural strengths, ranging from 15 to 50 MPa, including 20 to 40 MPa, such as 25 to 35 MPa and compressive strengths that range from 25 to 200 MPa, including 50 to 150 MPa, such as 75 to 125 MPa. In some embodiments, columns may be composite, wherein it may act compositely with other structural units by the introduction of interfacial shear mechanisms. In other embodiments, columns may be non-composite, wherein it utilizes the properties of the basic column alone. In producing columns, the composition after combination with water may be poured into a column form or cast around a correlated steel reinforcing column structure (e.g., steel rebar). In some embodiments, the steel reinforcement is pre-tensioned prior to casting the composition around the steel framework. In other embodiments, columns may be cast with a steel reinforcing cage that is mechanically anchored to the concrete column. The columns formed from the compositions of the invention may also employ additional structural support components such as, but not limited to, cables, wires and mesh composed of steel, ductile iron, polymeric fibers, aluminum or plastic. The structural support components may be employed parallel, perpendicular, or at some other angle to the carried load. The molded or casted composition may be further compacted by roller compaction, hydraulic pressure, vibrational compaction, or resonant shock compaction. The composition is further allowed to set and is cured in an environment with a controlled temperature and humidity. In addition, the columns formed from the compositions of the invention may include a variety of additional components, such as but not limited to, plasticizers, foaming agents, accelerators, retarders and air entrainment additives. Where desired, these additional components may include chemical admixtures such that the columns possess increased resistance to damage by bio-degradation, frost, water, fire and corrosion.

Another building material formed from the compositions of the invention is a concrete slab. Concrete slabs are those building materials used in the construction of prefabricated foundations, floors and wall panels. In some instances, a concrete slab may be employed as a floor unit (e.g., hollow plank unit or double tee design). In other instances, a precast concrete slab may be a shallow precast plank used as a foundation for in-situ concrete formwork. Wall panels are, in a broad sense, vertical load-bearing members of a building that are polygonal and possess a width that is more than four times its thickness. Precast concrete foundation, floors and wall panels may vary considerably in dimension depending on the intended use of the precast concrete slab (e.g., one or two storey building). As such, precast concrete slabs may have dimensions which range from 1 to 10 m in length or longer, including 3 to 8 m, such as 5 to 6 m; height that ranges from 1 to 10 m or taller, including 4 to 10 m, such as 4 to 5 m; and a thickness that may range from 0.005 to 0.25 m or thicker, including 0.1 to 0.2 m such as 0.1 to 0.15 m. Formed building materials such as slabs, and structures made therefrom, may be thicker than corresponding structures that lack components of the composition of the invention. In addition, structures made from amorphous building materials formed from the composition of the invention may be thicker than corresponding structures that are not formed from the composition of the invention. In some embodiments, thickness of formed building materials or related structures is increased by 1.5 fold or more, 2-fold or more, or 5-fold or more. Concrete slabs formed from the compositions of the invention may vary in their mechanical and physical properties depending on their intended use. For example, a prefabricated slab that is employed in a floor unit may possess larger flexural strengths and lesser compressive strengths than a slab that is employed as a load-bearing wall. For example, unreinforced concrete slabs may possess flexural strengths that vary, ranging from 2 to 25 MPa, including 5 to 15 MPa, such as 7 to 12 MPa and compressive strengths that range from 10 to 100 MPa, including 25 to 75 MPa, such as 50 MPa. Structurally reinforced concrete slabs may possess considerably larger flexural strengths, ranging from 15 to 50 MPa, including 20 to 40 MPa, such as 25 to 35 MPa and compressive strengths that range from 25 to 200 MPa, including 50 to 150 MPa, such as 75 to 125 MPa. In producing concrete slabs, the composition after combination with water may be poured into a slab mold or cast around a correlated steel reinforcing structure (e.g., steel rebar). In some embodiments, the steel reinforcement is pretensioned prior to casting the composition around the steel framework. In other embodiments, slabs of the invention may be cast with a steel reinforcing cage that is mechanically anchored to the concrete slab. In some embodiments, the concrete slabs of the invention may improve its structural capacity by casting a second, supportive concrete layer that is mechanically anchored to the previously precast concrete slab. The slabs of the invention may also employ additional structural support components such as, but not limited to, cables, wires and mesh composed of steel, ductile iron, polymeric fibers, aluminum or plastic. The structural support components may be employed parallel, perpendicular, or at some other angle to the carried load. The molded or casted composition may be further compacted by roller compaction, hydraulic pressure, vibrational compaction, or resonant shock compaction. The composition is further allowed to set and is cured in an environment with a controlled temperature and humidity. In addition, the slabs may include a variety of further components, such as but not limited to, plasticizers, foaming agents, accelerators, retarders and air entrainment additives. Where desired, the further components may include chemical admixtures such that the slabs possess increased resistance to damage by bio-degradation, frost, water, fire and corrosion.

Another building material formed from the compositions of the invention is an acoustic barrier, which refers to a structure used as a barrier for the attenuation or absorption of sound. As such, an acoustic barrier may include, but is not limited to, structures such as acoustical panels, reflective barriers, absorptive barriers, reactive barriers, etc. Acoustic barriers may widely vary in size and shape. Acoustic barriers may be polygonal, circular, or any other shape depending on its intended use. Acoustic barrier may be employed in the attenuation of sound from highways, roadways, bridges, industrial facilities, power plants, loading docks, public transportation stations, military facilities, gun ranges, housing complexes, entertainment venues (e.g., stadiums, concert halls) and the like. Acoustic barriers may also be employed for sound insulation for the interior of homes, music studios, movie theaters, classrooms, etc. The acoustic barriers may have dimensions that vary greatly depending on its intended use, ranging from 0.5 to 10 m in length or longer, e.g., 5 m and 0.1 to 10 m in height/width or wider, e.g., 5 m and a thickness ranging from 10 to 100 cm, or thicker e.g., 25 to 50 cm, including 40 cm. Where desired, the acoustic barrier may be employed with various coatings or liners (e.g., polymeric), and may be configured for easy joining with each other or pillars separating additional acoustic barriers to produce long acoustic barrier structures made up of multiple acoustic barriers of the invention. In some embodiments, acoustic barriers formed from the compositions of the invention may employ sound absorptive material (e.g., wood shavings, textile fibers, glass wool, rock wool, polymeric foam, vermiculite, etc.) in addition to a structurally reinforcing framework. In some embodiments, acoustic barriers may be used as noise-reduction barriers in an outdoor environment (e.g., along a highway, near an airport, etc.) and may be employed with structural support components (e.g., columns, posts, beams, etc.). In producing acoustic barriers formed from the compositions of the invention, the composition of the invention after combination with water is poured into a mold to form the desired acoustic barrier shape and size. Also the composition may be poured out into a sheet mold or a roller may be used to form sheets of a desired thickness. The shaped composition may be further compacted by roller compaction, hydraulic pressure, vibrational compaction, or resonant shock compaction. The sheets are then cut to the desired dimensions of the acoustic barriers. In some instances, the resultant composition may also be foamed using mechanically or chemically introduced gases prior to being shaped or while the composition is setting in order to form a lightweight acoustic panel structure. The shaped composition is further allowed to set and is cured in an environment with a controlled temperature and humidity. In addition, the acoustic barriers may include a variety of further components, such as but not limited to, plasticizers, foaming agents, accelerators, retarders and air entrainment additives. Where desired, the further components may include chemical admixtures such that they possess increased resistance to damage by bio-degradation, frost, water, fire and corrosion. In some embodiments, the acoustic barriers may employ structural support components such as, but not limited to, cables, wires and mesh composed of steel, ductile iron, polymeric fibers, aluminum or plastic.

Another building material formed from the compositions of the invention is an insulation material, which refers to a material used to attenuate or inhibit the conduction of heat. Insulation may also include those materials that reduce or inhibit radiant transmission of heat. Insulation material formed from the compositions of the invention may consist of one or more of the following constituents: a cementitious forming material, a dispersing agent, an air entraining agent, inert densifying particulate, a mixture of ionic and non-ionic surfactants, plasticizers, accelerators, lightweight aggregate, organic and inorganic binding agents and glass particles. In certain embodiments of the invention, an amount of cementitious forming material may be replaced by the above described composition of the invention. Binding compositions for the insulation material of the invention include a component selected from the group consisting of carbides, Gypsum powder, Blakite, nitrides, calcium carbonate, oxides, titanates, sulfides, zinc selenide, zinc telluride, inorganic siloxane compound and their mixtures thereof. In certain embodiments of the invention, an amount of the binding composition may be replaced by the above described composition of the invention. Where desired, insulation material of the invention may also be prepared using a chemical admixture or any other convenient protocol such that they are resistant to damage by termites, insects, bacteria, fungus. Etc. Insulation materials may be prepared using any convenient protocol such that they are freeze/thaw, rain and fire resistant. Insulation material formed from the compositions of the invention may be prepared in accordance with traditional manufacturing protocols for such materials, with the exception that the composition of the invention is employed. In producing the insulation materials of the invention, an amount of the composition of the invention may be combined with water and other components of the insulation material, which may include, but are not limited to a dispersing agent, an air entraining agent, inert densifying particulate, a mixture of ionic and non-ionic surfactants, plasticizers, accelerators, lightweight aggregate, organic and inorganic binding agents and glass particles. The resultant insulation material may then be molded into the desired shape (e.g., wall panel) or poured into the void space of concrete masonry units, flooring units, roof decks or cast around pipes, conduits and basins.

### Aggregate

In some embodiments, the invention provides a synthetic rock or an aggregate comprising the composition of the invention or or the set and hardened form thereof. In some embodiments, the aggregate is made from the compositions of the invention. The aggregates and the methods of making and using the aggregates are described in U.S. application Ser. No. 12/475,378, filed May 29, 2009, which is incorporated herein by reference in its entirety. The aggregate may be formed from hydraulic cement or SCM or self-cementing composition of the invention. In some embodiments, aggregates are formed, in whole or in part, from compositions of the invention that have been exposed to freshwater and allowed to harden into stable compounds, which may then be further processed, if necessary, to form particles as appropriate to the type of aggregate desired. In some embodiments, aggregates are formed from compositions of the invention exposed to conditions of temperature and/or pressure that convert them into stable compounds. The invention further provides structures, such as roadways, buildings, dams, and other manmade structures, containing the synthetic rock or aggregates made from the compositions of the invention.

In some embodiments, some or all the embodiments recited above for the composition of the invention are also found in the aggregates made from the compositions of the invention. Since these structures or aggregates are produced from the compositions of the invention, they may include markers or one or more elements that identify them as being obtained from carbonate brines and/or being obtained from water having trace amounts of various elements present in the initial salt water source, as described herein. For example, where the mineral component of the of the aggregate or the structure is one that has been produced from sea water, the set product will contain a seawater marker profile of different elements in identifying amounts, such as magnesium, potassium, sulfur, boron, sodium, and chloride, etc. In some embodiments, where the mineral component of the aggregate or the structure is one that has been produced from carbonate brine, the set product will contain the carbonate brine marker profile of different elements in identifying amounts, such as, but are not limited to, one or more of barium, cobalt, copper, lanthanum, mercury, arsenic, cadmium, lead, nickel, scandium, titanium, zinc, zirconium, molybdenum, and selenium.

The term aggregate is used herein in its art-accepted manner to include a particulate composition that finds use in concretes, mortars and other materials, e.g., roadbeds, asphalts, and other structures and is suitable for use in such structures. Aggregates formed from the compositions of the invention are particulate compositions that may in some embodiments be classified as fine or coarse. Fine aggregates according to embodiments of the invention are particulate compositions that almost entirely pass through a Number 4 sieve (ASTM C 125 and ASTM C 33). Fine aggregate compositions have an average particle size ranging from 0.001 inch (in) to 0.25 in, such as 0.05 in to 0.125 in and including 0.01 in to 0.08 in. Coarse aggregates formed from the compositions of the invention are compositions that are predominantly retained on a Number 4 sieve (ASTM C 125 and ASTM C 33). Coarse aggregate compositions formed from the compositions of the invention, are compositions that have an average particle size ranging from 0.125 in to 6 in, such as 0.187 in to 3.0 in and including 0.25 in to 1.0 in. As used herein, “aggregate” may also in some embodiments encompass larger sizes, such as 3 in to 12 in or even 3 in to 24 in, or larger, such as 12 in to 48 in, or larger than 48 in, e.g., such as sizes used in riprap and the like. In some embodiments, such as producing wave-resistant structures for the ocean, the sizes may be even larger, such as over 48 in, e.g., over 60 in, or over 72 in.

Significant properties of the compositions may include one or more of hardness, abrasion resistance, density, porosity, chemical composition, mineral composition, isotopic composition, size, shape, acid resistance, alkaline resistance, leachable chloride content, retention of CO₂, reactivity (or lack thereof).

Aggregates formed from the compositions of the invention have a density that may vary so long as the aggregate provides the desired properties for the use for which it will be employed, e.g., for the building material in which it is employed. In certain instances, the density of the aggregate particles ranges from 1.1 to 5 gm/cc, such as 1.3 gm/cc to 3.15 gm/cc, and including 1.8 gm/cc to 2.7 gm/cc. Other particle densities in embodiments of the invention, e.g., for lightweight aggregates, may range from 1.1 to 2.2 gm/cc, e.g, 1.2 to 2.0 g/cc or 1.4 to 1.8 g/cc. In some embodiments the invention provides aggregates that range in bulk density (unit weight) from 50 lb/ft³ to 200 lb/ft³, or 75 lb/ft³ to 175 lb/ft³, or 50 lb/ft³ to 100 lb/ft³, or 75 lb/ft³ to 125 lb/ft³, or 90 lb/ft³ to 115 lb/ft³, or 100 lb/ft³ to 200 lb/ft³, or 125 lb/ft³ to 175 lb/ft³, or 140 lb/ft³ to 160 lb/ft³, or 50 lb/ft³ to 200 lb/ft³. Some embodiments of the invention provide lightweight aggregate, e.g., aggregate that has a bulk density (unit weight) of 75 lb/ft³ to 125 lb/ft³. Some embodiments of the invention provide lightweight aggregate, e.g., aggregate that has a bulk density (unit weight) of 90 lb/ft³ to 115 lb/ft³.

The hardness of the aggregate particles making up the aggregate may also vary, and in some embodiments, the hardness, expressed on the Mohs scale, ranges from 1.0-9; or 1-7; or 1-6; or 1-5; or 1-4; or 2-9; or 2-8; or 2-7; or 2-5; or 2-4; or 3-9; or 3-7; or 3-6; or 4-9; or 4-7; or 4-6; or 5-9; or 5-7; or 6-9; or 6-8; or 8-9. Other hardness scales may also be used to characterize the aggregate, such as the Rockwell, Vickers, or Brinell scales, and equivalent values to those of the Mohs scale may be used to characterize the aggregates of the invention; e.g., a Vickers hardness rating of 250 corresponds to a Mohs rating of 3; conversions between the scales are known in the art.

The abrasion resistance of an aggregate may also be of significance, e.g., for use in a roadway surface, where aggregates of high abrasion resistance are useful to keep surfaces from polishing. Abrasion resistance is related to hardness but is not the same. Aggregates include aggregates that have an abrasion resistance similar to that of natural limestone, or aggregates that have an abrasion resistance superior to natural limestone, as well as aggregates having an abrasion resistance lower than natural limestone, as measured by art accepted methods, such as ASTM C131-03. In some embodiments aggregates made from the compositions of the invention have an abrasion resistance of less than 50%, or less than 40%, or less than 35%, or less than 30%, or less than 25%, or less than 20%, or less than 15%, or less than 10%, or between 10% to 50% when measured by ASTM C131-03.

Aggregates may also have a porosity within a particular ranges. As will be appreciated by those of skill in the art, in some cases a highly porous aggregate is desired, in others an aggregate of moderate porosity is desired, while in other cases aggregates of low porosity, or no porosity, are desired. Porosities of aggregates in some embodiments of the invention, as measured by water uptake after oven drying followed by full immersion for 60 minutes, expressed as % dry weight, can be in the range of 1-40%, such as 2-20%, or 2-15%, including 2-10% or even 3-9%.

In addition, aggregates formed from the compositions of the invention may further include or exclude substances such as chloride. These substances are considered undesirable in some applications; for example, chloride is undesirable in aggregates intended for use in concrete because of its tendency to corrode rebar. However, in some uses, such as base course for a roadway, aggregate containing chloride may be acceptable. Methods of making aggregates from the compositions of the invention may include one or more steps to minimize the chloride and/or sodium content of the aggregate, if chloride is a component of the starting materials. In some embodiments, such a step or steps is not necessary as the intended final use of the aggregate is relatively insensitive to the content of these materials. Thus, in some embodiments, the leachable chloride content of the aggregates of the invention is less than 5%. In some embodiments, the leachable chloride content of the aggregate ranges from 0.0001% to 0.05%. In some embodiments the leachable chloride content is less than 0.05%, in some embodiments the leachable chloride content is les than 0.1%, and in some embodiments the leachable chloride content is less than 0.5%.

The aggregate formed from the compositions of the invention may be of any size and shape suitable for a particular use, as described further herein. As the aggregates are synthetic, both the size and the shape may be substantially controlled, allowing for a great variety of specific aggregates as well as aggregate mixes, as described further. In some embodiments, the invention provides coarse aggregate, e.g., compositions that are predominantly retained on a Number 4 sieve (ASTM C 125 and ASTM C 33). Coarse aggregate formed from the compositions of the invention has an average particle size ranging from 0.125 in to 6 in, such as 0.187 in to 3.0 in and including 0.25 in to 1.0 in. Fine aggregate formed from the compositions of the invention has an average particle size ranging from 0.001 inch (in) to 0.25 in, such as 0.05 in to 0.125 in and including 0.01 in to 0.08 in.

Aggregates formed from the compositions of the invention may be reactive or non-reactive. Reactive aggregate are those aggregate particles that upon initiation by a substance (e.g., water) undergo a reaction with constituents (e.g., compounds) in other aggregate particles to form a reaction product. In some embodiments, the reaction product may be a matrix between aggregate particles forming a stabilizing structure. In some embodiments, the matrix formed may be an expansive gel that, depending on the environment, may act to destabilize the mass; in some cases where there is room for the expansive gel to expand, e.g., in aggregate that is laid as part of a road bed, with void spaces, a reactive aggregate of this type is acceptable. Aggregate formed from the compositions of the invention may also be non-reactive.

In some embodiments, the invention provides aggregates that are resistant to acid, resistant to base, or resistant to both acid and base. For example, in some embodiments, the invention provides aggregates that, when exposed to a pH of 2, 3, 4, or 5, depending on the test desired (e.g., an H₂SO₄ solution that has been diluted to a pH of 2, 3, 4, or 5), release less than 1, 0.1, 0.01, or 0.001% of the CO₂ contained in the aggregate in a 48 hour period, or a 1-week period, or a 5-week period, or a 25-week period, while remaining intact and retaining a portion or substantially all of its hardness, abrasion resistance, and the like. Similar results may be obtained for aggregates formed from the compositions of the invention that are resistant to base, e.g., when exposed to a pH of 12, 11, 10, or 9, release less than 1, 0.1, 0.01, or 0.001% of their CO₂ in a 48 hour, lweek, 5 week, or 25 week period, while remaining intact and retaining a portion or substantially all of its hardness, abrasion resistance, and the like. The aggregates may be ground to a standard surface area or sieve size before conducting such tests. Carbon content of the material may be monitored by, e.g., coulometry, or any other suitable method.

In some embodiments, the invention provides a lightweight aggregate formed from the compositions of the invention, e.g., an aggregate with a bulk density of 75-125 lb/ft³, or 90-115 lb/ft³. The lightweight aggregate in some embodiments contains carbonate and sulfate or sulfite, or a combination of sulfate and sulfite. In some embodiments, the molar ratio of carbonate to sulfate and/or sulfite is 1000:1 to 10:1, or 500:1 to 50:1, or 300:1 to 75:1.

In some of these embodiments, the aggregate further contains one or more elements including, but are not limited to, barium, cobalt, copper, lanthanum, mercury, arsenic, cadmium, lead, nickel, scandium, titanium, zinc, zirconium, molybdenum, and selenium, which may originate from a subterranean carbonate brine. In some embodiments, the aggregate contains dypingite.

In some embodiments, the invention provides a customized set of aggregates formed from the compositions of the invention, e.g., a set of aggregates with a plurality of characteristics that is chosen to match a predetermined set of characteristics, such as at least two, three, four, or five of size, shape, surface texture, hardness, abrasion resistance, density, porosity, acid stability, base stability, CO₂ release stability, and color. In some embodiments, the invention provides a set of aggregates formed from the compositions of the invention with a plurality of characteristics that are chosen to match a predetermined set of characteristics, where the characteristics include size, shape, and hardness. In some embodiments, the invention provides a set of aggregates formed from the compositions of the invention with a plurality of characteristics that are chosen to match a predetermined set of characteristics, where the characteristics include size, shape, hardness, and surface texture. In some embodiments, the invention provides a set of aggregates formed from the compositions of the invention with a plurality of characteristics that are chosen to match a predetermined set of characteristics, where the characteristics include size, shape, hardness, and density. In some embodiments, the invention provides a set of aggregates formed from the compositions of the invention with a plurality of characteristics that are chosen to match a predetermined set of characteristics, where the characteristics include size, shape, and density.

The aggregate may have particle shapes including, but not limited to, rounded, irregular, flaky, angular, elongated, flaky-elongated, subangular, subrounded, well rounded and any mixtures thereof; in some cases the aggregate further has particle surface textures that include, but are not limited to, glassy, smooth, granular, rough, crystalline, honeycombed and mixtures thereof. In some embodiments, the aggregate has particle shapes that include, but are not limited to, polygonal, cylindrical, spherical, triangular, curved shapes, annulus, ellipsoidal, oval, star shaped, prisms or any mixtures thereof; and in some cases may further have particle surface textures that include, but are not limited to, glassy, smooth, granular, rough, crystalline, honeycombed and mixtures thereof. The aggregate may have a Mohs hardness that ranges from about 1.5 to 9, such as about 2.5 to 6, or equivalent hardness on the Rockwell, Vickers, or Brinell scales. Any of the above aggregates may further include one or more of: Portland cement, fly ash, lime and a binder, for example, Portland cement, such as where the weight ratio of the synthetic carbonate and Portland cement ranges from 0.1/1 to 5/1. The aggregate has a unit density of between 100 to 150 lb/ft³, such as between 75-125 lb/ft³.

In some embodiments, the invention provides an aggregate formed from the compositions of the invention suitable for use in a building material wherein the aggregate has a unit density of less than 115 lb/cu ft and is a carbon negative aggregate.

In some embodiments, the invention provides road base comprising aggregate made from the compositions of the invention, described herein. In some embodiments, the invention provides an asphalt comprising aggregate made from the compositions of the invention, described herein.

In some embodiments, the invention provides a concoidally-fracturing aggregate.

### II. Methods and Systems

### Methods and Systems for Making the Composition

Aspects of the invention include methods and systems for making the composition of the invention. The method to produce the compositions of the invention includes source of cations, source of carbon, such as, carbonate brine, and an optional source of alkalinity, depending upon the materials used for the process.

In one aspect, this invention relates to methods for making a carbonate containing material, such as solid material using a source of cation and a source of carbon where the source of carbon is carbonate brine. In such methods, the carbonate brine may also provide alkalinity. Optionally a proton removing agent may be added to the source of carbon or the source of cations to optimize the pH of the solution such that the carbonate containing material is formed. Accordingly, in one aspect, there is provided a method including contacting a source of cations with a carbonate brine to give a reaction product comprising carbonic acid, bicarbonate, carbonate, or mixture thereof. In some embodiments, the reaction product is used to make the compositions provided herein. In some embodiments, the reaction product includes a precipitated material which after filteration results in the composition of the invention. In some embodiments, the reaction product includes a precipitated material and the mother liquor containing the precipitated material. In some embodiments, the reaction product includes a slurry made from dewatering the precipitated material. The reaction product may be subjected to one or more of steps including, but not limited to, precipitation, filteration, dewatering, washing the precipitate, drying the precipitate, milling the precipitate, and storing the precipitate, to give the composition of the invention. The reaction product may be used as is for making the self-cementing compositions of the invention. In one aspect, there is provided a method comprising contacting a source of cations with a carbonate brine to give the composition of the invention. It is to be understood that the reaction product may have the components, properties, and characteristics of the compositions of the invention, as described herein.

In some embodiments, the compositions of the invention are not formed from flue gas or from a carbon dioxide source. In some embodiments, the compositions of the invention are formed from a solution containing no more than 5% by wt; or no more than 1% by wt; or no more than 0.1% by wt; or between 0.1-5% by wt; or between 1-5% by wt, of the dissolved carbon dioxide from flue gas. In some embodiments, some carbon dioxide may be added to the carbonate brine to convert the carbonate to bicarbonates. In such embodiments, the carbon dioxide may be from flue gas. In still such embodiments, the amount of carbon dioxide dissolved in the carbonate brine may be between about 1% to 20% by wt.

### Source of Cations

“Source of cations” includes any solid or solution that contains mono or divalent cations, such as, sodium, potassium, alkaline earth metal ions, or combination thereof, or any aqueous medium containing sodium, potassium, alkaline earth metals, or combinations thereof. The alkaline earth metals include calcium, magnesium, strontium, barium, etc. or combinations thereof. The source of cations employed in the invention may be an alkaline-earth-metal-containing water, such as, fresh water or saltwater, depending on the method employing the water. In some embodiments, the water employed in the process includes one or more alkaline earth metals, e.g., magnesium, calcium, etc. In some embodiments, the source of cations contains one or more of the alkaline earth metal ions in an amount of 1% to 99% by wt; or 1% to 95% by wt; or 1% to 90% by wt; or 1% to 80% by wt; or 1% to 70% by wt; or 1% to 60% by wt; or 1% to 50% by wt; or 1% to 40% by wt; or 1% to 30% by wt; or 1% to 20% by wt; or 1% to 10% by wt; or 20% to 95% by wt; or 20% to 80% by wt; or 20% to 50% by wt; or 50% to 95% by wt; or 50% to 80% by wt; or 50% to 75% by wt; or 75% to 90% by wt; or 75% to 80% by wt; or 80% to 90% by wt of the solution containing the alkaline earth metal ions. In some embodiments, the source of cations is saltwater, such as, seawater. In some embodiments, the source of cations is hard water or naturally occurring hard brines.

“Saltwater” is employed in its conventional sense to refer to a number of different types of aqueous fluids other than fresh water, where the term “saltwater” includes brackish water, sea water and brine (including, naturally occurring subterranean brines or anthropogenic subterranean brines and man-made brines, e.g., geothermal plant wastewaters, desalination waste waters, etc), as well as other salines having a salinity that is greater than that of freshwater. Brine is water saturated or nearly saturated with salt and has a salinity that is 50 ppt (parts per thousand) or greater. Brackish water is water that is saltier than fresh water, but not as salty as seawater, having a salinity ranging from 0.5 to 35 ppt. Seawater is water from a sea or ocean and has a salinity ranging from 35 to 50 ppt. Fresh water is water with no or low concentration of salt or total dissolved solids. In some embodiments, fresh water is water with less than 0.5 ppt salt or total dissolved solids.

The saltwater source from which the composition of the invention is derived may be a naturally occurring source, such as a sea, ocean, lake, swamp, estuary, lagoon, etc., or a man-made source. The compositions of the invention may be produced by precipitation from alkaline-earth-metal-containing water, such as, a saltwater (may be called saltwater derived composition), or a freshwater with added alkaline earth metal ions. The saltwater employed in methods may vary.

In some embodiments, the water employed in the invention may be a mineral rich, e.g., calcium and/or magnesium rich, freshwater source. In some embodiments, calcium rich waters may be combined with magnesium silicate minerals, such as olivine or serpentine. The acidity in the solution, due to the addition of carbonate brines, may dissolve the magnesium silicate, leading to the formation of calcium magnesium silicate carbonate compounds.

In some embodiments, the compositions are obtained from a saltwater, e.g., by treating a volume of a saltwater in a manner sufficient to produce the desired composition of the invention from the initial volume of saltwater. In certain embodiments, the compositions of the invention are derived from saltwater by precipitating them from the saltwater. In certain embodiments, the compositions of the invention are separated in a solid form from the saltwater. The compositions of the invention may be more stable in salt water than in freshwater, such that they may be viewed as saltwater metastable compositions.

In certain embodiments, the water may be obtained from the power plant that is also providing the gaseous waste stream. For example, in water cooled power plants, such as seawater cooled power plants, water that has been employed by the power plant may then be sent to the precipitation system and employed as the water in the precipitation reaction. In certain of these embodiments, the water may be cooled prior to entering the precipitation reactor.

In some embodiments, the source of cations does not contain a dissolved CO₂ from flue gas. In some embodiments, the solution containing the source of cations does not contain more than 5% by wt; or more than 1% by wt; or more than 0.1% by wt; or contains between 0.1-5% by wt; or between 1-5% by wt, of the dissolved carbon dioxide from flue gas.

Divalent cations (e.g., alkaline earth metal cations such as Ca²⁺ and Mg²⁺), which are useful for producing precipitation material or the composition of the invention, may be found in industrial wastes, seawater, brines, hard water, minerals, and many other suitable sources.

In some locations, industrial waste streams from various industrial processes provide for convenient sources of cations (as well as in some cases other materials useful in the process, e.g., metal hydroxide). Such waste streams include, but are not limited to, mining wastes; fossil fuel burning ash (e.g., fly ash, bottom ash, boiler slag); slag (e.g., iron slag, phosphorous slag); cement kiln waste (e.g., cement kiln dust); oil refinery/petrochemical refinery waste (e.g., oil field and methane seam brines); coal seam wastes (e.g., gas production brines and coal seam brine); paper processing waste; water softening waste brine (e.g., ion exchange effluent); silicon processing wastes; agricultural waste; metal finishing waste; high pH textile waste; and caustic sludge.

In some locations, a convenient source of cations for use in systems and methods of the invention is water (e.g., an aqueous solution comprising cations such as seawater or subterranean brine), which may vary depending upon the particular location at which the invention is practiced. Suitable aqueous solutions of cations that may be used include solutions comprising one or more divalent cations, e.g., alkaline earth metal cations such as Ca²⁺ and Mg²⁺. In some embodiments, the aqueous source of cations comprises alkaline earth metal cations. In some embodiments, the alkaline earth metal cations include calcium, magnesium, or a mixture thereof. In some embodiments, the aqueous solution of cations comprises calcium in amounts ranging from 50 to 50,000 ppm, 50 to 40,000 ppm, 50 to 20,000 ppm, 100 to 10,000 ppm, 200 to 5000 ppm, or 400 to 1000 ppm.

Freshwater may be a convenient source of cations (e.g., cations of alkaline earth metals such as Ca²⁺ and Mg²⁺). Any of a number of suitable freshwater sources may be used, including freshwater sources ranging from sources relatively free of minerals to sources relatively rich in minerals. Mineral-rich freshwater sources may be naturally occurring, including any of a number of hard water sources, lakes, or inland seas. Some mineral-rich freshwater sources such as alkaline lakes or inland seas (e.g., Lake Van in Turkey) also provide a source of pH-modifying agents. Mineral-rich freshwater sources may also be anthropogenic. For example, a mineral-poor (soft) water may be contacted with a source of cations such as alkaline earth metal cations (e.g., Ca²⁺, Mg²⁺, etc.) to produce a mineral-rich water that is suitable for methods and systems described herein. Cations or precursors thereof (e.g., salts, minerals) may be added to freshwater (or any other type of water described herein) using any convenient protocol (e.g., addition of solids, suspensions, or solutions). In some embodiments, divalent cations selected from Ca²⁺ and Mg²⁺ are added to freshwater. In some embodiments, monovalent cations selected from Na⁺ and K⁺ are added to freshwater. In some embodiments, freshwater comprising Ca²⁺ is combined with magnesium silicates (e.g., olivine or serpentine), or products or processed forms thereof, yielding a solution comprising calcium and magnesium cations.

### Brines

In some embodiments, brines may serve various purposes, such as, but not limited to, providing a source of carbon, a source of cations, and/or a source of alkalinity. In some embodiments, the source of carbon in brine is carbonate and/or bicarbonate. Such brines may be called carbonate brines or carbonate rich brines or soda bearing brines. As used herein, “carbonate brine” includes any brine containing carbonate and/or bicarbonate. The brine can be synthetic brine such as a solution of brine containing the carbonate, e.g., sodium bicarbonate or sodium carbonate, or the brine can be naturally occurring brine, e.g., subterranean brine such as naturally occurring lakes. The synthetic brine can be made from the naturally occurring carbonate and/or bicarbonate minerals by crushing and dissolving the minerals in brine. The carbonate and/or bicarbonate minerals can be found under the surface, on the surface, or subsurface of the lakes. Some examples of the carbonate and/or bicarbonate minerals are as described below. The carbonate and/or bicarbonate in the brines may provide a source of alkalinity as well as the source of carbon to make calcium carbonate compositions of the invention.

In some embodiments, the subterranean brines of this invention may be a convenient source for carbonate and/or bicarbonate, divalent cations, monovalent cations, proton removing agents, or any combination thereof. The subterranean brine that is employed in embodiments of the invention may be from any convenient subterranean brine source. “Subterranean brine” is employed in its conventional sense to include naturally occurring or anthropogenic, aqueous saline compositions obtained from a geological location. The geological location of the subterranean brine can be found below ground (subterranean geological location), on the surface, or subsurface of the lakes. The aqueous saline composition may be a concentrated aqueous saline composition including an aqueous solution which has a salinity of 500 ppm total dissolved solids (TDS) or greater, 5,000 ppm total dissolved solids (TDS) or greater, 10,000 ppm total dissolved solids (TDS) or greater, such as 20,000 ppm TDS or greater and including 50,000 ppm TDS or greater or between 5,000 ppm to 100,000 ppm. Subterranean brines of the invention may be subterranean aqueous saline compositions and in some embodiments, may have circulated through crustal rocks and become enriched in substances leached from the surrounding mineral.

Subterranean geological location includes a geological location which is located below ground level. The ground level includes a solid-fluid interface of the earth's surface, such as a solid-gas interface as found on dry land where dry land meets the earth's atmosphere, as well as a liquid-solid interface as found beneath a body of surface water (e.g., lack, ocean, stream, etc) where solid ground meets the body of water (where examples of this interface include lake beds, ocean floors, etc). As such, the subterranean location can be a location beneath land or a location beneath a body of water (e.g., oceanic ridge). For example, a subterranean location may be a deep geological alkaline aquifer or an underground well located in the sedimentary basins of a petroleum field, a subterranean metal ore, a geothermal field, or an oceanic ridge, among other underground locations.

In some embodiments, a single carbonate brine may be employed or a mixture of two or more carbonate brines may be employed for the methods of the invention. A single carbonate brine includes a carbonate brine which is either a synthetic brine or has been obtained from a single, distinct geological location (e.g., underground well or a naturally occurring lake or deposit). A mixture of two or more carbonate brines includes mixing of two or more carbonate brines, where each carbonate brine is obtained from a distinct geological location or is a mixture of a synthetic brine and a naturally occurring brine. In embodiments where a mixture of two or more carbonate brines are employed, at least one brine may serve as a carbonate brine; at least one brine may serve as a source of cations (e.g., hard brines); and/or at least one brine may serve as a source of alkalinity. It is to be understood that a single carbonate brine may serve both as a source of carbonate and a source of alkalinity.

The subterranean geological location may be a location that is 100 m or deeper below ground level, or 200 m or deeper below ground level, or 300 m or deeper below ground level, or 400 m or deeper below ground level, or 500 m or deeper below ground level, or 600 m or deeper below ground level, or 700 m or deeper below ground level, or 800 m or deeper below ground level, or 900 m or deeper below ground level, or 1000 m or deeper below ground level, including 1500 m or deeper below ground level, 2000 m or deeper below ground level, 2500 m or deeper below ground level and 3000 m or deeper below ground level. In some embodiments, a subterranean location is a location that is between 100 m and 3500 m below ground level, such as between 200 m and 2500 m below ground level, such as between 200 m and 2000 m below ground level, such as between 200 m and 1500 m below ground level, such as between 200 m and 1000 m below ground level and including between 200 m and 800 m below ground level. Subterranean brines of the invention may include, but are not limited to, oil-field brines, basinal brines, basinal water, pore water, formation water, and deep sea hypersaline waters, among others.

The carbonate present in the carbonate brines of the invention may include a dissolved CO₂ or any oxyanion of carbon, e.g., bicarbonate (HCO₃⁻), carbonic acid (H₂CO₃), or carbonate (CO₃²). Deposits of sodium carbonate and/or bicarbonate are found in large quantities in countries like United States, China, Botswana, Uganda, Kenya, Mexico, Peru, India, Egypt, South Africa and Turkey. It is found both as extensive beds of sodium minerals and as sodium-rich waters (brines).

The origin of sodium carbonate and/or bicarbonate in natural deposits can be due to various reasons, including (a) evaporation of sodium carbonate and/or bicarbonate-rich thermal spring water; (b) carbonation of sodium sulfide to sodium carbonate; (c) ion-exchange in sodium bearing soils; (d) concentration dependent and temperature dependent equilibrium relationships among carbon dioxide, sodium bicarbonate, and carbonate that converts carbonate solutions to sodium bicarbonate, or carbon dioxide removed from sodium bicarbonate solutions to form carbonates; and (e) leaching of alkaline carbonatites or basic ultra-basics rocks. The sodium may have been derived from the leaching of sodic feldspars or volcanic ash deposits, and the carbon dioxide from the atmosphere.

The groundwaters in metamorphic or igneous terrains produce alkaline solutions on evaporation. The absence of chloride and sulfate in these rocks permits solutions to become predominantly sodium and carbon dioxide bearing. The chemical fractionation of inflowing waters and brines within closed depositional basins can produce different minerals accumulating in separate areas.

Some types of carbonate bearing minerals that can be used to make carbonate brines are illustrated in Table VI.

TABLE VI

| Mineral name | Chemical composition | Na₂CO₃ %* |
|---|---|---|
| Thermonatrite | Na₂CO₃•H₂O | 85.5 |
| Wegscheiderite | Na₂CO₃•3NaHCO₃ | 74.0 |
| Trona (sesquicarbonate) | Na₂CO₃•NaHCO₃•2H₂O | 70.4 |
| Nahcolite | NaHCO₃ | 63.1 |
| Bradleyite | Na₂PO₄•MgCO₃ | 47.1 |
| Pirssonite | Na₂CO₃•CaCO₃•2H₂O | 43.8 |
| Tychite | 2MgCO₃•2Na₂CO₃•Na₂SO₄ | 42.6 |
| Northupite | Na₂CO₃•NaCl•MgCO₃ | 40.6 |
| Natron (washing soda) | Na₂CO₃•10H₂O | 37.1 |
| Dawsonite | NaAl(CO₃)(OH)₂ | 35.8 |
| Gaylussite | Na₂CO₃•CaCO₃•5H₂O | 35.8 |
| Shortite | Na₂CO₃•2CaCO₃ | 34.6 |
| Burkeite | Na₂CO₃•2Na₂SO₄ | 27.2 |
| Hanskite | 2Na₂CO₃•9Na₂SO₄•KCl | 13.6 |

*Includes bicarbonate converted to carbonate

It is to be understood that the carbonate and/or bicarbonate bearing minerals illustrated in Table VI are for illustrative purposes only and that other carbonate and/or bicarbonate bearing minerals known in the art, are well within the scope of the invention. The carbonate and/or bicarbonate minerals illustrated in Table VI may be present in separate deposits or may be present in the same deposit. Carbonate brines useful in the methods and compositions of the invention can be obtained from, for example, trona deposits located in Utah, California (such as, Searles Lake and Owens Lake); Green river formation in Wyoming; Colorado; and Railroad valley in Nevada; shallow-water limestones and dolostones of the Conococheague Limestone (Upper Cambrian) of western Maryland; lakes located in East African Rift Valley (e.g., Lake Bogoria, Lake Natron and Lake Magadi); lake Chad basin in Africa; lakes located in Libyan Desert in Egypt (Wadi Natrun system); and lakes located in central Asia (from south-east Siberia to north-east China) such as, Wucheng basin and Biyang basin in Henan province of China; Sambhar lake and Lonar lake in India; and Zabuye Caka, Bangkog Cuo, and Guogaling Cuo in Tibet. The carbonate and/or bicarbonate minerals include, but are not limited to, trona, minor nahcolite, and trace amounts of pirssonite and thermonatrite.

Five forms of carbonate brines include, but are not limited to, buried, surface or subsurface brines, crystalline shoreline or bottom crusts, shallow lake bottom crusts, and surface efflorescences.

Trona and dolomite are associated throughout the trona zone. Calcite, zeolites, feldspar, and clay minerals are the typical minerals found within the associated rocks of the trona deposit. The trona crystals, which are generally white and/or gray due to impurities, occur in massive units and as disseminated crystals in claystone and shale. Crude trona (“trona ore”) may comprise 80-95% of sodium sesquicarbonate (Na₂CO₃.NaHCO₃.2H₂O) and, in lesser amounts, sodium chloride (NaCl), sodium sulfate (Na₂SO₄), organic matter, and insolubles such as clay and shales. In Wyoming, these deposits are located in 25 separate identified beds or zones ranging from 800 to 2800 feet below the earth's surface and are typically extracted by conventional mining techniques, such as, the room and pillar and longwall methods.

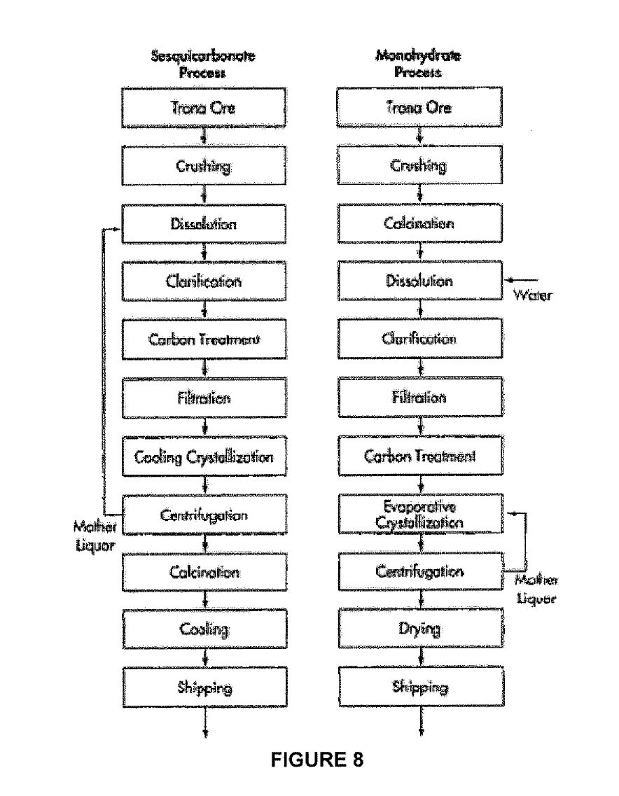

The carbonate and/or bicarbonate ores may require processing in order to recover the carbonate brines. The carbonate brines processed and recovered may be brines including only carbonate, or only bicarbonate, or both carbonate and bicarbonate ions. Typically, most of the sodium carbonate and/or bicarbonate from the Green River deposits is produced from the conventionally mined trona ore via the sesquicarbonate process or the monohydrate process. Both processes use the same procedure but in different sequences. FIG. 8 illustrates a flow diagram of both the processes.

The “monohydrate” process involves crushing and screening the bulk trona ore which, as noted above, contains both sodium carbonate (Na₂CO₃) and sodium bicarbonate (NaHCO₃) as well as impurities such as silicates and organic matter. After the ore is screened, it may be calcined (i.e., heated) at temperatures greater than 150° C. to convert sodium bicarbonate to sodium carbonate. Such conversion of the bicarbonate to carbonate may give predominantly carbonate containing brine. The crude soda ash may be dissolved in recycled liquor which may be then clarified and filtered to remove the insoluble solids. The liquor may be carbon treated to remove dissolved organic matter which may cause foaming and color problems in the final product, and may be again filtered to remove entrained carbon before going to a monohydrate crystallizer unit. This unit has a high temperature evaporator system generally having one or more effects (evaporators), where sodium carbonate monohydrate may be crystallized. The resulting slurry may then be centrifuged, and the separated monohydrate crystals may be sent to dryers to produce soda ash. The soluble impurities may be recycled with the centrate to the crystallizer where they may be further concentrated. In some embodiments of the invention, the source of cations, such as, alkaline earth metal ions or a solution containing alkaline earth metal ions (e.g., synthetic solution containing calcium or magnesium ions or naturally occurring hard brines) may be added to the ore solution at any stage of the above recited process to precipitate out the composition of the invention. For example, in some embodiments, the alkaline earth metal ions or a solution containing alkaline earth metal ions may be added to the trona ore solution once ore has been crushed, or calcined, or dissolved in liquor, or is filtered or centrifuged, as described above or as illustrated in FIG. 8.

In some embodiments, the underground ore may be subjected to solution mining where water is injected (or an aqueous solution) into a deposit of soluble ore, the solution may be allowed to dissolve as much ore as possible, and the solution may be pumped to the surface. The solution may be evaporated to produce brines with higher alkalinity or higher concentration of carbonate and/or bicarbonate ions. The alkaline earth metal ions or a solution containing alkaline earth metal ions may be added to this solution to precipitate out the carbonate composition of the invention.

In some embodiments, the alkaline earth metal ions or the solution containing alkaline earth metal ions is added to the above-ground processes which treat bulk ore that has been conventionally mined. Bulk trona (sodium sesquicarbonate), for example, may be dissolved in an aqueous solvent at high temperatures which may be difficult to achieve underground. This may allow for a higher concentration to be achieved. In some embodiments, the alkaline earth metal ions or a solution containing alkaline earth metal ions may be added to solution after the bulk ore has been dissolved in the aqueous solvent. After purification, these liquors may be cooled to recrystallize the carbonate or sesquicarbonate, which may be then calcined and converted to soda ash. In some embodiments, the alkaline earth metal ions or a solution containing alkaline earth metal ions may be added to the liquor before or after crystallization, as explained above.

In some embodiments, the bicarbonate or the carbonate content of the mined ore may be decomposed thermally in a calciner, a process which may not be performed on ore in situ. The calcined ore may then be dissolved in hot liquors to produce saturated sodium carbonate liquor. In either case, calcination of dry material may be required to convert bicarbonate values to carbonate. For example, some solution mining processes may include the addition of conventionally mined ore to the mine brine to increase the sodium content of the brine and, therefore, make the brine processable by techniques applied to conventionally mined ore. It is to be understood that the alkaline earth metal ions or a solution containing alkaline earth metal ions may be added to the ore underground or above ground, before or after processing, including the methods as described above, to make the composition of the invention.

In some embodiments, the solid trona mineral is dissolved using water in a dissolution unit which may optionally be heated using flue gas and/or heat exchangers. The water used for dissolving the solid trona may be the spent water obtained from any of the steps recited herein. For example, the water used for dissolving trona may be the water obtained (supernatant) after the filtration of the precipitate with divalent cations. The sodium bicarbonate in the trona solution may be converted fully to the carbonate by adding a proton removing agent. Such proton removing agents have been described herein. For example, sodium hydroxide made from an electrochemical process may be added to the trona solution for the conversion of the bicarbonate in the solution to the carbonate. Such processing of the brine solution may result in the carbonate brine predominantly containing carbonate ions. The carbonate brine thus obtained may be treated with alkaline earth metal ions or a solution containing alkaline earth metal ions (e.g. a calcium chloride brine) to precipitate the carbonate composition of the invention. The slurry containing the precipitate may be filtered and the supernatant may be used to dissolve more trona. The dewatered solid is concentrated, dried, and further processed as described herein.

In some embodiments, the solid trona mineral is dissolved using water in a dissolution unit which may optionally be heated using flue gas and/or heat exchangers. The water used for dissolving the solid trona may be the spent water obtained from any of the steps recited herein. For example, the water used for dissolving trona may be the water obtained (supernatant) after the filtration of the precipitate with divalent cations. The sodium carbonate in the trona solution may be converted to bicarbonate by passing CO₂ in the solution. The reaction may be represented by the following equation:

CO₃²⁻+H₂O+CO₂=2HCO₃⁻

In some embodiments, the systems and method provided herein include a contactor configured to produce the carbonate brine predominantly containing the bicarbonate ions by dissolving the carbon dioxide into a carbonate brine, such as, trona brine solution. The carbon dioxide may be absorbed into the carbonate brine utilizing a gas mixer/gas absorber described in U.S. patent application Ser. No. 12/503,557 filed on Jul. 16, 2009, titled, “CO₂ Utilization In Electrochemical Systems,” herein incorporated by reference in its entirety. In some embodiments, the gas mixer/gas absorber comprises a series of spray nozzles that produces a flat sheet or curtain of liquid into which the gas is absorbed; in another embodiment, the gas mixer/gas absorber comprises a spray absorber that creates a mist and into which the gas is absorbed; in other embodiments, other commercially available gas/liquid absorber, e.g., an absorber available from Neumann Systems, Colorado, USA is used. In some embodiments, the system is operatively connected to a carbon dioxide gas/liquid contactor configured to dissolve carbon dioxide in the carbonate brine when the carbonate brine predominantly containing the bicarbonate ions or the bicarbonate brine is produced.

In some embodiments the alkalinity of the carbonate brine may not be sufficient to dissolve the CO₂ and a proton removing agent may be added to increase the alkalinity. In some embodiments, the proton removing agent is a natural base. Such natural bases are well known in the art and include, without limitation, mineral, microorganism, waste stream, coal ash, and combination thereof. Examples of the proton removing agent that may be used, have been described herein.

The carbon dioxide may be obtained from various industrial sources that release carbon dioxide including carbon dioxide from combustion gases of fossil fuelled power plants, e.g., conventional coal, oil and gas power plants, or IGCC (Integrated Gasification Combined Cycle) power plants that generate power by burning sygas; cement manufacturing plants that convert limestone to lime; ore processing plants; fermentation plants; and the like. In some embodiments, the carbon dioxide is an industrial waste stream including, but not limited to, flue gas from combustion; a flue gas from a chemical processing plant; a flue gas from a plant that produces CO₂ as a byproduct; or combination thereof. In some embodiments, the carbon dioxide may comprise other gases, e.g., nitrogen, oxides of nitrogen (nitrous oxide, nitric oxide), sulfur and sulfur gases (sulfur dioxide, hydrogen sulfide), and vaporized materials. In some embodiments, the system includes a gas treatment system that removes constituents in the carbon dioxide gas stream before the gas is utilized in the contactor.

The carbonate brine predominantly containing the bicarbonate ions or the bicarbonate brine either obtained by the process described above or naturally occurring, may be treated with a base, such as, sodium hydroxide made from an electrochemical process, to give the carbonate ions. Such electrochemical process has been described herein. The carbonate brine thus obtained is treated with the alkaline earth metal ions or the solution containing alkaline earth metal ions (e.g. a calcium chloride brine) to precipitate the carbonate composition of the invention. The slurry containing the precipitate may be filtered and the supernatant may be used to dissolve more trona. The dewatered solid is concentrated, dried, and further processed as described herein.

In some embodiments, the methods and systems of the invention are a zero liquid discharge methods and systems.

In some embodiments, the tailings and the spent solutions, obtained after the mining of the carbonate ores, are used as carbonate brines in the compositions and methods of the present invention.

In some embodiments, the carbonate brines of the invention are brine-bearing-evaporate or evaporite horizons in the lake. A system of wells (injection and production) and pipelines may be used to produce brine from the horizons. In some embodiments, an effluent may be injected into the evaporite horizon to manufacture brine by solution mining. In some embodiments, the carbonate brines of the invention are made from the evaporite deposits exposed at the surface. For example, at Owens lake, Trona is exposed at the surface and is selectively mined with an excavator, stockpiled adjacent to the area of excavation, and later spread out on the surface to air dry.

Large deposits of lithium carbonate are found in Chile in Salar de Atacama in the Andes Mountains and in Antofagasta. In the United States, the lithium carbonate brines are in Nevada. There is also a lithium carbonate plant in Argentina on the Salar del Hombre Muerto. Other countries with deposits of lithium carbonate brines include China, Russia, Australia, Canada, and Zimbabwe. In some embodiments, one or more of the elements from the carbonate brines are removed before using the carbonate brines for the compositions and methods of this invention. The one or more elements that may be removed before using the carbonate brines include, but are not limited to, lithium, borate, iron, etc. These one or more elements may be used for other industrial applications. For example, the lithium carbonate brines may be pumped from the salt mine and may be evaporated in large shallow pools, where a sequential crystallization of the salts may be started. Since the brines of chlorides may be saturated with sodium chloride, the first salt to be precipitated may be halite, or if sulfates are present, halite and hydrated calcium sulfate. The precipitation may continue with silvinite (KClNaCl) and afterward silvite (KCl). The latter may be a product for industrial use so that toward the end of the precipitation of the silvite, the brine may be transferred to another pool and the precipitated salt thereof may be recovered for obtaining potassium chloride by differential floatation. After the precipitation, crystallization of carnalite (KClMgCl₂.6H₂O) and then bishoffite (MgCl₂.6H₂O) may take place. In this stage, the lithium may be increased to about 4.5-5.5%, with a magnesium content of about 4%. At that point, lithium carnalite (LiClMgCl₂.6H₂O) may get precipitated.

Other carbonate brines include soda lakes, such as, mono lake, big soda lake, and soap lake. Mono Lake is situated on the eastern slope of the Sierra Nevada mountain range in California. It is a saline lake (−90 g/l) with a pH around 10. Calcium carbonate is the principal precipitate and causes the formation of tufa towers which reach a height of almost one meter above the water. In addition to carbonate, mono lake also contains phosphate, sulfate and other ions, such as, arsenic and selenium. Soap Lake is another soda lake situated in central Washington State (USA), with increasing salinity and alkalinity. Characteristic of this lake are its sharp stratification and its high sulfide concentration (200 mM) in the monimolimnion, i.e., the bottom layer of the lake. The salinity goes from 15 g/l in the mixolimnion, i.e., the top layer of the lake, to 140 g/l in the monimolimnion and the pH is round 10.

In some embodiments, the carbonate brine is obtained from an evaporite or an ophiolite. The evaporite can be used in its conventional sense to refer to a mineral deposit which forms when a restricted alkaline body of water (e.g., lake, pond, lagoon, etc.) is dehydrated by evaporation which results in concentration of ions from the alkaline body of water to precipitate out and form a mineral deposit, e.g., the crust along Lake Natron in Africa's Great Rift Valley. Naturally occurring evaporites may be found in evaporite basins, which can be classified into six different depositional settings: continental grabens, geosynclinals basins, artesian basins, stranded marine waters, and arid drainage basins. Ions found within evaporites are derived from the weathering of the rocks and sediments with the watershed and from various types of source water (meteoric, phreatic, marine, etc.). As such, the composition of evaporites may vary. For example, evaporites may contain halides (e.g., halite, sylvite, fluorite, etc.), sulfates (e.g., gypsum, anhydrite, barite, etc.), nitrates (nitratine, niter, etc.), borates (e.g., borax), and carbonates (e.g., calcite, aragonite, dolomite, trona, etc.), among others. Therefore, the brines obtained from evaporites may provide a source of carbonate as well as alkalinity.

In some embodiments, the evaporite or ophiolites may also be a source of one or more cations. In some embodiments, the cations may be monovalent cations, such as Na⁺, K⁺. In some embodiments, the cations are divalent cations, such as Ca²⁺, Mg²⁺, Sr²⁺, Ba²⁺Mn²⁺, Zn²⁺, Fe². The source of divalent cations from evaporites may be in the form of mineral salts, such as sulfate salts (e.g., calcium sulfate), or borate salts (e.g., borax). In some instances, divalent cations of the evaporite are alkaline earth metal cations, e.g., Ca², Mg².

In certain embodiments, the evaporites contain borate. Borates present in evaporites of the invention may be any borate salt, e.g., Na₃BO₃. The amount of borate present in evaporites of the invention may vary. In some instances, the amount of borate that is present in the evaporite ranges from 1% to 95% (w/w), such as 5% to 90% (w/w), such as 10% to 90% (w/w), including about 15% to 85% (w/w), for instance about 20% to 75% (w/w), such as 25% to 75% (w/w), such as 25% to 60% (w/w), including about 25% to 50% (w/w).

Evaporites or ophiolites may be obtained using any convenient protocol. For instance, naturally forming surface or subsurface evaporites may be obtained by quarry excavation using conventional earth-moving equipment, e.g., bulldozers, front-end loaders, back hoes, etc. In these embodiments, evaporites or ophiolites may also be further processed after excavation to separate each mineral as desired, such as by rehydration followed by sequential precipitation or by density-based separation methods. In other embodiments, evaporites may be obtained by pond precipitation. In these embodiments, a source evaporite aqueous composition (e.g., surface or subsurface brine) may first be obtained, such as by a surface turbine motor pump or subsurface brine pump, and subsequently dehydrated to produce the evaporite. In some embodiments, the composition of the source evaporite aqueous composition may be adjusted (i.e., adding or removing components, as desired) prior to dehydrating the source water to produce an evaporite of a desired composition.

Some examples of the soda lakes and soda deserts, typically exhibiting high pH values, are illustrated in Table VII below. One of the largest fossil soda lakes is the Green River Formation in Wyoming and Utah. The lakes illustrated in Table VII below also have large amounts of carbonate/bicarbonates deposits.

TABLE VII

| Continent | Country | Location |
|---|---|---|
| Africa | Libya | Lake Fezzan |
| | Egypt | Wadi Natrum |
| | Ethiopia | Lake Aranguadi, Lake Kilotes, Lake Abiata, |
| | | Lake Shala, Lake Chilu, Lake Hertale, |
| | | Lake Metahara |
| | Sudan | Dariba Lake |
| | Kenya | Lake Bogoria, Lake Nakuru, Lake Elmenteita, |
| | | Lake Magadi, Lake Simbi, Lake Sonachi, |
| | | Lake Oloidien |
| | Tanzania | Lake Natron, Lake Eyasi, Lake Magad, Lake |
| | | Manyara, Lake Balangida, Bosotu Crater Lake, |
| | | Lake Kusare, Lake Tulusia, El Kekhooito, |
| | | Momela Lake, Lake Lekandiro, Lake |
| | | Reshitani, Lake Lgarya, Lake Ndutu |
| | Uganda | Lake Rukwa North, Lake Katwe, Lake |
| | | Mahenga, Lake Kikorongo, Lake Nyamunuka |
| | Chad | Lake Munyanyange, Lake Murumuli, Lake |
| | | Nunyampaka, Lake Bodu, Lake Rombou, Lake |
| | | Dijikare, Lake Monboio, Lake Yoan |
| Asia | Siberia | Kulunda Steppe, Tanatar Lakes, Karakul, |
| | | Chita, Barnaul, Slavgerod, Lake Baikal |
| | | region, Lake Khatyn |
| | Armenia | Araxes plain lake |
| | Turkey | Lake Van, Lake Salda |
| | India | Lake Looner, Lake Sambhar |
| | China | Outer Mongolia, various “nors”; Sui-Yuan, |
| | | Cha-Han-Nor and Na-Lin-Nor; Heilungkiang, |
| | | Hailar and Tsitsihar; Kirin, Fu-U-Hsein and |
| | | Taboos-Nor; Liao-Ning, Tao-Nan Hsein; Jehol, |
| | | various soda lakes; Tibet, alkaline deserts; |
| | | Chahar, Lang-Chai; Shansi, U-Tsu-Hsein; |
| | | Shensi, Shen-Hsia-Hsein, Kansu, Ning-Hsia- |
| | | Hsein, Qinhgai Hu |
| Australia | | Lake Corangamite, Red Rock Lake, Lake |
| | | Werowrap, Lake Chidnup |
| Central | Mexico | Lake Texcoco |
| America | | |
| Europe | Hungary | Lake Feher, Pecena Slatina |
| | Former | |
| | Yugoslavia | |
| North | Canada | Manito |
| America | USA | Alkali Valley, Albert Lake Lenore, Soap Lake, |
| | | Big Soda Lake, |
| | | Owens Lake, Borax Lake, Mono Lake, Searles |
| | | Lake, Deep Springs, |
| | | Rhodes Marsh, Harney Lake, Summer Lake, |
| | | Surprise Valley, |
| | | Pyramid Lake, Walker Lake, Union Pacific |
| | | Lakes (Green River), Ragtown Soda lake |
| South | Venezuela | Langunilla Valley |
| America | Chile | Antofagasta |

In some embodiments, the carbonated brines may be sufficiently alkaline to precipitate the carbonate compositions of the invention after the addition of the alkaline earth metal ions or a solution containing alkaline earth metal ions. In some embodiments, the addition of the alkaline earth metal ions or a solution containing alkaline earth metal ions to the carbonate brine may be accompanied by a proton removing agent, such as an alkali, or a solution containing the alkali. The proton removing agents or the source of alkalinity, have been described herein.

The amount of carbonates present in the brines of the invention may vary. In some instances, the amount of carbonate present ranges from 50 to 100,000 ppm; or alternatively 100 to 75,000 ppm; or alternatively 500 to 50,000 ppm; or alternatively 1000 to 25,000 ppm.

As such, in certain embodiments, the carbonate present in the carbonate brines may comprise 5% by wt or more of carbonates; or 10% by wt or more of carbonates; or 15% by wt or more of carbonates; or 20% by wt or more of carbonates; or 30% by wt or more of carbonates; or 40% by wt or more of carbonates; or 50% by wt or more of carbonates; or 60% by wt or more of carbonates; or 70% by wt or more of carbonates; or 80% by wt or more of carbonates; or 90% by wt or more of carbonates; or 99% by wt or more of carbonates; or 5-99% by wt of carbonates; or 5-95% by wt of carbonates; or 5-80% by wt of carbonates; or 5-75% by wt of carbonates; or 5-70% by wt of carbonates; or 5-60% by wt of carbonates; or 5-50% by wt of carbonates; or 5-40% by wt of carbonates; or 5-30% by wt of carbonates; or 5-20% by wt of carbonates; or 5-10% by wt of carbonates; or 10-80% by wt of carbonates; or 10-50% by wt of carbonates; or 10-20% by wt of carbonates; or 20-80% by wt of carbonates; or 20-50% by wt of carbonates; or 30-75% by wt of carbonates; or 30-50% by wt of carbonates; or 40-80% by wt of carbonates; or 50-75% by wt of carbonates; or 50-90% by wt of carbonates; or 60-80% by wt of carbonates; or 60-95% by wt of carbonates; or 70-90% by wt of carbonates; or 80-90% by wt of carbonates; or 5% by wt of carbonates; or 10% by wt of carbonates or 20% by wt of carbonates; or 25% by wt of carbonates; or 30% by wt of carbonates; or 40% by wt of carbonates; or 50% by wt of carbonates; or 60% by wt of carbonates; or 70% by wt of carbonates; or 80% by wt of carbonates; or 90% by wt of carbonates. In some embodiments, the amount of carbonate recited above is present in the subterranean brine. In some embodiments, the amount of carbonate recited above is present in the ore above ground. In some embodiments, the amount of carbonate recited above is present in the underground ore. In some embodiments, the amount of carbonate recited above is present in the brine extracted from the ore. In some embodiments, the amount of carbonate recited above is present in the brine after the processing of the ore. Some of the examples of the methods of processing are as described herein.

In some embodiments, the bicarbonate present in the carbonate brines may comprise 5% by wt or more of bicarbonates; or 10% by wt or more of bicarbonates; or 15% by wt or more of bicarbonates; or 20% by wt or more of bicarbonates; or 30% by wt or more of bicarbonates; or 40% by wt or more of bicarbonates; or 50% by wt or more of bicarbonates; or 60% by wt or more of bicarbonates; or 70% by wt or more of bicarbonates; or 80% by wt or more of bicarbonates; or 90% by wt or more of bicarbonates; or 99% by wt or more of bicarbonates; or 5-99% by wt of bicarbonates; or 5-95% by wt of bicarbonates; or 5-80% by wt of bicarbonates; or 5-75% by wt of bicarbonates; or 5-70% by wt of bicarbonates; or 5-60% by wt of bicarbonates; or 5-50% by wt of bicarbonates; or 5-40% by wt of bicarbonates; or 5-30% by wt of bicarbonates; or 5-20% by wt of bicarbonates; or 5-10% by wt of bicarbonates; or 10-80% by wt of bicarbonates; or 10-50% by wt of bicarbonates; or 10-20% by wt of bicarbonates; or 20-80% by wt of bicarbonates; or 20-50% by wt of bicarbonates; or 30-75% by wt of bicarbonates; or 30-50% by wt of bicarbonates; or 40-80% by wt of bicarbonates; or 50-75% by wt of bicarbonates; or 50-90% by wt of bicarbonates; or 60-80% by wt of bicarbonates; or 60-95% by wt of bicarbonates; or 70-90% by wt of bicarbonates; or 80-90% by wt of bicarbonates; or 5% by wt of bicarbonates; or 10% by wt of bicarbonates or 20% by wt of bicarbonates; or 25% by wt of bicarbonates; or 30% by wt of bicarbonates; or 40% by wt of bicarbonates; or 50% by wt of bicarbonates; or 60% by wt of bicarbonates; or 70% by wt of bicarbonates; or 80% by wt of bicarbonates; or 90% by wt of bicarbonates. In some embodiments, the amount of bicarbonate recited above is present in the subterranean brine. In some embodiments, the amount of bicarbonate recited above is present in the ore above ground. In some embodiments, the amount of bicarbonate recited above is present in the underground ore. In some embodiments, the amount of bicarbonate recited above is present in the brine extracted from the ore. In some embodiments, the amount of bicarbonate recited above is present in the brine after the processing of the ore. Some of the examples of the methods of processing are as described herein.

In some embodiments, the concentration of calcium and/or magnesium ions is almost absent or negligible in the carbonate brine. In some embodiments, the concentration of calcium and/or magnesium ions in the carbonate brine is less than 1% by wt; or alternatively less than 0.5% by wt; or still alternatively less than 0.5% by wt; or further alternatively 0.1-1% by wt.

In some embodiments, the pH of the carbonate brine is greater than 7; or 7-10; or greater than 10; or 8-12; or 8-14.

In addition to carbonates, the carbonate brine may also contain other anions, such as, but are not limited to, sulfate, phosphate, chloride etc. In some embodiments, the carbonate brines comprise large amounts of sulfur which may be present in various forms, such as, but are not limited to, hydrogen sulfide (H₂S), sulfite (SO₃²⁻), and thionates (S₄O₆²⁻).

In some embodiments, the carbonate brine includes one or more of elements including, but not limited to, aluminum, barium, cobalt, copper, iron, lanthanum, lithium, mercury, arsenic, cadmium, lead, nickel, phosphorus, scandium, titanium, zinc, zirconium, molybdenum, and/or selenium. In some embodiments, the carbonate brine includes one or more of elements including, but not limited to, lanthanum, mercury, arsenic, lead, and selenium. In some embodiments, the carbonate brines are processed to remove one or more of the elements, such as, lithium, iron, etc. and the remaining brine is used to make the composition of the invention, and/or the brine may be used to make the composition of the invention and then processed to remove one or more of these elements. The foregoing elements may be considered as markers for identifying reaction products, i.e., carbonate compositions of the invention derived from carbonate brines.

In some embodiments, synthetic brines or subterranean brines of the invention provide a source of alkalinity and contain proton-removing agents. In some embodiments, the carbonate brines also include proton removing agents. In some embodiments, the brines that provide a source of cations may also include proton removing agents. “Proton-removing agent” includes a substance or compound which possesses sufficient alkalinity or basicity to remove one or more protons from a proton-containing species in solution. In some embodiments, the amount of proton-removing agent is an amount such that the brine possesses a neutral pH (i.e., pH=7). In these embodiments, the stoichiometric sum of proton-removing agents is equal to the stoichiometric sum of proton-containing agents in the brine. The stoichiometric sum of proton-removing agents is the sum of all substances or compounds (e.g., halides, oxyanions, organic bases, etc.) which can remove one or more protons from a proton-containing species in solution. In some embodiments, the amount of proton-removing agents in the brine is an amount such that the brine is alkaline. By alkaline is meant the stoichiometric sum of proton-removing agents in the brine exceeds the stoichiometric sum of proton-containing agents. In some instances, the alkaline brine has a pH that is above neutral pH (i.e., pH>7), e.g., the brine has a pH ranging from 7.1 to 12, such as 8 to 12, such as 8 to 11, and including 9 to 11. In some embodiments, as described in greater detail below, while being basic the pH of the brine may be insufficient to cause precipitation of the carbonate-compound precipitation material or the composition of the invention. For example, the pH of the brine may be 9.5 or lower, such as 9.3 or lower, including 9 or lower.

Proton-removing agents present in the brines of the invention may vary. In some embodiments, the proton-removing agents may be anions. Anions may be halides, such as Cl⁻, F⁻, I⁻ and Br⁻, among others and oxyanions, e.g., sulfate, carbonate, borate and nitrate, among others.

In some embodiments, the proton-removing agent is borate. Borates present in the brines of the invention may be any oxyanion of boron, e.g., BO₃³⁻, B₂O₅⁴⁻, B₃O₇⁵⁻, and B₄O₉⁶⁻, among others. The amount of borate present in the brines of the invention may vary. In some instances, the amount of borate present ranges from 50 to 100,000 ppm, such as 100 to 75,000 ppm, including 500 to 50,000 ppm, for example 1000 to 25,000 ppm. As such, in some embodiments, the proton removing agents present in the brines may comprise 5% or more of borates, such about 10% or more of borates, including about 25% or more of borates, for instance about 50% or more of borates, such as about 75% or more of borates, including about 90% or more of borates. Where both carbonate and borate are present, the molar ratio of carbonate to borate (i.e., carbonate:borate) in the carbonate brines may be between 1:1 and 1:2.5; or 1:2.5 and 1:5; or 1:5 and 1:10; or 1:10 and 1:25; or 1:100 and 1:150; or 1:150 and 1:200; or 1:200 and 1:250; or 1:250 and 1:500; or 1:500 and 1:1000, or a range thereof. For example, the molar ratio of carbonate to borate in carbonate brines of the invention may be between 1:1 and 1:10; or 1:5 and 1:25; or 1:10 and 1:50; or 1:25 and 1:100; or 1:50 and 1:500; or 1:100 and 1:1000. In other embodiments, the ratio of carbonate to borate (i.e., carbonate:borate) in the carbonate brine may be between 1:1 and 2.5:1; or 2.5:1 and 5:1; or 5:1 and 10:1; or 10:1 and 25:1; or 25:1 and 50:1; or 50:1 and 100:1; or 100:1 and 150:1; or 150:1 and 200:1; or 200:1 and 250:1; or 250:1 and 500:1; or 500:1 and 1000:1, or a range thereof. For example, the ratio of carbonate to borate in the carbonate brines of the invention may be between 1:1 and 10:1; or 5:1 and 25:1; or 10:1 and 50:1; or 25:1 and 100:1; or 50:1 and 500:1; or 100:1 and 1000:1.

In some embodiments, proton-removing agents present in the brines may be an organic base. In some instances, the organic base may be a monocarboxylic acid anion, e.g., formate, acetate, propionate, butyrate, and valerate, among others. In other instances, the organic base may be a dicarboxylic acid anion, e.g., oxalate, malonate, succinate, and glutarate, among others. In other instances, the organic base may be phenolic compounds, e.g., phenol, methylphenol, ethylphenol, and dimethylphenol, among others. In some embodiments, the organic base may be a nitrogenous base, e.g., primary amines such as methyl amine, secondary amines such as diisopropylamine, tertiary amines such as diisopropylethylamine, aromatic amines such as aniline, heteroaromatics such as pyridine, imidazole, and benzimidazole, and various forms thereof. The amount of organic base present in brines of the invention may vary. In some instances, the amount of organic base present in the brine ranges from 1 to 200 mmol/liter, such as 1 to 175 mmol/liter, such as 1 to 100 mmol/liter, such as 10 to 100 mmol/liter, including 10 to 75 mmol/liter. Thus, in certain embodiments, proton removing agents present in the brines may make up 5% or more of organic base, such about 10% or more of organic base, including about 25% or more of organic base, for instance about 50% or more of organic base, such as about 75% or more of organic base, including about 90% or more of organic base.

In some embodiments, the brines of the invention may have a bacterial content. Examples of the types of bacteria that may be present in the naturally occurring brine or may be added to the brines include sulfur oxidizing bacteria (e.g., Shewanella putrefaciens, Thiobacillus), aerobic halophilic bacteria (e.g., Salinivibrio costicola and Halomanos halodenitrificans), high salinity bacteria (e.g., endospore-containing Bacillus and Marinococcus halophilus), among others. Bacteria may be present in the brines of the invention in an amount that varies, such as where the concentration is 1×10⁸ colony forming units/ml (cfu/ml) or less, such as 5×10⁶ cfu/ml or less, such as 1×10⁵ cfu/ml or less, such as 5×10⁴ cfu/ml or less, such as 1×10³ cfu/ml or less, and including 1×10² cfu/ml or less. In some embodiments, the concentration of bacteria in the brines may depend on the temperature of the brine. For example, at temperatures greater than about 80° C., the brines of the invention may have very little bacterial content, such as where the bacterial concentration is 1×10⁵ cfu/ml or less, such as 1×10⁴ cfu/ml or less, such as 5×10³ cfu/ml or less, such as 1×10³ cfu/ml or less, such as 5×10² cfu/ml or less, including 1×10² cfu/ml or less.

In some embodiments, where the brines have very little bacterial content, substantially (e.g., 80% or more) the entire alkalinity (i.e., basicity) of the brine may be derived from organic bases. In these embodiments, 80% or more, such as 90% or more, including 95% or more, up to 100% of the alkalinity of the brine may be derived from organic bases present in the brine. At temperatures ranging between 20-80° C., the brines of the invention may have a high bacterial content. In these embodiments, the concentration of bacteria in the brine may be 1×10⁵ cfu/ml or greater, such as 5×10⁵ cfu/ml or greater, such as 1×10⁶ cfu/ml or greater, such as 5×10⁶ cfu/ml or greater, such as 8×10⁶ cfu/ml or greater, including 1×10⁷ cfu/ml or greater. In some embodiments, where the brines have a high bacterial content, very little of the alkalinity (e.g., 20% or less) of the brine may be derived from organic bases. In these embodiments, 20% or less, such as 15% or less, such as 10% or less, including 5% or less of the alkalinity of the brine may be derived from organic bases present in the brine.

Subterranean brines may be found at higher temperatures and pressures than other naturally occurring bodies of water such as oceans or lakes. The internal pressures in subterranean formations of the invention may vary depending on the makeup of the brine as well as the depth and geographic location of the subterranean formation, e.g., ranging from 4 to 200 atm, such as 5 to 150 atm, such as 5 to 100 atm, such as 5 to 50 atm, such as 5 to 25 atm, such as 5 to 15 atm, and including 5 to 10 atm. In some embodiments, the subterranean brine is thermally active. The internal temperatures of subterranean brines of this invention may vary depending on the makeup of the composition as well as the depth and geographic location of the subterranean formation, ranging from −5 to 250° C., such as 0 to 200° C., such as 5 to 150° C., such as 10 to 100° C., such as 20 to 75° C., including 25 to 50° C. The elevated temperatures and pressures may be used to generate energy to drive one or more methods for making the composition of the invention, further described herein.

In some embodiments, the brines of the invention may have distinct ranges or minimum or maximum levels of elements, ions, or other substances, for example, but not limited to, chloride, lithium, sodium, sulfur, fluoride, potassium, bromide, silicon, strontium, calcium, boron, magnesium, iron, barium and the like. In some embodiments, the brines of the invention may include strontium, which may be present in the brine in an amount of up to 10,000 ppm or less, ranging in certain embodiments from 3 to 10,000 ppm, such as from 5 to 5000 ppm, such as from 5 to 1000 ppm, e.g., 5 to 500 ppm, including 5 to 100 ppm. In other embodiments, the brines of the invention may include barium, which may be present in the brine in an amount of up to 2500 ppm or less, ranging in certain instances from 1 to 2500 ppm, such as from 5 to 2500 ppm, such as from 10 to 1000 ppm, e.g., 10 to 500 ppm, including 10 to 100 ppm.

In other embodiments, the brines of the invention may include iron, which may be present in the brine in an amount of up to 5000 ppm or less, ranging in certain instances from 1 to 5000 ppm, such as from 5 to 5000 ppm, such as from 10 to 1000 ppm, e.g., 10 to 500 ppm, including 10 to 100 ppm. In other embodiments, the brines of the invention may include sodium, which may be present in the brine in an amount of up to 100,000 ppm or less, ranging in certain instances from 1000 to 100,000 ppm, such as from 1000 to 10,000 ppm, such as from 1500 to 10,000 ppm, e.g., 2000 to 8000 ppm, including 2000 to 7500 ppm. In other embodiments, the brines of the invention may include lithium, which may be present in the brine in an amount of up to 500 ppm or less, ranging in certain instances from 0.1 to 500 ppm, such as from 1 to 500 ppm, such as from 5 to 250 ppm, e.g., 10 to 100 ppm, including 10 to 50 ppm. In other embodiments, the brines of the invention may include chloride, which may be present in the brine in an amount of up to 500,000 ppm or less, ranging in certain instances from 500 to 500,000 ppm, such as from 1000 to 250,000 ppm, such as from 1000 to 100,000 ppm, e.g., 2000 to 100,000 ppm, including 2000 to 50,000 ppm. In other embodiments, the brines of the invention may include fluoride, which may be present in the brine in an amount of up to 100 ppm or less, ranging in certain instances from 0.1 to 100 ppm, such as from 1 to 50 ppm, such as from 1 to 25 ppm, e.g., 2 to 25 ppm, including 2 to 10 ppm. In other embodiments, the brines of the invention may include potassium, which may be present in the brine in an amount of up to 100,000 ppm or less, ranging in certain instances from 10 to 100,000 ppm, such as from 100 to 100,000 ppm, such as from 1000 to 50,000 ppm, e.g., 1000 to 25,000 ppm, including 1000 to 10,000 ppm.

In other embodiments, the brines of the invention may include bromide, which may be present in the brine in an amount of up to 5000 ppm or less, ranging in certain instances from 1 to 5000 ppm, such as from 5 to 5000 ppm, such as from 10 to 1000 ppm, e.g., 10 to 500 ppm, including 10 to 100 ppm. In other embodiments, the brines of the invention may include silicon, which may be present in the brine in an amount of up to 5000 ppm or less, ranging in certain instances from 1 to 5000 ppm, such as from 5 to 5000 ppm, such as from 10 to 1000 ppm, e.g., 10 to 500 ppm, including 10 to 100 ppm. In other embodiments, the brines of the invention may include calcium, which may be present in the brine in an amount of up to 100,000 ppm or less, ranging in certain instances from 100 to 100,000 ppm, such as from 100 to 50,000 ppm, such as from 200 to 10,000 ppm, e.g., 200 to 5000 ppm, including 200 to 1000 ppm. In other embodiments, the brines of the invention may include boron, which may be present in the brine in an amount of up to 1000 ppm or less, ranging in certain instances from 1 to 1000 ppm, such as from 10 to 1000 ppm, such as from 20 to 500 ppm, e.g., 20 to 250 ppm, including 20 to 100 ppm. In other embodiments, the brines of the invention may include magnesium, which may be present in the brine in an amount of up to 10,000 ppm or less, ranging in certain instances from 10 to 10,000 ppm, such as from 50 to 5000 ppm, such as from 50 to 1000 ppm, e.g., 100 to 1000 ppm, including 100 to 500 ppm.

In some embodiments, subterranean brines may be obtained from a subterranean location beneath or nearby a metal ore mine or petroleum field and as such, may be rich in one or more identifiable trace elements (e.g., zinc, aluminum, lead, manganese, copper, cadmium, strontium, barium mercury, selenium, arsenic etc.) depending on the type of metal ore mine or petroleum field and its vicinity to the subterranean location where the subterranean brine is obtained. The brine may be used in mining activities before or after its use in methods of this invention. The brine may be concentrated or otherwise processed after mining activities prior to use in methods of this invention.

The concentration and identity of a trace element may provide an identifiable physical profile of a particular brine. The trace element or the above recited ions may be found in the calcium carbonate precipitates or the compositions of the invention prepared from such brines and as such may be used as markers for the calcium carbonate precipitates or the compositions. In some embodiments, the trace metal element in the brine is zinc, which may be present in the brine in an amount of up to 250 ppm or less, ranging in certain instances from 1 to 250 ppm, such as 5 to 250 ppm, such as from 10 to 100 ppm, e.g., 10 to 75 ppm, including 10 to 50 ppm. In other embodiments, the identifying trace metal element in the brine is lead, which may be present in the brine in an amount of up to 100 ppm or less, ranging in certain instances from 1 to 100 ppm, such as 5 to 100 ppm, such as from 10 to 100 ppm, e.g., 10 to 75 ppm, including 10 to 50 ppm. In yet other embodiments, the identifying trace metal element in the brine is manganese, which may be present in the brine in an amount of up to 200 ppm or less, ranging in certain instances from 1 to 200 ppm, such as 5 to 200 ppm, such as from 10 to 200 ppm, e.g., 10 to 150 ppm, including 10 to 100 ppm. In some embodiments, the brine may have a molar ratio of different carbonates which varies, e.g., carbonates present in the brines of the invention include, but are not limited to, carbonates of beryllium, magnesium, calcium, strontium, lithium, barium, radium or any combinations thereof.

In some embodiments, the brine may have an isotopic composition which varies depending on the factors which influenced its formation and the location from which it is obtained. Many elements have stable isotopes, and these isotopes may be preferentially used in various processes, e.g., biological processes and as a result, different isotopes may be present in each brine in distinctive amounts. An example is carbon, which will be used to illustrate one example of a brine described herein. However, it will be appreciated that these methods are also applicable to other elements with stable isotopes if their ratios can be measured in a similar fashion to carbon; such elements may include nitrogen, sulfur, and boron. Methods for characterizing a composition by measuring its relative isotope composition (e.g., ^{δ13}C) is described in U.S. patent application Ser. No. 12/163,205, filed Jun. 27, 2008; the disclosure of which is herein incorporated by reference. For example, the degree of water-rock exchange and the degree of mixing along fluid flow paths between water and minerals can modify the isotopic composition of the subterranean brine, in some instances the ratio of strontium-87 to strontium-86 (⁸⁷Sr/⁸⁶Sr). In one embodiment, the brine may have a high initial concentration of rubidium, such as brine found in granites formations. One aspect of this invention is that brines may be characterized by high strontium-87 to strontium-86 ratios. In some embodiments, the strontium-87 to strontium-86 ratio of the brines of the invention may vary, ranging between 0.71/1 and 0.85/1, such as between 0.71/1 and 0.825/1, such as between 0.71/1 and 0.80/1, such as between 0.75/1 and 0.85/1, and including between 0.75/1 and 0.80/1. Any suitable method may be used for measuring the strontium-87 to strontium-86 ratio, methods including, but not limited to 90°-sector thermal ionization mass spectrometry.

In some embodiments, the brines may be distinguished from one another by the amount and type of different isotopes present in the brine (e.g., δ¹³C, δ¹⁸O, etc). In another instance, the ratio of lithium-7 to lithium-6 (⁷Li/⁶Li,) may be a distinguishing feature of the brine. Other isotopic ratios that may be measured in order to describe or identify brine profile include, but are not limited to ⁸⁰Se/⁷⁶Se, ²⁶Mg/²⁴Mg, ⁴⁴Ca/⁴³Ca, ⁴⁴Ca/⁴²Ca, ⁴⁸Ca/⁴²Ca, ⁶⁵Cu/⁶³Cu, ¹⁴⁷Sm/¹⁴³Nd, ²⁰⁷Pb/²⁰⁸Pb, ²²⁶Ra/²²⁸Ra, ¹³⁸Ba/¹³⁷Ba, or other isotopic ratios. These isotopic elements may be found in the reaction product or the composition of the invention or the cement product formed from the composition of the invention, and as such, may be used to distinguish the composition or the cement products. Any suitable method may be used for measuring the isotope ratios of the brine and the products resulting from the brine, such as, reaction product, composition, and/or cement product of the invention, methods including, but not limited to 90°-sector thermal ionization mass spectrometry. In some embodiments, the reaction product or the composition of the invention or the cement product formed from the composition of the invention has the isotopic composition that is indicative of a mixture of more than one subterranean brine.

In some embodiments, the brines of the invention may have a composition which includes one or more identifying components which distinguish each brine from other brines. As such, the composition of each brine may be distinct from one another. In some embodiments, the brines may be distinguished from one another by the amount and type of elements, ions or other substances present in the brine (e.g., trace metal ions, Hg, Se, As, etc). In other embodiments, the brines may be distinguished from one another by the molar ratio of carbonates present in the brine. In other embodiments, the brines may be distinguished from one another by the amount and type of different isotopes present in the brine (e.g., δ¹³C, δ¹⁸O, etc.). In other embodiments, the brines may be distinguished from one another by the isotopic ratio of particular elements present in the brine (e.g., ⁸⁷Sr/⁸⁶Sr).

The composition of the brines may vary. In some embodiments, the brines provide a source of cations (e.g., hard brines). The cations may be monovalent cations, such as Na⁺, K⁺, etc. The cations may also be divalent cations, such as Ca²⁺, Mg²⁺, Sr²⁺, Ba²⁺, Mn²⁺, Zn²⁺, Fe²⁺, etc. In some instances, the divalent cations of the brine are alkaline earth metal cations, e.g., Ca²⁺, Mg²⁺. The brine, when serving as a source of cations, may have Ca²⁺ present in amounts that vary, ranging from 50 to 100,000 ppm, such as 100 to 75,000 ppm, including 500 to 50,000 ppm, for example 1000 to 25,000 ppm. The brines may have Mg²⁺ present in amounts that vary, ranging from 50 to 25,000 ppm, such as 100 to 15,000 ppm, including 500 to 10,000 ppm, for example 1000 to 5,000 ppm. In brines where both Ca²⁺ and Mg²⁺ are present, the molar ratio of Ca²⁺ to Mg²⁺ (i.e., Ca²⁺:Mg²⁺) in the brine may vary, and in one embodiment may range between 1:1 and 100:1. In some instance the Ca²⁺:Mg²⁺ may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of Ca²⁺ to Mg²⁺ in subterranean brines of interest may range between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca²⁺) in the brine ranges between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the ratio of Mg²′ to Ca²′ in the subterranean brines of interest may range between 1:1 and 1:10; 1:5 and 1:25; 1:10 and 1:50; 1:25 and 1:100; 1:50 and 1:500; or 1:100 and 1:1000. In particular embodiments the Mg²⁺:Ca²⁺ of a brine may be lower than 1:1, such as 1:2, 1:3, 1:4, 1:10, 1:100 or lower.

In some embodiments, the carbonate brine does not have any alkaline earth metal ions or has less than 500 ppm; or less than 100 ppm; or less than 10 ppm; or between 10-500 ppm; or between 10-100 ppm alkaline earth metal ions.

Brines may be concentrated waste streams from wastewater treatment plants. In some embodiments, brines of this invention may be water resulting from dissolution of mineral sources (e.g., oil and gas exploration or extraction) that has been concentrated or otherwise treated. The waste streams from underground sources such as gas or petroleum mining may contain hydrocarbons, carbonates, cations or anions. Treatment of these waste streams to reduce hydrocarbons and the water volume may result in an aqueous mixture rich in carbonates, salinity, alkalinity or any combination thereof. This aqueous mixture may be used to precipitate reaction product, such as, carbonic acid, bicarbonate, carbonates, or mixture thereof.

### Treatment of Brine

Aspects of the invention include methods of modifying the composition of the synthetic or the subterranean brine based on a desired reaction product of carbonic acid, carbonate, bicarbonate or any combination thereof. Methods may include altering or modifying the composition of the synthetic or the subterranean brine. Treating a brine to modify the composition or physical properties of that brine may improve the reactivity of the brine with the solution containing the cations, such as, alkaline earth metal ions or may improve the properties of the reaction product or the composition of the invention or the cement product formed from the composition of the invention.

The alteration or the modification of the brine may include treating the brine to remove or add components. In some embodiments, modifying the composition includes concentrating or diluting a brine to achieve a desired ionic strength or component concentration. In some embodiments, modifying the brine may include heating or cooling a brine prior to or during any reaction with the solution containing the cations, such as, alkaline earth metal ions. The brine may be treated in situ. In some embodiments, modifying the brine includes mixing two or more different brines to produce a brine mixture, where each of the two or more brines is obtained from distinct sources (e.g., man-made or synthetic brine and subterranean brine or brines from separate subterranean locations). The amount of each brine in the mixture may vary as desired, ranging in some instances from 0.1% to 99.9% by volume, such as 5% to 95% by volume, including 10% to 90% by volume. Two or more brines may be mixed by any convenient mixing protocol, such as using agitator drives, counterflow impellers, turbine impellers, anchor impellers, ribbon impellers, axial flow impellers, radial flow impellers, hydrofoil mixers, aerators, among others.

In some embodiments, the methods of the invention include obtaining brine from a subterranean location for reaction with cations, such as, alkaline earth metal ions. A subterranean brine can be obtained by any convenient protocol, such as for example by pumping the subterranean brine from the subterranean location using, for example a down-well turbine motor pump, a geothermal well pump or a surface-located brine pump. In some embodiments, obtaining the subterranean brine may include pumping the subterranean brine from the underground location and storing it in an above-ground storage basin. The above-ground storage basin may be any convenient storage basin. In some embodiments, the above-ground storage basin may be a naturally-occurring geological structure, such as, a tailings pond or dried riverbed or may be a manmade structure, such as a storage tank. Where desired, the subterranean brine may be stored in the above-ground storage basin for a period of time following pumping from the subterranean location and prior to contacting it with the cations. For example, the subterranean brine may be stored for a period of time ranging from 1 to 1000 days or longer, such as 1 to 500 days or longer, and including 1 to 100 days or longer. In these embodiments, the subterranean brine may be stored at a temperature ranging from 1 to 75° C., such as 10 to 50° C. and including 10 to 25° C. In other embodiments, the subterranean brine may be left in the subterranean location (e.g., in an underground well) until needed and pumped from the underground location directly into the reactor for contacting with the source of cations. In other embodiments, the subterranean brine may be left in the subterranean location (e.g., in an underground well) and contacting and/or other operations may be performed underground. Brines may be treated prior to, during or after storage for any length of time.

In some embodiments, the composition of the brine mixture may be determined, monitored or assessed after synthetically preparing the brine or after obtaining brine from the subterranean location or after mixing the two or more subterranean brines together. Based on the determined composition of the brine or the brine mixture, the brine may be further treated. Where desired, monitoring and modification may be performed using real-time protocols, such that these two processes are occurring continuously to provide the desired brine.

Changes in the brine that may be achieved upon treatment may vary greatly. For example, the chemical makeup of the brine may be modified, e.g., via production of new chemical species in the brine or augmentation or other modification of the concentration of a chemical species already present in the brine. In some embodiments, one or more components of the brine may be removed from the brine. For example, the brine may be modified by the addition of elements, such as, but not limited to, strontium, lanthanum, etc. to facilitate the reaction of the brine with the cations or to improve the properties of the composition of the invention. The brine may also be modified to remove one or more elements, such as, lithium, iron, aluminum, etc. which find use in other applications.

In some embodiments, the elements may be added to the brine prior to contacting the brine with the source of cations. In some embodiments, the elements may be added at the same time as contacting the brine with the source of cations. In some embodiments, the elements may be added to the brine after contacting the brine with the source of cations. Where desired, the elements may also be added to the brine at more than one time during methods of the invention (e.g., before, during or after contacting the subterranean brine with the source of cations). In some embodiments, the elements added to the brine ranges from 0.01 to 100.0 grams/liter of brine, such as from 1 to 100 grams/liter of brine, for example 5 to 80 grams/liter of brine, including 5 to 50 grams/liter of brine.

In some embodiments, one or more components may be removed so that the brine is modified in such a way that the brine after reaction with the source of cations and the removal of the precipitate, is suitable for disposal.

In some embodiments, if the concentration of carbonate in the brine is less than optimal for the precipitation of the composition, then a carbonate may be added to the brine to increase the concentration of the carbonate in the brine. In some embodiments, if the carbonate in the brine is an excess of bicarbonate then carbon dioxide may be added to the brine to convert the carbonate into the bicarbonate in the brine. Such carbon dioxide may be pressurized into the brine solution and temeperature, pressure, and/or pH of the solution may be optimized to convert the carbonate in the brine to the bicarbonate. In some embodiments, such carbon dioxide may originate from flue gas emitted from the power plants, chemical processing plants, steel mills, paper mills, cement plants, and other industrial plants that produce CO₂ as a byproduct. The gaseous stream may be substantially pure CO₂ or a multi-component gaseous stream that includes CO₂ and one or more additional gases. Multi-component gaseous streams (containing CO₂) that may be employed as a CO₂ source in embodiments of the subject methods include both reducing, e.g., syngas, shifted syngas, natural gas, and hydrogen and the like, and oxidizing condition streams, e.g., flue gases from combustion. Exhaust gases containing NOx, SOx, VOCs, particulates and Hg would incorporate these compounds along with the carbonate in the precipitated product. Particular multi-component gaseous streams of interest that may be used according to the invention include, but are not limited to, oxygen containing combustion power plant flue gas, turbo charged boiler product gas, coal gasification product gas, shifted coal gasification product gas, anaerobic digester product gas, wellhead natural gas stream, reformed natural gas or methane hydrates, and the like. In some embodiments, if the carbonate in the brine is an excess of bicarbonate then a proton removing agent, e.g., sodium hydroxide may be added to the brine to convert the bicarbonate into the carbonate in the brine.

In some embodiments, the composition of the brine, such as subterranean brine, may be considered to be less than optimal when the amount of organic bases (e.g., acetate, propionate, butyrate, etc.) present in the brine exceeds the amount of inorganic bases (e.g., borate, carbonate, etc.), such as where the molar ratio of organic base to inorganic bases is 2:1 or greater, such as 5:1 or greater, such as 10:1 or greater, such as 100:1 or greater, including 1000:1 or greater. In other embodiments, the composition of the brine may be considered to be less than optimal when the amount of inorganic bases present in the brine exceeds the amount of organic bases, such as where the molar ratio of inorganic base to organic base is 2:1 or greater, such as 5:1 or greater, such as 10:1 or greater, such as 100:1 or greater, including 1000:1 or greater. As such, in some embodiments, the composition of the brine may be adjusted by adding organic base or inorganic base to increase the amount of organic base or inorganic base present in the brine.

In some embodiments, the composition of the brine, such as subterranean brine, may be modified to enhance the energy efficiency of the methods of the invention. The energy efficiency may be enhanced by reducing the energy required to practice methods of the invention, such as by reducing the amount of energy by 2-fold or greater, such as 3-fold or greater, such as 5-fold or greater, including 10-fold or greater, e.g., as compared to a suitable control. For example, energy efficiency may be enhanced by reducing the amount of energy required to precipitate the carbonate-containing precipitation material, such as, by adding the proton-removing agent to the brine. In these embodiments, adding the proton-removing agent may help to rapidly precipitate the carbonate-containing precipitation material without any extra input of energy, such as required by cooling or agitating the reaction mixture.

In embodiments where two or more brines are mixed, at least one of the brines may be chosen to provide a source of one or more cations to the brine mixture and at least one of the brine may be chosen to be the carbonate brine. For example, in embodiments where two or more subterranean brines are mixed, at least one of the subterranean brines may be chosen to provide a source of one or more cations to the brine mixture and at least one of the subterranean brine may be chosen to be the carbonate brine. In some embodiments, the brine may be provided with cations or the subterranean brine may naturally possess cations, to provide a source of cations. In some embodiments, the brines providing a source of one or more cations may be modified to increase the concentration of the cations, e.g., Na⁺, K⁺, Ca²⁺, Mg²⁺, Sr²⁺, Ba²⁺Mn²⁺, Zn²⁺, and Fe²⁺. In some instances, the divalent cations may be alkaline-earth-metal-cations, e.g., Ca²⁺, Mg²⁺. The amount of cations provided by the brine or the amount of the cations provided by the modified subterranean brine may vary, in some embodiments, ranging from 50 to 100,000 ppm, such as 100 to 75,000 ppm, including 500 to 50,000 ppm, for example 1000 to 25,000 ppm. Suitable compositions for adjusting the concentration of divalent cations in the brine include aqueous compositions comprising one or more divalent cations, e.g., alkaline earth metal cations such as Ca²⁺ and Mg²⁺. In some embodiments, where Ca²⁺ and Mg²⁺ are both present, the ratio of Ca²⁺ to Mg²⁺ (i.e., Ca²⁺:Mg²⁺) in the brine may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Ca²′ to Mg²′ in the brine may be between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca²⁺) in the brine may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Mg²⁺ to Ca²⁺ in the brine may be between 1:1 and 1:10; 1:5 and 1:25; 1:10 and 1:50; 1:25 and 1:100; 1:50 and 1:500; or 1:100 and 1:1000.

In embodiments where two or more brines are mixed, at least one of the brines may be chosen to provide a source of one or more proton-removing agents to the brine mixture and at least one of the brine may be chosen to be the carbonate brine. For example, in embodiments where two or more subterranean brines are mixed, at least one of the subterranean brines may be chosen to provide a source of one or more proton-removing agents to the brine mixture and at least one of the subterranean brine may be chosen to be the carbonate brine. In some embodiments, proton-removing agents present in the brine may be halides, e.g., Cl⁻, F⁻, I⁻ and Br⁻. In other embodiments, proton-removing agents present in the brine may be oxyanions, such as sulfate, carbonate, borate and nitrate, among others. In some embodiments, the oxyanion is carbonate, e.g., bicarbonate (HCO₃⁻) and carbonate (CO₃²⁻). The brine containing the proton-removing agents may be modified to increase or decrease the proton-removing agents to adjust the pH of the reaction between the carbonate brine and the brine containing cations. As such, in some embodiments, the amount of proton-removing agents provided to the brine mixture may be 5% or more, or 10% or more, or 25% or more, or 50% or more, or 75% or more, or 90% or more. Examples of such proton-removing agents include, but are not limited to, borates; an organic base, e.g., formate, acetate, propionate, butyrate, valerate, oxalate, malonate, succinate, glutarate, phenol, methylphenol, ethylphenol, and dimethylphenol, among others; naturally occurring proton-removing agents, such as, microorganisms and fungi; synthetic chemical proton-removing agents, such as, sodium hydroxide; man-made waste streams; and electrochemical proton-removing protocols, all of which have been described herein.

In certain embodiments, the composition of the brine may be modified by adding an amount of two different types of proton-removing agents to the brine. In these embodiments, the composition of the brine is modified by adding a first proton-removing agent and a second proton-removing agent to the brine, where the second proton-removing agent is distinct from the first protein-removing agent. In some embodiments, both the first and second proton-removing agents are added before contacting the brine with the source of cations. In some embodiments, both the first and second proton-removing agents are added during the contacting of the brine with the source of cations. In still some embodiments, a first proton removing agent is added to the brine before contacting the brine with the source of cations and a second proton-removing agent is added to the reaction mixture after contacting the brine with the source of cations. In some embodiments, the first proton-removing agent and the second proton-removing agent are added sequentially. In some embodiments, the first proton-removing agent and the second proton-removing agent are added simultaneously.

In certain embodiments, the first proton removing agent is a weak base. A weak base includes a chemical base which does not fully ionize in an aqueous solution. As Bronsted-Lowry bases are proton acceptors, a weak base may include a chemical base in which protonation is incomplete. For example, a first proton removing agent may be an oxyanion, e.g., sulfate, carbonate, borate and nitrate, among others. In other instances, the first proton removing agent may be an organic base, e.g., monocarboxylic anion, dicarboxylic anion, phenolic compounds, and nitrogenous bases, among others. In some embodiments, the second proton removing agent is a strong base. The strong base includes a chemical base which fully ionizes in an aqueous solution. In some embodiments, the second proton removing agent may be a metal oxide (e.g., calcium oxide (CaO), magnesium oxide (MgO), strontium oxide (SrO), beryllium oxide (BeO), barium oxide (BaO), etc.) or may be a metal hydroxide (e.g., sodium hydroxide (NaOH), potassium hydroxide (KOH), calcium hydroxide (Ca(OH)₂), magnesium hydroxide (Mg(OH)₂, etc.). In some embodiments, first proton remving agent is a strong base and the second proton remving agent is a weak base.

Brines may contain other valuable minerals besides those which impart alkaline value and which can form carbonates. Minerals such as lithium may be co-extracted, concentrated and used or sold for profit.

In some embodiments, the composition of the brine, such as, the subterranean brine, may be considered to be less than optimal when the brine contains bacterial content, such as where the concentration of bacteria is 1×10⁵ cfu/ml or greater, such as 5×10⁵ cfu/ml or greater, such as 1×10⁶ cfu/ml or greater, such as 5×10⁶ cfu/ml or greater, including 1×10⁷ cfu/ml or greater. As such, in some embodiments, the composition of the brine may be modified to reduce or eliminate the amount of bacterial content in the brine. The bacterial concentration of the brine may be decreased by 5-fold or more, such as 10-fold or more, such as 100-fold or more, such as 1000-fold or more, such as 10.000-fold or more, such as 100.000-fold or more, including 1,000,000-fold or more. The bacterial content may be reduced or eliminated by treating the brine with any convenient protocol, such as increasing the temperatue of the brine. In some embodiments, methods of the invention also include determining and assessing the composition of the brine after treating the brine with a protocol for reducing or eliminating bacterial content.

In some embodiments, the bacterial concentration of the brine is reduced or eliminated by adding an amount of a bactericidal composition. Bactericidal compositions may be any convenient composition which inactivates or kills bacteria and may include, but are not limited to, bacterial disinfectants (e.g., dichloroisocyanurate, iodopovidone, isopropanol, triclosan, tricholorophenol, cetyl trimethyammonium bromide, peroxides, etc.), antibiotics (e.g., penicillin, cephalosporins, monobactams, daptomycin, fluoroquinolones, metronidazole, nitrofurantoin, etc.), antiseptics (e.g., potassium hypochlorite, sodium benzenesulfochlroamide, Lugol's solution, urea perhydrate, sorbic acid, hexachlorophene, Dibromol, etc.). The bactericidal composition may be added to the brine by any convenient protocol, such as a solid, an aqueous composition, a liquid, etc.

In some embodiments, the bacterial concentration of the brine is reduced or eliminated by adjusting the temperature of the brine. The temperature of the brine may be adjusted by any convenient protocol, such as by heat coils, Peltier thermoelectric devices, solar heating devices, water baths, oil baths, gas-power water boilers, etc. Adjusting the temperature of the brine to reduce or eliminate bacterial content may vary, such as increasing the temperature of the brine by 5° C. or more, such as 10° C. or more, such as 15° C. or more, such as 25° C. or more, such as 50° C. or more, such as 75° C. or more, including 100° C. or more.

In other embodiments, the bacterial concentration of the brine is reduced or eliminated by irradiating the brine with electromagnetic radiation, e.g., UV light. The brine may be irradiated with electromagnetic radiation by any convenient protocol, such as by using one or more lamps or lasers. In some instances, the brine may be irradiated in the storage basin, with or without stirring. In other instances, the subterranean brine may be pumped through UV-transparent (e.g., quartz) pipes and irradiated by one or more lamps or laser while the subterranean brine is pumped. The duration of irradiation may vary depending on the volume of the brine and the desired extent of treatment. In some embodiments, the brine may be irradiated for 0.5 hours or more, such as 1 hour or more, such as 2 hours or more, such as 5 hours or more, such as 10 hours or more, including 24 hours or more.

In some embodiments, the treatment of brine may include modifying the concentration of carbonate in the carbonate brine at any time, before, during or after a reaction with the source of cations. In some embodiments, modifying the carbonate brine includes concentrating carbonate in the brine. The concentration of the carbonate in the brine may be accomplished using any convenient protocol, e.g., distillation, evaporation, among other protocols (e.g., so as to decrease the total volume of the brine while keeping the mass of carbonate constant). In some embodiments, the brine may be concentrated by the use of evaporation ponds to reduce the total volume of water and volatile organic substances in the brine. In some embodiments, the brine may be concentrated by using heat from a power plant in order to evaporate water and volatile organic substances. In some embodiments, carbonate in the brine may be concentrated by adding carbonate to the brine (i.e., so as to increase the mass of carbonate while keeping the total volume of the carbonate brine constant). Carbonate may be added to the brine by any suitable protocol. For example, sodium carbonate may be added to the brine as a solid or a slurry. In some instances, sodium carbonate may be dissolved in an aqueous solution and the aqueous solution added to the brine. In other embodiments, methods of the invention may include decreasing the carbonate concentration in the carbonate brine to facilitate the reaction of the carbonate brine with the source of cations. As such, the concentration of carbonate in the brine may be decreased, e.g., by 0.1M or more, such as by 0.5 M or more, such as by 1 M or more, such as by 2 M or more, such as by 5 M or more, including by 10 M or more. Decreasing the concentration of carbonate in the brine may be accomplished using any convenient protocol for example, diluting the brine with diluent (e.g., water).

The treatment of the brine may include modifying the temperature of the brine. Such modification of the temperature may also facilitate reduction or elimination of the bacterial content in the brine. The initial temperature of the brine may vary depending on the source of the brine (e.g., subterranean brine), ranging from −5 to 110° C., such as from 0 to 100° C., such as from 10 to 80° C., and including from 20 to 60° C. In certain embodiments, the temperature of the brine may be adjusted (i.e., increased or decreased) as desired, e.g., by 5° C. or more, such as 10° C. or more, such as 15° C. or more, such as 25° C. or more, such as 50° C. or more, such as 75° C. or more, including 100° C. or more. Where desired, the temperature of the brine may be adjusted to a temperature which is equivalent to the temperature of the source of cations contacted with the brine. The temperature of the brine may be adjusted using any convenient protocol, such as, for example, a thermal heat exchanger, electric heating coils, Peltier thermoelectric devices, gas-powered boilers, among other protocols.

In certain embodiments, the temperature of the brine may be raised using energy generated from low or zero carbon dioxide emission sources, e.g., solar energy source, wind energy source, hydroelectric energy source, etc. In certain embodiments, the temperature of a brine may be lowered and the excess heat energy used for a beneficial purpose. In some embodiments, excess thermal energy of the brine may be used to drive one or more processes of this invention. Heat energy may be converted to electrical energy or used as thermal energy. The thermal energy of the brine may be collected via a heat exchanger (e.g., a vertical or horizontal closed loop) and transferred to a process of this invention, for example dewatering the precipitate of this invention. Thermal energy of the brine may be used to generate electrical power (e.g., steam generator). In some embodiments, thermal energy from the brine may be used to heat the precipitate or the product of this invention in order to dry that precipitate or the product (e.g., dry an aggregate or the formed building material). In some embodiments, thermal energy from a geothermal source may be converted to electrical energy and is used to drive the generation of a proton removing agent from an electrochemical process.

### Source of Alkalinity

In order to produce carbonate-containing precipitation material, protons are removed from various species (e.g. carbonic acid, bicarbonate, hydronium, etc.) in the divalent cation-containing solution to shift the equilibrium towards carbonate. The terms “source of alkalinity” or “proton removing agents” or “pH raising agent,” are used interchangeably herein. As protons are removed, more carbonates are formed. In some embodiments, proton-removing agents and/or methods are used while contacting a divalent cation-containing aqueous solution with carbonate brine in one phase of the precipitation reaction, wherein the pH may remain constant, increase, or even decrease, followed by a rapid removal of protons (e.g., by addition of a base) to cause precipitation of carbonate-containing precipitation material. Protons may be removed from the various species (e.g. carbonic acid, bicarbonate, hydronium, etc.) by any suitable approach, including, but not limited to, use of naturally occurring proton-removing agents, use of microorganisms and fungi, use of synthetic chemical proton-removing agents, recovery of man-made waste streams, and using electrochemical means.

Naturally occurring proton-removing agents encompass any proton-removing agents that can be found in the wider environment that may create or have a basic local environment. Some embodiments provide for naturally occurring proton-removing agents including minerals that create basic environments upon addition to solution. Such minerals include, but are not limited to, lime (CaO); periclase (MgO); iron hydroxide minerals (e.g., goethite and limonite); and volcanic ash. Methods for digestion of such minerals and rocks comprising such minerals are well known in the art.

Many minerals provide sources of divalent cations and, in addition, some minerals are sources of base. Mafic and ultramafic minerals such as olivine, serpentine, and any other suitable mineral may be dissolved using any convenient protocol. In one embodiment, cations such as calcium may be provided for methods and compositions of this invention from feldspars such as anorthite. Cations may be obtained directly from mineral sources or from subterranean brines, high in calcium or other divalent cations. Dissolution may be accelerated by increasing surface area, such as by milling by conventional means or by, e.g., jet milling, as well as by use of, e.g., ultrasonic techniques. In addition, mineral dissolution may be accelerated by exposure to acid or base. Metal silicates (e.g., magnesium silicates) and other minerals comprising cations of interest may be dissolved, e.g., in acid (e.g., HCl such as HCl from an electrochemical process) to produce, for example, magnesium and other metal cations for use in precipitation material, and, subsequently, compositions of the invention. In some embodiments, magnesium silicates and other minerals may be digested or dissolved in an aqueous solution that has become acidic due to the addition of carbon dioxide and other components of waste gas (e.g., combustion gas). Alternatively, other metal species such as metal hydroxide (e.g., Mg(OH)₂, Ca(OH)₂) may be made available for use in aggregate by dissolution of one or more metal silicates (e.g., olivine and serpentine) with aqueous alkali hydroxide (e.g., NaOH) or any other suitable caustic material. Any suitable concentration of aqueous alkali hydroxide or other caustic material may be used to decompose metal silicates, including highly concentrated and very dilute solutions. The concentration (by weight) of an alkali hydroxide (e.g., NaOH) in solution may be, for example, from 30% to 80% and from 70% to 20% water. Advantageously, metal silicates and the like digested with aqueous alkali hydroxide may be used directly to produce precipitation material, and, subsequently, aggregate from a waste gas stream. In addition, base value from the precipitation reaction mixture may be recovered and reused to digest additional metal silicates and the like.

Some embodiments provide for using naturally alkaline bodies of water as naturally occurring proton-removing agents. Examples of naturally alkaline bodies of water include, but are not limited to surface water sources (e.g. alkaline lakes such as Mono Lake in California) and ground water sources (e.g. basic aquifers such as the deep geologic alkaline aquifers located at Searles Lake in California). Other embodiments provide for use of deposits from dried alkaline bodies of water such as the crust along Lake Natron in Africa's Great Rift Valley.

In some embodiments, organisms that excrete basic molecules or solutions in their normal metabolism are used as proton-removing agents. Examples of such organisms are fungi that produce alkaline protease (e.g., the deep-sea fungus Aspergillus ustus with an optimal pH of 9) and bacteria that create alkaline molecules (e.g., cyanobacteria such as Lyngbya sp. from the Atlin wetland in British Columbia, which increases pH from a byproduct of photosynthesis). In some embodiments, organisms are used to produce proton-removing agents, wherein the organisms (e.g., Bacillus pasteurii, which hydrolyzes urea to ammonia) metabolize a contaminant (e.g. urea) to produce proton-removing agents or solutions comprising proton-removing agents (e.g., ammonia, ammonium hydroxide). In some embodiments, organisms are cultured separately from the precipitation reaction mixture, wherein proton-removing agents or solution comprising proton-removing agents are used for addition to the precipitation reaction mixture. In some embodiments, naturally occurring or manufactured enzymes are used in combination with proton-removing agents to invoke precipitation of precipitation material. Carbonic anhydrase, which is an enzyme produced by plants and animals, accelerates transformation of carbonic acid to bicarbonate in aqueous solution.

Chemical agents for effecting proton removal generally refer to synthetic chemical agents that are produced in large quantities and are commercially available. For example, chemical agents for removing protons include, but are not limited to, hydroxides, organic bases, super bases, oxides, ammonia, and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). Organic bases are carbon-containing molecules that are generally nitrogenous bases including primary amines such as methyl amine, secondary amines such as diisopropylamine, tertiary such as diisopropylethylamine, aromatic amines such as aniline, heteroaromatics such as pyridine, imidazole, and benzimidazole, and various forms thereof. In some embodiments, an organic base selected from pyridine, methylamine, imidazole, benzimidazole, histidine, and a phophazene is used to remove protons from various species (e.g., carbonic acid, bicarbonate, hydronium, etc.) for precipitation of precipitation material. In some embodiments, ammonia is used to raise pH to a level sufficient to precipitate precipitation material from a solution of divalent cations and an industrial waste stream. Super bases suitable for use as proton-removing agents include sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) are also suitable proton-removing agents that may be used. Carbonates for use in the invention include, but are not limited to, sodium carbonate.

In addition to comprising cations of interest and other suitable metal forms, waste streams from various industrial processes may provide proton-removing agents. Such waste streams include, but are not limited to, mining wastes; fossil fuel burning ash (e.g., combustion ash such as fly ash, bottom ash, boiler slag); slag (e.g. iron slag, phosphorous slag); cement kiln waste; oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge. Mining wastes include any wastes from the extraction of metal or another precious or useful mineral from the earth. In some embodiments, wastes from mining are used to modify pH, wherein the waste is selected from red mud from the Bayer aluminum extraction process; waste from magnesium extraction from sea water (e.g., Mg(OH)₂ such as that found in Moss Landing, California); and wastes from mining processes involving leaching. For example, red mud may be used to modify pH as described in U.S. Provisional Patent Application No. 61/161,369, titled, “Neutralizing industrial wastes utilizing CO₂ and a divalent cation solution,” filed 18 Mar. 2009, which is hereby incorporated by reference in its entirety. Fossil fuel burning ash, cement kiln dust, and slag, collectively waste sources of metal oxides, further described in U.S. patent application Ser. No. 12/486,692, titled, “Methods and systems for utilizing waste sources of metal oxides,” filed 17 Jun. 2009, the disclosure of which is incorporated herein in its entirety, may be used in alone or in combination with other proton-removing agents to provide proton-removing agents for the invention. Agricultural waste, either through animal waste or excessive fertilizer use, may contain potassium hydroxide (KOH) or ammonia (NH₃) or both. As such, agricultural waste may be used in some embodiments of the invention as a proton-removing agent. This agricultural waste is often collected in ponds, but it may also percolate down into aquifers, where it can be accessed and used.

Where desired, the pH of the water is raised using any convenient and/or suitable approach. In certain embodiments, a pH raising agent may be employed, where examples of such agents include oxides, hydroxides (e.g., sodium hydroxide, potassium hydroxide, brucite), carbonates (e.g. sodium carbonate), coal ash, naturally occurring mineral, and the like. The amount of pH elevating agent that is added to the source of cations or the carbonate brine will depend on the particular nature of the agent and the volume of water being modified, and will be sufficient to raise the pH to the desired value. Alternatively, the pH of the source of cations can be raised to the desired level by electrolysis of the water.

One approach can be to use the coal ash from a coal-fired power plant, which contains many oxides, to elevate the pH of sea water. Other coal processes, like the gasification of coal, to produce syngas, also produce hydrogen gas and carbon monoxide, and may serve as a source of hydroxide as well. Some naturally occurring minerals, such as, serpentine contain hydroxide, and can be dissolved, yielding a hydroxide source. The amount of pH elevating agent that is added to the water will depend on the particular nature of the agent and the volume of water being modified, and will be sufficient to raise the pH of the water to the desired value. Alternatively, the pH of the source of cations can be raised to the desired level by electrolysis of the water. Where electrolysis is employed, a variety of different protocols may be taken, such as use of the Mercury cell process (also called the Castner-Kellner process); the Diaphragm cell process and the membrane cell process. Where desired, byproducts of the hydrolysis product, e.g., H₂, sodium metal, etc. may be harvested and employed for other purposes, as desired.

Electrochemical methods are another means to remove protons from various species in a solution, either by removing protons from solute (e.g., deprotonation of carbonic acid or bicarbonate) or from solvent (e.g., deprotonation of hydronium or water). Deprotonation of solvent may result, for example, if proton production from carbonate dissolution matches or exceeds electrochemical proton removal from solute molecules. In some embodiments, low-voltage electrochemical methods are used to remove protons.

In some embodiments, carbonates dissolved in an aqueous solution that does not contain divalent cations is treated by a low-voltage electrochemical method to remove protons from carbonic acid, bicarbonate, hydronium, or any species or combination thereof resulting from the dissolution of carbonates. A low-voltage electrochemical method operates at an average voltage of 2, 1.9, 1.8, 1.7, or 1.6 V or less, such as 1.5, 1.4, 1.3, 1.2, 1.1 V or less, such as 1 V or less, such as 0.9 V or less, 0.8 V or less, 0.7 V or less, 0.6 V or less, 0.5 V or less, 0.4 V or less, 0.3 V or less, 0.2 V or less, or 0.1 V or less. Low-voltage electrochemical methods that do not generate chlorine gas are convenient for use in systems and methods of the invention. Low-voltage electrochemical methods to remove protons that do not generate oxygen gas are also convenient for use in systems and methods of the invention. In some embodiments, low-voltage electrochemical methods generate hydrogen gas at the cathode and transport it to the anode where the hydrogen gas is converted to protons. Electrochemical methods that do not generate hydrogen gas may also be convenient. In some embodiments, electrochemical processes to remove protons do not generate a gas at the anode. In some instances, electrochemical methods to remove protons do not generate any gaseous by-byproduct.

Electrochemical methods for effecting proton removal are further described in U.S. patent application Ser. No. 12/344,019, titled, “Method of sequestring CO₂,” filed 24 Dec. 2008; U.S. patent application Ser. No. 12/375,632, titled, “Low Energy Electrochemical Hydroxide System and Method,” filed 23 Dec. 2008; International Patent Application No. PCT/US08/088,242, titled, “Low energy electromechanical hydroxide system and method,” filed 23 Dec. 2008; International Patent Application No. PCT/US09/32301, titled, “Low energy electrochemical bicarbonate ion solution,” filed 28 Jan. 2009; and International Patent Application No. PCT/US09/48511, titled, “Low energy 4-cell electrochemical system with carbon dioxide gas,” filed 24 Jun. 2009, each of which are incorporated herein by reference in their entirety. Low voltage electrochemical processes may produce hydroxide at the cathode and protons at the anode; where such processes utilize a salt containing chloride, e.g. NaCl, a product of the process will be HCl.

Alternatively, electrochemical methods may be used to produce caustic molecules (e.g., hydroxide) through, for example, the chlor-alkali process, or modification thereof. Electrodes (i.e., cathodes and anodes) may be present in the apparatus containing the divalent cation-containing aqueous solution, and a selective barrier, such as a membrane, may separate the electrodes. Electrochemical systems and methods for removing protons may produce by-products (e.g., hydrogen) that may be harvested and used for other purposes. Additional electrochemical approaches that may be used in systems and methods of the invention include, but are not limited to, those described in U.S. patent application Ser. No. 12/503,557, titled, “CO₂ utilization in electrochemical systems,” filed 15 Jul. 2009 and U.S. Provisional Application No. 61/091,729, titled, “Low energy absorption of hydrogen ion from an electrolyte solution into a solid material,” filed 11 Sep. 2008, the disclosures of which are herein incorporated by reference in their entirety.

Combinations of the above mentioned sources of proton removal may be employed. One such combination is the use of a microorganisms and electrochemical systems. Combinations of microorganisms and electrochemical systems include microbial electrolysis cells, including microbial fuel cells, and bio-electrochemically assisted microbial reactors. In such microbial electrochemical systems, microorganisms (e.g. bacteria) are grown on or very near an electrode and in the course of the metabolism of material (e.g. organic material) electrons are generated that are taken up by the electrode.

Additives other than pH elevating agents may also be introduced into the water in order to influence the nature of the precipitate that is produced. As such, certain embodiments of the methods include providing an additive in water before or during the time when the water is subjected to the precipitation conditions. Certain calcium carbonate polymorphs can be favored by trace amounts of certain additives, such as, but are not limited to, lanthanum as lanthanum chloride, transition metals, iron, nickel, and the like. For instance, iron may favor the formation of disordered dolomite (protodolomite).

In some embodiments the proton removing agent may include a hydroxide, such as sodium hydroxide.

The proton removing agent may be added to increase the pH of the solution to alkalinity region such that the carbonate compositions of the invention precipitate out. It is to be understood that the amount of the proton removing agent and the amount of alkaline earth metal ion will vary depending on the pH of the solution and the precipitation conditions. In some embodiments, the amount of the proton removing agent is 1% to 80% by wt; or 1 to 70% by wt; or 1 to 60% by wt; or 1 to 50% by wt; or 1 to 40% by wt; or 1 to 30% by wt; or 1 to 20% by wt; or 1 to 10% by wt; or 1 to 5% by wt; or 5% to 80% by wt; or 5 to 70% by wt; or 5 to 60% by wt; or 5 to 50% by wt; or 5 to 40% by wt; or 5 to 30% by wt; or 5 to 20% by wt; or 5 to 10% by wt; 10% to 80% by wt; or 10 to 70% by wt; or 10 to 60% by wt; or 10 to 50% by wt; or 10 to 40% by wt; or 10 to 30% by wt; or 10 to 20% by wt; 20% to 80% by wt; or 20 to 50% by wt; or 40 to 80% by wt; or 40 to 60% by wt; or 50 to 80% by wt; or 50 to 60% by wt; or 60 to 80% by wt of the solution containing the proton removing agent. For example, in some embodiments, the amount of NaOH is 1% to 80% by wt; or 1 to 70% by wt; or 1 to 60% by wt; or 1 to 50% by wt; or 1 to 40% by wt; or 1 to 30% by wt; or 1 to 20% by wt; or 1 to 10% by wt; or 1 to 5% by wt; or 5% to 80% by wt; or 5 to 70% by wt; or 5 to 60% by wt; or 5 to 50% by wt; or 5 to 40% by wt; or 5 to 30% by wt; or 5 to 20% by wt; or 5 to 10% by wt; 10% to 80% by wt; or 10 to 70% by wt; or 10 to 60% by wt; or 10 to 50% by wt; or 10 to 40% by wt; or 10 to 30% by wt; or 10 to 20% by wt; 20% to 80% by wt; or 20 to 50% by wt; or 40 to 80% by wt; or 40 to 60% by wt; or 50 to 80% by wt; or 50 to 60% by wt; or 60 to 80% by wt of the solution containing NaOH.

### Methods

A variety of different methods may be employed to prepare the carbonate compositions of the invention. In one aspect, there is provided a method including contacting a source of cation with a carbonate brine to give a reaction product comprising carbonic acid, bicarbonate, carbonate, or mixture thereof. The reaction product may be used as is to make the composition of the invention. In some embodiments, the reaction product may be subjected to one or more of steps including, but not limited to, precipitation, dewatering, washing of the precipitate, dewatering of the washed precipitate, drying, milling, storing, to make the composition of the invention.

In some embodiments, there is provided a method including contacting a source of cation with a carbonate brine to give the composition provided herein. In some embodiments, there is provided a method including contacting a source of cation with a carbonate brine to give a composition, wherein the composition includes a carbonate, bicarbonate, or mixture thereof and one or more elements including, but not limited to, barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa; or the composition includes a carbonate, bicarbonate, or mixture thereof and one or more elements including, but not limited to, barium, cobalt, copper, lanthanum, mercury, arsenic, cadmium, lead, nickel, scandium, titanium, zinc, zirconium, molybdenum, and selenium, wherein the composition has a carbon isotopic fractionation value (δ¹³C) of greater than −5‰; or the composition includes at least 47% w/w vaterite and one or more elements including, but not limited to, barium, cobalt, copper, lanthanum, mercury, arsenic, cadmium, lead, nickel, scandium, titanium, zinc, zirconium, molybdenum, and selenium; or the composition includes at least 10% w/w vaterite, at least 1% w/w amorphous calcium carbonate (ACC), and one or more elements including, but not limited to, barium, cobalt, copper, lanthanum, mercury, arsenic, cadmium, lead, nickel, scandium, titanium, zinc, zirconium, molybdenum, and selenium.

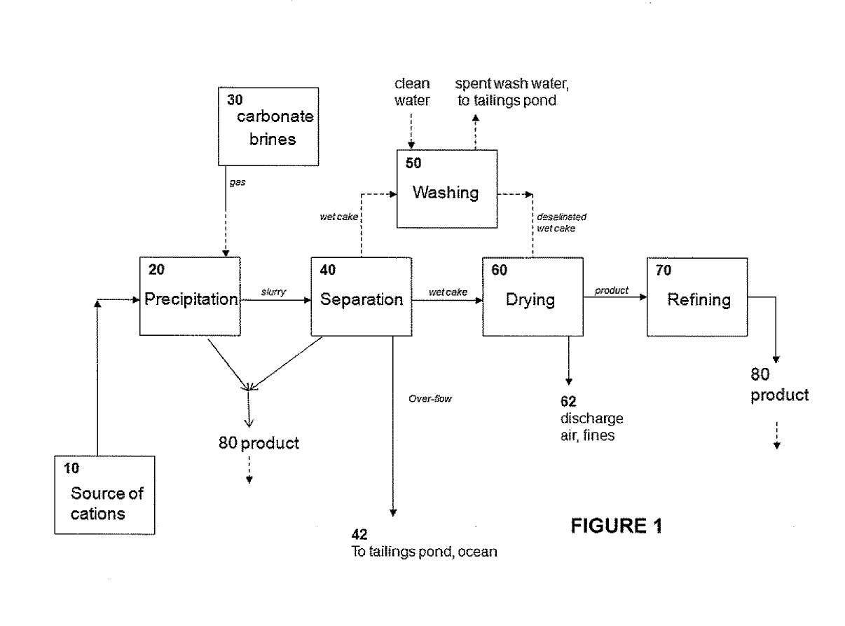

FIG. 1 provides an illustrative schematic flow diagram of a carbonate precipitation process according to some embodiments of the invention. In FIG. 1, any source of cations, such as sea water 10 is subjected to precipitation conditions at precipitation step 20. In some embodiments depicted in FIG. 1, the source of cations 10 is first charged with the carbonate brine, which carbonate brine is then subjected to one or more conditions or one or more precipitation conditions. It is to be understood that the carbonate brine may be a brine containing only carbonate ions, only bicarbonate ions, or both carbonate and bicarbonate ions. The carbonate brine may be prepared using the methods described herein. For example, the carbonate brine containing predominantly carbonate ions can be prepared by dissolving solid trona mineral in the water and treating the water with a base to convert the bicarbonate ions to the carbonate ions. In some embodiments, the naturally occurring bicarbonate brine may be treated with a base, such as sodium hydroxide, to convert the bicarbonate ions to the carbonate tions.

As depicted in FIG. 1, the carbonate brine 30 is contacted with the source of cations 10 at precipitation step 20. The provided carbonate brine 30 and/or the source of cations 10 may optionally be contacted with a proton removing agent, before, during, and/or after subjecting them to the precipitation step 20. The amount of the proton removing agent added may be dependent on the desired pH of the solution at the precipitation step 20. In some embodiments, the desired pH of the solution is alkaline, i.e. above 7. Contact protocols include, but are not limited to, direct contacting protocols, e.g., flowing the carbonate brine through the volume of water containing cations, e.g. alkaline earth metal ions; concurrent contacting means, e.g., contact between unidirectionally flowing liquid phase streams; and countercurrent means, e.g., contact between oppositely flowing liquid phase streams, and the like. Thus, contact may be accomplished through use of infusers, bubblers, fluidic Venturi reactor, sparger, gas filter, spray, tray, or packed column reactors, and the like, as may be convenient. In some embodiments, the contact is by spray. In some embodiments, the contact is through packed column. In some embodiments, the carbonate brine is added to the source of cations. In some embodiments, the source of cations is added to the carbonate brines. In some embodiments, both the source of cations and the carbonate brine is simultaneously added to the reactor for precipitation.

In some embodiments, the methods include contacting the volume of water, containing cations, e.g. alkaline earth metal ions, that is subjected to the mineral precipitation conditions with the carbonate brine, e.g. trona brine. The contacting of the water containing cations with the carbonate brine may occur before and/or during the time when the water is subject to one or more conditions or one or more precipitation conditions. Accordingly, embodiments of the invention include methods in which the volume of water is contacted with the carbonate brine prior to subjecting the volume of water to one or more conditions or one or more precipitation conditions. Embodiments of the invention include methods in which the volume of water is contacted with the carbonate brine while the volume of water is being subjected to one or more conditions or one or more precipitation conditions. Embodiments of the invention include methods in which the volume of water is contacted with the carbonate brine both prior to subjecting the volume of water to one or more conditions or one or more precipitation conditions and while the volume of water is being subjected to precipitation conditions. In some embodiments, the same water may be cycled more than once, wherein a first cycle of precipitation removes primarily calcium carbonate and magnesium carbonate minerals, and leaves remaining alkaline water to which other alkaline earth metal ion sources may be added, that can have more carbonate brine cycled through it, precipitating more carbonate compounds.

The carbonate compound precipitation may occur in a continuous process or at separate steps. As such, charging and precipitation may occur in the same reactor of a system, e.g., as illustrated in FIG. 1 at step 20, according to some embodiments of the invention. In yet other embodiments of the invention, these two steps may occur in separate reactors, such that the water is first charged with the carbonate brine in a charging reactor and the resultant carbonate brine charged water is then subjected to precipitation conditions in a separate reactor.

In methods of making the composition of the invention, a volume of water is subjected to one or more suitable conditions or precipitation conditions sufficient to produce a reaction product containing precipitated carbonate compound composition (bicarbonates, carbonates, or mixture thereof) and mother liquor (i.e., the part of the water that is left over after precipitation of the carbonate compound(s) from water). At precipitation step 20, carbonate compounds, which may be amorphous or crystalline, are precipitated. These carbonate compounds may form a reaction product comprising carbonic acid, bicarbonate, carbonate, or mixture thereof. The carbonate precipitate may be the self-cementing composition and may be stored as is in the mother liquor or may be further processed to make the cement products. Alternatively, the precipitate may be subjected to further processing to give the hydraulic cement or the SCM compositions of the invention.

The one or more conditions or one or more precipitation conditions of interest include those that change the physical environment of the water to produce the desired precipitate product. Such one or more conditions or precipitation conditions include, but are not limited to, one or more of temperature, pH, precipitation, dewatering or separation of the precipitate, drying, milling, and storage. For example, the temperature of the water may be within a suitable range for the precipitation of the desired composition to occur. For example, the temperature of the water may be raised to an amount suitable for precipitation of the desired carbonate compound(s) to occur. In such embodiments, the temperature of the water may be from 5 to 70° C., such as from 20 to 50° C., and including from 25 to 45° C. As such, while a given set of precipitation conditions may have a temperature ranging from 0 to 100° C., the temperature may be raised in certain embodiments to produce the desired precipitate. In certain embodiments, the temperature is raised using energy generated from low or zero carbon dioxide emission sources, e.g., solar energy source, wind energy source, hydroelectric energy source, etc.

The residence time of the precipitate in the reactor before the precipitate is removed from the solution, may vary. In some embodiments, the residence time of the precipitate in the solution is more than 5 seconds, or between 5 seconds-1 hour, or between 5 seconds-1 minute, or between 5 seconds to 20 seconds, or between 5 seconds to 30 seconds, or between 5 seconds to 40 seconds. Without being limited by any theory, it is contemplated that the residence time of the precipitate may affect the size of the particle. For example, a shorter residence time may give smaller size particles or more disperse particles whereas longer residence time may give agglomerated or larger size particles. In some embodiments, the residence time in the process of the invention may be used to make small size as well as large size particles in a single or multiple batches which may be separated or may remain mixed for later steps of the process.

In normal sea water, the carbonate may be in the form of bicarbonate ions (HCO₃⁻) and/or may be in the form of carbonate ions (CO₃⁻²). When calcium carbonate precipitates from normal sea water, CO₂ may be released. Above pH 10.33, greater than 90% of the carbonate may be in the form of carbonate ion, and no CO₂ may be released during the precipitation of calcium carbonate. While the pH of the water may range from 7 to 14 during a given precipitation process, in certain embodiments the pH is raised to alkaline levels in order to drive the precipitation of carbonate compound as desired. In some embodiments, the pH is raised to a level which minimizes if not eliminates CO₂ gas generation production during precipitation. In these embodiments, the pH may be raised to 10 or higher, such as 11 or higher. In some embodiments, the one or more conditions or the precipitation conditions include contacting the saltwater or the alkaline-earth metal containing water with a proton removing agent. The proton removing agent may be any proton removing agent, as described herein, for example, but not limited to, oxide, hydroxide, such as sodium hydroxide, carbonate, coal ash, naturally occurring mineral, and combination thereof. In some embodiments, the one or more conditions or the precipitation conditions include contacting the saltwater or the alkaline-earth metal containing water to electrochemical conditions. Such electrochemical conditions have been described herein.

The nature of the precipitate may also be influenced by selection of appropriate major ion ratios. Major ion ratios may have influence on polymorph formation. For example, magnesium may stabilize the vaterite and/or amorphous calcium carbonate in the precipitate.

Rate of precipitation may also influence compound polymorphic phase formation and may be controlled in a manner sufficient to produce a desired precipitate product. The most rapid precipitation can be achieved by seeding the solution with a desired polymorphic phase. Without seeding, rapid precipitation can be achieved by rapidly increasing the pH of the sea water. The higher the pH is, the more rapid the precipitation may be.

In some embodiments, a set of conditions to produce the desired precipitate from the water include, but are not limited to, the water's temperature and pH, and in some instances the concentrations of additives and ionic species in the water. Precipitation conditions may also include factors such as mixing rate, forms of agitation such as ultrasonics, and the presence of seed crystals, catalysts, membranes, or substrates. In some embodiments, precipitation conditions include supersaturated conditions, temperature, pH, and/or concentration gradients, or cycling or changing any of these parameters. The protocols employed to prepare carbonate compound precipitates according to the invention may be batch or continuous protocols. It will be appreciated that precipitation conditions may be different to produce a given precipitate in a continuous flow system compared to a batch system.

Following production of the carbonate precipitate from the water, the resultant precipitated carbonate composition may be separated from the mother liquor or dewatered to produce the precipitate product, as illustrated at step 40 of FIG. 1. Alternatively, the precipitate is left as is in the mother liquor or mother supernate and is used as a self-cementing composition of the invention.

Separation of the precipitate can be achieved using any convenient approach, including a mechanical approach, e.g., where bulk excess water is drained from the precipitate, e.g., either by gravity alone or with the addition of vacuum, mechanical pressing, by filtering the precipitate from the mother liquor to produce a filtrate, etc. Separation of bulk water produces a wet, dewatered precipitate.

The above protocol results in the production of slurry of the precipitate and mother liquor. This precipitate in the mother liquor and/or in the slurry may give the self-cementing composition of the invention. In some embodiments, a portion or whole of the dewatered precipitate or the slurry is further processed to make the hydraulic cement or the SCM compositions of the invention.

Where desired, the compositions made up of the precipitate and the mother liquor may be stored for a period of time following precipitation and prior to further processing. For example, the composition may be stored for a period of time ranging from 1 to 1000 days or longer, such as 1 to 10 days or longer, at a temperature ranging from 1 to 40° C., such as 20 to 25° C.

The slurry components are then separated. Embodiments may include treatment of the mother liquor, where the mother liquor may or may not be present in the same composition as the product. For example, where the mother liquor is to be returned to the ocean, the mother liquor may be contacted with the carbonate brine in a manner sufficient to increase the concentration of carbonate ion present in the mother liquor. Contact may be conducted using any convenient protocol, such as those described above. In certain embodiments, the mother liquor has an alkaline pH, and contact with the carbonate brine is carried out in a manner sufficient to reduce the pH to a range between 5 and 9, e.g., 6 and 8.5, including 7.5 to 8.2. In certain embodiments, the treated brine may be contacted with carbonate brine or the source of cations, e.g., as described above, to make the composition of the invention.

The resultant mother liquor of the reaction may be disposed of using any convenient protocol. In certain embodiments, it may be sent to a tailings pond for disposal. In certain embodiments, it may be disposed of in a naturally occurring body of water, e.g., ocean, sea, lake or river. In certain embodiments, the mother liquor is returned to the source of feedwater for the methods of invention, e.g., an ocean or sea. Alternatively, the mother liquor may be further processed, e.g., subjected to desalination protocols, as described further in U.S. application Ser. No. 12/163,205, filed Jun. 27, 2008; the disclosure of which is herein incorporated by reference.

In one aspect, the mother liquor obtained after the removal of the carbonate precipitate may be treated with a carbon dioxide source, such as carbon dioxide from a fossil fuel fired power plant, to sequester CO₂ as a bicarbonate, carbonate, or mixture thereof, either by using the remaining alkalinity from carbonates and borates or by adding additional alkalinity, such as NaOH or KOH. Such methods to sequester the CO₂ from the power plant are described in US Publication No. 2009/0020044, filed May 23, 2008, which is incorporated herein by reference in its entirety.

The resultant dewatered precipitate is then dried to produce the composition of the invention, as illustrated at step 60 of FIG. 1. Drying can be achieved by air drying the precipitate. Where the precipitate is air dried, air drying may be at a temperature ranging from −70 to 120° C., as desired. In certain embodiments, drying is achieved by freeze-drying (i.e., lyophilization), where the precipitate is frozen, the surrounding pressure is reduced and enough heat is added to allow the frozen water in the material to sublime directly from the frozen precipitate phase to gas. In yet another embodiment, the precipitate is spray dried to dry the precipitate, where the liquid containing the precipitate is dried by feeding it through a hot gas (such as the gaseous waste stream from the power plant), e.g., where the liquid feed is pumped through an atomizer into a main drying chamber and a hot gas is passed as a co-current or counter-current to the atomizer direction. Depending on the particular drying protocol of the system, the drying station may include a filtration element, freeze drying structure, spray drying structure, etc.

In some embodiments, the step of spray drying may include separation of different sized particles of the precipitate. For example, a first batch of larger sized particles may be collected from the spray dryer followed by the collection of the smaller sized particles. In some embodiments, a single batch may give one or more, such as, for example only, two, three, four, or five different sizes of the particles (e.g., micron and sub-micron particles as defined herein) which may be separated for later use or which different sized particle may be mixed together to make the composition of the invention.

In some embodiments, the particles with different morphologies, such as fine or agglomerated, and/or the particles with different sizes may be mixed to make the compositions of the invention. For example, a composition of the invention may include a mix of fine disperse particles with larger agglomerated particles or the composition of the invention may include a mix of particles with different sizes, e.g., particles with sizes ranging between 0.1 micron to 100 micron. In some embodiments, the composition of the invention may be modulated by mixing the particles with different particle size, surface area, zeta potential, and/or morphologies.

Where desired, the dewatered precipitate product from the separation reactor 40 may be washed before drying, as illustrated at step 50 of FIG. 1. The precipitate may be washed with freshwater, e.g., to remove salts (such as NaCl) from the dewatered precipitate. Used wash water may be disposed of as convenient, e.g., by disposing of it in a tailings pond, etc. The water used for washing may contain metals, such as, iron, nickel, etc.

At step 70, the dried precipitate is refined, milled, aged, and/or cured, e.g., to provide for desired physical characteristics, such as particle size, surface area, zeta potential, etc., or to add one or more components to the precipitate, such as admixtures, aggregate, supplementary cementitious materials, etc., to produce a composition of the invention 80. Refinement may include a variety of different protocols. In certain embodiments, the product is subjected to mechanical refinement, e.g., grinding, in order to obtain a product with desired physical properties, e.g., particle size, etc. The dried precipitate may be milled or ground to obtain a desired particle size.

Aspects of the invention further include systems, e.g., processing plants or factories, for producing the carbonate compound compositions, e.g., saltwater derived carbonate and hydroxide mineral compositions, and cements of the invention, as well as concretes and mortars that include the cements of the invention. Systems of the invention may have any configuration which enables practice of the particular production method of interest.

In one aspect, there is provided a system for making the composition of the invention, comprising (a) an input for a source of cations; (b) an input for source of carbonate brine; and (c) a reactor connected to the inputs of step (a) and step (b) that is configured to make the reaction product comprising carbonic acid, bicarbonate, carbonate, or mixture thereof. The reaction product may be used as is to make the composition of the invention or the reaction product may be subjected to one or more steps of filteration, dewatering, drying, milling, and storage to result in the composition of the invention.

In another aspect, there is provided a system for making a composition, comprising (a) an input for a source of cations; (b) an input for carbonate brine; and (c) a reactor connected to the inputs of step (a) and step (b) that is configured to make a composition, wherein the composition includes a carbonate, bicarbonate, or mixture thereof and one or more elements including, but not limited to, barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa; or the composition includes a carbonate, bicarbonate, or mixture thereof and one or more elements including, but not limited to, barium, cobalt, copper, lanthanum, mercury, arsenic, cadmium, lead, nickel, scandium, titanium, zinc, zirconium, molybdenum, and selenium, wherein the composition has a carbon isotopic fractionation value (δ¹³C) of greater than −5‰; or the composition includes at least 47% w/w vaterite and one or more elements including, but not limited to, barium, cobalt, copper, lanthanum, mercury, arsenic, cadmium, lead, nickel, scandium, titanium, zinc, zirconium, molybdenum, and selenium; or the composition includes at least 10% w/w vaterite, at least 1% w/w amorphous calcium carbonate (ACC), and one or more elements including, but not limited to, barium, cobalt, copper, lanthanum, mercury, arsenic, cadmium, lead, nickel, scandium, titanium, zinc, zirconium, molybdenum, and selenium.

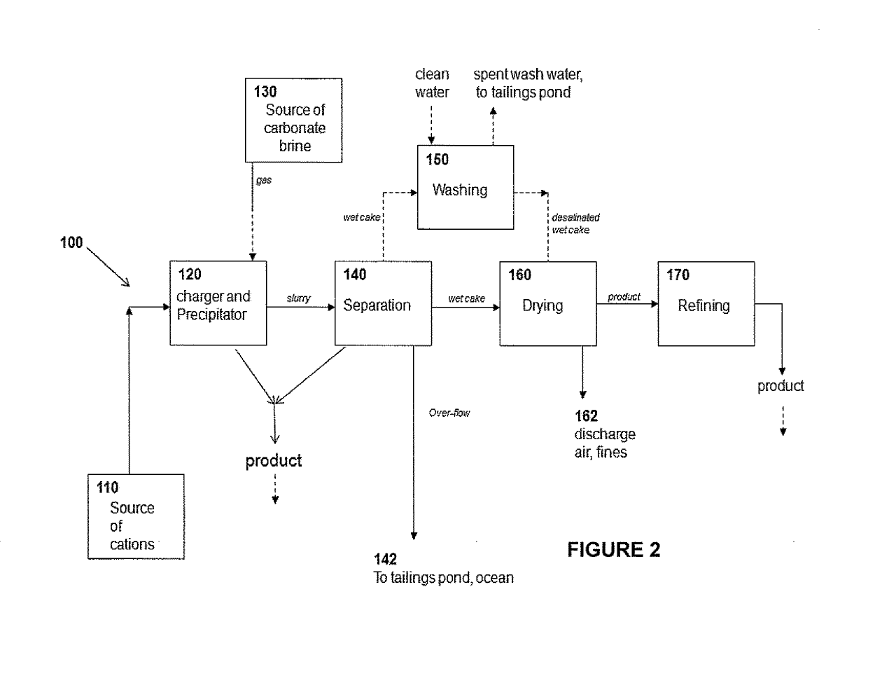

FIG. 2 provides an illustrative schematic of a system to conduct the methods of some embodiments of the invention. In FIG. 2, system 100 includes source of cations 110, such as, alkaline earth-metal containing water. In some embodiments, source of cations 110 includes a structure having an input for salt water, such as a pipe or conduit from an ocean, etc. Where the salt water source is seawater, the input is in fluid communication with a source of sea water. For example, the input is a pipe line or feed from ocean water to a land based system or an inlet port in the hull of ship, e.g., where the system is part of a ship, e.g., in an ocean based system.

FIG. 2 also shows a carbonate brine source 130. This source may vary, as described above. In some embodiments, the source of carbonate brine 130 includes a structure having an input for the carbonate brine, such as a pipe or conduit. In some embodiments, when the source of the carbonate brine is a subterranean brine, the input is in communication with the source, such as, the mine. For example, the input is a pipe line or feed from the mine to the system. Alternatively, the source of the carbonate brine may be a tanks or series of tanks containing the carbonate brine connected to the input for the carbonate brine.

The methods and systems of the invention may also include producing one or more bore holes (i.e., well bore) in the subterranean formation to connect the subterranean brine to the system of the invention, such as, to connect to the input for the carbonate brine. One or more bore holes can be produced in the subterranean formation by employing any convenient protocol. For instance, bore holes may be produced using conventional excavation drilling techniques, e.g., particle jet drilling, rotary mechanical drilling, rotary blasthole drilling, hole openers, rock reamers, flycutters, turbine-motor drilling, thermal spallation drilling, high power pulse laser drilling or any combination thereof. The bore holes may be drilled to any depth as desired, depending upon the thickness of the walls and porosity of the subterranean formation. In some embodiments, the bore holes may extend to a depth of 1 meter or deeper into the subterranean formation, such as 5 meters or deeper into the subterranean formation, such as 10 meters or deeper into the subterranean formation, such as 20 meters or deeper into the subterranean formation, such as 30 meters or deeper into the subterranean formation, such as 40 meters or deeper into the subterranean formation, such as 50 meters or deeper into the subterranean formation, such as 75 meters or deeper into the subterranean formation, including 100 meters or 200 m or 300 m or 500 m deeper into the subterranean formation. The diameter of the bore hole may also vary, depending upon the nature and the porosity of the subterranean formation. In some embodiments, the diameter of the bore hole ranges, e.g., from 5 to 100 cm, such as 10 to 90 cm, such as 10 to 90 cm, such as 20 to 80 cm, such as 25 to 75 cm, and including 30 to 50 cm.

After producing one or more bore holes in the subterranean formation, methods of the invention may also include inserting one or more conduits into the bore hole. The conduit includes a tube, pipeline or an analogous structure configured to convey a gas or liquid from one location to another. Conduits of the invention may vary in shape, where the cross-section of the conduit may be circular, rectangular, oblong, square, etc. The diameter of the conduit may also vary, depending on the size of the bore hole as well as the nature of the composition (e.g., viscosity), ranging from 5 to 100 cm, such as 10 to 90 cm, such as 10 to 90 cm, such as 20 to 80 cm, such as 25 to 75 cm, and including 30 to 50 cm. Depending on the depth of the subterranean formation, the wall thicknesses of the conduit may vary, ranging in some embodiments from 0.5 to 25 cm or thicker, such as 1 to 15 cm or thicker, such as 1 to 10 cm or thicker, including 1 to 5 cm or thicker. In some embodiments, conduits may be designed to support high internal pressure from the flow of the brine composition. In other embodiments, the conduit may be designed to support high external loadings (e.g., external hydrostatic pressures, earth loads, etc.). Conduits may be inserted to any depth into the subterranean formation, as desired, e.g., to a depth of 0.5 meter or deeper into the subterranean formation, such as 1 meters or deeper into the subterranean formation, such as 2 meters or deeper into the subterranean formation, such as 3 meters or deeper into the subterranean formation, such as 4 meters or deeper into the subterranean formation, such as 5 meters or deeper into the subterranean formation, including 10 meters or 100 meters, or 200 meters or 300 meters deeper into the subterranean formation. In some embodiments, conduits of the invention are two-way delivery units such that a single conduit may be employed to both introduce a fluid composition into the subterranean formation as well as withdraw a fluid composition from within the subterranean brine. For example, in some instances a conduit may be employed to introduce water into the subterranean formation. In some embodiments, the same conduit may be employed to withdraw the brine from within the subterranean formation at a later time. In some embodiments, brine may be withdrawn from within the subterranean formation and employed to produce a reaction product, as described herein. In other words, conduits may be configured to both convey a fluid composition into the subterranean formation as well as withdraw a fluid composition from within the subterranean formation.

Brine disposed within the subterranean formation may be removed by any convenient protocol, such as, but not limited to, employing an oil-field pump, down-well turbine motor pump, rotary lobe pump, hydraulic pump, fluid transfer pump, geothermal well pump, a water-submersible vacuum pump, or surface-located brine pump, among other protocols. Brine disposed within the subterranean formation may be used in any methods of this invention, for example, as a source of alkalinity, source of carbonate brine, and/or source of cations, such as, divalent cations.

The methods and systems of the invention may also include one or more detectors configured for monitoring the subterranean carbonate brine (not illustrated in FIG. 1 or FIG. 2). Monitoring the subterranean carbonate brine may include, but is not limited to, collecting data about the pressure, temperature and composition of the subterranean carbonate brine. The detectors may be any convenient device configured to monitor the subterranean carbonate brine, such as for example pressure sensors (e.g., permanent downhole pressure gauges, piezoresistive strain gage pressure sensors, capacitive pressure sensors, electromagnetic pressure sensors, potentiometric pressure sensors, etc.), temperature sensors (resistance temperature detectors, thermocouples, permanent downhole temperature gauges, gas thermometers, thermistors, pyrometers, infrared radiation sensors, etc.) volume sensors (e.g., geophysical diffraction tomography, X-ray tomography, hydroacoustic surveyers, etc.), and devices for determining chemical makeup of the subterranean carbonate brine (e.g, IR spectrometer, NMR spectrometer, UV-vis spectrophotometer, high performance liquid chromatographs, inductively coupled plasma emission spectrometers, inductively coupled plasma mass spectrometers, ion chromatographs, X-ray diffractometers, gas chromatographs, gas chromatography-mass spectrometers, flow-injection analysis, scintillation counters, acidimetric titration, and flame emission spectrometers, etc.).

In some embodiments, the systems of the invention may include a heat exchanger to collect and utilize excess thermal energy from a subterranean carbonate brine. The heat exchanger may be an open loop or closed loop configuration to collect heat from the brine. Thermal energy may be converted to electrical energy using a steam generator or any device known in the art for generating electrical energy from an aqueous geothermal source. Thermal energy may be used dry the precipitate or the compositions of this invention.

In some embodiments, detectors for monitoring the subterranean carbonate brine may also include a computer interface which is configured to provide a user with the collected data about the subterranean carbonate brine. For example, a detector may determine the internal pressure of a subterranean carbonate brine and the computer interface may provide a summary of the changes in the internal pressure within the subterranean carbonate brine over time. In some embodiments, the summary may be stored as a computer readable data file or may be printed out as a user readable document.

In some embodiments, the detector may be a monitoring device such that it can collect real-time data (e.g., internal pressure, temperature, etc.) about the subterranean carbonate brine. In other embodiments, the detector may be one or more detectors configured to determine the parameters of the subterranean carbonate brine at regular intervals, e.g., determining the composition every 1 minute, every 5 minutes, every 10 minutes, every 30 minutes, every 60 minutes, every 100 minutes, every 200 minutes, every 500 minutes, or some other interval.

The inputs for the source of cations 110 and the source of the carbonate brine 130 are connected to the charger and precipitator reactor 120 (FIG. 2). The precipitation reactor 120 is connected to the two inputs and is configured to make the reaction product containing the carbonate precipitate. The charger and precipitation reactor 120 may be configured to include any number of different elements, such as temperature regulators (e.g., configured to heat the water to a desired temperature), chemical additive elements, e.g., for introducing chemical pH elevating agents (such as NaOH) into the water, electrolysis elements, e.g., cathodes/anodes, etc. This reactor 120 may operate as a batch process or a continuous process. It is to be understood that system in FIG. 2 is for illustration purposes only and that the system may be modified to achieve the same result. For example, the system may have more than one reactor, and/or more than one source of cations, and/or more than one source of the carbonate brine interconnected in the system.

The reaction product of the precipitation reaction, e.g., the slurry may be removed from the reactor and used to make the self-cementing composition of the invention. Alternatively, the reaction product of the precipitation reaction, e.g., the slurry is then processed at a bulk dewatering station 140, as illustrated in FIG. 2. The dewatering station 140 may use a variety of different water removal processes, including processes such as continuous centrifugation, centrifugation, filter centrifugation, gravitational settling, and the like. The slurry obtained after bulk dewatering but still wetted in a mother supernate can be used to make the self-cementing composition of the invention. The dewatering station 140 may be any number of dewatering stations connected to each other to dewater the slurry (e.g., parallel, in series, or combination thereof).

In some embodiments, systems may also include a desalination station (not illustrated in FIG. 2). The desalination station may be in fluid communication with the liquid-solid separator 140 such that the liquid product may be conveyed from the liquid-solid separator to the desalination station directly. The systems may include a conveyance (e.g., pipe) where the output depleted brine may be directly pumped into the desalination station or may flow to desalination station by gravity. Desalination stations of the invention may employ any convenient protocol for desalination, and may include, but are not limited to distillers, vapor compressors, filtration devices, electrodialyzers, ion-exchange membranes, nano-filtration membranes, reverse osmosis desalination membranes, multiple effect evaporators or a combination thereof.

The system shown in FIG. 2 may also include a drying station 160 or a series of drying stations for drying the dewatered precipitate produced at station 140. Depending on the particular drying protocol of the system, the drying station 160 or the series of drying stations may include a filtration element, freeze drying structure, oven drying, spray drying structure, etc., as described above.

Also shown in FIG. 2, is an optional washing station 150, where bulk dewatered precipitate from separation station 140 is washed, e.g., to remove salts and other solutes from the precipitate, prior to drying at the drying station 160. Dried precipitate from station 160 is then sent to refining station 170, where the precipitate may be mechanically processed and/or one or more components may be added to the precipitate (e.g., as described above) to produce the composition, such as, hydraulic cement and SCM compositions of the invention. The refining station 170 may have grinders, millers, crushers, compressors, blender, etc. in order to obtain desired physical properties in the composition of the invention.

The system may further include outlet conveyers, e.g., conveyer belt, slurry pump, that allow for the removal of precipitate from one or more of the following: the contacting reactor, precipitation reactor, drying station, or from the refining station. In certain embodiments, the system may further include a station for preparing a building material, such as cement, from the precipitate. This station can be configured to produce a variety of cements, aggregates, or cementitious materials from the precipitate, such as described herein.

In some embodiments, the system of the invention includes a processing station that may include a compressor configured to pressurize the brine, the source of cations, the reaction mixture in the reactor, the reaction product, the precipitate, the dewatered precipitate, and/or the dried precipitate, as desired. Compressors of the invention may employ any convenient compression protocol, and may include, but are not limited to, positive displacement pumps (e.g., piston or gear pumps), static or dynamic fluid compression pumps, radial flow centrifugal-type compressors, helical blade-type compressors, rotary compressors, reciprocating compressors, liquid-ring compressors, among other devices for fluid compression. In some embodiments, the compressor may be configured to pressurize to a pressure of 5 atm or greater, such as 10 atm or greater, such as 25 atm or greater, including 50 atm or greater.

In some embodiments, the systems of the invention may include a control station, configured to control the amount of the carbonate brine and/or the amount of cations conveyed to the precipitator or the charger; the amount of the precipitate conveyed to the separator; the amount of the precipitate conveyed to the drying station; and/or the amount of the precipitate conveyed to the refining station. A control station may include a set of valves or multi-valve systems which are manually, mechanically or digitally controlled, or may employ any other convenient flow regulator protocol. In some instances, the control station may include a computer interface, (where regulation is computer-assisted or is entirely controlled by computer) configured to provide a user with input and output parameters to control the amounts, as described above.

As indicated above, the system may be present on land or sea. For example, the system may be a land based system that is in a coastal region, e.g., close to a source of sea water, or even an interior location, where water is piped into the system from a salt water source, e.g., ocean. Alternatively, the system may be a water based system, e.g., a system that is present on or in water. Such a system may be present on a boat, ocean based platform etc., as desired.

It is to be understood that the methods and the systems depicted in the figures are in no way limiting to the scope of the invention. One or more the steps in the methods may be skipped or the order of the steps may be altered to make the products and compositions of the invention. Similarly, one or more of the components in the systems may be avoided to make the products and compositions of the invention. For example, the source of cation may already be present in the reactor when the carbonate brine is added to the reactor, or vice versa.

### Methods and Systems for Assessing a Region, a Formation, and Brine

### Assessing the Region

In one aspect, there are provided methods of assessing a region for a subterranean carbonate brine including creating a representation of the region. The representation of the region includes a combination of a physical data wherein the physical data includes data indicative of a subterranean carbonate brine and the data indicative of sources of cations. The method includes determining a proximity of the subterranean carbonate brine to the source of cations to assess the region for the subterranean carbonate brine. Such proximity may be determined by the representation of the region including data indicating the proximity of the subterranean brine to the source of cations. In some embodiments, the proximity of the source of cations to the subterranean brine is less than 100 surface miles; or less than 90 surface miles; or less than 80 surface miles; less than 70 surface miles; or less than 60 surface miles; or less than 50 surface miles; or less than 40 surface miles; or less than 30 surface miles; or less than 20 surface miles; or less than 10 surface miles; or less than 5 surface miles; or less than 1 surface mile; or between 1 to 100 surface miles; or between 1 to 80 surface miles; or between 1 to 50 surface miles; or between 1 to 40 surface miles; or between 1 to 25 surface miles; or between 1 to 5 surface miles. In some embodiments, the source of cations is a hard brine or calcium silicate rock deposits.

In some embodiments, the proximity may be determined by the representation of the region including data indicating the proximity of the subterranean brine to the source of cations and/or the source of alkalinity. The assessment of the region may be used to determine probability of finding a source of carbonate brine that may be reacted with a source of cations. The region may be assessed using data associated with the presence of subterranean carbonate brines and/or data used for indicating the proximity of these brines to sources of cations. In some embodiments, the subterranean brine may be hard brine (i.e., containing divalent cations). In some embodiments, the data associated with the presence of hard brines (e.g., the presence of calcium containing rocks) may be collected and assessed. In some embodiments, publicly available databases may be used to locate the source of cations. For example only, the source of calcium in Wyoming may be determined using Wyoming oil and gas conservation databases and Department of Energy databases. In some embodiments, the source of calcium has calcium at about 10,000 ppm or between 1,000-10,000 ppm. In some embodiments, the brine may be an alkaline brine (i.e. pH greater than 7 or an alkalinity greater than 100 mEq/1). In some embodiments, the data associated with the presence of alkaline brines (e.g., the presence of evaporite rock formations) may be collected and assessed. The brine may be wastewater from a mining operation.

In some embodiments, the proximity of the source of water may also be determined in addition to the source of subterranean carbonate brine, the source of cations, and/or source of alkalinity. In some embodiments, the proximity of the cement plants, ready mix plants, and/or concrete plants may also be determined in addition to the source of subterranean carbonate brine, the source of cations, source of alkalinity, and/or source of water.

Any geographical region may be assessed by reviewing physical data, such as, but not limited to, geographical, lithographical, hydrological, seismic data or a combination thereof (e.g., surface, mining, petroleum maps, and lithographical and hydrological surveys), and anthropogenic data (e.g., population maps, power grid maps) about a region. The assessment may include reviewing existing data and/or acquiring new anthropogenic or physical data about a region or any combination of data. Other data may be acquired by any means (e.g., satellite data, air surveys, ground surveys, hydrological surveys, seismic surveys, infra red, mobile NMR geophysical tomography, magnetic robotic mapping, or the like). Physical data of a region may include maps of seismic, lithological, geographical data, as well as maps of mineral and petroleum deposits. Anthropogenic data may include population surveys, maps of power sources, source of carbonate brine and/or source of cations. The data and/or maps may be collected and a representation may be created to capture the relevant data.

The representation may be a map, table, matrix, computer program or any combination thereof. The data may be combined by means such as a software program to create a map of a region indicating the confluence of physical and anthropogenic features of a region. An example of a suitable software program for creating representations of this invention includes, MetaCarta™. Software programs may utilize searches of available published data of brine locations. Searches may be limited by specific key word ‘search terms’. Search terms that may facilitate searches for carbonate brines and/or hard brines include, but are not limited, brines, alkaline springs, pickle weed(s), alkaline plants, alkaliophiles, halotolerant, and calcium carbonate. Search terms that may facilitate searches for hard brines include, but are not limited, calcium chloride, albitization, anorthite weathering, calcium plagioclase, skarn, divalent cations and non-marine evaporites. In some embodiments of this invention, a representation may be generated which combines desired data into a single machine readable or human readable form and indicates likely locations of brines suitable for methods, compositions, and systems of this invention.

Legal data (e.g., status of real estate, water, mineral rights) of a particular region may also be included in any assessment of a region, such as licensee status of land, mineral, petroleum or hydrological rights to portions of a region to be assessed. Algorithms may be used to combine such data and provide estimates of physical suitability and/or legal availability of brine in a region to be assessed. The legal rights to water and mineral use in a region may be pursued. The ‘Beneficial Use’ rights may be pursued to obtain water rights to a region. Beneficial use may include the right to utilize real property, including light, air, water and access to it, in any lawful manner to gain a profit, advantage, or enjoyment from it. This includes the right to enjoy real or personal property held by a person who has equitable title to it while legal title is held by another.

A beneficial use involves greater rights than a mere right to possession of land, since it extends to the light, water and air in and over the land and access to it, which may be infringed by the beneficial use of other property by another owner. Beneficial use rights may be acquired simply by diverting and using the water, posting a notice of appropriation at the point of diversion, and recording a copy of the notice with the County Recorder. Beneficial use rights may be acquired by application through a State Water Board. Any entity intending to appropriate water may be required to file an application for a water right permit with a State Water Board. An application for a new water appropriation may be approved if it is determined to be for a useful or beneficial purpose and if water is available for appropriation. In evaluating an application, the Board may consider the relative benefits derived from the beneficial uses, possible water pollution, and water quality. If a permit is approved, it may be approved in full or it may be subject to specified conditions. While the time frame involved in obtaining a license for water rights may be highly variable, the pursuit of water rights may occur by following predetermined steps outlined in state water board regulations. Permit decisions may be required to be reached within six months on accepted applications for non-protested projects which do not require extensive environmental review. Applications with unique requirements for environmental review and/or require protest resolution, may extend the time frame by months and even years. In one embodiment of this invention, Beneficial Use water rights may be pursued in the state of California. The process to obtain a permit in the state of California is outlined in Table VIII.

TABLE VIII
Steps to Obtain a Beneficial Use Water Permit in California

| Step | Board's Role | Applicant’s Tasks |
|---|---|---|
| File | If you need assistance Board | Prepare an application which meets |
| Application | engineers would help you prepare | specific requirements, including a filing |
| | application forms, small project | fee. |
| | maps, and other documents. | |
| | Incomplete applications won't be | |
| | accepted. | |
| Acceptance of | Board notifies you within 30 days | Provide any additional information |
| Application | that either your application is | requested by the Board within 60 days |
| | incomplete or that it has been | of notification. |
| | accepted. Acceptance of your | |
| | application establishes your priority | |
| | as the date of filing. | |
| Environmental | Your proposed project is assessed to | Assume cost for preparation of any |
| Review | determine to what extent it could | required environmental studies. |
| | alter the environment. | |
| Public Notice | The Board will send you a public | For small projects, - Post the notice for |
| | notice describing your proposed | 40 consecutive days in two conspicuous |
| | project. Copies of the notice are also | places near your project location. |
| | sent to known interested parties and | For large projects - Publish the notice in |
| | to post offices in the area of your | a newspaper at least once a week for |
| | project for posting. | three consecutive weeks. |
| Protests | During the noticing period, the | Respond to any protest in writing and |
| | Board may receive protests against | attempt to reach agreements so that |
| | your proposed project from | protests can be withdrawn. |
| | interested individuals or groups. | |
| Hearings | If protests cannot otherwise be | In case of protest - prepare testimony |
| | resolved, you and the protestant | and exhibits for presentation at the |
| | present your cases at a field | hearing and cooperate with the Board |
| | investigation or during a hearing | and protestant toward reaching a |
| | conducted by the Board. The Board | satisfactory resolution. |
| | issues a decision on protested | |
| | applications based on information | |
| | gathered at the field investigation or | |
| | on evidence presented during the | |
| | hearing. | |
| Permit | A water right permit is issued when | Prior to issuance of a permit, you must |
| Issuance | protests, if any, are resolved or | submit a permit fee as directed by the |
| | dismissed, or when the Board | Board. If water conservation measures |
| | approves the application by decision | are required, they will be included as a |
| | following a hearing. In addition, a | condition of your permit. |
| | permit fee must be paid. During this | |
| | phase, the Board determines whether | |
| | water conservation measures are | |
| | needed. | |

Preferable properties of a region that may yield suitable brine include a region with substantial quantities of accessible subterranean brine. The methods of the invention further include generating other physical data about the region, such as, drilling a well. The other data may be acquired by seismic, infrared, geophysical tomographic, magnetic, robotic, aerial, ground mapping methods or any combination thereof. The brine may be accessible by any means, such as, through existing bore holes or rock amenable to drilling or permeable rock (e.g., a permeability of greater than 50 mD (milliDarcys)). Other desirable properties of region may be the presence of calcium in the existing rock. Other desirable properties include the availability of legal rights to the water or minerals in the region. The subterranean brine that is employed in embodiments of the invention may be from any convenient subterranean brine. The brine may be associated with a petrochemical deposit. Desirable properties of a brine in a region include, but are not limited to, the proximity of a power source to the source of brine. The brine may be within 5-50 surface miles of a source of power. In some embodiments, the power sources may be solar or wind farms. In some embodiments, the power source may be a coal, nuclear or gas power plants. The location of the carbonate brine relative to the location of a source of cations may also be assessed.

### Assessing the Subterranean Formation

In some embodiments, the subterranean formation may be assessed to determine the suitability of the formation for using the subterranean brine from the formation, for the compositions and methods of the invention. The assessment of the subterranean formation includes a human's (or a computer, if using a computer monitored process) evaluation of the subterranean formation and determination whether the subterranean formation is suitable or unsuitable for drilling for the subterranean brine. Assessing the subterranean formation may include, but is not limited to determining the internal pressure, internal volume, size, internal temperature, porosity, and composition of the subterranean formation.

In some embodiments, assessing the subterranean formation includes determining the internal pressure within the subterranean formation. The internal pressure as well as the depth and geographic location of the subterranean formation may vary, e.g., ranging from 4 to 200 atm, such as 5 to 150 atm, such as 5 to 100 atm, such as 5 to 50 atm, such as 5 to 25 atm, such as 5 to 15 atm, and including 5 to 10 atm. The internal pressure of the subterranean formation can be determined using any convenient protocol, such as for example, permanent down-hole pressure gauges, piezoresistive strain gage pressure sensors, capacitive pressure sensors, electromagnetic pressure sensors, potentiometric pressure sensors, among other protocols.

In some embodiments, assessing the subterranean formation includes determining the internal temperature within the subterranean formation. The internal temperatures of suitable subterranean formations of the invention may vary depending on depth and geographic location of the subterranean formation, ranging from −5 to 250° C., such as 0 to 200° C., such as 5 to 150° C., such as 10 to 100° C., such as 20 to 75° C., including 25 to 50° C. The internal temperature of the subterranean formation may be determined using any convenient protocol, such as for example, permanent down-hole temperature gauges, gas thermometers, thermocouples, thermistors, resistance temperature detectors, pyrometers, infrared radiation sensors, among other protocols.

In some embodiments, assessing the subterranean formation includes determining the size and internal volume of the subterranean formation. The size and internal volume of suitable subterranean formations of the invention may vary. The size includes the total amount of space occupied by the subterranean formation as measured by the dimensions of the external surfaces which are in contact with the outside environment. In some embodiments, the size of the subterranean formation may be 10³ liters or greater, such as 10⁴ liters or greater, such as 10⁵ liters or greater, such as 10⁶ liters or greater, such as 10⁷ liters or greater, such as 10⁸ liters or greater and including 10⁹ liters or greater. The internal volume includes the total amount of space found within the subterranean formation which is not in direct contact with the outside environment (e.g., ocean). In some embodiments, the internal volume of the subterranean formation may be 10³ liters or greater, such as 10⁴ liters or greater, such as 10⁵ liters or greater, such as 10⁶ liters or greater, such as 10⁷ liters or greater, such as 10⁸ liters or greater and including 10⁹ liters or greater. Depending upon the thickness of external walls and number of segregating walls within the subterranean formation, in certain embodiments, the size and internal volume may differ, e.g., by 5% or more, such as 10% or more, such as 25% or more, such as 30% or more, such as 40% or more, such as 50% or more, including 75% or more. The size and internal volume of the subterranean formation can be determined using any convenient protocol, such as for example, geophysical diffraction tomography, X-ray tomography, hydroacoustic survey, among other protocols.

In some embodiments, assessing the subterranean formation includes determining the porosity of the subterranean formation. The porosity includes the ratio of the total volume of its void or pore spaces (i.e., pore volume) to its gross bulk internal volume. The porosity of the subterranean formation is a measure of the capacity within the subterranean formation. Depending on the type of subterranean formation, the porosity of suitable subterranean formations of the invention may vary. In some embodiments, the porosity of subterranean formations ranges between 0.01 to 1.0, such as 0.01 to 0.95, such as 0.05 to 0.9, such as 0.1 to 0.75, such as 0.2 to 0.7 and including 0.25 to 0.55. The size of the pores within the subterranean formation may also vary. The porosity of the subterranean formation can be determined using any convenient protocol, such as for example, magnetic resonance imaging, computed tomography scanning, geophysical diffraction tomography, hydroacoustic survey, gas expansion analysis, among other protocols.

In some embodiments, assessing the subterranean formation may also include determining the composition of the subterranean formation including determining the composition of brine. Determining the composition of the subterranean formation includes the analysis of the components which make up the subterranean formation. Determining the composition of the subterranean formation may include, but is not limited to, determining the mineralogy, metal composition, salt composition, ionic composition, organometallic composition, and organic composition of the subterranean formation. Any convenient protocol can be employed to determine the composition of the subterranean formation. In some embodiments, prior to pumping out the brine from the subterranean formation, a sample of the subterranean formation may be obtained by for example, pump excavation or side wall drilling to determine the composition. Methods for analyzing the composition of the subterranean formation include, but are not limited to, inductively coupled plasma emission spectrometry, inductively coupled plasma mass spectrometry, ion chromatography, X-ray diffraction, gas chromatography, gas chromatography-mass spectrometry, flow-injection analysis, scintillation counting, acidimetric titration, and flame emission spectrometry, among other protocols.

### Assessing the Brine

In one aspect, there is provided a method for evaluating a probability that a subterranean carbonate brine in a region is suitable for reaction with a source of cations. The method includes determining a one or more properties of the subterranean carbonate brine, and evaluating a probability that the subterranean carbonate brine in the region is suitable for reaction with the source of cations based on the determination. In some embodiments, the determination of a one or more properties of the subterranean carbonate brine includes extracting a sample of the brine from the subterranean formation and analyzing the properties of the brine.

Once a region has been assessed for the probability of a suitable brine for reaction with the source of cations, the brine in that region may be located and assessed in detail for reactivity with cations. “Assessing” includes a human (either alone or with the assistance of a computer, if using a computer-automated process initially set up under human direction) determining the composition of one or more of the subterranean brine and evaluating the determined composition of the one or more subterranean brine. In some embodiments, the subterranean brine may be assessed to determine the suitability of the subterranean brine for contacting with the source of cations to result in a reaction product containing carbonic acid, bicarbonate, carbonates or any combination thereof. In some embodiments, the reaction may be a precipitation reaction comprising divalent cations.

Methods of the invention also include, in some embodiments, determining the properties of the subterranean brine or synthetic brines including, but not limited to, determining the components present in the subterranean brine. Determining the composition of subterranean brine may include, but is not limited to, determining the metal composition, salt composition, ionic composition, organometallic composition, organic composition, bacterial content, pH, physical properties (e.g., boiling point), electrochemical properties, spectroscopic properties, acid-base properties, polydispersities, isotopic composition, and partition coefficient of the subterranean brine.

The brine may be assessed remotely using testing equipment delivered to a brine location via a bore well. The brine may be assessed after removal from the subterranean site using any available method for testing the physical properties of a brine sample. Any convenient protocol may be employed to determine the composition of the subterranean brine. In some embodiments, prior to analysis, a sample of the subterranean brine may be obtained and filtered (e.g., by vacuum filtration) to separate the solid components from the liquid components. Methods for analyzing the properties of a subterranean brine may include, but are not limited to the use of inductively coupled plasma emission spectrometry, inductively coupled plasma mass spectrometry, ion chromatography, x-ray diffraction, gas chromatography, infrared or mass spectrometry, flow-injection analysis, scintillation counting, acidimetric titration, and flame emission spectrometry or any method known in the art for assessing the properties of a brine.

In some embodiments, determining the properties of the subterranean brine includes determining the alkalinity or the pH of the subterranean brine. The pH can be determined using any convenient protocol, e.g., a glass electrode coupled to a pH meter. In certain embodiments, determining the pH of the subterranean brine includes a brine-specific pH measurement that accounts for potential interference from sodium ions. The brine-specific pH measurement includes a pH measurement which distinguishes the relative contributions to the alkalinity of the brine, such as for example, alkalinity resulting from carbonates, sulfates, borates, nitrates, or organic bases, among others.

The properties of the subterranean brine may be determined at any phase during methods of the invention. For example, the composition of the subterranean brine may be determined before contacting the subterranean brine with the source of cations, during contacting with the source of cations, or even after contacting the subterranean brine with the source of cations. In some embodiments, methods also include monitoring the subterranean brine throughout the entire procedure. In some embodiments, monitoring the subterranean brine includes collecting real-time data (e.g., pH, conductivity, spectroscopic data, etc.) about the subterranean brine, such as by employing a detector in the reactor to monitor the reaction mixture. In other embodiments, the subterranean brine may be monitored by determining the composition of the subterranean brine at regular intervals, e.g., determining the composition every 1 minute, every 5 minutes, every 10 minutes, every 30 minutes, every 60 minutes, every 100 minutes, every 200 minutes, every 500 minutes, or some other interval.

Subterranean brines of the invention may be subterranean aqueous saline compositions and in some embodiments, may have circulated through crustal rocks and become enriched in substances leached from the surrounding mineral. As such, the ionic composition of subterranean brines may vary. Brines may be assessed to determine the ionic composition, for example concentration and identity of any divalent cations present in the brine. Methods of this invention may include assessing the brine for the conductivity, ionic strength and ionic composition to determine the suitability of the brine. In some embodiments, the subterranean brines may be assessed to determine the composition and concentration of one or more cations. The cations may be monovalent cations, such as Na⁺, K⁺, etc. In some instances the brines of interest may be substantially free of divalent cations or contain substantial amounts of divalent cations, such as Ca²⁺, Mg²⁺, Sr²⁺, Ba²⁺Mn²⁺, Zn²⁺, Fe²⁺, etc. In some instances, the divalent cations of the subterranean brine are alkaline earth metal cations, e.g., Ca²⁺, Mg²⁺.

The brine may be assessed to determine the pH and/or to determine composition of any proton removing agents. In some embodiments the alkalinity of the brine may be measured by quantifying the amount of borate, carbonate and/or hydroxyl components of the brine.

In some embodiments, subterranean brines of the invention may be assessed for bacterial content. Examples of the types of bacteria that may be present in subterranean brines include sulfur oxidizing bacteria (e.g., Shewanella putrefaciens, Thiobacillus), aerobic halophilic bacteria (e.g., Salinivibrio costicola and Halomanos halodenitrificans), high salinity bacteria (e.g., endospore-containing Bacillus and Marinococcus halophilus), among others. Brines may be assessed by sampling brines sources and culturing samples in an appropriate medium. Brines may be assessed using light microscopy, electron microscopy, epifluorescent microscopy or photography. The brine may be assessed to determine the temperature or pressure of the brine at the subterranean location. The brine may be assessed to determine the conductivity of the brine using methods known in the art for measuring conductivity.

After determining the properties of the brine, the brine may be modified based on the concentration of divalent cations, alkalinity, temperature, and/or ionic strength. In some embodiments, the modification of the subterranean carbonate brine composition occurs above the ground. In some embodiments, the modification of the subterranean carbonate brine composition occurs below the ground. In some embodiments, the modification of the subterranean carbonate brine includes raising the pH of the brine. In some embodiments, the modification of the subterranean carbonate brine includes diluting the brine with water. In some embodiments, the modification of the subterranean carbonate brine includes concentrating the brine.

After assessing the composition of the subterranean brine, the subterranean brine may be contacted with the source of cations with or without any further adjustments or modifications depending on the composition of the brine. Such modifications of the brine have been described herein.

### Systems

In one aspect, there is provided a system including (a) an input for a source of one or more carbonate brines; (b) an input for a source of cations; (c) a detector configured for determining a composition of the one or more carbonate brines; and (d) a reactor connected to the inputs of step (a) and step (b) configured to give a reaction product comprising carbonic acid, bicarbonate, carbonate, or mixture thereof, wherein the detector is operably connected to the input and/or the reactor. Such systems have been described in detail above. In some embodiments, the reactor is configured to dilute the one or more carbonate brines with water. In some embodiments, the reactor is configured to concentrate the one or more carbonate brines by removing water.

### Methods and Systems for Making a Cement Product

Aspects of the invention also provide methods and systems for making a cement product from the compositions of the invention. The compositions of the invention may be used to make cement products such as building materials or pre-cast or formed building materials, and/or aggregates.

In some embodiments, the invention provides a method of producing a cement product from the composition of the invention by obtaining the composition of the invention; and producing a cement product. In one aspect, there is provided a method for making a cement product from the composition of the invention, including (a) combining the composition of the invention with an aqueous medium under one or more suitable conditions; and (b) allowing the composition to set and harden into a cement product. In some embodiments, the methods comprise addition of Portland cement clinker, aggregate, SCM, or a combination thereof to the composition, before combining the composition with the aqueous medium.

In one aspect, there is provided a method for making formed building material from the compositions of the invention, such as, the hydraulic cement composition, the SCM composition, or the self-cementing composition, by combining the composition with an aqueous medium under one or more suitable conditions; and allowing the composition to set and harden into the formed building material. In some embodiments, the composition is poured into molds before or after step (a) of the combination. In some embodiments, the mold is for the formed building material. In some embodiments, the aqueous medium includes fresh water.

In some embodiments the obtaining step comprises precipitating the composition from a divalent cation-containing water, e.g., an alkaline-earth-metal-ion containing water such as salt water, e.g., sea water. The obtaining step comprises contacting the divalent cation-containing water, e.g., alkaline-earth-metal-ion containing water, to the carbonate brine prior to, and/or during, the precipitating step. In some embodiments the obtaining step further comprises raising the pH of the alkaline-earth-metal-ion containing water to 10 or higher prior to or during the precipitating step. The producing step may include allowing the composition to form a solid product, such as by mixing the composition with an aqueous medium including, but not limited to, one or more of fresh water, Portland cement, fly ash, lime and a binder, and optionally mechanically refining the solid product, such as by molding, extruding, pelletizing or crushing. The producing step may include contacting the composition with fresh water to convert the polymorphs in the composition to a freshwater stable product. In some embodiments, this may be done by spreading the composition in an open area; and contacting the spread composition with fresh water. In some embodiments, the aggregate producer comprises a refining station to mechanically refine the aggregate made from the composition of the invention.

In some embodiments, the composition of the invention after mixing in the water is poured into the molds designed to make one or more of the pre-formed building material. The composition is then allowed to set and harden into the pre-formed or pre-cast material.

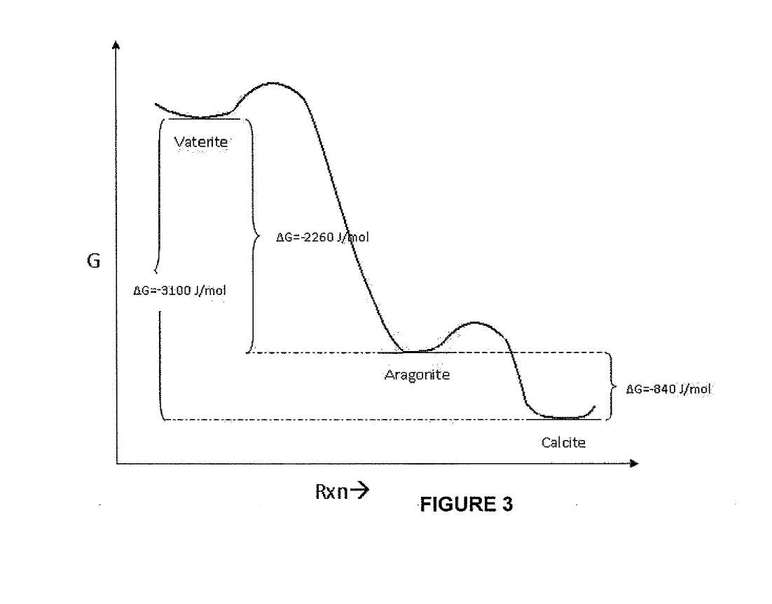

Upon precipitation of calcium carbonate as described herein, amorphous calcium carbonate (ACC) may initially precipitate and transform into one or more of its three more stable phases (vaterite, aragonite, or calcite). A thermodynamic driving force may exist for the transformation from unstable phases to more stable phases, as described by Ostwald in his Step Rule (Ostwald, W. Zeitschrift fur Physikalische Chemie 289 (1897)). For this reason, calcium carbonate phases transform in the order: ACC to vaterite, aragonite, and calcite where intermediate phases may or may not be present. For instance, ACC can transform to vaterite and may not transform to aragonite or calcite; or ACC can transform to vaterite and then directly to calcite, skipping the aragonite form; or alternatively, ACC can transform to vaterite and then to aragonite without transforming to calcite. During this transformation, excesses of energy are released, as exhibited by FIG. 3. This intrinsic energy may be harnessed to create a strong aggregation tendency and surface interactions that may lead to agglomeration and cementing.

The transformation between calcium carbonate polymorphs may occur via solid-state transition or may be solution mediated. In some embodiments, the transformation is solution-mediated because it may require less energy than the thermally activated solid-state transition. The solution-mediated transformation is environmentally conscious and more applicable to a cementing application. Vaterite is metastable and the difference in thermodynamic stability of calcium carbonate polymorphs may be manifested as a difference in solubility, where the least stable phases are the most soluble (Ostwald, supra.). Therefore, vaterite may dissolve readily in solution and transform favorably towards a more stable polymorph:aragonite or calcite. The driving force for the formation of a particular calcium carbonate polymorph or combination of polymorphs is the change in Gibbs free energy from a supersaturated solution to equilibrium (Spanos & Koutsoukos Journal of Crystal Growth (1998) 191, 783-790).

In a polymorphic system like calcium carbonate, two kinetic processes may exist simultaneously in solution: dissolution of the metastable phase and growth of the stable phase (Kralj et al. Journal of Crystal Growth (1997) 177, 248-257). In some embodiments, the aragonite or calcite crystals may be growing while vaterite is undergoing dissolution in the aqueous medium.

Crystallization of the polymorphs is a surface controlled process where heterogeneous nucleation may be responsible for the formation of multiple solid phases. When a single phase is present, the number of particles may decrease with time, while their size increases (Spanos & Koutsoukos, supra.). Vaterite may be framboidal (spherical aggregates of discrete micro/nano-crystallites) or non-framboidal.

In some embodiments, the composition of the invention, as prepared by the methods described above, is treated with the aqueous medium under one or more suitable conditions. The aqueous medium includes, but is not limited to, fresh water optionally containing sodium chloride, calcium chloride, magnesium chloride, or combination thereof or aqueous medium may be brine. The aqueous medium may facilitate the transformation of vaterite to other polymorphic forms to result in the cement product. In some embodiments, aqueous medium is fresh water.

In some embodiments, the one or more suitable conditions include, but are not limited to, temperature, pressure, time period for setting, a ratio of the aqueous medium to the composition, and combination thereof. The temperature may be related to the temperature of the aqueous medium. In some embodiments, the temperature is in a range of 0-110° C.; 0-80° C.; or 0-60° C.; or 0-40° C.; or 25-100° C.; or 25-75° C.; or 25-50° C.; or 37-100° C.; or 37-60° C.; or 40-100° C.; or 40-60° C.; or 50-100° C.; or 50-80° C.; or 60-100° C.; or 60-80° C.; or 80-100° C. In some embodiments, the pressure atmospheric pressure or above atm. pressure. In some embodiments, the time period for setting the cement product is 30 min. to 48 hrs; or 30 min. to 24 hrs; or 30 min. to 12 hrs; or min. to 8 hrs; or 30 min. to 4 hrs; or 30 min. to 2 hrs; 2 to 48 hrs; or 2 to 24 hrs; or 2 to 12 hrs; or 2 to 8 hrs; or 2 to 4 hrs; 5 to 48 hrs; or 5 to 24 hrs; or 5 to 12 hrs; or 5 to 8 hrs; or 5 to 4 hrs; or 5 to 2 hrs; 10 to 48 hrs; or 10 to 24 hrs; or 24 to 48 hrs. In some embodiments, the ratio of the aqueous medium to the dry components or the composition of the invention (aqueous medium:dry components or aqueous medium:composition of the invention) is 0.1-10; or 0.1-8; or 0.1-6; or 0.1-4; or 0.1-2; or 0.1-1; or 0.2-10; or 0.2-8; or 0.2-6; or 0.2-4; or 0.2-2; or 0.2-1; or 0.3-10; or 0.3-8; or 0.3-6; or 0.3-4; or 0.3-2; or 0.3-1; or 0.4-10; or 0.4-8; or 0.4-6; or 0.4-4; or 0.4-2; or 0.4-1; or 0.5-10; or 0.5-8; or 0.5-6; or 0.5-4; or 0.5-2; or 0.5-1; or 0.6-10; or 0.6-8; or 0.6-6; or 0.6-4; or 0.6-2; or 0.6-1; or 0.8-10; or 0.8-8; or 0.8-6; or 0.8-4; or 0.8-2; or 0.8-1; or 1-10; or 1-8; or 1-6; or 1-4; or 1-2; or 1:1; or 2:1; or 3:1.

In some embodiments, the precipitate may be rinsed with fresh water to remove halite or the chloride content from the precipitate. The chloride may be undesirable in some applications, for example, in aggregates intended for use in concrete since the chloride has a tendency to corrode rebar. Further, the rinsing of the slurry or the precipitate with water may cause the vaterite in the composition to shift to more stable forms such as aragonite and calcite and result in the cemented material. For example, the self-cementing composition can be kept in the saltwater until before use and is rinsed with fresh water that may remove the halite from the precipitate and facilitate the formation of the cemented material.

In some embodiments, such rinsing may not be desirable as it may reduce the yield of the composition. In such embodiments, the precipitate may be washed with a solution having a low chloride concentration but high concentration of divalent cations (such as, calcium, magnesium, etc.). Such high concentration of the divalent ion may prevent the dissolution of the precipitate, thereby reducing the yield loss and the conversion to cemented material.

During the mixing of the composition with the aqueous medium, the precipitate may be subjected to high shear mixer. After mixing, the precipitate may be dewatered again and placed in pre-formed molds to make pre-formed building materials. Alternatively, the precipitate may be mixed with water and is allowed to set. The precipitate sets over a period of days and is then placed in the oven for drying, e.g., at 40° C., or from 40° C.-60° C., or from 40° C.-50° C., or from 40° C.-100° C., or from 50° C.-60° C., or from 50° C.-80° C., or from 50° C.-100° C., or from 60° C.-80° C., or from 60° C.-100° C. The precipitate is then subjected to curing at high temperature, such as from 50° C.-60° C., or from 50° C.-80° C., or from 50° C.-100° C., or from 60° C.-80° C., or from 60° C.-100° C., or 60° C., or 80° C.-100° C., in high humidity, such as, in 30%, or 40%, or 50%, or 60% humidity.

The cement product produced by the methods described above may be a building material, an aggregate or a pre-cast material or a formed building material. These materials have been described herein.

In yet another aspect, there is provided a system for making the cement product from the composition of the invention comprising (a) an input for the composition of the invention; (b) an input for an aqueous medium; and (c) a reactor connected to the inputs of step (a) and step (b) configured to mix the composition of the invention with the aqueous medium under one or more of suitable conditions to make a cement product. In some embodiments, the system further comprises a filtration element to filter the composition after the mixing step (c). In still some embodiments, the system further comprises a drying step to dry the filtered composition to make the cement product.

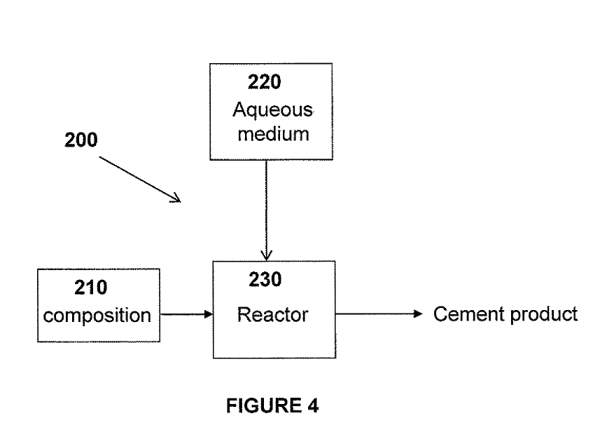

FIG. 4 shows an illustrative system embodiment 200 to make the cement product from the composition of the invention. In some embodiments, system 200 includes a source for the composition of the invention 210. In some embodiments, the source for the composition includes a structure having an input for the composition. Such structure having an input includes, but is not limited to, a funnel, a tube, a pipe or a conduit, etc. Any input that can facilitate the administration of the composition to the reactor 230 is within the scope of the invention. It is well understood that in some embodiments, no such source for the composition or the structure with an input for the composition is needed, when the composition is already present in the reactor 230. In some embodiments, there is provided a source for aqueous medium 220 such as, water optionally containing sodium chloride, calcium chloride, magnesium chloride, or combination thereof or brine. In some embodiments, the source for the aqueous medium 220 contains an input for the aqueous medium, such as, but not limited to, a funnel, a tube, a pipe or a conduit, etc. Any input that can facilitate the administration of the aqueous medium to the reactor 230 is within the scope of the invention. It is well understood that in some embodiments, no such source for the aqueous medium or the structure with an input for the aqueous medium is needed, when the aqueous medium is already present in the reactor 230.

The reactor 230 is connected to the two inputs and is configured to mix the composition of the invention with the aqueous medium under one or more of suitable conditions to make a cement product. The one or more suitable conditions have been defined above. The reactor 230 may be configured to include any number of different elements, such as temperature regulators (e.g., configured to heat the water to a desired temperature), chemical additive elements, e.g., for introducing chemical pH elevating agents (such as NaOH) into the water. This reactor 230 may operate as a batch process or a continuous process. The system may optionally contain a filtration element to filter the composition after wetting (not shown in FIG. 4).

After the addition of water to the composition in the reactor, the composition sets and hardens into the cement product. The cement product may optionally be dried and cured.

In one aspect, there is provided a method to make a cement product of desired compressive strength, including combining a composition of the invention with an aqueous medium under one or more conditions including, but not limited to, temperature, pressure, time period for setting, a ratio of the aqueous medium to the composition, and combination thereof. In some embodiments, the composition includes at least 47% w/w vaterite or at least 10% w/w vaterite and at least 1% w/w ACC. In some embodiments, the composition includes a carbon isotopic fractionation value (δ¹³C) of greater than −5‰. In some embodiments, the composition upon combination with water; setting; and hardening, has a compressive strength of at least 14 MPa. In some embodiments, the method includes optimizing one or more of the conditions; and allowing the composition to set and harden into a cement product of desired compressive strength.

The one or more conditions including, but not limited to, temperature, pressure, time period for setting, a ratio of the aqueous medium to the composition, and combination thereof, have been described herein. The optimization of these one or more conditions includes modifying the one or more conditions to achieve a cement product of desired compressive strength. For example, the ratio of the aqueous medium to the composition can affect the setting time, hardening time, hydration reaction, shrinkage, and the compressive strength of the cemented product. Therefore, optimization of the ratio of the aqueous medium to the composition can result in the cement product of desired compressive strength.

### III. Packages

In one aspect, there is provided a package including the composition of the invention. In some embodiments, there is provided a package including a pre-cast or a formed building material formed from the composition of the invention. These pre-cast or formed building materials are as described herein. The package further includes a packaging material that is adapted to contain the composition. The package may contain one or more of such packaging materials.

The packaging material includes, but is not limited to, metal container; sacks; bags such as, but not limited to, paper bags or plastic bags; boxes; silo such as, but not limited to, tower silo, bunker silo, bag silo, low level mobile silo, or static upright cement silo; and bins. It is understood that any container that can be used for carrying or storing the composition of the invention is well within the scope of the invention.

In some embodiments, these packages are portable. In some embodiments, these packages and/or packaging materials are disposable or recyclable.

The packaging material are further adapted to store and/or preserve the composition of the invention for longer than few months to few years. In some embodiments, the packaging materials are further adapted to store and/or preserve the composition of the invention for longer than 1 week, or longer than 1 month, or longer than 2 months, or longer than 5 months, or longer than 1 year, or longer than 2 years, or longer than 5 years, or longer than 10 years, or between 1 week to 1 year, or between 1 month to 1 year, or between 1 month to 5 years, or between 1 week to 10 years.

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

The abbreviations used in the application have an ordinary meaning unless indicated otherwise. Some of the abbreviations are defined below:

| | |
|---|---|
| ACC = | Amorphous calcium carbonate |
| CaCl₂ = | Calcium chloride |
| CaO = | Calcium oxide |
| CaSO₄ = | Calcium sulfate |
| DI = | Deionized water |
| FT-IR = | Fourier transform infrared spectroscopy |
| g = | gram |
| μm = | micrometer |
| mL = | milliliter |
| M = | molar |
| MgCl₂ = | Magnesium chloride |
| NaCl = | Sodium chloride |
| Na₂CO₃ = | Sodium carbonate |
| NaF = | Sodium fluoride |
| NaOH = | Sodium hydroxide |
| NaP = | Sodium phosphate |
| Na₂SiO₄ = | Sodium silicate |
| OPC = | Ordinary Portland cement |
| ppm = | Parts per million |
| RCM = | Reactive carbonate minerals |
| SCM = | Supplementary cementitious material |
| SEM = | Scanning electron microscopy |
| TGA = | Thermo-gravimetric analysis |
| XRD = | X-ray diffraction |

### EXAMPLES

### Example 1

### Synthesis of the Composition from Carbonate Brine

In this experiment, calcium chloride was added to trona brine when it resulted in a calcium carbonate precipitate. The precipitate was analyzed for particle morphology, content of vaterite, particle size, calorimetry, and calcium concentration.

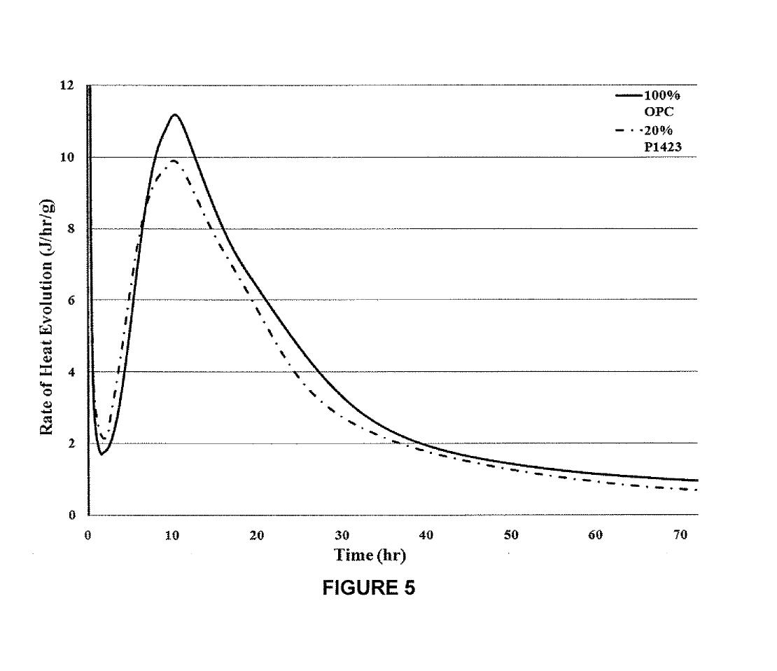

The precipitation, after 30 minutes of stirring at 1200 rpm, produced dispersed 7 μm spheres, that were 100% calcite according to XRD and SEM. The calorimetry of the precipitate illustrates that 20% replacement of OPC with this precipitate (shown as 20% P1423 in FIG. 5) has 88% cumulative heat (an indication of reactivity) at 3 days compared to 100% OPC. The cumulative heat indicates that the precipitate is reactive and is not an inert filler. It is contemplated that the high cumulative heat may be related to one or more of to particle size distribution, surface area, and/or morphology of the particles.

The precipitate was found to have spheres agglomerated with dumbell shaped or twinned particles. The precipitation conditions were varied to study the effect of the precipitation conditions on the morphology of the particles. For example, the precipitate was rinsed with acetone instead of water to avoid oven drying. The materials filtered after 1 min of stirring were found to be gel like and took time to release water. The material was rinsed with acetone to reduce the time for drying. The material was finally dried in the desiccators. This material was compared to the material that was oven dried. The oven dried material was found to be chains of bulging spheres and the acetone rinsed material was found to be fuzzy spheres.

Another precipitation condition that was studied was mixing effects. Without being bound by any theory, it was contemplated that abrasion between the stir bar and the beaker, during the mixing of the trona brine with calcium chloride, might cause the changes in the morphology of the precipitate. An increase in the viscosity of the mixture during stirring may prevent the mixing if the mixing is done at low rpm. A change in the stri bar shape and/or change in the stirring mechanism may affect the mixing of the precipitate. It is contemplated that static mixer placement and plug flow reactor wall effects may play a role in fine particle morphology. At low rpm, no specific morphology was observed. After freeze drying, the material was found to be a free flowing powder.

Precipitate morphology was also found to be affected by time. A change in the material behavior was observed during the precipitation when the precipitate was filtered after 10-min mix. By 14 minutes while filtering, the precipitate had formed 10 μm spheres.

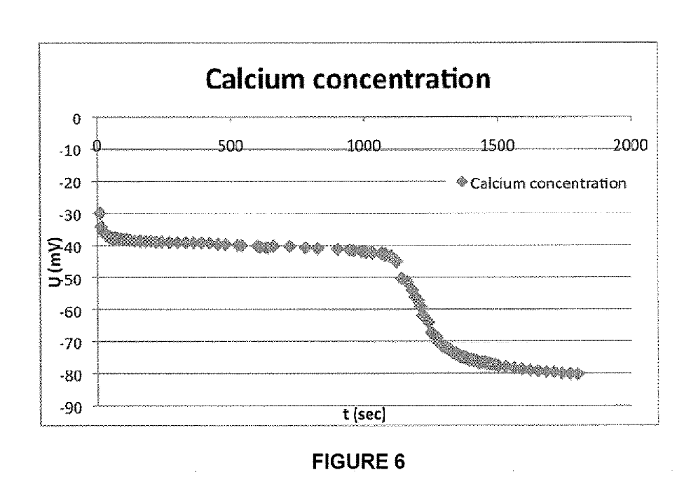

Calcium concentration was monitored during the precipitation reaction. The calcium concentration was found to drop after 18 minutes (FIG. 6).

### Example 2

### Vaterite vs. Calcite Precipitation Across a Range of Precipitation Conditions

In this study, an effect of precipitation conditions in the precipitation of the cement material from synthetic hard brine was investigated. Solutions containing various concentrations of Ca²⁺ ions (0.01 mol/L, 0.05 mol/L; and 0.10 mol/L) were prepared by adding anhydrous Na₂CO₃ to 0.2 mol/L Ca²⁺ solution. Table 1 shows a summary of the concentrations.

TABLE 1

| | Target | | | | Yield | Total carbonate |
|---|---|---|---|---|---|---|
| Na₂CO₃ | [Ca²⁺]_{f} | [Ca²⁺]_{f} | pH_{f} | % C | (g/L) | mineralized (g/L) |
| 42.40 g | 0.10 | 0.10 | 7.76 | 9.6 | 14.15 | 4.98 |
| 63.60 g | 0.05 | 0.05 | 7.98 | 9.7 | 17.83 | 6.34 |
| 80.56 g | 0.01 | 0.014 | 8.35 | 10.4 | 22.47 | 8.57 |

Initial Ca²⁺ concentration = 0.2 mol/L for all experiments
Initial and final Mg²⁺ concentrations = 0.04-0.05 mol/L for all experiments
Final alkalinity = 3-9 mmol/kg for all experiments
pH = 8.0-8.5 during base addition

The addition of anhydrous Na₂CO₃ to the calcium solution resulted in the formation of precipitates with varying vaterite content. Table 2 shows the amount of vaterite formed in the precipitation conditions for three sets of experiments, Experiment 1, Experiment 2, and Experiment 3.

TABLE 2

| | Experiment 1 | Experiment 2 | Experiment 3 |
|---|---|---|---|
| XRD | Na₂CO₃ | Na₂CO₃ | Na₂CO₃ |
| vaterite | 43% | 31% | 32% |
| calcite | 46% | 61% | 65% |
| aragonite | — | — | — |
| [Ca²⁺]ᵢ | 0.2M | 0.2M | 0.2M |
| [Ca²⁺]_{f} | 0.1M | 0.05M | 0.01M |

### Example 3

### Vaterite vs. Calcite Precipitation in Old Brine and Fresh Brine

A batch of old brine and fresh brine with varying concentration of Na₂CO₃ solution was added to the calcium ion containing solution in a varying duration of times. Old brine was made 6 days before the experiment and was filtered two days before the experiment to remove any precipitated gypsum from the solution. Fresh brine was made one day before the experiments and was filtered on the same day as the experiments. Table 3 shows a summary of the concentrations.

TABLE 3

| | | | | | | | Total |
|---|---|---|---|---|---|---|---|
| | | | | | | | carbonate |
| Brine | | Base | | [Ca²⁺]_{f} | | Yield | mineralized |
| type | Na₂CO₃ | duration | pH_{f} | (mol/L) | % C | (g/L) | (g/L) |
| Old | 50%* | 10 min. | 7.78 | 0.1 | 10.26 | 11.43 | 4.30 |
| fresh | 50%* | 10 min. | 8.03 | 0.1 | 9.69 | 11.05 | 3.93 |
| Old | 25% | 10 min. | 7.67 | 0.1 | 10.50 | 11.23 | 4.32 |
| fresh | 25% | 10 min. | 7.54 | 0.1 | 9.55 | 11.10 | 3.89 |
| Old | 25% | 4 min. | 7.88 | 0.1 | 10.41 | 11.43 | 4.36 |
| fresh | 25% | 4 min. | 7.70 | 0.1 | 10.29 | 11.09 | 4.18 |

Initial Ca²⁺ concentration = 0.2 mol/L for all experiments
Initial and final Mg²⁺ concentrations = 0.04-0.05 mol/L for all experiments
Final alkalinity = 2-5 mmol/kg for all experiments
pH = 8.0-8.5 during base addition
*Na₂CO₃ is not soluble in solution at 50%

Highest vaterite content was observed in the precipitate with 25% Na₂CO₃ in old brine with 10 min. base addition. Table 4 shows the amount of vaterite formed in the precipitation conditions for three sets of experiments.

TABLE 4

| | Experiment 1 | | Experiment 2 | | Experment 3 | |
|---|---|---|---|---|---|---|
| | 50% | 50% | 25% | 25% | 25% | 25% |
| | Na₂CO₃ | Na₂CO₃ | Na₂CO₃ | Na₂CO₃ | Na₂CO₃ | Na₂CO₃ |
| | in old | in fresh | in old | in fresh | in old | in fresh |
| | brine + | brine + | brine + | brine + | brine + | brine + |
| | 10 min | 10 min | 10 min | 10 min | 4 min | 4 min |
| XRD | addition | addition | addition | addition | addition | addition |
| vaterite | 86% | 80% | 94% | 86% | 90% | 81% |
| calcite | 5% | 16% | 4% | 7% | 6% | 15% |
| [Ca²⁺]ᵢ | 0.2M | 0.2M | 0.2M | 0.2M | 0.2M | 0.2M |
| [Ca²⁺]_{f} | 0.1M | 0.1M | 0.1M | 0.1M | 0.1M | 0.1M |

### Example 4

### Brines with Carbonates

In this study, various brines were subjected to different precipitation conditions and the precipitated material was analyzed. The brines included seawater based synthetic brine with NaCl (seawater+27.9 g/L CaCl₂+99.13 g/L NaCl), seawater based synthetic brine without NaCl (seawater+27.9 g/L CaCl₂), and deionized water based synthetic brine (deionized water+29.4 g/L CaCl₂). These brines were treated with Na₂CO₃ anhydrous, 50% wt Na₂CO₃ solution, and 25% wt Na₂CO₃ solution.

Seawater based synthetic brine with NaCl (seawater+27.9 g/L CaCl₂+99.13 g/L NaCl) when treated with Na₂CO₃ anhydrous resulted in 43% vaterite content in the precipitated material. The initial ratio of Ca:Mg ([Ca²⁺]ᵢ:[Mg²⁺]ᵢ) was about 4:1. Table 5 shows the concentrations of the initial and final ions in the solution.

TABLE 5
Synthetic brine (seawater)

| [Ca²⁺]ᵢ | 0.20M |
|---|---|
| [Mg²⁺]i | 0.05M |
| [NaCl]ᵢ | 2.1M |
| [Ca²⁺]_{f} | 0.10M |
| [Mg²⁺]_{f} | 0.05M |
| Alk_{f} | 3.4 mM eq |
| vaterite | 43% |
| calcite | 46% |
| halite | 11% |

When seawater based synthetic brine (seawater+27.9 g/L CaCl₂+99.13 g/L NaCl) was treated with 50% wt Na₂CO₃, it resulted in 90% vaterite content in the precipitated material. The vaterite content seemed to increase when the sodium carbonate was not anhydrous. The initial ratio of Ca:Mg ([Ca²⁺]ᵢ:[Mg²⁺]ᵢ) was about 4:1. Table 6 shows the concentrations of the initial and final ions in the solution.

TABLE 6
Synthetic brine (seawater)

| [Ca²⁺]ᵢ | 0.20M |
|---|---|
| [Mg²⁺]ᵢ | 0.05M |
| [NaCl]ᵢ | 2.1M |
| [Ca²⁺]_{f} | 0.10M |
| [Mg²⁺]_{f} | 0.05M |
| Alk_{f} | 3.3 mM eq |
| vaterite | 90% |
| calcite | 6% |
| halite | 4% |

When seawater based synthetic brine (seawater+27.9 g/L CaCl₂+99.13 g/L NaCl) was treated with 25% wt Na₂CO₃, it resulted in 94% vaterite content in the precipitated material. The vaterite content increased with 25% wt Na₂CO₃ as compared to 50% wt Na₂CO₃. This could be due to higher solubility of Na₂CO₃ in the solution when it is 25% wt Na₂CO₃. The 50% wt Na₂CO₃ is sparingly soluble in water. The initial ratio of Ca:Mg ([Ca²⁺]ᵢ:[Mg²⁺]ᵢ) was about 4:1. Table 7 shows the concentrations of the initial and final ions in the solution.

TABLE 7
Synthetic brine (seawater)

| [Ca²⁺]ᵢ | 0.20M |
|---|---|
| [Mg²⁺]ᵢ | 0.05M |
| [NaCl]ᵢ | 2.1M |
| [Ca²⁺]_{f} | 0.10M |
| [Mg²⁺]_{f} | 0.05M |
| Alk_{f} | 2.3 mM eq |
| vaterite | 94% |
| calcite | 4% |
| halite | 2% |

Seawater based synthetic brine without NaCl (seawater+27.9 g/L CaCl₂) was treated with 25% wt Na₂CO₃, which resulted in 92% vaterite content in the precipitated material. The initial ratio of Ca:Mg ([Ca²⁺]ᵢ:[Mg²⁺]ᵢ) was about 4:1. Table 8 shows the concentrations of the initial and final ions in the solution.

TABLE 8
Synthetic brine (seawater)

| [Ca²⁺]ᵢ | 0.20M |
|---|---|
| [Mg²⁺]ᵢ | 0.05M |
| [NaCl]ᵢ | 0.47M |
| [Ca²⁺]_{f} | 0.10M |
| [Mg²⁺]_{f} | 0.05M |
| Alk_{f} | — |
| vaterite | 92% |
| calcite | 5% |
| halite | 3% |

Deionized water based synthetic brine (Deionized water+29.4 g/L CaCl₂) was treated with 25% wt Na₂CO₃, which resulted in 90% vaterite content in the precipitated material. The absence of magnesium did not seem to have any effect on the precipitation of vaterite. Table 9 shows the concentrations of the initial and final ions in the solution.

TABLE 9
Synthetic brine (deionized water)

| [Ca²⁺]ᵢ | 0.20M |
|---|---|
| [Mg²⁺]ᵢ | — |
| [NaCl]ᵢ | — |
| [Ca²⁺]_{f} | 0.10M |
| [Mg²⁺]_{f} | — |
| vaterite | 90% |
| calcite | 5% |
| amorphous | 5% |

### Example 5

### Brines with Carbonates

In this study, an effect of a ratio of calcium with the base in the formation of the carbonate precipitate is studied. Various concentrations of brine containing 0.2 M Ca²⁺ were treated with different concentrations of sodium carbonate.

Table 10 for sample 1; sample 2; sample 3; and sample 4, illustrate the formation of vaterite compositions from synthetic brine (tap water+29.4 g/L CaCl₂) (0M NaCl+0.2M Ca²⁺) with calcium:base stoichiometric ratio of 1:1.

TABLE 10

| | | Liquid | Na₂CO₃ | CaCl₂ | | | Alk_{f} | | |
|---|---|---|---|---|---|---|---|---|---|
| | | residence | flow rate | flow rate | Yield | Ca²⁺_{f} | (mM | PSA | |
| | [Na₂CO₃] | time | (mL/min) | (mL/min) | (g/L) | (mM) | eq) | (μm) | XRD |
| Sample 1 | 0.25M | 10 min | 44.4 | 55.6 | — | 0.10 | 25.63 | Median | 94.6% |
| | | | | | | | | 26.81 | vaterite |
| | | | | | | | | Mean | 5.4% |
| | | | | | | | | 27.25 | calcite |
| Sample 2 | 0.25M | 10 min | 44.4 | 55.6 | ~10.28 | 1.36 | 11.40 | Median | 90% |
| | | | | | | | | 27.39 | vaterite |
| | | | | | | | | Mean | 10% |
| | | | | | | | | 28.01 | calcite |
| Sample 3 | 0.25M | 10 min | 44.4 | 55.6 | ~10.14 | | 7.45 | Median | 95.2% |
| | | | | | | | | 31.28 | vaterite |
| | | | | | | | | Mean | 3.5% |
| | | | | | | | | 32.17 | calcite |
| Sample 4 | 0.25M | 10 min | 28.6 | 71.4 | ~13.52 | | 14.89 | Median | 96.9% |
| | | | | | | | | 24.35 | vaterite |
| | | | | | | | | Mean | 3.1% |
| | | | | | | | | 23.52 | calcite |

Table 11 for sample 1; sample 2; sample 3; and sample 4, illustrate the formation of vaterite compositions from synthetic brine (tap water+29.4 g/L CaCl₂) (0M NaCl+0.2M Ca²⁺) with calcium:base stoichiometric ratio of 1.5:1.

TABLE 11

| | | Liquid | Na₂CO₃ | CaCl₂ | | | Alk_{f} | | |
|---|---|---|---|---|---|---|---|---|---|
| | | residence | flow rate | flow rate | Yield | Ca²⁺_{f} | (mM | PSA | |
| | [Na₂CO₃] | time | (mL/min) | (mL/min) | (g/L) | (mM) | eq) | (μm) | XRD |
| Sample 1 | 0.5M | 20 min | 10.5 | 39.5 | — | 19.96 | 4.40 | Median | 85.9% |
| | | | | | | | | 21.49 | vaterite |
| | | | | | | | | Mean | 14.1% |
| | | | | | | | | 22.36 | calcite |
| Sample 2 | 0.25M | 5 min | 69.6 | 130.4 | ~8.84 | | 4.40 | Median | 93.1% |
| | | | | | | | | 17.71 | vaterite |
| | | | | | | | | Mean | 6.9% |
| | | | | | | | | 18.50 | calcite |
| Sample 3 | 0.25M | 5 min | 69.6 | 130.4 | ~8.92 | 33.92 | 4.03 | Median | 85.9% |
| | | | | | | | | 18.00 | vaterite |
| | | | | | | | | Mean | 14.1% |
| | | | | | | | | 18.84 | calcite |
| Sample 4 | 0.25M | 5 min | 69.6 | 130.4 | ~9.07 | 32.92 | 4.67 | Median | 91.9% |
| | | | | | | | | 17.65 | vaterite |
| | | | | | | | | Mean | 8.1% |
| | | | | | | | | 18.44 | calcite |

Table 12 for sample 1; sample 2; and sample 3, illustrate the formation of vaterite compositions from synthetic brine (tap water+29.4 g/L CaCl₂) (0M NaCl+0.2M Ca²⁺) with calcium:base stoichiometric ratio of 2:1.

TABLE 12

| | | Liquid | Na₂CO₃ | CaCl₂ | | | Alk_{f} | | |
|---|---|---|---|---|---|---|---|---|---|
| | | residence | flow rate | flow rate | Yield | Ca²⁺_{f} | (mM | PSA | XRD |
| | [Na₂CO₃] | time | (mL/min) | (mL/min) | (g/L) | (mM) | eq) | (μm) | |
| Sample 1 | 0.25M | 5 min | 57.1 | 142.9 | — | 78.22 | 3.70 | Median | 96.8% |
| | | | | | | | | 11.06 | vaterite |
| | | | | | | | | Mean | 3.2% |
| | | | | | | | | 11.53 | calcite |
| Sample 2 | 0.25M | 5 min | 57.1 | 142.9 | ~7.21 | 61.72 | 1.51 | Median | 94.6% |
| | | | | | | | | 14.03 | vaterite |
| | | | | | | | | Mean | 5.4% |
| | | | | | | | | 14.60 | calcite |
| Sample 3 | 0.25M | 5 min | 57.1 | 142.9 | ~7.29 | 63.40 | 4.01 | Median | 91.6% |
| | | | | | | | | 12.07 | vaterite |
| | | | | | | | | Mean | 8.4% |
| | | | | | | | | 12.55 | calcite |

Table 13 illustrates the formation of vaterite composition from synthetic brine (tap water+29.4 g/L CaCl₂) (0.6M NaCl+0.2M Ca²⁺) with calcium:base stoichiometric ratio of 1:1.

TABLE 13

| | | Na₂CO₃ | CaCl₂ | | | | |
|---|---|---|---|---|---|---|---|
| | | flow | flow | | | | |
| | Liquid | rate | rate | | Ca²⁺_{f} | Alk_{f} | |
| | residence | (mL/ | (mL/ | Yield | (mmol/ | (mmol/ | |
| [Na₂CO₃] | time | min) | min) | (g/L) | L) | Kg) | XRD |
| 0.25M | 20 min | 22.2 | 27.8 | ~9.78 | 0.14 | 19.51 | 95.5% |
| | | | | | | | vaterite |
| | | | | | | | 4.5% |
| | | | | | | | calcite |

Table 14 for sample 1 and sample 2, illustrates the formation of vaterite composition from synthetic brine (tap water+29.4 g/L CaCl₂+35.06 g/L NaCl) (0.6M NaCl+0.2M Ca²⁺) with calcium:base stoichiometric ratio of 1.5:1.

TABLE 14

| | | Liquid | Na₂CO₃ | CaCl₂ | | | | |
|---|---|---|---|---|---|---|---|---|
| | | residence | flow rate | flow rate | Yield | Ca²⁺_{f} | Alk_{f} | |
| | [Na₂CO₃] | time | (mL/min) | (mL/min) | (g/L) | (mmol/L) | (mmol/Kg) | XRD |
| Sample 1 | 0.25M | 10 min | 34.8 | 65.2 | ~6.89 | 52.26 | 3.84 | 93.7% |
| | | | | | | | | vaterite |
| | | | | | | | | 6.2% |
| | | | | | | | | calcite |
| Sample 2 | 0.5M | 20 min | 10.5 | 39.5 | 11.24 | | 3.66 | 95.2% |
| | | | | | | | | vaterite |
| | | | | | | | | 4.8% |
| | | | | | | | | calcite |

Table 15 illustrates the formation of vaterite composition from synthetic brine (tap water+29.4 g/L CaCl₂+35.06 g/L NaCl) (0.6M NaCl+0.2M Ca²⁺) with calcium:base stoichiometric ratio of 2:1.

TABLE 15

| | | Na₂CO₃ | CaCl₂ | | | | |
|---|---|---|---|---|---|---|---|
| | | flow | flow | | | | |
| | Liquid | rate | rate | | Ca²⁺_{f} | Alk_{f} | |
| | residence | (mL/ | (mL/ | Yield | (mmol/ | (mmol/ | |
| [Na₂CO₃] | time | min) | min) | (g/L) | L) | Kg) | XRD |
| 0.5M | 5 min | 33.3 | 166.7 | ~8.80 | 68.02 | 4.44 | 95.5% |
| | | | | | | | vaterite |
| | | | | | | | 4.5% |
| | | | | | | | calcite |

Table 16 illustrates the formation of vaterite composition from synthetic brine (2.1M NaCl+0.2M Ca²⁺) with calcium:base stoichiometric ratio of 1:1.

TABLE 16

| | | Na₂CO₃ | CaCl₂ | | | | |
|---|---|---|---|---|---|---|---|
| | Liquid | flow | flow | | | | |
| | resi- | rate | rate | | Ca²⁺_{f} | Alk_{f} | |
| | dence | (mL/ | (mL/ | Yield | (mmol/ | (mmol/ | |
| [Na₂CO₃] | time | min) | min) | (g/L) | L) | Kg) | XRD |
| 0.5M | 5 min | 57.1 | 142.9 | ~13.45 | 0.20 | 24.09 | 81.9 % |
| | | | | | | | vaterite |
| | | | | | | | 14.8% |
| | | | | | | | calcite |
| | | | | | | | 3.3% |
| | | | | | | | halite |

Table 17 illustrates the formation of vaterite composition from synthetic brine (2.1M NaCl+0.2M Ca²⁺) with calcium:base stoichiometric ratio of 1.5:1.

TABLE 17

| | | Na₂CO₃ | CaCl₂ | | | | |
|---|---|---|---|---|---|---|---|
| | | flow | flow | | | | |
| | Liquid | rate | rate | | Ca²⁺_{f} | Alk_{f} | |
| | residence | (mL/ | (mL/ | Yield | (mmol/ | (mmol/ | |
| [Na₂CO₃] | time | min) | min) | (g/L) | L) | Kg) | XRD |
| 0.25M | 5 min | 69.6 | 130.4 | ~9.63 | 24.58 | 4 | 95.5 % |
| | | | | | | | vaterite |
| | | | | | | | 4.5% |
| | | | | | | | calcite |

Table 18 for sample 1 and sample 2, illustrates the formation of vaterite composition from synthetic brine (tap water+29.4 g/L CaCl₂+122.72 g/L NaCl) (2.1M NaCl+0.2M Ca²⁺) with calcium:base stoichiometric ratio of 2:1.

TABLE 18

| | | Liquid | Na₂CO₃ | CaCl₂ | | | | |
|---|---|---|---|---|---|---|---|---|
| | | residence | flow rate | flow rate | Yield | Ca²⁺_{f} | Alk_{f} | |
| | [Na₂CO₃] | time | (mL/min) | (mL/min) | (g/L) | (mmol/L) | (mmol/Kg) | XRD |
| Sample 1 | 0.25M | 20 min | 14.3 | 35.7 | ~8.03 | 48.02 | 4.12 | 76.3% |
| | | | | | | | | vaterite |
| | | | | | | | | 22.7% |
| | | | | | | | | calcite |
| | | | | | | | | 1% |
| | | | | | | | | halite |
| Sample 2 | 0.5M | 10 min | 16.7 | 83.3 | ~8.95 | 60.06 | 3.60 | 92.8% |
| | | | | | | | | vaterite |
| | | | | | | | | 5% |
| | | | | | | | | calcite |
| | | | | | | | | 2.2% |
| | | | | | | | | halite |

### Example 6

### Stability of Vaterite Compositions

Vaterite composition made from seawater+CaCl₂ dihydrate+NaCl+25% wt Na₂CO₃ was found to be stable over a period of 4 days (as shown in Table 19 for day 1; day 3; and day 4) in the mother supernate.

TABLE 19

| Day 1 | Day 3 | Day 4 |
|---|---|---|
| Vaterite 69% | Vaterite 65% | Vaterite 65% |
| Calcite 29% | Calcite 30% | Calcite 31% |
| Halite 2% | Halite 4% | Halite 4% |

### Example 7

### Stability of Vaterite Compositions

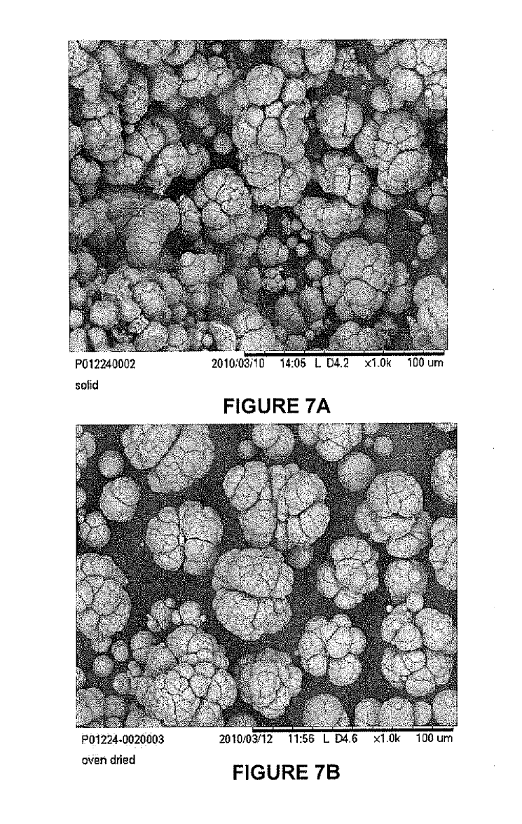

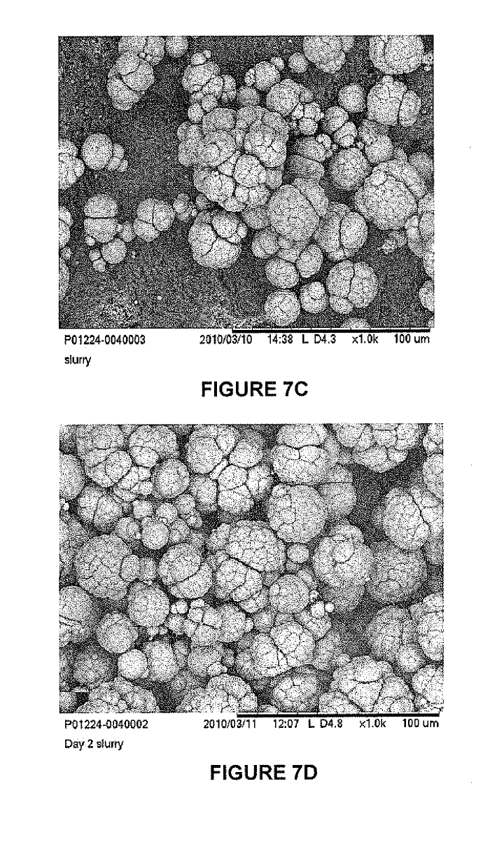

In this study, an effect of a ratio of calcium with the base on the stability of the vaterite composition was studied. Vaterite composition made from tap water+CaCl₂ dihydrate+0.25M Na₂CO₃ (Ca:base stoichiometric ratio of 1:1) was found to be stable over a period of 2 days (as shown in FIG. 7 (FIG. 7A for solid obtained after dewatering but before oven drying; FIG. 7B for solid obtained after dewatering and after oven drying; FIG. 7C for slurry as is from precipitation of the composition after day 1; and FIG. 7D for slurry as is from precipitation of the composition after day 2)) in the mother supernate.

Vaterite composition made from tap water+CaCl₂ dihydrate+0.25M Na₂CO₃ (Ca:base stoichiometric ratio of 1.5:1) was found to show some transformation to calcite over a period of 2 days in the mother supernate.

Vaterite composition made from tap water+CaCl₂ dihydrate+0.25M Na₂CO₃ (Ca:base stoichiometric ratio of 2:1) was found to show almost complete transformation to calcite over a period of 2 days in the mother supernate.

### Example 8

### Stability of Vaterite Compositions

Vaterite composition made from deionized water+CaCl₂ dihydrate+25% wt Na₂CO₃ was found to show some transformation to calcite overnight. The precipitate filtered and oven dried on day 1 contained 87% vaterite, 6% calcite, and 8% ACC. Vaterite showed no agglomeration on day 1. The precipitate that settled overnight and was filtered and oven dried the next day, contained 52% vaterite and 48% calcite.

### Example 9

### Carbonate Precipitate from Trona Brine

Trona brine was mixed with calcium chloride with varying ratios of Ca:CO₃ to result in carbonate compositions of the invention. The samples were analyzed after 120 minutes for particle size (PSA), polymorph and morphology. Table 20 illustrates the summary of the results. All the samples showed calcite formation with varying particle size and morphology.

TABLE 20

| | | | | | | Relative | | |
|---|---|---|---|---|---|---|---|---|
| | | | | PSA | Standard | standard | | |
| | | | | Mean | deviation | deviation | | |
| Exp | [CaCl₂] | Ca:CO₃ | T | Diameter | (SD) | (RSD) | Polymorph | Morphology |
| ID | (mM) | (mol:mol) | (° C.) | (μm) | (μm) | (%) | (XRD) | (SEM) |
| P01422 | 100 | .5 | 20 | 5.66 | 0.40 | 12% | Calcite | Agglomerated |
| | | | | | | | | spheres and |
| | | | | | | | | twins |
| P01423 | 200 | 2 | 20 | 5.73 | 2.36 | 41% | Calcite | Agglomerated |
| | | | | | | | | spheres and |
| | | | | | | | | twins |
| P01424 | 100 | .5 | 20 | 5.10 | 0.62 | 12% | Calcite | Agglomerated |
| | | | | | | | | spheres and |
| | | | | | | | | twins |
| P01425 | 200 | 3 | 20 | 6.51 | 0.80 | 12% | Calcite | Agglomerated |
| | | | | | | | | spheres and |
| | | | | | | | | twins |
| P01427 | 200 | 1 | 40 | 5.88 | 2.07 | 35% | Calcite | Agglomerated |
| | | | | | | | | spheres and |
| | | | | | | | | twins |
| P01428 | 100 | 3 | 40 | 11.30 | 3.73 | 33% | Calcite | Agglomerated |
| | | | | | | | | spheres |
| P01429 | 200 | 2 | 40 | 5.38 | 2.19 | 41% | Calcite | Agglomerated |
| | | | | | | | | spheres and |
| | | | | | | | | twins |
| P01431 | 100 | 1 | 40 | 7.92 | 1.00 | 13% | Calcite | Agglomerated |
| | | | | | | | | spheres |

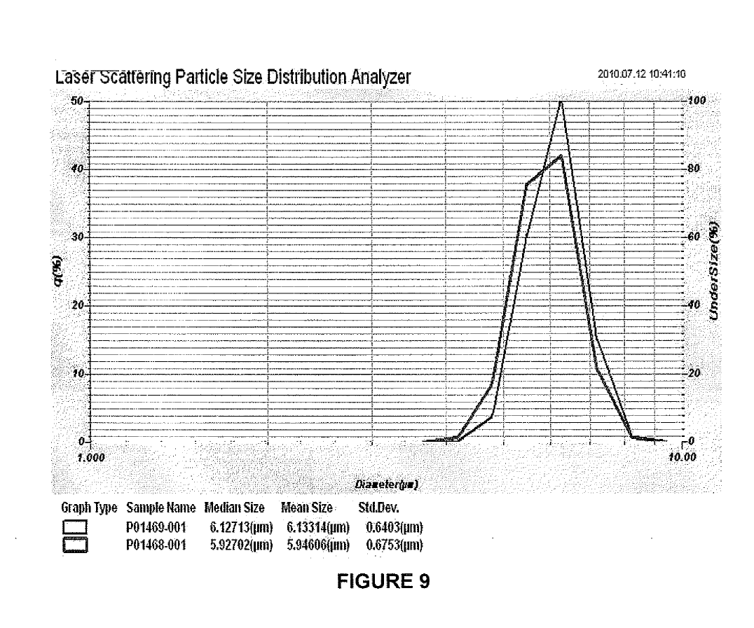

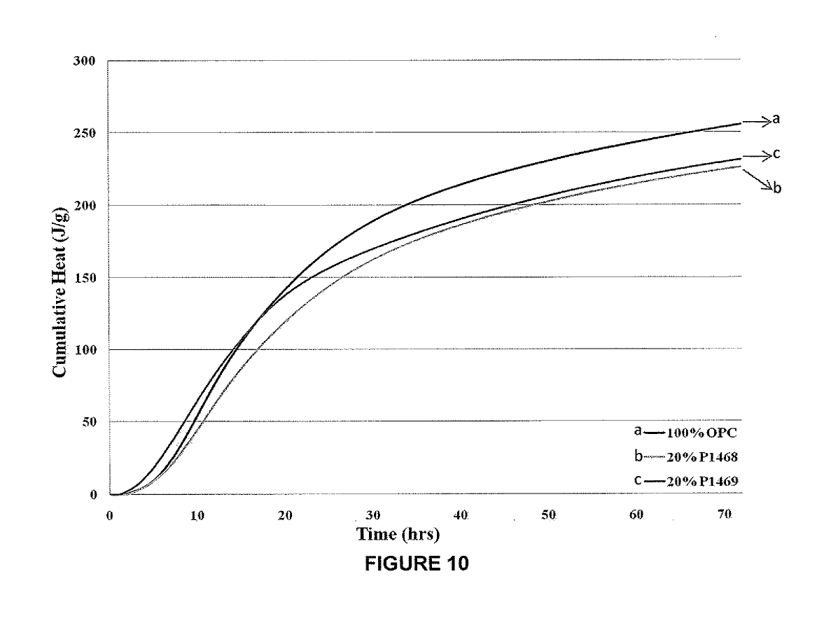

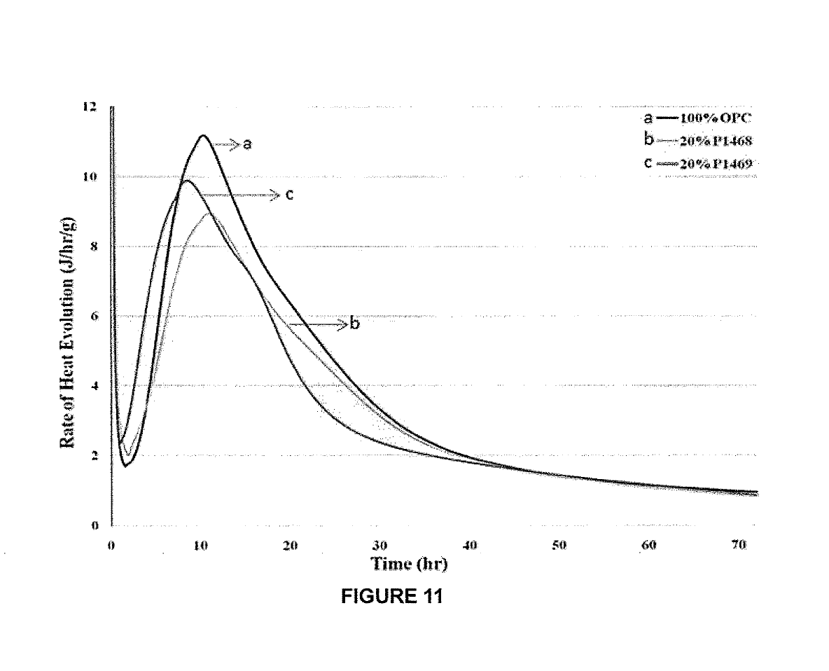

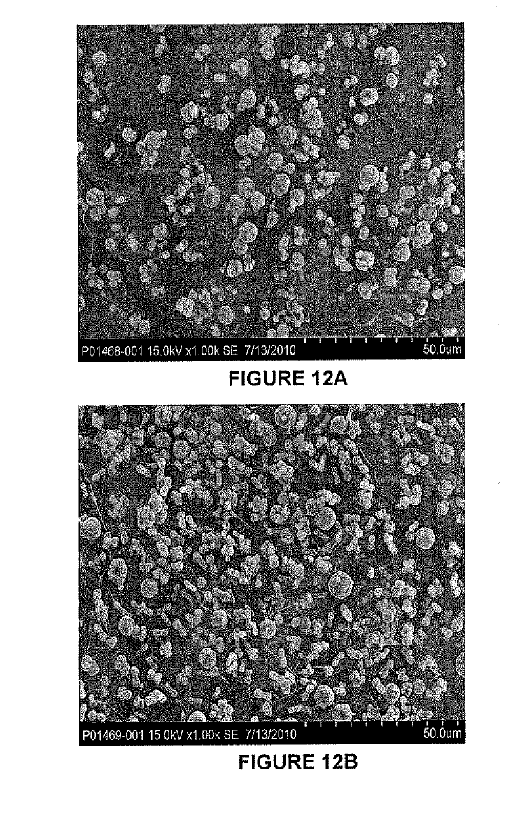

Samples P1422 was repeated as sample P1468 and sample P1423 was repeated as sample P1469. It was observed that while samples P1468 and P1469 had comparable particle size (FIG. 9) and comparable cumulative heat (FIG. 10 for 20% P1468 and P1469 with 80% OPC), the samples showed varying heat of evolution. The sample P1469 (20% P1469 in 80% OPC) showed acceleration effect where the peak in the heat evolution graph (FIG. 11) showed a shift to the left side. Without being bound by any theory, it is contemplated that physical properties, such as, particle size, surface area, and/or morphology may play a role in the heat evolution of the composition. FIG. 12A and FIG. 12B illustrate the SEM images of the samples P1468 and P1469, respectively.

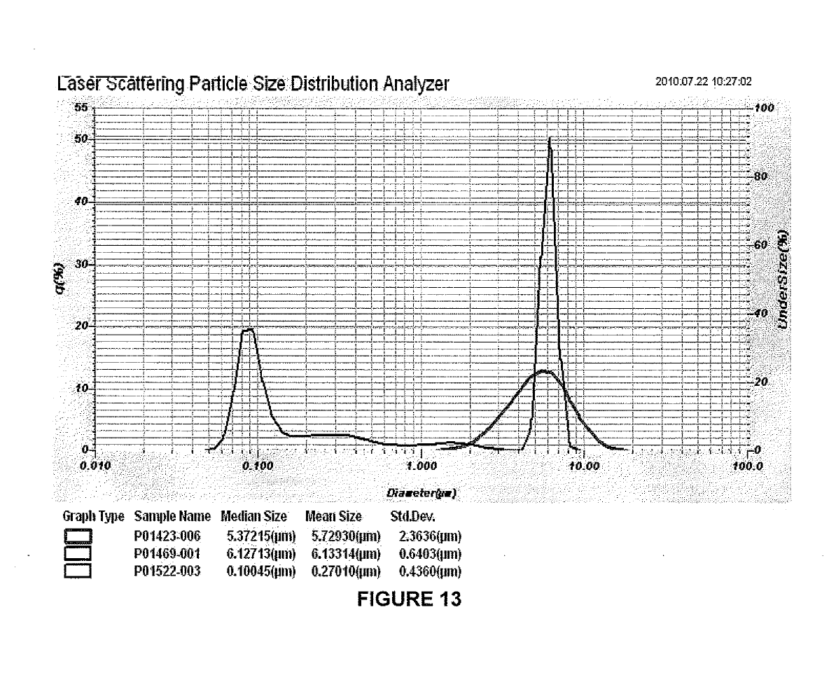

The reaction similar to P1423 or P1469 was scaled up with the same stoichiometric conditions to give sample P1522. It was observed that the scaled up reaction with vigorous mechanical agitation resulted in finer rod shaped particles. The particle size comparison of the samples P1423, P1469, and P1522, is illustrated in FIG. 13.

The summary of the comparison of the particle size and morphology is illustrated in Table 21.

TABLE 21

| | | | | PSA Mean | | | | |
|---|---|---|---|---|---|---|---|---|
| Exp | [CaCl₂] | Ca:CO₃ | T | Diameter | SD | RSD | Polymorph | Morphology |
| ID | (mM) | (mol:mol) | (° C.) | (μm) | (μm) | (%) | (XRD) | (SEM) |
| P01423 | 200 | 2 | 20 | 5.73 | 2.36 | 41% | Calcite | Agglomerated |
| | | | | | | | | spheres and |
| | | | | | | | | twins |
| P01469 | 200 | 2 | 20 | 6.13 | 0.64 | 41% | Calcite | Agglomerated |
| | | | | | | | | spheres and |
| | | | | | | | | twins |
| P01522 | 200 | 2 | 20 | 0.27 | 0.43 | 41% | Calcite | Rods |

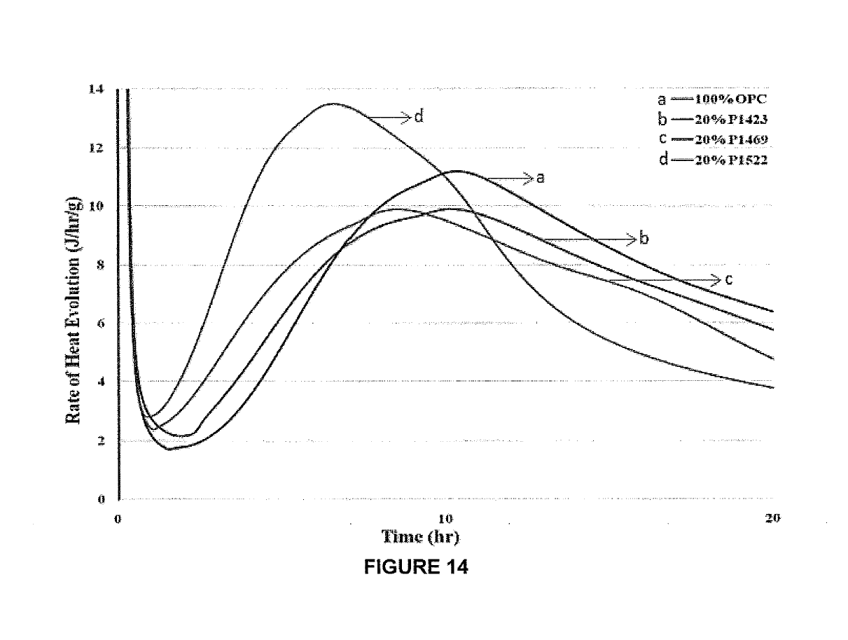

The rate of heat evolution (FIG. 14) of 20% of the samples P1423, P1469, and P1522 with 80% OPC in comparison with 100% OPC, showed an acceleration effect for P1522 where the graph shifted to the left side.

The compressive strength comparison of 20% of P1522 in 80% OPC with 100% OPC showed that the compressive strength at 1 day for 20% P1522 in 80% OPC was 78% of 100% OPC. The P1522 showed higher demand for water due to small particle size. The higher water/cement ratio (W/CM) of 20% P1522 and 80% OPC might have contributed to lower compressive strength, however, even with high water/cement ratio, the P1522 composition showed 78% compressive strength as compared to 100% OPC.

TABLE 22

| | | | Compressive strength (psi) | | | |
|---|---|---|---|---|---|---|
| | W/CM | Flow | 1 d | 3 d | 7 d | 28 d |
| 100 | 0.49 | ~90% | 1900 | 3280 | 4230 | |
| Average baselines | | | | | | |
| 80/20 | 0.57 | 62% | 1490 (78%) | | | |
| P1522 | | | | | | |

### Example 10

### Large Scale Reaction with Trona Brine

A 5.12 L per batch of trona brine (density (g/mL):1.25, pH:9.5, alk (mmol/Kg):998, % C:0.43) was mixed with 10.01 L of CaCl₂ ([CaCl₂]:0.100 mol/L) for 120 minutes using a IKA RW 20 digital blue mixer. The reaction was conducted in batches by changing reaction conditions, such as, mixing speed, filtration techniques, and viscosity measurements. The reactions conditions were as illustrated in Table 23. Under the tested reaction conditions, 100% calcite product was observed.

TABLE 23

| | | | | Mixed batches 2-4 |
|---|---|---|---|---|
| Batch 1 | Batch 2 | Batch 3 | Batch 4 | to create batch 5 |
| Mixer insertion | Mixer insertion | Mixer insertion | Mixer insertion | |
| near side | near side | at center | at center | |
| Propeller depth: | Propeller depth: | Propeller depth: | Propeller depth: | |
| 21 in | 21 in | 21 in | 21 in | |
| Mixing speed: | Mixing speed: | Mixing speed: | Mixing speed: | |
| 1500 rpm | 1800 rpm | 1800 rpm | 1800 rpm | |
| filter with 1 L | filter with large | filter with large | filter with large | |
| filter flask | Buchner funnel | Buchner funnel | Buchner funnel | |
| Whatman #3 | | and 1 L filter flask | and 1 L filter flask | |
| | | with Whatman #3 | with Whatman #3 | |
| XRD-100% calcite | XRD-100% calcite | XRD-100% calcite | XRD-100% calcite | XRD-100% calcite |
| PSA-mean: 0.76 μm, | PSA-mean: 0.09 μm, | PSA-mean: 0.09 μm, | PSA-mean: 0.10 μm, | PSA-mean: 0.10 μm, |
| median: 0.40 μm | median: 0.28 μm | median: 0.30 μm | median: 0.31 μm | median: 0.27 μm |
| SEM: capsulated rods | SEM: capsulated rods | SEM: capsulated rods | SEM: capsulated rods | |

What is claimed is:

1. A cementitious composition, comprising: a carbonate, bicarbonate, or mixture thereof and one or more elements selected from the group consisting of barium, cobalt, copper, lanthanum, mercury, arsenic, cadmium, lead, nickel, scandium, titanium, zinc, zirconium, molybdenum, and selenium, wherein the composition upon combination with water; setting; and hardening has a compressive strength of at least 14 MPa.

2. The cementitious composition of claim 1, wherein the carbonate comprises at least 47% w/w vaterite.

3. The cementitious composition of claim 1, wherein the one or more elements are selected from the group consisting of lanthanum, mercury, arsenic, lead, and selenium.

4. The cementitious composition of claim 1, wherein each of the one or more elements are present in the composition in an amount of between 0.1-1000 ppm.

5. The cementitious composition of claim 1, wherein the composition is a particulate composition with an average particle size of 0.1-100 microns.

6. The cementitious composition of claim 1, wherein the composition has a δ¹³C of greater than −5‰.

7. The cementitious composition of claim 1, wherein the carbonate comprises a polymorph selected from the group consisting of amorphous calcium carbonate, aragonite, calcite, ikaite, a precursor phase of vaterite, a precursor phase of aragonite, an intermediary phase that is less stable than calcite, polymorphic forms in between these polymorphs, and combination thereof.

8. The cementitious composition of claim 1, wherein the composition further comprises Portland cement, aggregate, supplementary cementitious material (SCM), or combination thereof.

9. The cementitious composition of claim 1, wherein the composition is a hydraulic cement, a supplementary cementitious material, a self-cementing material, or an aggregate.

10. The cementitious composition of claim 1, wherein the composition has a zeta potential of greater than −25 mV.

11. A formed building material, comprising: the composition of claim 1 or the set and hardened form thereof.

12. A method comprising: contacting a source of cation with a carbonate brine to give a reaction product comprising carbonic acid, bicarbonate, carbonate, or mixture thereof.

13. The method of claim 12, further comprising using a portion of the reaction product to produce a building material.

14. The method of claim 12, wherein the source of cation is an aqueous solution containing alkaline earth metal ions.

15. The method of claim 14, wherein the alkaline earth metal ion is calcium ion, magnesium ion, or combination thereof.

16. The method of claim 12, wherein the carbonate brine comprises 5% to 95% carbonate by wt.

17. The method of claim 12, wherein the method further comprises adding a proton removing agent.

18. The method of claim 17, wherein the proton removing agent is sodium hydroxide.

19. The method of claim 12, wherein the method comprises one or more of conditions selected from the group consisting of temperature, pH, precipitation, residence time of the precipitate, dewatering of the precipitate, washing the precipitate with water, drying, milling, and storage.

20. A system, comprising:
a) an input for a source of cation,
b) an input for a source of carbonate brine, and
c) a reactor connected to the inputs of step (a) and step (b) that is configured to give a reaction product comprising carbonic acid, bicarbonate, carbonate, or mixture thereof.
